(19) United States
(12) Patent Application Publication
(10) Pub. No.: US 2026/0270386 A1
(43) Pub. Date: Sep. 10, 2026

(54) AERIAL FLOATING VIDEO DISPLAY APPARATUS, MOBILE TERMINAL, AND DISPLAY METHOD

(71) Applicant: Maxell, Ltd., Kyoto (JP)

(72) Inventors: Kazuo SHIKITA, Kyoto (JP); Toshimasa NAGAI, Kyoto (JP); Koji FUJITA, Kyoto (JP); Sho ASAKURA, Kyoto (JP); Takuya SHIMIZU, Kyoto (JP)

(73) Assignee: Maxell, Ltd., Kyoto (JP)

(21) Appl. No.: 19/491,412

(22) PCT Filed: Apr. 26, 2024
(86) PCT No.: PCT/JP2024/016594

§ 371 Date: Dec. 9, 2025

(30) Foreign Application Priority Data
Jun. 13, 2023 (JP) 2023-097155
Dec. 1, 2023 (JP) 2023-204087

(51) Int. Cl. H04N 13/388; G06F 3/01; G06V 20/20; G06V 20/40; G06V 40/20; H04N 13/275; H04N 13/366; H04N 13/398

(52) U.S. Cl. CPC H04N 13/388; G06F 3/011; G06V 20/20; G06V 20/41; G06V 40/28; H04N 13/275; H04N 13/366; H04N 13/398

(57) ABSTRACT

An aerial floating video display apparatus that includes a video processor, a display configured to display a video that has been subjected to video processing by the video processor, an optical system configured to generate an aerial floating video based on the video displayed on the display, a recognition unit configured to recognize contact of an object with a display range of the aerial floating video, and a communication unit configured to communicate with a user's mobile terminal, and when contact of the mobile terminal with the display range is recognized, a target image designated at the mobile terminal side is displayed as the aerial floating video.

### TECHNICAL FIELD

The present invention relates to an aerial floating video display apparatus.

### BACKGROUND ART

For example, Patent Document 1 discloses an aerial floating information display technology.

### RELATED ART DOCUMENT

### Patent Document

[Patent Document 1] Japanese Patent Application Laid-open Publication No. 2019-128722

### SUMMARY OF THE INVENTION

### Problems to be Solved by the Invention

However, in the disclosure of Patent Document 1, sufficient consideration has not been given to the configuration for obtaining practical brightness and quality of an aerial floating video, the configuration for enabling a user to visually recognize an aerial floating video more enjoyably, and the like.

An object of the present invention is to provide a more suitable aerial floating video display apparatus.

### Means for Solving the Problems

In order to solve the problem described above, for example, the configuration described in claims is adopted. Although this application includes a plurality of means for solving the problem, one example thereof may be presented as an aerial floating video display apparatus including a video processor, a display configured to display a video that has been subjected to video processing by the video processor, an optical system configured to generate an aerial floating video based on the video displayed on the display, a recognition unit configured to recognize contact of an object with a display range of the aerial floating video, an a communication unit configured to communicate with a user's mobile terminal. When contact of the mobile terminal with the display range is recognized, a target image designated at the mobile terminal side is displayed as the aerial floating video.

### Effects of the Invention

According to the present invention, it is possible to realize a more suitable aerial floating video display apparatus. Other problems, configurations, and effects will become apparent in the following description of the embodiments.

### BRIEF DESCRIPTIONS OF THE DRAWINGS

FIG. 1 A diagram showing an example of usage form of an air floating video display apparatus according to one embodiment of the present invention.

FIG. 2A A diagram showing examples of a configuration of a main part and a configuration of a retroreflection portion of the air floating video display apparatus according to one embodiment of the present invention.

FIG. 2B A diagram showing examples of a configuration of a main part and a configuration of a retroreflection portion of the air floating video display apparatus according to one embodiment of the present invention.

FIG. 2C A diagram showing examples of a configuration of a main part and a configuration of a retroreflection portion of the air floating video display apparatus according to one embodiment of the present invention.

FIG. 2D A diagram showing examples of a configuration of a main part and a configuration of a retroreflection portion of the aerial floating video display apparatus according to one embodiment of the present invention.

FIG. 2E A projection drawing of a retroreflection plate constituting the aerial floating video display apparatus according to one embodiment of the present invention.

FIG. 2F A top view showing the retroreflection plate constituting the aerial floating video display apparatus according to one embodiment of the present invention.

FIG. 2G A perspective view showing a corner reflector constituting the retroreflection plate constituting the aerial floating video display apparatus according to one embodiment of the present invention.

FIG. 2H A top view showing the corner reflector constituting the retroreflection plate constituting the aerial floating video display apparatus according to one embodiment of the present invention.

FIG. 2I A side view showing the corner reflector constituting the retroreflection plate constituting the aerial floating video display apparatus according to one embodiment of the present invention.

FIG. 3 A diagram showing a configuration example of an air floating video display apparatus according to one embodiment of the present invention.

FIG. 4A A diagram showing an example of the configuration of the air floating video display apparatus according to one embodiment of the present invention.

FIG. 4B A diagram showing an example of the configuration of the air floating video display apparatus according to one embodiment of the present invention.

FIG. 4C A diagram showing an example of the configuration of the air floating video display apparatus according to one embodiment of the present invention.

FIG. 4D A diagram showing an example of the configuration of the air floating video display apparatus according to one embodiment of the present invention.

FIG. 4E A diagram showing an example of the configuration of the air floating video display apparatus according to one embodiment of the present invention.

FIG. 4F A diagram showing an example of the configuration of the air floating video display apparatus according to one embodiment of the present invention.

FIG. 4G A diagram showing an example of the configuration of the air floating video display apparatus according to one embodiment of the present invention.

FIG. 4H A diagram showing an example of the configuration of the air floating video display apparatus according to one embodiment of the present invention.

FIG. 4I A diagram showing an example of the configuration of the air floating video display apparatus according to one embodiment of the present invention.

FIG. 4J A diagram showing an example of the configuration of the air floating video display apparatus according to one embodiment of the present invention.

FIG. 4K A diagram showing an example of the configuration of the air floating video display apparatus according to one embodiment of the present invention.

FIG. 4L A diagram showing an example of the configuration of the air floating video display apparatus according to one embodiment of the present invention.

FIG. 4M A diagram showing an example of the configuration of the air floating video display apparatus according to one embodiment of the present invention.

FIG. 4N A diagram showing an example of the configuration of the air floating video display apparatus according to one embodiment of the present invention.

FIG. 4O A diagram showing an example of the configuration of the air floating video display apparatus according to one embodiment of the present invention.

FIG. 5 A cross-sectional view showing a configuration of a display apparatus according to one embodiment of the present invention.

FIG. 6 A cross-sectional view showing a configuration of the display apparatus according to one embodiment of the present invention.

FIG. 7 A cross-sectional view showing a configuration of the display apparatus according to one embodiment of the present invention.

FIG. 8 A layout drawing showing a main part of the air floating video display apparatus according to one embodiment of the present invention.

FIG. 9 A cross-sectional view showing a configuration of a display apparatus according to one embodiment of the present invention.

FIG. 10 A cross-sectional view showing a configuration of a display apparatus according to one embodiment of the present invention.

FIG. 11 An explanatory diagram for describing light source diffusion characteristics of the video display apparatus according to one embodiment of the present invention.

FIG. 12 An explanatory diagram for describing diffusion characteristics of the video display apparatus according to one embodiment of the present invention.

FIG. 13A An explanatory diagram of an example of a problem to be solved by image processing according to one embodiment of the present invention.

FIG. 13B An explanatory diagram of an example of image processing according to one embodiment of the present invention.

FIG. 13C An explanatory diagram of an example of video display processing according to one embodiment of the present invention.

FIG. 13D An explanatory diagram of an example of video display processing according to one embodiment of the present invention.

FIG. 14 A diagram showing an example of a configuration of a main part and a configuration of a retroreflection portion of the air floating video display apparatus according to one embodiment of the present invention.

FIG. 15 A diagram showing a configuration of the air floating video display system according to one embodiment of the present invention.

FIG. 16 A diagram schematically showing the air floating video display system according to one embodiment of the present invention.

FIG. 17 A diagram showing a configuration of a mobile terminal according to one embodiment of the present invention.

FIG. 18A A perspective view showing insertion and contact operations of the mobile terminal with respect to the air floating video according to one embodiment of the present invention.

FIG. 18B A plan view in an XY plane showing insertion and contact operations of the mobile terminal with respect to the air floating video according to one embodiment of the present invention.

FIG. 18C A plan view in a YZ plane showing insertion and contact operations of the mobile terminal with respect to the air floating video according to one embodiment of the present invention.

FIG. 18D A plan view in an XZ plane showing insertion and contact operations of the mobile terminal with respect to the air floating video according to one embodiment of the present invention.

FIG. 19A A perspective view showing an example of an attitude and the like of the mobile terminal at the time of insertion and contact operations with respect to the air floating video according to one embodiment of the present invention.

FIG. 19B A plan view in the XY plane showing an example of an attitude and the like of the mobile terminal at the time of insertion and contact operations with respect to the air floating video according to one embodiment of the present invention.

FIG. 19C A plan view in the YZ plane showing an example of an attitude and the like of the mobile terminal at the time of insertion and contact operations with respect to the air floating video according to one embodiment of the present invention.

FIG. 19D A plan view in the XZ plane showing an example of an attitude and the like of the mobile terminal at the time of insertion and contact operations with respect to the air floating video according to one embodiment of the present invention.

FIG. 19E A plan view in the YZ plane showing an example of an attitude and the like of the mobile terminal at the time of insertion and contact operations with respect to the air floating video according to one embodiment of the present invention.

FIG. 19F A plan view in the YZ plane showing an example of an attitude and the like of the mobile terminal at the time of insertion and contact operations with respect to the air floating video according to one embodiment of the present invention.

FIG. 20A A plan view in the YZ plane showing an example of a position and the like of the mobile terminal at the time of insertion and contact operations with respect to the air floating video according to one embodiment of the present invention.

FIG. 20B A plan view in the XY plane showing an example of a position and the like of the mobile terminal at the time of insertion and contact operations with respect to the air floating video according to one embodiment of the present invention.

FIG. 20C A plan view in the YZ plane showing an example of a position and the like of the mobile terminal at the time of insertion and contact operations with respect to the air floating video according to one embodiment of the present invention.

FIG. 21A An explanatory diagram showing a display example of a guide image on the air floating video according to one embodiment of the present invention.

FIG. 21B An explanatory diagram showing a display example of a guide image on the air floating video according to one embodiment of the present invention.

FIG. 22A A plan view in the XY plane showing an example of contact of the mobile terminal with respect to the air floating video according to one embodiment of the present invention.

FIG. 22B A plan view in the XZ plane showing an example of a non-visible region caused by contact of the mobile terminal with respect to the air floating video according to one embodiment of the present invention.

FIG. 22C A plan view in the YZ plane showing an example of light obstruction caused by contact of the mobile terminal with respect to the air floating video according to one embodiment of the present invention.

FIG. 23A A plan view in the XY plane showing a display example of a guide image on the air floating video and an example of the non-visible region caused by contact of the mobile terminal according to one embodiment of the present invention.

FIG. 23B A plan view in the XY plane showing a display example of the guide image on the air floating video and an example of a display region restriction according to one embodiment of the present invention.

FIG. 24A A plan view in the XY plane showing a display example of the guide image on the air floating video according to one embodiment of the present invention.

FIG. 24B A plan view in the XY plane showing a display example of the guide image on the air floating video according to one embodiment of the present invention.

FIG. 24C An explanatory diagram showing a display example of the guide image on the air floating video and the display region restriction according to one embodiment of the present invention.

FIG. 24D An explanatory diagram showing an example of guide audio output according to one embodiment of the present invention.

FIG. 25A A cross-sectional view in the YZ plane showing an arrangement example of sensors in the air floating video display apparatus according to one embodiment of the present invention.

FIG. 25B A plan view in the XY plane showing a configuration example of an aerial operation detection sensor according to one embodiment of the present invention.

FIG. 25C A cross-sectional view in the YZ plane showing an arrangement example of sensors in the air floating video display apparatus according to one embodiment of the present invention.

FIG. 26A An explanatory diagram showing a display example of an application screen of the mobile terminal according to one embodiment of the present invention.

FIG. 26B An explanatory diagram showing a display example of the application screen of the mobile terminal according to one embodiment of the present invention.

FIG. 26C An explanatory diagram showing a display example of the application screen in the mobile terminal according to one embodiment of the present invention.

FIG. 27A An explanatory diagram showing a display example of a QR code screen in the mobile terminal according to one embodiment of the present invention.

FIG. 27B A cross-sectional view in the YZ plane showing an example of imaging a QR code of the mobile terminal in the air floating video display apparatus according to one embodiment of the present invention.

FIG. 28A A perspective view showing a display example of the QR code on the air floating video according to one embodiment of the present invention.

FIG. 28B A cross-sectional view in the YZ plane showing an example of imaging the QR code on the air floating video of the air floating video display apparatus by the mobile terminal according to one embodiment of the present invention.

FIG. 28C A perspective view showing a display example of the QR code in a screen of a second display apparatus according to one embodiment of the present invention.

FIG. 29 A drawing showing a configuration example of a system according to one embodiment of the present invention, with the mobile terminal and the air floating video display apparatus are communicatively connected.

FIG. 30 A drawing showing an example of dual display between the mobile terminal and the air floating video display apparatus according to one embodiment of the present invention.

FIG. 31 A drawing showing a flow of basic controls of the system according to one embodiment of the present invention.

FIG. 32A A drawing showing an example of display and settings before connection of the system according to one embodiment of the present invention.

FIG. 32B A drawing showing an example (modes) of display and settings after connection of the system according to one embodiment of the present invention.

FIG. 33 A drawing showing a GUI example (1) for mode settings as an example of a screen display of the mobile terminal according to one embodiment of the present invention.

FIG. 34 A drawing showing a GUI example (2) for mode settings as an example of a screen display of the mobile terminal according to one embodiment of the present invention.

FIG. 35 A drawing showing a functional block configuration example of the system according to one embodiment of the present invention.

FIG. 36 A drawing showing a configuration example of a screen of the air floating video display apparatus and an example of the screen of the mobile terminal according to one embodiment of the present invention.

FIG. 37 A drawing showing Example 1 of a problem and its solution according to one embodiment of the present invention.

FIG. 38 A drawing showing Example 2 of a problem and its solution according to one embodiment of the present invention.

FIG. 39 A drawing showing Example 3 of a problem and its solution according to one embodiment of the present invention.

FIG. 40 A drawing showing Example 4 of a problem and its solution according to one embodiment of the present invention.

FIG. 41 A drawing showing examples (patterns) of image display of the air floating video display apparatus and the mobile terminal according to one embodiment of the present invention.

FIG. 42 A drawing showing examples of operations that are control targets and sensors used for controlling such operations according to one embodiment of the present invention.

FIG. 43 A drawing showing Example 1 of an attitude of the air floating video display apparatus according to one embodiment of the present invention.

FIG. 44 A drawing showing Example 2 of an attitude of the air floating video display apparatus according to one embodiment of the present invention.

FIG. 45 A drawing showing Example 3 of an attitude of the air floating video display apparatus according to one embodiment of the present invention.

FIG. 46 A drawing showing an exemplary sequence (1) in Mode 1 according to one embodiment of the present invention.

FIG. 47 A drawing showing an exemplary sequence (2) in Mode 1 according to one embodiment of the present invention.

FIG. 48 A drawing showing an exemplary sequence (3) in Mode 1 according to one embodiment of the present invention.

FIG. 49 A drawing showing an exemplary sequence (4) in Mode 1 according to one embodiment of the present invention.

FIG. 50 A drawing showing an exemplary sequence (1) in Mode 2 according to one embodiment of the present invention.

FIG. 51 A drawing showing an exemplary sequence (2) in Mode 2 according to one embodiment of the present invention.

FIG. 52 A drawing showing an exemplary sequence (1) in Mode 3 according to one embodiment of the present invention.

FIG. 53 A drawing showing an exemplary sequence (2) in Mode 3 according to one embodiment of the present invention.

FIG. 54 A drawing showing an exemplary sequence (1) in Mode 5 according to one embodiment of the present invention.

FIG. 55 A drawing showing an exemplary sequence (1) in Mode 7 according to one embodiment of the present invention.

FIG. 56 A drawing showing an exemplary sequence (2) in Mode 7 according to one embodiment of the present invention.

FIG. 57 A drawing showing an exemplary sequence (3) in Mode 7 according to one embodiment of the present invention.

FIG. 58 A drawing showing an exemplary sequence (4) in Mode 7 according to one embodiment of the present invention.

FIG. 59 A drawing showing an exemplary sequence (1) in Mode 8 according to one embodiment of the present invention.

FIG. 60 A drawing showing an exemplary sequence (2) in Mode 8 according to one embodiment of the present invention.

FIG. 61 A drawing showing an exemplary sequence (1) in Mode 9 according to one embodiment of the present invention.

FIG. 62 A drawing showing an exemplary sequence (2) in Mode 9 according to one embodiment of the present invention.

FIG. 63 A drawing showing an exemplary sequence (1) in Mode 11 according to one embodiment of the present invention.

### DETAILED DESCRIPTION OF THE INVENTION

Hereinafter, embodiments of the present invention will be described in detail with reference to the drawings. Note that the present invention is not limited to the described embodiments, and various changes and modifications can be made by those skilled in the art within the scope of the technical idea disclosed in this specification. Further, in all of the drawings for describing the present invention, components having the same function are denoted by the same reference characters, and repetitive descriptions will be omitted in some cases.

The following embodiments relate to a video display apparatus capable of transmitting a video by video light from a video light emitting source through a transparent member such as glass that partitions a space, and displaying the video as an air floating video outside the transparent member. In the following description of the embodiments, a video floating in the air is expressed by the term “air floating video”. Instead of this term, expressions such as “aerial image”, “space image”, “aerial floating video”, “air floating optical image of a display image”, “aerial floating optical image of a display image”, etc. may be used. The term “air floating video” mainly used in the description of the embodiments is used as a representative example of these terms.

According to the following embodiments, for example, it is possible to realize a video display apparatus suitable for an ATM of a bank, a ticket vending machine of a train station, a digital signage, or the like. For example, though a touch panel is generally used in an ATM of a bank, a ticket vending machine of a station, or the like at present, it becomes possible to display high-resolution video information above a transparent glass surface or a light-transmitting plate material in a state of floating in the air. At this time, by making the divergence angle of the emitted video light small, that is, an acute angle, and further aligning the video light with a specific polarized wave, only the normal reflected light is efficiently reflected with respect to the retroreflection plate, so that the light utilization efficiency can be increased, the ghost image which is generated in addition to the main air floating image and is a problem in the conventional retroreflective system can be suppressed, and a clear air floating video can be obtained. Also, with the apparatus including the light source of the present embodiment, it is possible to provide a novel and highly usable air floating video display apparatus (air floating video display system) capable of significantly reducing power consumption.

Further, it is also possible to provide an in-vehicle air floating video display apparatus capable of displaying a so-called unidirectional air floating video which can be visually recognized inside and/or outside the vehicle.

### First Embodiment

### Example of Usage Form of Air Floating Video Display Apparatus

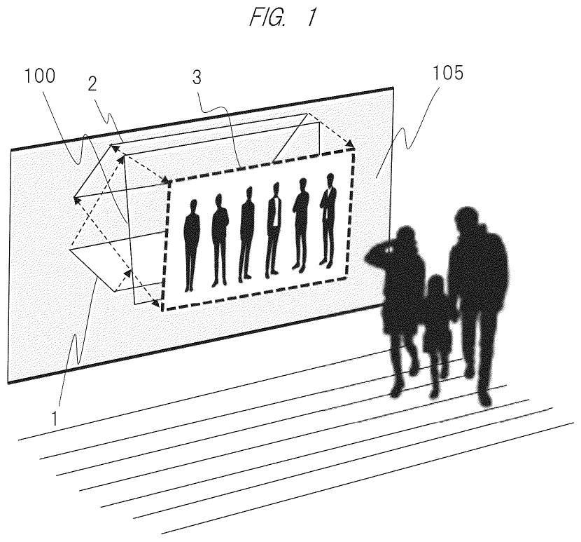

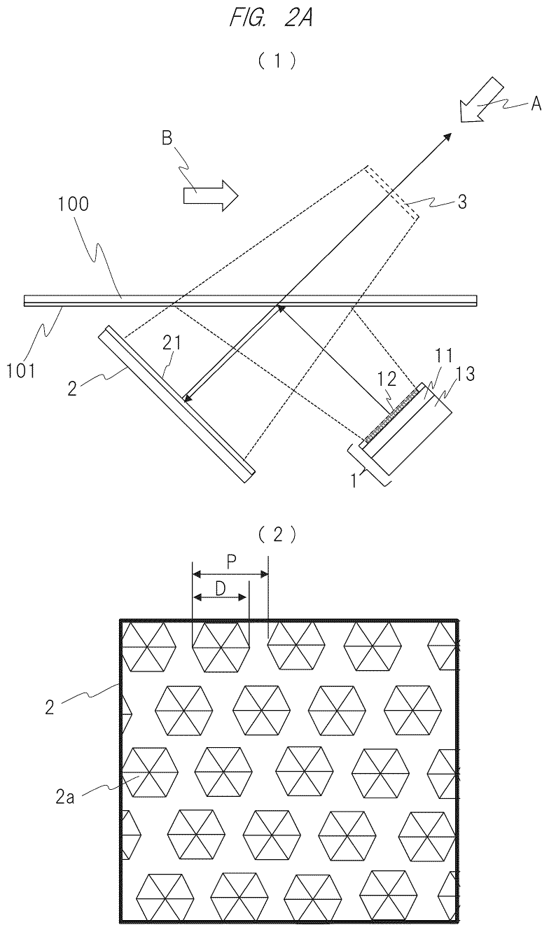

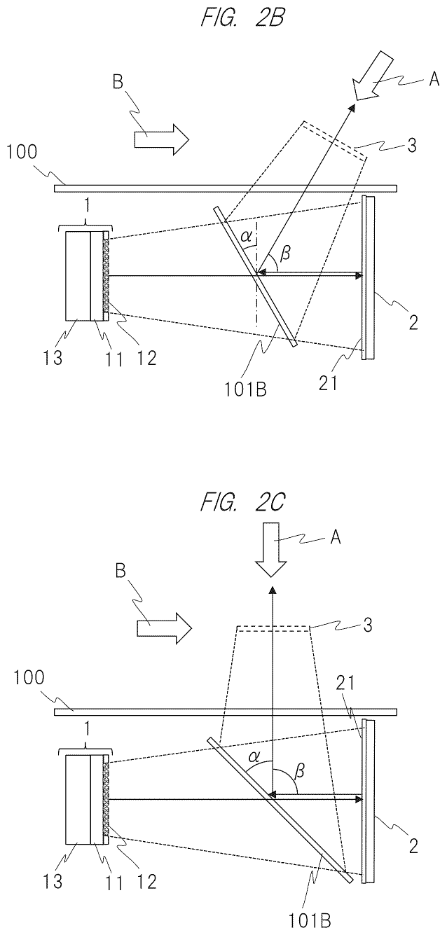

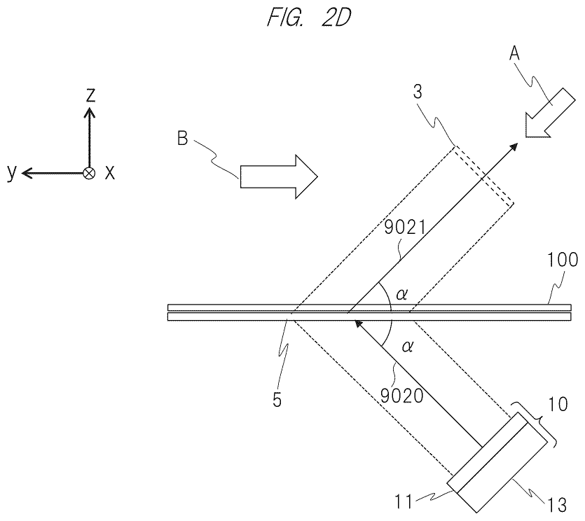

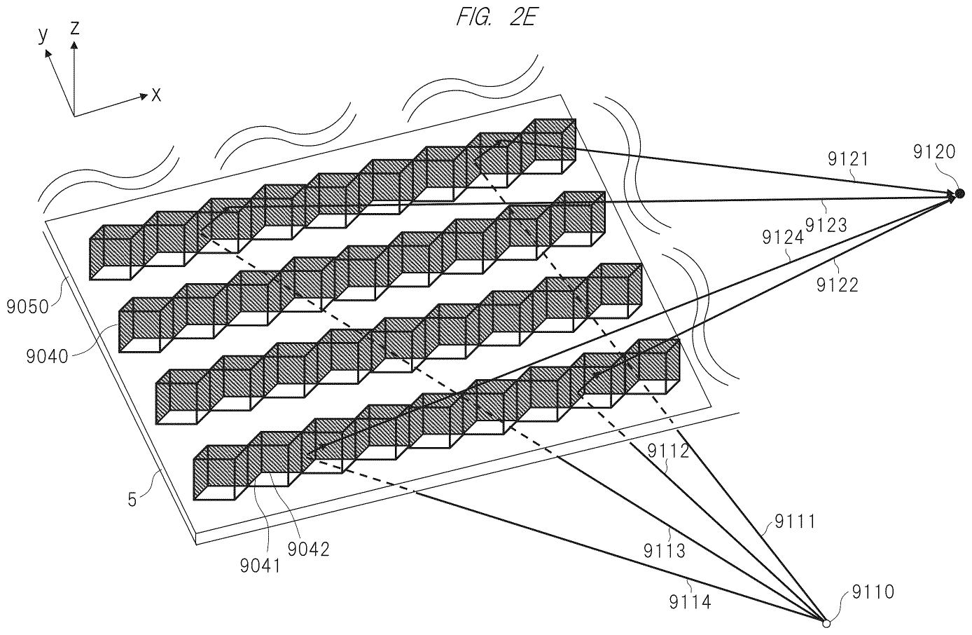

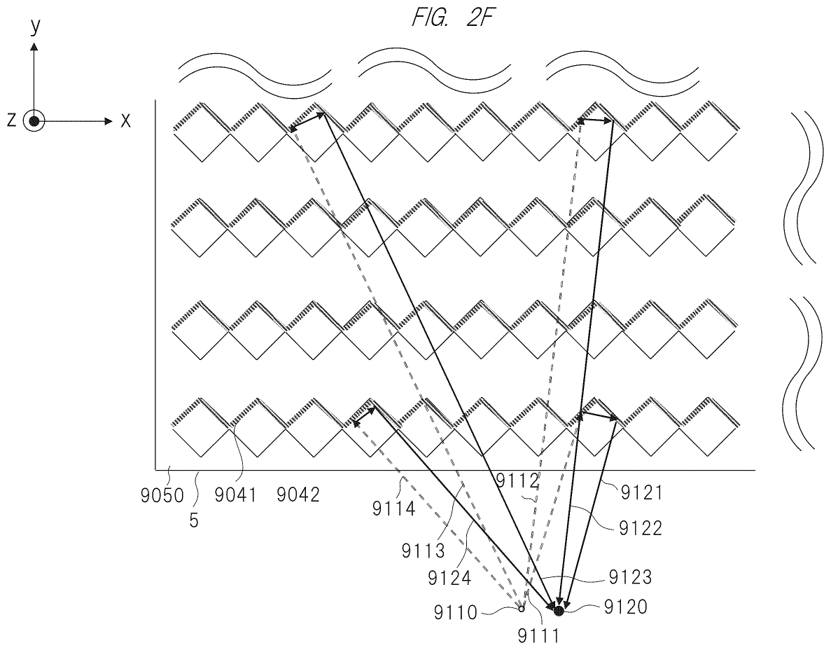

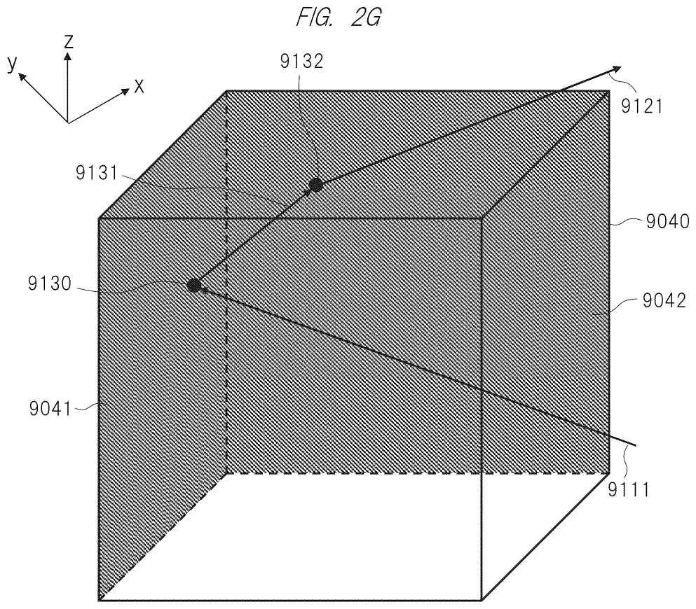

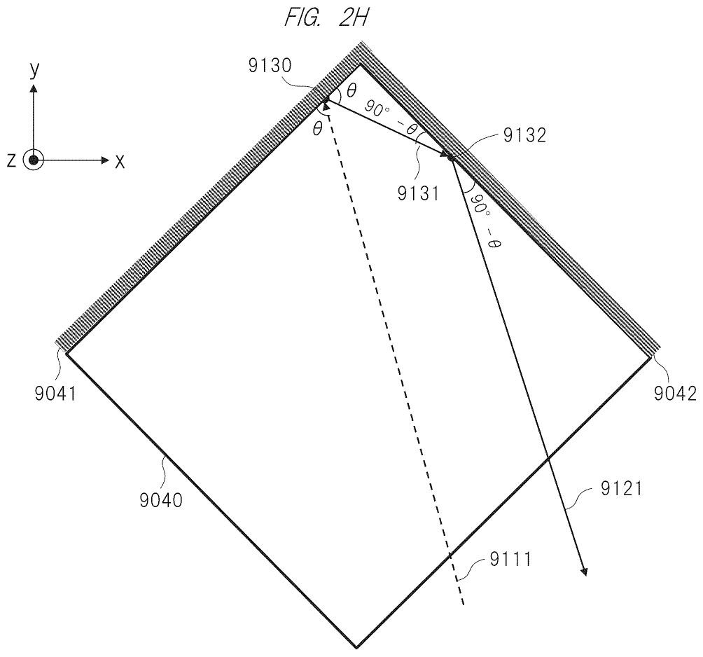

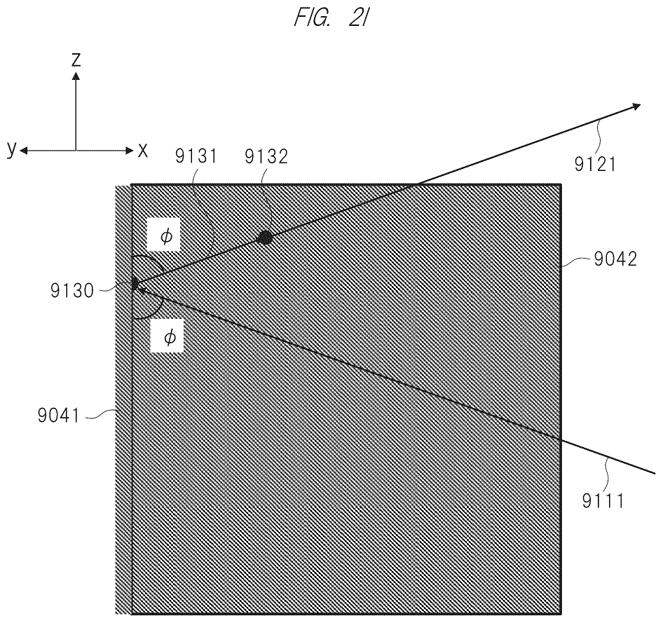

FIG. 1 is a diagram showing an example of usage form of an air floating video display apparatus according to one embodiment of the present invention, and is a diagram showing an entire configuration of the air floating video display apparatus according to the present embodiment. Although a specific configuration of the air floating video display apparatus will be described in detail with reference to FIG. 2 and the like, light of a specific polarized wave with narrow-angle directional characteristics is emitted from a video display apparatus 1 as a video light flux, once enters a retroreflection plate 2 through reflection or the like on an optical system in the air floating video display apparatus, is retroreflected and passes through a transparent member 100 (glass or the like), thereby forming an aerial image (air floating video 3) which is a real image on the outside of the glass surface. In the following description of the embodiments, the retroreflection plate 2 (retroreflective plate) will be used as an example of a retroreflector. However, the retroreflection plate 2 of the present invention is not limited to a planar plate, and is used as an example of a concept including a sheet-like retroreflector attached to a planar or non-planar member or an entire assembly in which a sheet-like retroreflector is attached to a planar or non-planar member. In addition, since the light ray reflected by the retroreflection plate 2 has optical properties that allow it to form an image, the retroreflection plate 2 may also be referred to as an imaging optical member or an imaging optical plate.

In a store or the like, a space is partitioned by a show window (referred to also as “window glass”) 105 which is a translucent member such as glass. With the air floating video display apparatus of the present embodiment, the floating video can be displayed in one direction to the outside and/or the inside of the store (space) through such a transparent member.

In FIG. 1, the inner side of the window glass 105 (the inside of the store) is shown on the far side in the depth direction, and the outer side thereof (e.g., a sidewalk) is shown on the near side. On the other hand, it is also possible to form an aerial image at a desired position in the store by providing a reflector configured to reflect a specific polarized wave on the window glass 105 and reflecting the light by the reflector.

### Configuration Example of Optical System of Air Floating Video Display Apparatus

FIG. 2A is a diagram showing an example of a configuration of an optical system of the air floating video display apparatus according to one embodiment of the present invention. The configuration of the air floating video display apparatus will be described more specifically with reference to FIG. 2A. As shown in FIG. 2A(1), the display apparatus 1 which diverges video light of a specific polarized wave at a narrow angle is provided in the oblique direction of the transparent member 100 such as glass. The display apparatus 1 includes a liquid crystal display panel 11 and a light source apparatus 13 configured to generate light of a specific polarized wave with narrow-angle diffusion characteristics.

The video light of a specific polarized wave from the display apparatus 1 is reflected by a polarization separator 101 having a film selectively reflecting the video light of a specific polarized wave and provided on the transparent member 100 (in the drawing, the polarization separator 101 is formed in a sheet shape and is adhered to the transparent member 100), and enters the retroreflection plate 2. A λ/4 plate 21 is provided on a video light incident surface of the retroreflection plate 2. The video light passes through the λ/4 plate 21 twice at the time when the video light enters the retroreflection plate 2 and at the time when the video light is emitted from the retroreflection plate 2, whereby the video light is subjected to polarization conversion from a specific polarized wave to the other polarized wave. Here, since the polarization separator 101 which selectively reflects the video light of a specific polarized wave has a property of transmitting the polarized light of the other polarized wave subjected to the polarization conversion, the video light of the specific polarized wave after the polarization conversion passes through the polarization separator 101. The video light that has passed through the polarization separator 101 forms the air floating video 3, which is a real image, on the outer side of the transparent member 100. Note that the principal light ray of the video light that enters the retroreflection plate 2 is shown in FIG. 2A as an example in which it enters at an angle of 90° with respect to the retroreflection plate 2. However, the angle at which the principal light ray of the video light enters the retroreflection plate 2 is not limited to 90°, and may enter at an angle of, for example, 90°±15°.

Here, a first example of a polarization design in the optical system in FIG. 2A will be described. For example, the configuration in which the video light of S polarization is emitted from the display apparatus 1 to the polarization separator 101 and in which the polarization separator 101 has the property of reflecting S polarization and transmitting P polarization is also possible. In this case, the video light of S polarization that has reached the polarization separator 101 from the display apparatus 1 is reflected by the polarization separator 101 and is directed toward the retroreflection plate 2. Since the video light passes through the λ/4 plate 21 provided on the incident surface of the retroreflection plate 2 twice when the video light is reflected by the retroreflection plate 2, the video light is converted from S-polarized light into P-polarized light. The video light converted into P-polarized light is directed toward the polarization separator 101 again. Here, since the polarization separator 101 has the property of reflecting S polarization and transmitting P polarization, the video light of P polarization passes through the polarization separator 101 and then passes through the transparent member 100. Since the video light that has passed through the transparent member 100 is the light generated by the retroreflection plate 2, the air floating video 3 which is an optical image of the displayed video of the display apparatus 1 is formed at a position having a mirror relationship with the displayed video of the display apparatus 1 with respect to the polarization separator 101. With the polarization design described above, the air floating video 3 can be suitably formed.

Next, a second example of the polarization design in the optical system in FIG. 2A will be described. For example, the configuration in which the video light of P polarization is emitted from the display apparatus 1 to the polarization separator 101 and in which the polarization separator 101 has the property of reflecting P polarization and transmitting S polarization is also possible. In this case, the video light of P polarization that has reached the polarization separator 101 from the display apparatus 1 is reflected by the polarization separator 101 and is directed toward the retroreflection plate 2. Since the video light passes through the λ/4 plate 21 provided on the incident surface of the retroreflection plate 2 twice when the video light is reflected by the retroreflection plate 2, the video light is converted from P-polarized light into S-polarized light. The video light converted into S-polarized light is directed toward the polarization separator 101 again. Here, since the polarization separator 101 has the property of reflecting P polarization and transmitting S polarization, the video light of S polarization passes through the polarization separator 101 and then passes through the transparent member 100. Since the video light that has passed through the transparent member 100 is the light generated by the retroreflection plate 2, the air floating video 3 which is an optical image of the displayed video of the display apparatus 1 is formed at a position having a mirror relationship with the displayed video of the display apparatus 1 with respect to the polarization separator 101. With the polarization design described above, the air floating video 3 can be suitably formed.

Note that the light that forms the air floating video 3 is a set of light rays converging from the retroreflection plate 2 to the optical image of the air floating video 3, and these light rays go straight even after passing through the optical image of the air floating video 3. Therefore, the air floating video 3 is a video having high directivity, unlike diffused video light formed on a screen by a general projector or the like. Therefore, in the configuration of FIG. 2A, when the user visually recognizes the air floating video 3 from the direction of an arrow A, the air floating video 3 is visually recognized as a bright video. However, when another person visually recognizes the video from the direction of an arrow B, the air floating video 3 cannot be visually recognized as a video at all. These characteristics are very suitable for use in a system that displays a video requiring high security or a highly confidential video that is desired to be kept secret from a person facing the user.

Note that, depending on the performance of the retroreflection plate 2, the polarization axes of the video light after the reflection may become uneven, and the reflection angles may also become uneven. Such uneven light does not maintain the polarization state and traveling angle assumed in design in some cases. For example, such light with the polarization state and traveling angle that are not assumed in design may directly enter the video display surface of the liquid crystal display panel 11 again from the position of the retroreflection plate 2 without passing through the polarization separator. Also, such light with the polarization state and traveling angle that are not assumed in design may enter the video display surface of the liquid crystal display panel 11 again after being reflected by components in the air floating video display apparatus. The light that has entered the video display surface of the liquid crystal display panel 11 again is reflected again on the video display surface of the liquid crystal display panel 11 constituting the display apparatus 1, so that a ghost image is generated and the image quality of the air floating image is deteriorated in some cases. Thus, in the present embodiment, an absorptive polarization plate 12 may be provided on the video display surface of the display apparatus 1. The video light emitted from the display apparatus 1 passes through the absorptive polarization plate 12, and the reflected light returning from the polarization separator 101 is absorbed by the absorptive polarization plate 12, whereby the re-reflection described above can be suppressed. In this way, it is possible to prevent deterioration in image quality due to a ghost image of an air floating image. Specifically, in the configuration in which the video light of S polarization is emitted from the display apparatus 1 to the polarization separator 101, the polarization plate that absorbs P-polarized light can be used as the absorptive polarization plate 12. Also, in the configuration in which the video light of P polarization is emitted from the display apparatus 1 to the polarization separator 101, the polarization plate that absorbs S-polarized light can be used as the absorptive polarization plate 12.

The polarization separator 101 described above may be formed of, for example, a reflective polarization plate or a metal multilayer film that reflects a specific polarized wave.

Next, FIG. 2A(2) shows an example of a surface shape of a retroreflection plate as the typical retroreflection plate 2. The light ray that enters regularly arranged hexagonal columns is reflected by the wall surfaces and bottom surfaces of the hexagonal columns and emitted as retroreflected light in a direction corresponding to the incident light, and an air floating video which is a real image is displayed based on the video displayed on the display apparatus 1.

The resolution of the air floating image largely depends on the outer shape D and pitch P of the retroreflection portions of the retroreflection plate 2 shown in FIG. 2A(2), in addition to the resolution of the liquid crystal display panel 11. For example, when a 7-inch WUXGA (1920×1200 pixels) liquid crystal display panel is used, even if one pixel (one triplet) is about 80 μm, one pixel of the air floating image is about 300 μm if the diameter D of the retroreflection portion is 240 μm and the pitch is 300 μm, for example. Therefore, the effective resolution of the air floating video is reduced to about ⅓.

Therefore, in order to make the resolution of the air floating video equal to the resolution of the display apparatus 1, it is desired that the diameter and the pitch of the retroreflection portions are close to one pixel of the liquid crystal display panel. On the other hand, in order to suppress the occurrence of moire caused by the retroreflection plate and the pixels of the liquid crystal display panel, it is preferable to design each pitch ratio so as not to be an integral multiple of one pixel. Further, the shape is preferably arranged such that any one side of the retroreflection portion does not overlap with any one side of one pixel of the liquid crystal display panel.

Note that the surface shape of the retroreflection plate according to the present embodiment is not limited to the above example, and the retroreflection plate may have a variety of surface shapes to realize the retroreflection. Specifically, a retroreflective element in which triangular pyramidal prisms, hexagonal pyramidal prisms, other polygonal prisms, or combinations thereof are regularly arranged may be provided on the surface of the retroreflection plate of the present embodiment. Alternatively, a retroreflective element in which these prisms are regularly arranged to form cube corners may be provided on the surface of the retroreflection plate of the present embodiment. These can also be referred to as corner reflector arrays or multi-faceted reflector arrays. Moreover, a capsule-lens retroreflection element in which glass beads are regularly arranged may be provided on the surface of the retroreflection plate of the present embodiment. Since existing techniques can be used for the detailed configurations of these retroreflective elements, detailed description thereof will be omitted. Specifically, it is possible to use the techniques disclosed in Japanese Unexamined Patent Application Publications No. 2001-33609, No. 2001-264525, No. 2005-181555, No. 2008-70898, No. 2009-229942, and others.

### Another Configuration Example (1) of Optical System of Air Floating Video Display Apparatus

Another configuration example of the optical system of the air floating video display apparatus will be described with reference to FIG. 2B. Note that components in FIG. 2B denoted by the same reference characters as those in FIG. 2A have the same functions and configurations as those in FIG. 2A. The repetitive descriptions for such components will be omitted to simplify the description.

In the optical system in FIG. 2B, video light of a specific polarized wave is output from the display apparatus 1 as in FIG. 2A. The video light of a specific polarized wave output from the display apparatus 1 is input to a polarization separator 101B. The polarization separator 101B is a member that selectively transmits video light of a specific polarized wave. Unlike the polarization separator 101 in FIG. 2A, the polarization separator 101B is not integrated with the transparent member 100 but has a plate-like shape independently. Therefore, the polarization separator 101B may be expressed as a polarization separation plate. For example, the polarization separator 101B may be configured as a reflective polarization plate obtained by attaching a polarization separation sheet on a transparent member. Alternatively, the polarization separator 101B may be formed by attaching a metal multilayer film that selectively transmits a specific polarized wave and reflects the other specific polarized wave, on a transparent member. In FIG. 2B, the polarization separator 101B is configured so as to transmit the video light of a specific polarized wave output from the display apparatus 1.

The video light that has passed through the polarization separator 101B enters the retroreflection plate 2. The λ/4 plate 21 is provided on the video light incident surface of the retroreflection plate. The video light is subjected to polarization conversion from a specific polarized wave to the other polarized wave by passing through the λ/4 plate 21 twice at the time when it enters the retroreflection plate and at the time when it is emitted therefrom. Here, since the polarization separator 101B has a property of reflecting the light of the other polarized wave that has been subjected to the polarization conversion by the λ/4 plate 21, the video light after the polarization conversion is reflected by the polarization separator 101B. The video light reflected by the polarization separator 101B passes through the transparent member 100, and forms the air floating video 3 which is a real image outside the transparent member 100.

Here, a first example of polarization design in the optical system in FIG. 2B will be described. For example, the configuration in which the video light of P polarization is emitted from the display apparatus 1 to the polarization separator 101B and in which the polarization separator 101B has a property of reflecting S polarization and transmitting P polarization is also possible. In this case, the video light of P polarization that has reached the polarization separator 101B from the display apparatus 1 passes through the polarization separator 101B and travels toward the retroreflection plate 2. Since the video light passes through the λ/4 plate 21 provided on the incident surface of the retroreflection plate 2 twice when it is reflected by the retroreflection plate 2, the video light is converted from P-polarized light into S-polarized light. The video light converted into S-polarized light is directed to the polarization separator 101B again. Here, since the polarization separator 101B has a property of reflecting S polarization and transmitting P polarization, the video light of S polarization is reflected by the polarization separator 101 and passes through the transparent member 100. Since the video light that has passed through the transparent member 100 is the light generated by the retroreflection plate 2, the air floating video 3 which is an optical image of the displayed video of the display apparatus 1 is formed at a position having a mirror relationship with the displayed video of the display apparatus 1 with respect to the polarization separator 101B. With the polarization design described above, the air floating video 3 can be suitably formed.

Next, a second example of a polarization design in the optical system in FIG. 2B will be described. For example, the configuration in which the video light of S polarization is emitted from the display apparatus 1 to the polarization separator 101B and the polarization separator 101B has the property of reflecting P polarization and transmitting S polarization is also possible. In this case, the video light of S polarization that has reached the polarization separator 101B from the display apparatus 1 passes through the polarization separator 101B and is directed toward the retroreflection plate 2. Since the video light passes through the λ/4 plate 21 provided on the incident surface of the retroreflection plate 2 twice when the video light is reflected by the retroreflection plate 2, the video light is converted from S-polarized light into P-polarized light. The video light converted into P-polarized light is directed toward the polarization separator 101B again. Here, since the polarization separator 101B has the property of reflecting P polarization and transmitting S polarization, the video light of P polarization is reflected by the polarization separator 101 and then passes through the transparent member 100.

Since the video light that has passed through the transparent member 100 is the light generated by the retroreflection plate 2, the air floating video 3 which is an optical image of the displayed video of the display apparatus 1 is formed at a position having a mirror relationship with the displayed video of the display apparatus 1 with respect to the polarization separator 101B. With the polarization design described above, the air floating video 3 can be suitably formed.

In FIG. 2B, the video display surface of the display apparatus 1 and the surface of the retroreflection plate 2 are arranged parallel to each other. The polarization separator 101B is arranged so as to be inclined at an angle α (e.g., 30°) with respect to the video display surface of the display apparatus 1 and the surface of the retroreflection plate 2. Then, in the reflection by the polarization separator 101B, the traveling direction of the video light reflected by the polarization separator 101B (direction of principal light ray of the video light) differs by an angle β (e.g., 60°) from the traveling direction of the video light emitted from the retroreflection plate 2 (direction of principal light ray of the video light). With this configuration, in the optical system in FIG. 2B, the video light is output at a predetermined angle shown in the drawing toward the outside of the transparent member 100, and the air floating video 3 which is a real image is formed. In the configuration of FIG. 2B, when the user visually recognizes the air floating video 3 from the direction of an arrow A, the air floating video 3 is visually recognized as a bright video. However, when another person visually recognizes the video from the direction of an arrow B, the air floating video 3 cannot be visually recognized as a video at all. These characteristics are particularly suitable for use in a system that displays a video requiring high security or a highly confidential video that is desired to be kept secret from a person facing the user.

As described above, although the optical system in FIG. 2B has a different configuration from the optical system in FIG. 2A, it is possible to form a suitable air floating video like the optical system in FIG. 2A.

Note that it is also possible to provide an absorptive polarization plate on the surface of the transparent member 100 on the side closer to the polarization separator 101B. As the absorptive polarization plate, an absorptive polarization plate that transmits the polarized wave of the video light from the polarization separator 101B and absorbs the polarized wave whose phase is different by 90° from the polarized wave of the video light from the polarization separator 101B can be provided. In this way, the external light that enters the transparent member 100 from the side of the air floating video 3 can be reduced by about 50%, while sufficiently transmitting the video light for forming the air floating video 3. As a result, it is possible to reduce stray light in the optical system in FIG. 2B due to external light entering the transparent member 100 from the side of the air floating video 3.

### Another Configuration Example (2) of Optical System of Air Floating Video Display Apparatus

Another configuration example of the optical system of the air floating video display apparatus will be described with reference to FIG. 2C. Note that it is assumed that components in FIG. 2C denoted by the same reference characters as those in FIG. 2B have the same functions and configurations as those in FIG. 2B. The repetitive descriptions for such components will be omitted to simplify the description.

The optical system in FIG. 2C is different from the optical system in FIG. 2B only in the arrangement angle of the polarization separator 101B with respect to the video display surface of the display apparatus 1 and the surface of the retroreflection plate 2. All of the other configurations are the same as those of the optical system in FIG. 2B, and thus the repetitive descriptions will be omitted. The polarization design of the optical system in FIG. 2C is also similar to the polarization design of the optical system in FIG. 2B, and thus the repetitive descriptions will be omitted.

In the optical system in FIG. 2C, the polarization separator 101B is arranged so as to be inclined at an angle α with respect to the video display surface of the display apparatus 1 and the surface of the retroreflection plate 2. In FIG. 2C, the angle α is 45°. With this configuration, in the reflection of the polarization separator 101B, the angle β formed by the traveling direction of the video light reflected by the polarization separator 101B (direction of principal light ray of the video light) with respect to the traveling direction of the video light entering from the retroreflection plate 2 (direction of principal light ray of the video light) is 90°. As a result, the video display surface of the display apparatus 1 and the surface of the retroreflection plate 2 are in a perpendicular relationship with the traveling direction of the video light reflected by the polarization separator 101B, and the angular relationship of the surfaces constituting the optical system can be simplified. The angular relationship of the surfaces constituting the optical system can be more simplified if the surface of the transparent member 100 is arranged so as to be orthogonal to the traveling direction of the video light reflected by the polarization separator 101B. In the configuration in FIG. 2C, when the user visually recognizes the air floating video 3 from the direction of an arrow A, the air floating video 3 is visually recognized as a bright video. However, when another person visually recognizes the video from the direction of an arrow B, the air floating video 3 cannot be visually recognized as a video at all. These characteristics are particularly suitable for use in a system that displays a video requiring high security or a highly confidential video that is desired to be kept secret from a person facing the user.

As described above, although the optical system in FIG. 2C has a different configuration from the optical systems in FIG. 2A and FIG. 2B, it is possible to form a suitable air floating video like the optical systems in FIG. 2A and FIG. 2B. Furthermore, the angles of the surfaces constituting the optical system can be simplified.

Note that it is also possible to provide an absorptive polarization plate on the surface of the transparent member 100 on the side closer to the polarization separator 101B. As the absorptive polarization plate, an absorptive polarization plate that transmits the polarized wave of the video light from the polarization separator 101B and absorbs the polarized wave whose phase is different by 90° from the polarized wave of the video light from the polarization separator 101B can be provided. In this way, the external light that enters the transparent member 100 from the side of the air floating video 3 can be reduced by about 50%, while sufficiently transmitting the video light for forming the air floating video 3. As a result, it is possible to reduce stray light in the optical system in FIG. 2C due to the external light entering the transparent member 100 from the side of the air floating video 3.

### Another Configuration Example (3) of Optical System of Air Floating Video Display Apparatus

Another configuration example of the optical system of the air floating video display apparatus will be described with reference to FIG. 2D. The optical system in FIG. 2D is an optical system using a retroreflection plate 5 that differs from the retroreflection plate 2 used in FIG. 2A to FIG. 2C. Hereinafter, the third configuration example of the optical system will be described in detail with reference to FIG. 2D to FIG. 2I. Note that it is assumed that components in FIG. 2D denoted by the same reference characters as those in FIGS. 2A to 2C have the same functions and configurations as those in FIG. 2A to FIG. 2C. The repetitive descriptions for such components will be omitted to simplify the description.

FIG. 2D is a diagram showing examples of a configuration of a main part and a configuration of a retroreflection portion of the air floating video display apparatus according to one embodiment of the present invention. In the oblique direction of the transparent member 100 such as glass, there is provided a display apparatus 10 configured to emit video light. The display apparatus 10 includes the liquid crystal display panel 11 and the light source apparatus 13 configured to generate light.

A principal light ray 9020 representing the light flux emitted from the display apparatus 10 travels toward the retroreflection plate 5 and enters the retroreflection plate 5 at an incident angle α. The incident angle α may be, for example, 45° or the like. However, the incident angle α is not limited to 45°, and may be within a range of, for example, 45°±15°.

The retroreflection plate 5 is an optical member having optical properties that allow it to retroreflect at least a light ray in a certain direction. In addition, since the reflected light ray has image-forming optical properties, the retroreflection plate 5 may also be referred to as an imaging optical member or an imaging optical plate.

Although a specific configuration of the retroreflection plate 5 will be described in detail with reference to FIG. 2E, FIG. 2F, and the like, the principal light ray 9020 is retroreflected by the retroreflection plate 5 with respect to the x and y directions while travelling in the z direction. As a result, the reflected light ray 9021 travels along an optical path that is mirror-symmetric to the principal light ray 9020 with respect to the retroreflection plate 5, proceeds in a direction away from the retroreflection plate 5, and passes through the transparent member 100, thereby forming the air floating video 3 which is a real image on the image-forming surface.

The light flux that forms the air floating video 3 is a set of light rays converging from the retroreflection plate 5 to the optical image of the air floating video 3, and these light rays go straight even after passing through the optical image of the air floating video 3. Therefore, the air floating video 3 is a video having high directivity, unlike diffused video light formed on a screen by a general projector or the like. Therefore, in the configuration of FIG. 2, when the user visually recognizes the air floating video 3 from the direction of the arrow A, the air floating video 3 is visually recognized as a bright video. However, when another person visually recognizes the video from the direction of the arrow B, the air floating video 3 cannot be visually recognized as a video at all. These characteristics are very suitable for use in a system that displays a video requiring high security or a highly confidential video that is desired to be kept secret from a person facing the user.

A configuration example of the retroreflection plate 5 will be described with reference to FIG. 2E and FIG. 2F. The retroreflection plate 5 has a configuration in which a plurality of corner reflectors 9040 are arranged in an array on a surface of a transparent member 50. This can also be referred to as a corner reflector array or a multi-faceted reflector array.

Although a specific configuration of the corner reflector 9040 will be described in detail with reference to FIG. 2G, FIG. 2H, and FIG. 2I, the light rays 9111, 9112, 9113, and 9114 emitted from a light source 9110 are reflected twice by two mirror surfaces 9041 and 9042 of the corner reflector 9040, thereby forming reflected light rays 9121, 9122, 9123, and 9124. These two reflections constitute retroreflection with respect to the x and y directions, where the light rays are returned in the same direction as the incident direction (travels in a 180°-rotated direction), and constitute regular reflection with respect to the z direction, where total reflection causes the incident angle and the reflected angle to be equal.

Namely, the light rays 9111 to 9114 generate the reflected light rays 9121 to 9124 in a straight line symmetric about the z direction with respect to the corner reflector 9040, thereby forming an aerial real image 9120. Note that the light rays 9111 to 9114 emitted from the light source 9110 are four representative light rays of diffused light from the light source 9110. Depending on diffusion characteristics of the light source 9110, the light rays that enter the retroreflection plate 5 are not limited to these four rays. However, any such incident light ray undergoes the same type of reflection, thereby forming the aerial real image 9120. Note that, for clarity of the drawings, the position of the light source 9110 and the position of the aerial real image 9120 in the x direction are depicted as being offset, but in practice, the position of the light source 9110 and the position of the aerial real image 9120 in the x direction are at the same position and overlap each other when viewed from the z direction.

Next, a configuration and effects of the corner reflectors 9040 constituting the retroreflection plate 5 will be described with reference to FIG. 2G, FIG. 2H, and FIG. 2I. Each corner reflector 9040 is a cuboid in which only two certain surfaces serve as the mirror surfaces 9041 and 9042, while the remaining four surfaces are formed of a transparent member. The retroreflection plate 5 has a configuration in which these corner reflectors 9040 are arranged in an array such that the corresponding mirror surfaces face the same direction.

When viewed from above (+z direction), the light ray 9111 emitted from the light source 9110 enters the mirror surface 9041 (or mirror surface 9042) at a certain incident angle, is totally reflected at a reflection point 9130, and then is totally reflected again at a reflection point 9132 on the mirror surface 9042 (or mirror surface 9041).

When the incident angle of the light ray 9111 with respect to the mirror surface 9041 (or mirror surface 9042) is 0, the incident angle of a first reflected light ray 9131 with respect to the mirror surface 9042 (or mirror surface 9041) and reflected by the mirror surface 9041 (or mirror surface 9042) can be expressed as 90°-θ. Therefore, the second reflected light ray 9121 undergoes a rotation of 2θ for the first reflection and 2×(90°−θ) for the second reflection with respect to the light ray 9111, resulting in a total optical path reversal of 180°. On the other hand, when viewed from the side (intermediate direction between −x and −y), only one total reflection occurs in the z direction. Therefore, when the incident angle with respect to the mirror surface 9041 or the mirror surface 9042 is φ, the reflected light ray 9121 undergoes a rotation of 2×φ with respect to the light ray 9111 for a single reflection.

From the above, it is clear that the light ray that enters the corner reflector 9040 undergoes retroreflection resulting in a reversed optical path in the x and y directions, and regular reflection caused by total reflection in the z direction. Considering the retroreflection plate 5 as a whole, since the same type of reflection occurs in each optical path, the image is formed at a point symmetric about a z-axis direction by a reverse optical path with convergence in the x and y directions.

Here, in the optical system shown in FIG. 2A to FIG. 2C, the retroreflection plate 2 has retroreflection properties in three axial directions. As a result, when a diffusive incident light flux enters the retroreflection plate 2, the reflected light flux with convergence travels toward a side of the light source of the incident light ray with respect to the retroreflection plate 2. The reflected light flux with convergence forms an image in midair, thereby forming the air floating video 3. The traveling direction of the principal light ray of the reflected light flux with convergence reflected by the retroreflection plate 2 is opposite to the traveling direction of the principal light ray of the diffusive incident light flux that enters the retroreflection plate 2.

In contrast, in the optical system of FIG. 2D, the retroreflection plate 5 has retroreflection properties in two axial directions and undergoes regular reflection in the remaining one axial direction. As a result, when the diffusive incident light flux enters the retroreflection plate 5, the reflected light flux with convergence reflected by the corner reflector array travels toward a side opposite to the side where the light source of the incident light ray with respect to the retroreflection plate 5 is located. The reflected light flux with convergence forms an image in midair, thereby forming the air floating video 3.

The traveling direction of the principal light ray of the reflected light flux with convergence reflected by the corner reflector array of the retroreflection plate 5 is not opposite to the traveling direction of the principal light ray of the diffusive incident light flux that enters the retroreflection plate 5. A normal component of a plate-like surface of the retroreflection plate 5 with respect to the traveling direction of the principal light ray of the diffusive incident light flux that enters the retroreflection plate 5 and a normal component of the plate-like surface of the retroreflection plate 5 with respect to the traveling direction of the principal light ray after being reflected by the retroreflection plate 5 and becoming the reflected light flux with convergence remain unchanged before and after reflection by the corner reflector array, and the continues to travel in a straight line.

Namely, the diffusive incident light flux is converted into the reflected light flux with convergence by reflection at the retroreflection plate 5, whereas the light flux proceeds through the retroreflection plate 5 in a direction normal to the plate-like surface of the retroreflection plate 5. Here, the diffusive incident light flux that enters the retroreflection plate 5 and the reflected light flux with convergence emitted from the retroreflection plate 5 are geometrically symmetric about the plate-like surface of the retroreflection plate 5.

The resolution of the air floating image formed by the light ray from a video output unit 10 largely depends on the diameter D and pitch P (not shown) of the retroreflection portions of the retroreflection plate 5 shown in FIG. 2E and FIG. 2F, in addition to the resolution of the liquid crystal display panel 11. For example, when a 7-inch WUXGA (1920×1200 pixels) liquid crystal display panel is used, even if one pixel (one triplet) is about 80 μm, one pixel of the air floating image is about 300 μm if, for example, the diameter D of the retroreflection portion is 240 μm and the pitch is 300 μm. Therefore, the effective resolution of the air floating video is reduced to about ⅓.

Therefore, in order to make the resolution of the air floating video equal to the resolution of the display apparatus 1, it is desired that the diameter D and the pitch P of the retroreflection portions are close to one pixel of the liquid crystal display panel. On the other hand, in order to suppress the occurrence of moire caused by the retroreflection plate and the pixels of the liquid crystal display panel, it is preferable to design each pitch ratio so as not to be an integral multiple of one pixel. Further, the shape is preferably arranged such that any one side of the retroreflection portion does not overlap with any one side of one pixel of the liquid crystal display panel.

Note that the shape of the retroreflection plate (imaging optical plate) according to the present embodiment is not limited to the above example, and the retroreflection plate may have a variety of shapes to realize the retroreflection. Specifically, it may have various cubic corners or a corner reflector array, or may have a shape in which a slit mirror array, a double-faceted corner reflector array, a multi-faceted reflector array, or a combination of such reflection surfaces are regularly arranged. Alternatively, a capsule-lens retroreflection element in which glass beads are regularly arranged may be provided on the surface of the retroreflection plate of the present embodiment. Since existing techniques can be used for the detailed configurations of these retroreflective elements, detailed description thereof will be omitted. Specifically, it is possible to use the techniques disclosed in Japanese Patent Application Laid-Open Publication No. 2017-33005, Japanese Patent Application Laid-Open Publication No. 2019-133110, Japanese Patent Application Laid-Open Publication No. 2017-67933, WO2009/131128, and others.

Note that, in the optical system of FIG. 2D, the video light emitted from the display apparatus 10 may have any polarization state. Either S-polarized light or P-polarized light may be used without any issue.

As described above, although the optical system of FIG. 2D is an optical system using a retroreflection plate that differs from the retroreflection plate used in FIG. 2A to FIG. 2C, it is possible to form a suitable air floating video like the optical systems in FIG. 2A and FIG. 2C.

According to the optical systems in FIG. 2A, FIG. 2B, FIG. 2C, and FIG. 2D described above, it is possible to provide a brighter higher-quality air floating video.

### <<Block Diagram of Internal Configuration of Air Floating Video Display Apparatus>>

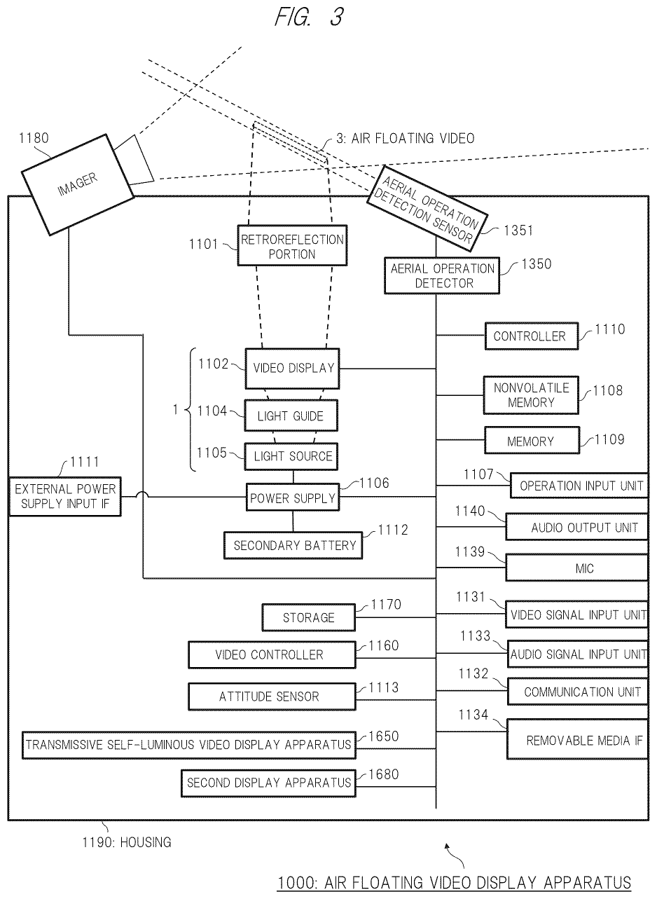

Next, a block diagram of an internal configuration of an air floating video display apparatus 1000 will be described. FIG. 3 is a block diagram showing an example of an internal configuration of the air floating video display apparatus 1000.

The air floating video display apparatus 1000 includes a retroreflection portion 1101, a video display 1102, a light guide 1104, a light source 1105, a power supply 1106, an external power supply input interface 1111, an operation input unit 1107, a nonvolatile memory 1108, a memory 1109, a controller 1110, a video signal input unit 1131, an audio signal input unit 1133, a communication unit 1132, an aerial operation detection sensor 1351, an aerial operation detector 1350, an audio output unit 1140, a microphone 1139, a video controller 1160, a storage 1170, an imager 1180, and the like. Note that the air floating video display apparatus 1000 may include a removable media interface 1134, an attitude sensor 1113, a transmissive self-luminous video display apparatus 1650, a second display apparatus 1680, a secondary battery 1112, and the like.

Each component of the air floating video display apparatus 1000 is arranged in a housing 1190. Note that the imager 1180 and the aerial operation detection sensor 1351 shown in FIG. 3 may be provided outside the housing 1190.

The retroreflection portion 1101 in FIG. 3 corresponds to the retroreflection plate 2 in FIG. 2A, FIG. 2B, and FIG. 2C. The retroreflection portion 1101 retroreflects the light modulated by the video display 1102. Of the reflected light from the retroreflection portion 1101, the light output to the outside of the air floating video display apparatus 1000 forms the air floating video 3.

The video display 1102 in FIG. 3 corresponds to the liquid crystal display panel 11 in FIG. 2A, FIG. 2B, and FIG. 2C. The light source 1105 in FIG. 3 corresponds to the light source apparatus 13 in FIG. 2A, FIG. 2B, and FIG. 2C. Further, the video display 1102, the light guide 1104, and the light source 1105 in FIG. 3 correspond to the display apparatus 1 in FIG. 2A, FIG. 2B, and FIG. 2C.

The video display 1102 is a display that generates a video by modulating transmitted light based on a video signal input under the control of the video controller 1160 to be described below. The video display 1102 corresponds to the liquid crystal display panel 11 in FIG. 2A, FIG. 2B, and FIG. 2C. As the video display 1102, for example, a transmissive liquid crystal panel is used. Alternatively, as the video display 1102, for example, a reflective liquid crystal panel using a method of modulating reflected light, a DMD (Digital Micromirror Device: registered trademark) panel, or the like may be used.

The light source 1105 is configured to generate light for the video display 1102, and is a solid-state light source such as an LED light source or a laser light source. The power supply 1106 converts an AC current input from the outside through the external power supply input interface 1111 into a DC current, and supplies power to the light source 1105. Further, the power supply 1106 supplies a necessary DC current to each unit in the air floating video display apparatus 1000. The secondary battery 1112 stores power supplied from the power supply 1106. Also, the secondary battery 1112 supplies power to the light source 1105 and other configurations that require power when power is not supplied from outside via the external power supply input interface 1111. In other words, when the air floating video display apparatus 1000 includes the secondary battery 1112, the user can use the air floating video display apparatus 1000 even when power is not supplied from outside.

The light guide 1104 guides the light generated by the light source 1105 and irradiates the video display 1102 with the light. A combination of the light guide 1104 and the light source 1105 may be referred to also as a backlight of the video display 1102. The light guide 1104 may have a configuration mainly made of glass. The light guide 1104 may have a configuration mainly made of plastic. The light guide 1104 may have a configuration using a mirror. Various configurations are possible as the combination of the light guide 1104 and the light source 1105. A specific configuration example of the combination of the light guide 1104 and the light source 1105 will be described below in detail.

The aerial operation detection sensor 1351 is a sensor that detects an operation on the air floating video 3 by a finger of the user 230. For example, the aerial operation detection sensor 1351 senses a range overlapping with the entire display range of the air floating video 3. Note that the aerial operation detection sensor 1351 may sense only a range overlapping with at least a part of the display range of the air floating video 3.

Specific examples of the aerial operation detection sensor 1351 include a distance sensor using invisible light such as infrared light, an invisible light laser, an ultrasonic wave, or the like. Also, the aerial operation detection sensor 1351 may be configured to be able to detect coordinates on a two-dimensional plane by combining a plurality of sensors. Further, the aerial operation detection sensor 1351 may be composed of a ToF (Time of Flight) type LiDAR (Light Detection and Ranging) or an image sensor.

The aerial operation detection sensor 1351 is not particularly limited as long as it can perform sensing for detecting a touch operation or the like on an object displayed as the air floating video 3 by a finger of the user. Such sensing can be performed by using an existing technique.

The aerial operation detector 1350 acquires a sensing signal from the aerial operation detection sensor 1351, and determines whether or not the finger of the user 230 has touched an object in the air floating video 3 and calculates the position (touch position) where the finger of the user 230 has touched the object, based on the sensing signal. The aerial operation detector 1350 is composed of, for example, a circuit such as a FPGA (Field Programmable Gate Array). Also, a part of the functions of the aerial operation detector 1350 may be implemented by software, for example, by a program for aerial operation detection executed by the controller 1110.

The aerial operation detection sensor 1351 and the aerial operation detector 1350 may be built in the air floating video display apparatus 1000, or may be provided outside separately from the air floating video display apparatus 1000. When provided separately from the air floating video display apparatus 1000, the aerial operation detection sensor 1351 and the aerial operation detector 1350 are configured to be able to transmit information and signals to the air floating video display apparatus 1000 via a wired or wireless communication connection path or video signal transmission path.

Also, the aerial operation detection sensor 1351 and the aerial operation detector 1350 may be provided separately. In this way, it is possible to construct a system in which the air floating video display apparatus 1000 without the aerial operation detection function is provided as a main body and only the aerial operation detection function can be added as an option. Further, the configuration in which only the aerial operation detection sensor 1351 is provided separately and the aerial operation detector 1350 is built in the air floating video display apparatus 1000 is also possible. In a case such as when it is desired to arrange the aerial operation detection sensor 1351 more freely with respect to the installation position of the air floating video display apparatus 1000, the configuration in which only the aerial operation detection sensor 1351 is provided separately is advantageous.

The imager 1180 is a camera having an image sensor, and is configured to capture the image of the space near the air floating video 3 and/or the face, arms, fingers, and the like of the user 230. A plurality of imagers 1180 may be provided. By using a plurality of imagers 1180 or by using an imager with a depth sensor, it is possible to assist the aerial operation detector 1350 in the detection processing of the touch operation on the air floating video 3 by the user 230. The imager 1180 may be provided separately from the air floating video display apparatus 1000. When the imager 1180 is provided separately from the air floating video display apparatus 1000, the imager 1180 may be configured to be able to transmit imaging signals to the air floating video display apparatus 1000 via a wired or wireless communication connection path or the like.

For example, when the aerial operation detection sensor 1351 is configured as an object intrusion sensor that detects whether or not an object has intruded a plane (intrusion detection plane) including the display plane of the air floating video 3, the aerial operation detection sensor 1351 may not be able to detect information indicating how far an object (e.g., a finger of the user) that has not intruded the intrusion detection plane is away from the intrusion detection plane or how close the object is to the intrusion detection plane.

In such a case, it is possible to calculate the distance between the object and the intrusion detection plane by using information such as depth calculation information of the object based on the captured images of the plurality of imagers 1180 or depth information of the object by the depth sensor. Further, these pieces of information and various kinds of information such as the distance between the object and the intrusion detection plane are used for various kinds of display control for the air floating video 3.

Alternatively, the aerial operation detector 1350 may detect a touch operation on the air floating video 3 by the user 230 based on the image captured by the imager 1180 without using the aerial operation detection sensor 1351.

Further, the imager 1180 may capture an image of the face of the user 230 who operates the air floating video 3, and the controller 1110 may perform the identification processing of the user 230. Also, in order to determine whether or not another person is standing around or behind the user 230 who operates the air floating video 3 and the person is peeking at the operation of the user 230 on the air floating video 3, the imager 1180 may capture an image of a range including the user 230 who operates the air floating video 3 and the surrounding region of the user 230.

The operation input unit 1107 is, for example, an operation button or a signal receiver or an infrared receiver such as a remote controller, and receives an input of a signal regarding an operation different from the aerial operation (touch operation) by the user 230. The operation input unit 1107 may be used by, for example, an administrator to operate the air floating video display apparatus 1000 apart from the above-described the user 230 who performs the touch operation on the air floating video 3.

The video signal input unit 1131 is connected to an external video output unit and receives an input of video data. Various digital video input interfaces may be used as the video signal input unit 1131. For example, the video signal input unit 1131 can be configured by a video input interface of the HDMI (High-Definition Multimedia Interface (registered trademark)) standard, a video input interface of the DVI (Digital Visual Interface) standard, or a video input interface of the DisplayPort standard.

Alternatively, an analog video input interface such as analog RGB or composite video may be provided. The audio signal input unit 1133 is connected to an external audio output unit and receives an input of audio data. The audio signal input unit 1133 can be configured by an audio input interface of the HDMI standard, an optical digital terminal interface, a coaxial digital terminal interface, or the like. In the case of the interface of the HDMI standard, the video signal input unit 1131 and the audio signal input unit 1133 may be configured as an interface having integrated terminal and cable. The audio output unit 1140 can output audio based on the audio data input to the audio signal input unit 1133. The audio output unit 1140 may be configured by a speaker.

Also, the audio output unit 1140 may output a built-in operation sound or error warning sound. Alternatively, a configuration to output a digital signal to an external device like the Audio Return Channel function specified in the HDMI standard may be adopted as the audio output unit 1140. The microphone 1139 is configured to capture sound in the vicinity of the air floating video display apparatus 1000 and converts it into a signal to generate an audio signal. There may be provided a configuration in which the microphone records a human voice such as the user's voice, and the controller 1110 described below performs audio recognition processing on the generated audio signal to acquire text information from the audio signal.

The nonvolatile memory 1108 stores various kinds of data used in the air floating video display apparatus 1000. The various kinds of data stored in the nonvolatile memory 1108 include, for example, data for various operations to be displayed in the air floating video 3, display icons, data of objects to be operated by user, layout information, and the like. The memory 1109 stores video data to be displayed as the air floating video 3, data for controlling the apparatus, and the like.

The controller 1110 controls the operation of each unit connected thereto. Also, the controller 1110 may perform arithmetic operation based on information acquired from each unit in the air floating video display apparatus 1000 in cooperation with a program stored in the memory 1109.

The communication unit 1132 communicates with an external device, an external server, or the like via a wired or wireless communication interface. When the communication unit 1132 has a wired communication interface, the wired communication interface may be configured by, for example, the LAN interface of the Ethernet standard. When the communication unit 1132 has a wireless communication interface, the wireless communication interface may be configured by, for example, the communication interface of the Wi-Fi standard, the communication interface of the Bluetooth standard, or the 4G or 5G mobile communication interface. Various kinds of data such as video data, image data, and audio data are transmitted and received through communication via the communication unit 1132.

Further, the removable media interface 1134 is an interface configured to connect removable recording media (removable media). The removable recording media (removable media) may be configured by a semiconductor memory such as solid state drive (SSD), a magnetic recording storage device such as hard disk drive (HDD), or an optical recording media such as an optical disc. The removable media interface 1134 can read various kinds of information such as video data, image data, audio data, and others recorded in the removable recording media. The video data, image data, and others recorded in the removable recording media are output as the air floating video 3 via the video display 1102 and retroreflection portion 1101.

The storage 1170 is a storage device that records various kinds of information, for example, various kinds of data such as video data, image data, and audio data. The storage 1170 may be configured by a magnetic recording storage device such as a hard disk drive (HDD), a semiconductor element memory such as a solid state drive (SSD), or the like. In the storage 1170, for example, various kinds of information, for example, various kinds of data such as video data, image data, and audio data may be recorded in advance at the time of product shipment. In addition, the storage 1170 may record various kinds of information, for example, various kinds of data such as video data, image data, and audio data acquired from an external device, an external server, or the like via the communication unit 1132.

The video data, the image data, and the like recorded in the storage 1170 are output as the air floating video 3 via the video display 1102 and the retroreflection portion 1101. Video data, image data, and the like of display icons, an object to be operated by a user, and the like which are displayed as the air floating video 3 are also recorded in the storage 1170.

Layout information of display icons, an object, and the like displayed as the air floating video 3, information of various kinds of metadata related to the object, and the like are also recorded in the storage 1170. The audio data recorded in the storage 1170 is output as audio from, for example, the audio output unit 1140.

The video controller 1160 performs various kinds of control related to a video signal to be input to the video display 1102. The video controller 1160 may be referred to as a video processing circuitry, and may be configured by hardware such as ASIC, FPGA, or video processor. Note that the video controller 1160 may be referred to also as a video processing unit or an image processing unit. For example, the video controller 1160 performs the control of video switching for determining which of a video signal stored in the memory 1109 or a video signal (video data) input to the video signal input unit 1131 is to be input to the video display 1102.

Also, the video controller 1160 may perform the control to form a composite video as the air floating video 3 by generating a superimposed video signal obtained by superimposing the video signal stored in the memory 1109 and the video signal input from the video signal input unit 1131 and inputting the superimposed video signal to the video display 1102.

Further, the video controller 1160 may perform the control to perform image processing on the video signal input from the video signal input unit 1131, the video signal to be stored in the memory 1109, or the like. Examples of the image processing include scaling processing for enlarging, reducing, and deforming an image, brightness adjustment processing for changing luminance, contrast adjustment processing for changing a contrast curve of an image, and retinex processing for decomposing an image into light components and changing weighting for each component.

In addition, the video controller 1160 may perform special effect video processing or the like for assisting an aerial operation (touch operation) of the user 230 to the video signal to be input to the video display 1102. The special effect video processing is performed based on, for example, the detection result of the touch operation of the user 230 by the aerial operation detector 1350 and the captured image of the user 230 by the imager 1180.

The attitude sensor 1113 is a sensor configured by a gravity sensor, an acceleration sensor, or a combination thereof, and can detect the attitude with which the air floating video display apparatus 1000 is installed. Based on the attitude detection result of the attitude sensor 1113, the controller 1110 may control the operation of each connected unit. For example, when an unfavorable attitude as the usage state of the user is detected, control to stop the display of the video displayed on the video display 1102 and display an error message to the user may be performed. Alternatively, when the attitude sensor 1113 detects that the installation attitude of the air floating video display apparatus 1000 has changed, control to rotate the display direction of the video displayed on the video display 1102 may be performed.

As described above, the air floating video display apparatus 1000 is provided with various functions. However, the air floating video display apparatus 1000 does not need to have all of these functions, and may have any configuration as long as the apparatus has a function of forming the air floating video 3.

### <Configuration Example of Air Floating Video Display Apparatus>

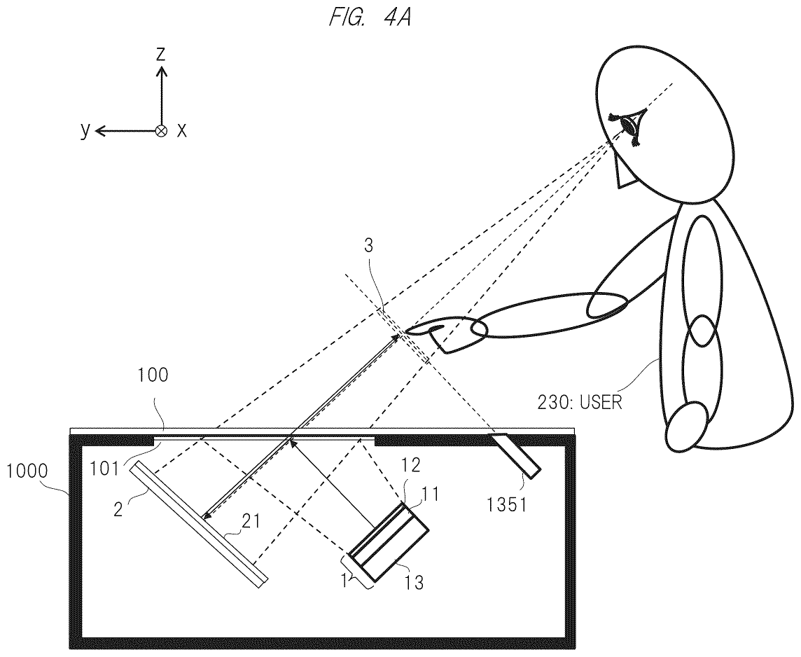

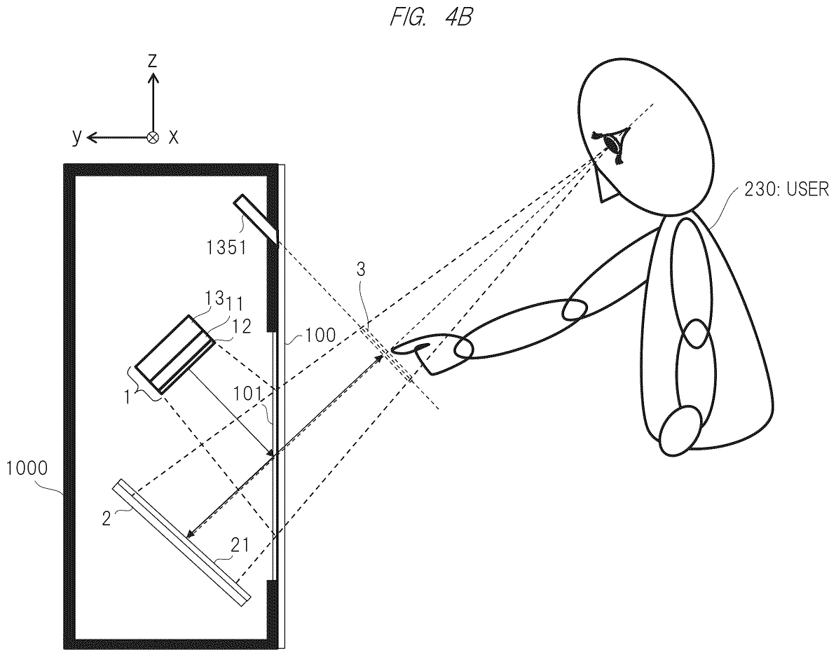

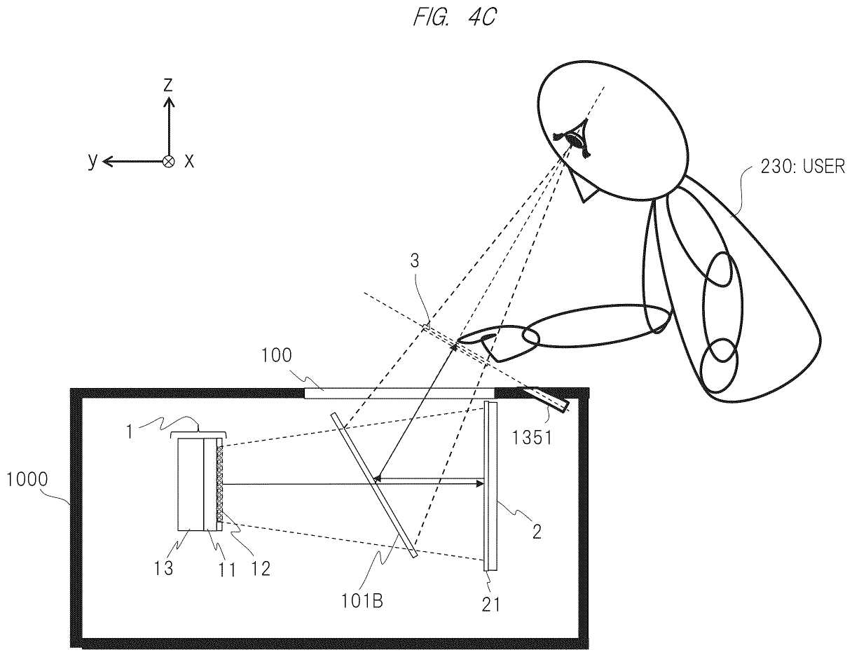

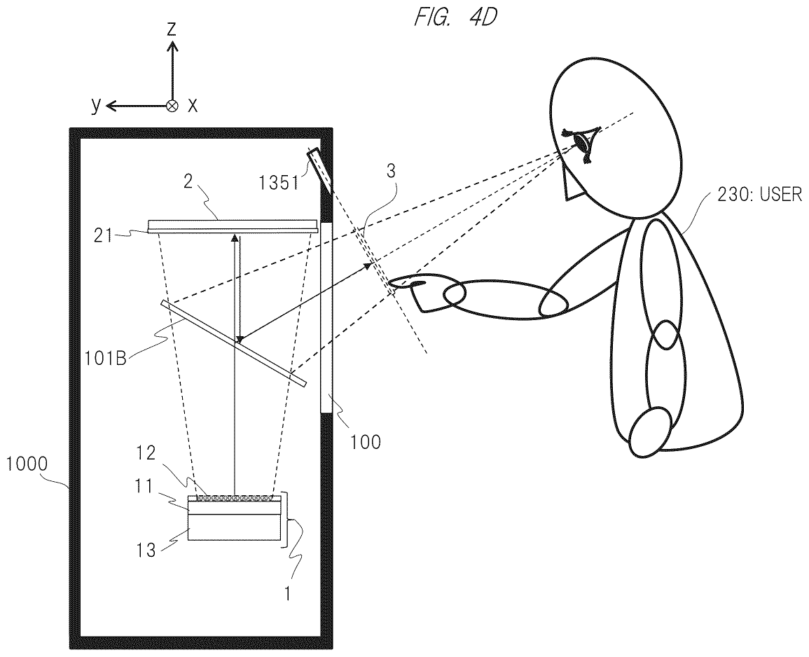

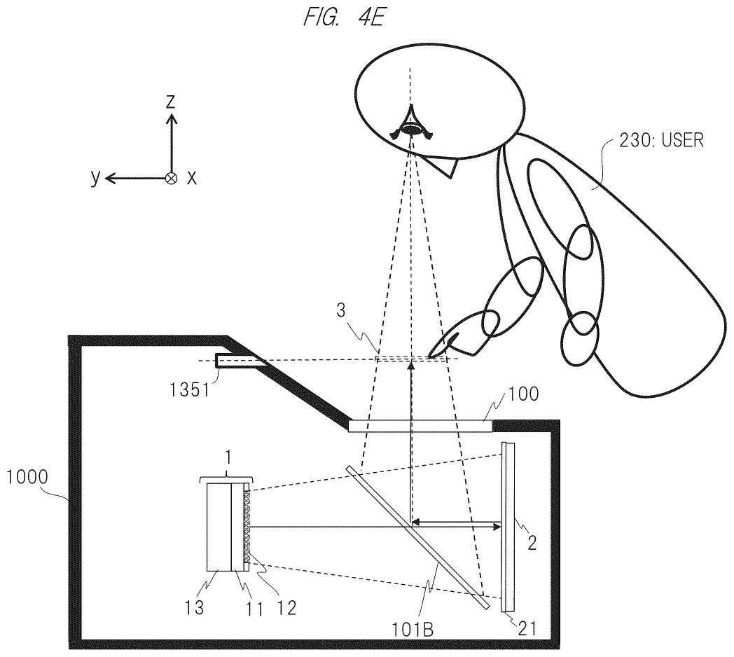

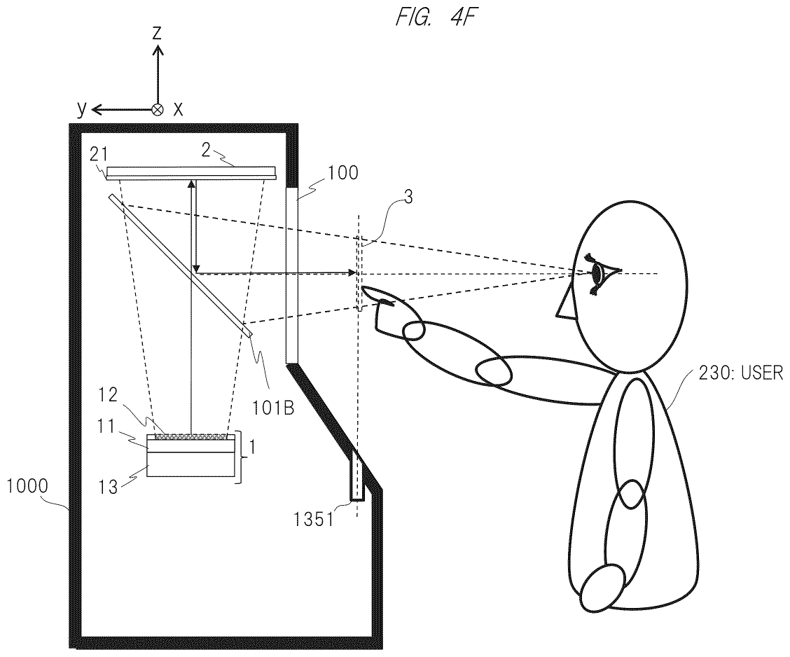

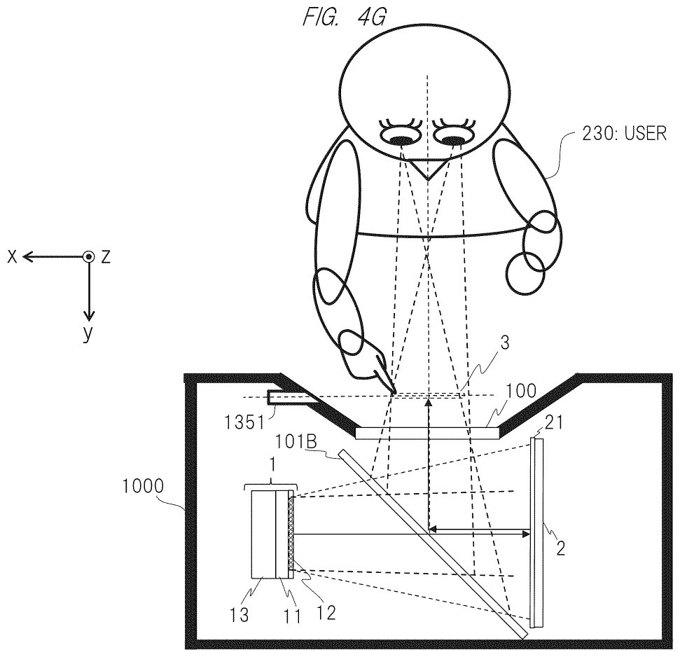

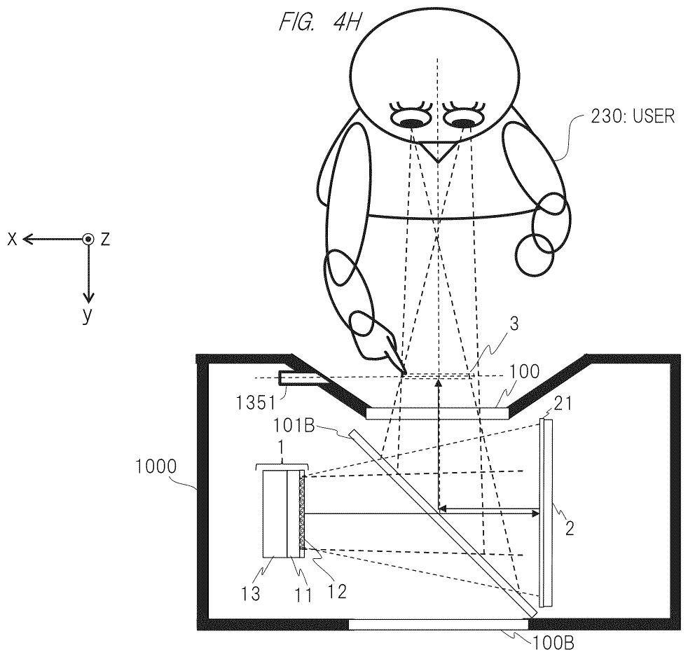

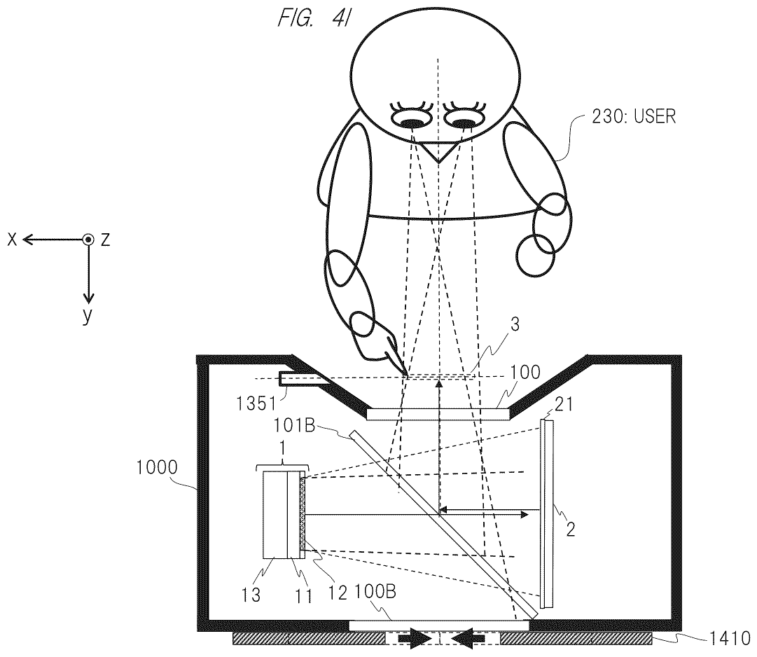

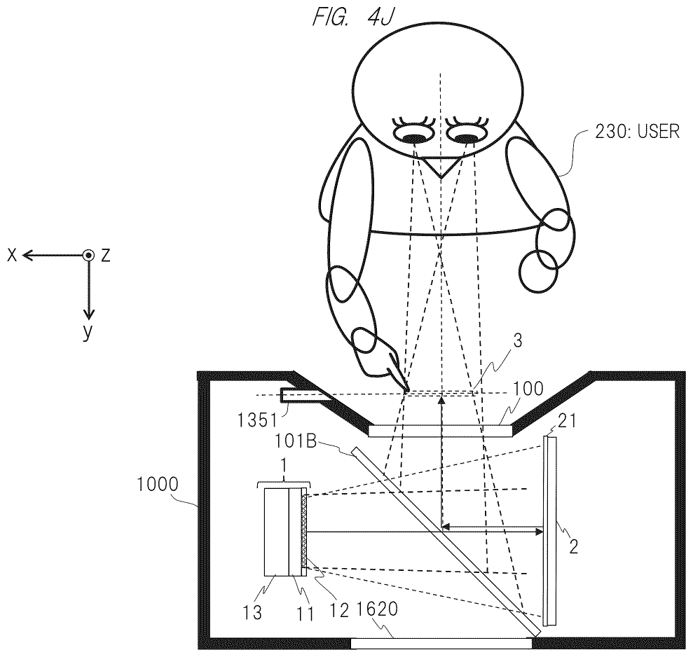

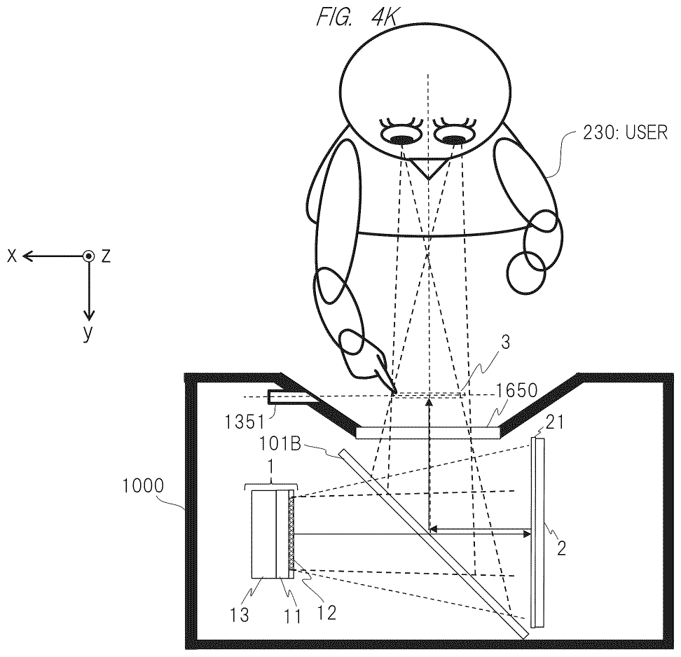

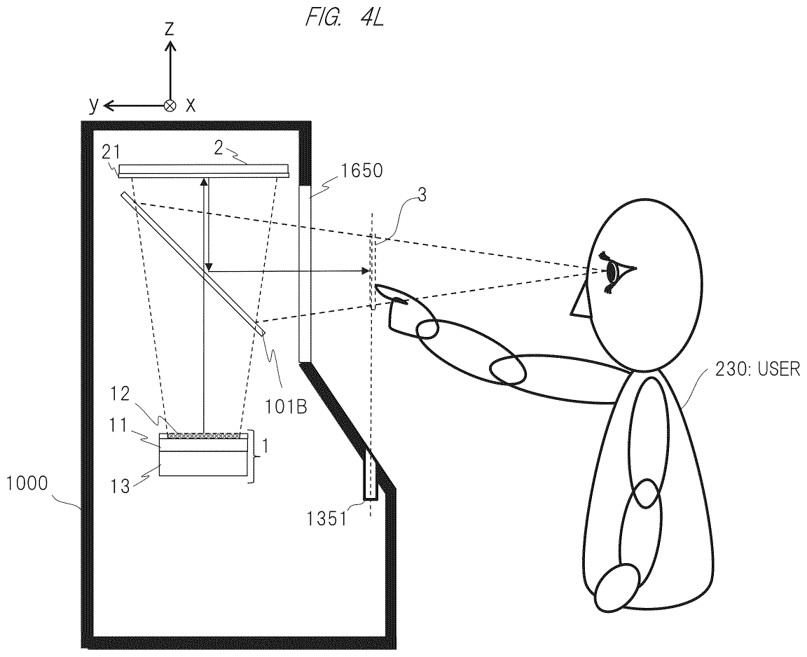

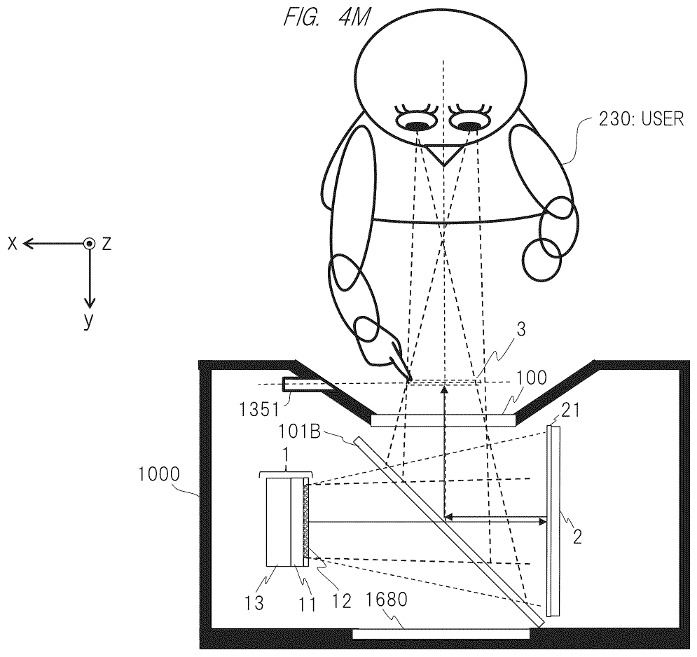

Next, the configuration example of the air floating video display apparatus will be described. As the layout of the components of the air floating video display apparatus according to the present embodiment, various layouts are possible depending on the usage form. Each layout in FIG. 4A to FIG. 4M will be described below. Note that, in any of the examples in FIG. 4A to FIG. 4M, a thick line surrounding the air floating video display apparatus 1000 indicates an example of the housing structure of the air floating video display apparatus 1000.

FIG. 4A is a diagram showing an example of the configuration of the air floating video display apparatus. The air floating video display apparatus 1000 shown in FIG. 4A is mounted with an optical system corresponding to the optical system shown in FIG. 2A. The air floating video display apparatus 1000 shown in FIG. 4A is installed horizontally such that the surface on the side where the air floating video 3 is formed faces upward. Namely, in FIG. 4A, the air floating video display apparatus 1000 has the transparent member 100 placed on an upper surface of the apparatus. The air floating video 3 is formed above the surface of the transparent member 100 of the air floating video display apparatus 1000. The light of the air floating video 3 travels obliquely upward. When the aerial operation detection sensor 1351 is provided as shown in the drawing, it is possible to detect the operation on the air floating video 3 by the finger of the user 230. Note that the x direction is the left-right direction when viewed from the user, the y direction is the front-rear direction (depth direction) when viewed from the user, and the z direction is the up-down direction (vertical direction). Hereinafter, since the definitions of the x direction, y direction, and z direction are the same in each drawing of FIG. 4A to FIG. 4M, the repetitive descriptions will be omitted.

FIG. 4B is a diagram showing an example of the configuration of the air floating video display apparatus. The air floating video display apparatus 1000 shown in FIG. 4B is mounted with an optical system corresponding to the optical system shown in FIG. 2A. The air floating video display apparatus 1000 shown in FIG. 4B is installed vertically such that the surface on the side where the air floating video 3 is formed is located on the front side of the air floating video display apparatus 1000 (faces the user 230). Namely, in FIG. 4B, the air floating video display apparatus 1000 has the transparent member 100 placed on the front side of the apparatus (on the side of the user 230). The air floating video 3 is formed on the side of the user 230 with respect to the surface of the transparent member 100 of the air floating video display apparatus 1000. The light of the air floating video 3 travels obliquely upward. When the aerial operation detection sensor 1351 is provided as shown in the drawing, it is possible to detect the operation on the air floating video 3 by the finger of the user 230. Here, as shown in FIG. 4B, the aerial operation detection sensor 1351 can utilize the reflection of the sensing light by the nail of the user for touch detection by sensing the finger of the user 230 from above. Since a nail generally has a higher reflectance than a pad of a finger, this configuration can improve the accuracy of touch detection.

FIG. 4C is a diagram showing an example of the configuration of the air floating video display apparatus. The air floating video display apparatus 1000 shown in FIG. 4C is mounted with an optical system corresponding to the optical system shown in FIG. 2B. The air floating video display apparatus 1000 shown in FIG. 4C is installed horizontally such that the surface on the side where the air floating video 3 is formed faces upward. Namely, in FIG. 4C, the air floating video display apparatus 1000 has the transparent member 100 placed on the upper surface of the apparatus. The air floating video 3 is formed above the surface of the transparent member 100 of the air floating video display apparatus 1000. The light of the air floating video 3 travels obliquely upward. When the aerial operation detection sensor 1351 is provided as shown in the drawing, it is possible to detect the operation on the air floating video 3 by the finger of the user 230.

FIG. 4D is a diagram showing an example of the configuration of the air floating video display apparatus. The air floating video display apparatus 1000 shown in FIG. 4D is mounted with an optical system corresponding to the optical system shown in FIG. 2B. The air floating video display apparatus 1000 shown in FIG. 4D is installed vertically such that the surface on the side where the air floating video 3 is formed is located on the front side of the air floating video display apparatus 1000 (faces the user 230). Namely, in FIG. 4D, the air floating video display apparatus 1000 has the transparent member 100 placed on the front side of the apparatus (on the side of the user 230). The air floating video 3 is formed on the side of the user 230 with respect to the surface of the transparent member 100 of the air floating video display apparatus 1000. The light of the air floating video 3 travels obliquely upward. When the aerial operation detection sensor 1351 is provided as shown in the drawing, it is possible to detect the operation on the air floating video 3 by the finger of the user 230. Here, as shown in FIG. 4D, the aerial operation detection sensor 1351 can utilize the reflection of the sensing light by the nail of the user for touch detection by sensing the finger of the user 230 from above. Since a nail generally has a higher reflectance than a pad of a finger, this configuration can improve the accuracy of touch detection.

FIG. 4E is a diagram showing an example of the configuration of the air floating video display apparatus. The air floating video display apparatus 1000 shown in FIG. 4E is mounted with an optical system corresponding to the optical system shown in FIG. 2C. The air floating video display apparatus 1000 shown in FIG. 4E is installed horizontally such that the surface on the side where the air floating video 3 is formed faces upward. Namely, in FIG. 4E, the air floating video display apparatus 1000 has the transparent member 100 placed on the upper surface of the apparatus. The air floating video 3 is formed above the surface of the transparent member 100 of the air floating video display apparatus 1000. The light of the air floating video 3 travels directly upward. When the aerial operation detection sensor 1351 is provided as shown in the drawing, it is possible to detect the operation on the air floating video 3 by the finger of the user 230.

FIG. 4F is a diagram showing an example of the configuration of the air floating video display apparatus. The air floating video display apparatus 1000 shown in FIG. 4F is mounted with an optical system corresponding to the optical system shown in FIG. 2C. The air floating video display apparatus 1000 shown in FIG. 4F is installed vertically such that the surface on the side where the air floating video 3 is formed is located on the front side of the air floating video display apparatus 1000 (faces the user 230). Namely, in FIG. 4F, the air floating video display apparatus 1000 has the transparent member 100 placed on the front side of the apparatus (on the side of the user 230). The air floating video 3 is formed on the side of the user 230 with respect to the surface of the transparent member 100 of the air floating video display apparatus 1000. The light of the air floating video 3 travels toward the user. When the aerial operation detection sensor 1351 is provided as shown in the drawing, it is possible to detect the operation on the air floating video 3 by the finger of the user 230.

FIG. 4G is a diagram showing an example of the configuration of the air floating video display apparatus. The air floating video display apparatus 1000 shown in FIG. 4G is mounted with an optical system corresponding to the optical system shown in FIG. 2C. In the optical system of each air floating video display apparatus shown in FIG. 4A to FIG. 4F, the central optical path of the video light emitted from the display apparatus 1 is on the y-z plane. Namely, in the optical system of each air floating video display apparatus shown in FIG. 4A to FIG. 4F, the video light travels in the front-rear direction and the up-down direction when viewed from the user. On the other hand, in the optical system of the air floating video display apparatus shown in FIG. 4G, the central optical path of the video light emitted from the display apparatus 1 is on the x-y plane. Namely, in the optical system of the air floating video display apparatus shown in FIG. 4G, video light travels in the left-right direction and front-rear direction when viewed from the user. The air floating video display apparatus 1000 shown in FIG. 4G is installed such that the surface on the side where the air floating video 3 is formed is located on the front side of the apparatus (faces the user 230). Namely, in FIG. 4G, the air floating video display apparatus 1000 has the transparent member 100 placed on the front side of the apparatus (on the side of the user 230). The air floating video 3 is formed on the side of the user 230 with respect to the surface of the transparent member 100 of the air floating video display apparatus 1000. The light of the air floating video 3 travels toward the user. When the aerial operation detection sensor 1351 is provided as shown in the drawing, it is possible to detect the operation on the air floating video 3 by the finger of the user 230.

FIG. 4H is a diagram showing an example of the configuration of the air floating video display apparatus. The air floating video display apparatus 1000 in FIG. 4H is different from the air floating video display apparatus 1000 in FIG. 4G in that a window having a transparent plate 100B such as glass or plastic is provided on the rear side of the apparatus (on the opposite side of the position where the user 230 visually recognizes the air floating video 3, that is, on the opposite side of the traveling direction of the video light of the air floating video 3 toward the user 230). Since the other configuration is the same as that of the air floating video display apparatus in FIG. 4G, the repetitive descriptions will be omitted. The air floating video display apparatus 1000 in FIG. 4H includes a window having the transparent plate 100B at a position on the opposite side of the traveling direction of the video light of the air floating video 3 with respect to the air floating video 3. Therefore, when the user 230 visually recognizes the air floating video 3, the user 230 can recognize the scenery behind the air floating video display apparatus 1000 as the background of the air floating video 3. Accordingly, the user 230 can perceive the air floating video 3 as if it is floating in the air in front of the scenery behind the air floating video display apparatus 1000. In this way, it is possible to further emphasize the sense of floating in the air of the air floating video 3.

Note that, depending on the polarization distribution of the video light output from the display apparatus 1 and the performance of the polarization separator 101B, there is a possibility that a part of the video light output from the display apparatus 1 is reflected by the polarization separator 101B and travels toward the transparent plate 100B. Depending on the coating property of the surface of the transparent plate 100B, the light may be reflected again on the surface of the transparent plate 100B and visually recognized by the user as stray light. Therefore, in order to prevent the stray light, the configuration in which the transparent plate 100B is not provided in the window on the rear side of the air floating video display apparatus 1000 is also possible.

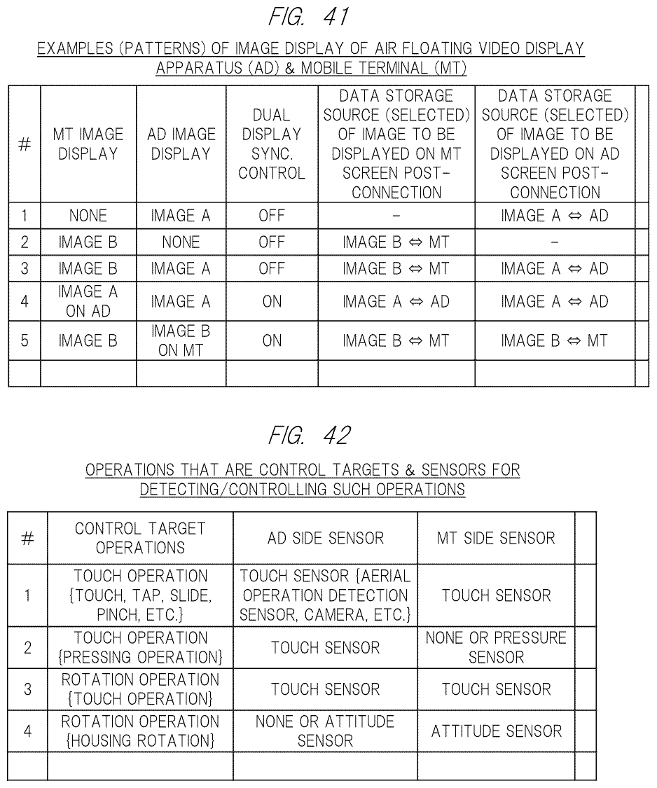

FIG. 41 is a diagram showing an example of the configuration of the air floating video display apparatus. The air floating video display apparatus 1000 in FIG. 41 is different from the air floating video display apparatus 1000 in FIG. 4H in that an opening/closing door 1410 for blocking light is provided on the window of the transparent plate 100B provided on the rear side of the apparatus (on the opposite side of the position where the user 230 visually recognizes the air floating video 3). Since the other configuration is the same as that of the air floating video display apparatus in FIG. 4H, the repetitive descriptions will be omitted.

The opening/closing door 1410 of the air floating video display apparatus 1000 in FIG. 41 includes, for example, a light-shielding plate and a mechanism for moving (sliding), rotating, or attaching/detaching the light-shielding plate, so that the state of the window (rear-side window) of the transparent plate 100B located on the rear side of the air floating video display apparatus 1000 can be switched between an open state and a light-shielding state. The movement (sliding) or rotation of the light-shielding plate of the opening/closing door 1410 may be electrically driven by a motor (not shown). The motor may be controlled by the controller 1110 in FIG. 3. Note that, in the example in FIG. 41, the case in which the light-shielding plate of the opening/closing door 1410 is composed of two plate members is disclosed. On the other hand, the light-shielding plate of the opening/closing door 1410 may be composed of one plate member.

For example, when the scenery seen behind the window of the transparent plate 100B of the air floating video display apparatus 1000 is outdoors, the brightness of sunlight varies depending on the weather. If the sunlight outside is strong, the background of the air floating video 3 may become too bright, and the visibility of the air floating video 3 for the user 230 may be lowered. In such a case, if the rear-side window can be brought into the light-shielding state by moving (sliding), rotating, or attaching the light-shielding plate of the opening/closing door 1410, the background of the air floating video 3 becomes dark and the visibility of the air floating video 3 can be increased relatively. The shielding action by the light-shielding plate of the opening/closing door 1410 may be performed manually by the hand of the user 230. Alternatively, the shielding action by the light-shielding plate of the opening/closing door 1410 may be performed by a motor (not shown) under the control of the controller 1110 in response to the operation input via the operation input unit 1107 in FIG. 3.

Note that it is also possible to measure the brightness of the space beyond the rear-side window by providing an illuminance sensor on the back side of the air floating video display apparatus 1000 (the side opposite to the user 230), for example, near the rear-side window. In this case, the opening/closing action of the light-shielding plate of the opening/closing door 1410 may be performed by a motor (not shown) under the control of the controller 1110 in FIG. 3 based on the detection result of the illuminance sensor. By controlling the opening/closing action of the light-shielding plate of the opening/closing door 1410 in this manner, the visibility of the air floating video 3 can be suitably maintained even if the user 230 does not manually open and close the light-shielding plate of the opening/closing door 1410.

Further, the light-shielding plate of the opening/closing door 1410 may be configured to be manually attachable/detachable. Depending on the purpose of use and installation environment of the air floating video display apparatus 1000, the user can select whether the rear-side window is brought into an open state or a light-shielding state. If it is planned to use the air floating video display apparatus 1000 while keeping the rear-side window in the light-shieling state for a long period of time, the attachable/detachable light-shielding plate may be fixed in the light-shielding state. Meanwhile, if it is planned to use the air floating video display apparatus 1000 while keeping the rear-side window in the open state for a long period of time, the attachable/detachable light-shielding plate may be detached. The light-shielding plate may be attached and detached using screws, a hook structure, or a fitting structure.

Note that, even in the example of the air floating video display apparatus 1000 in FIG. 41, depending on the polarization distribution of the video light output from the display apparatus 1 and the performance of the polarization separator 101B, there is a possibility that a part of the video light output from the display apparatus 1 is reflected by the polarization separator 101B and travels toward the transparent plate 100B. Depending on the coating property of the surface of the transparent plate 100B, the light may be reflected again on the surface of the transparent plate 100B and visually recognized by the user as stray light. Therefore, in order to prevent the stray light, the configuration in which the transparent plate 100B is not provided in the window on the rear side of the air floating video display apparatus 1000 is also possible. The above-described opening/closing door 1410 may be provided on the window that is not provided with the transparent plate 100B. In order to prevent the stray light, it is desirable that the inner surface of the light-shielding plate 1410 inside the housing has a coating or a material with low light reflectance.

FIG. 4J is a diagram showing an example of the configuration of the air floating video display apparatus. The air floating video display apparatus 1000 in FIG. 4J is different from the air floating video display apparatus in FIG. 4H in that an electronically-controlled transmittance variable unit 1620 is arranged on the rear-side window instead of arranging the transparent plate 100B made of glass or plastic. Since the other configuration is the same as that of the air floating video display apparatus in FIG. 4H, the repetitive descriptions will be omitted. An example of the electronically-controlled transmittance variable unit 1620 is a liquid crystal shutter or the like.

Namely, the liquid crystal shutter can control the light transmittance by controlling the voltage applied to the liquid crystal element sandwiched between two polarization plates.

Therefore, by controlling the liquid crystal shutter to increase the transmittance, the scenery beyond the rear-side window can be seen through the air floating video 3 on the background.

Meanwhile, by controlling the liquid crystal shutter to reduce the transmittance, the scenery beyond the rear-side window cannot be seen through the air floating video 3 on the background.

Further, since the halftone control is possible in the liquid crystal shutter, it can be set to, for example, a state of transmittance of 50%. For example, the controller 1110 can control the transmittance of the electronically-controlled transmittance variable unit 1620 in response to the operation input via the operation input unit 1107 in FIG. 3. With this configuration, in such a case where it is desired to see the scenery beyond the rear-side window as the background of the air floating video 3, but the scenery beyond the rear-side window on the background is too bright and the visibility of the air floating video 3 is lowered, the visibility of the air floating video 3 can be adjusted by controlling the transmittance of the electronically-controlled transmittance variable unit 1620.

Note that it is also possible to measure the brightness of the space beyond the rear-side window by providing an illuminance sensor on the back side of the air floating video display apparatus 1000 (the side opposite to the user 230), for example, near the rear-side window. In this case, the controller 1110 in FIG. 3 can control the transmittance of the electronically-controlled transmittance variable unit 1620 based on the detection result of the illuminance sensor. In this way, since the transmittance of the electronically-controlled transmittance variable unit 1620 can be adjusted based on the brightness of the space beyond the rear-side window even if the user 230 does not perform the operation input via the operation input unit 1107 in FIG. 3, it is possible to suitably maintain the visibility of the air floating video 3.

Furthermore, in the above example, the case where a liquid crystal shutter is used as the electronically-controlled transmittance variable unit 1620 has been described. Alternatively, electronic paper may be used as another example of the electronically-controlled transmittance variable unit 1620. Even in the case where electronic paper is used, the same effect as that described above can be obtained. Moreover, power consumption required to maintain the halftone state is very small in the electronic paper. Therefore, it is possible to realize the air floating video display apparatus with lower power consumption as compared with the case where a liquid crystal shutter is adopted.

FIG. 4K is a diagram showing an example of the configuration of the air floating video display apparatus. The air floating video display apparatus 1000 in FIG. 4K is different from the air floating video display apparatus in FIG. 4G in that a transmissive self-luminous video display apparatus 1650 is provided instead of the transparent member 100. Since the other configuration is the same as that of the air floating video display apparatus in FIG. 4G, the repetitive descriptions will be omitted.

In the air floating video display apparatus 1000 in FIG. 4K, after the video light flux passes through the display surface of the transmissive self-luminous video display apparatus 1650, the air floating video 3 is formed outside the air floating video display apparatus 1000. Namely, when a video is being displayed on the transmissive self-luminous video display apparatus 1650 which is a two-dimensional flat display, the air floating video 3 can be displayed as a projected video on the front side of the user with respect to the video on the transmissive self-luminous video display apparatus 1650. At this time, the user 230 can visually recognize two videos at different depth positions at the same time. The transmissive self-luminous video display apparatus 1650 can be configured using existing techniques of a transmissive organic EL panel disclosed in, for example, Japanese Unexamined Patent Application Publication No. 2014-216761. Although the transmissive self-luminous video display apparatus 1650 is not shown in FIG. 3, it can be configured as a component of the air floating video display apparatus 1000 in FIG. 3 so as to be connected to the other processing units such as the controller 1110.

Here, for example, if the performance that both the background and objects such as characters are displayed on the transmissive self-luminous video display apparatus 1650 and then the objects such as characters only are moved to the air floating video 3 on the front side is executed, it is possible to provide the user 230 with a more effective video experience with surprising effects.

Further, if the inside of the air floating video display apparatus 1000 is set to the light-shielding state, the background of the transmissive self-luminous video display apparatus 1650 becomes sufficiently dark. Therefore, in the case where no video is displayed on the display apparatus 1 or the light source of the display apparatus 1 is turned off and the video is displayed only on the transmissive self-luminous video display apparatus 1650, the transmissive self-luminous video display apparatus 1650 appears to the user 230 as if it is an ordinary two-dimensional flat display rather than a transmissive display (since the air floating video 3 in the embodiment of the present invention is displayed as a real optical image in a space without a screen, the position where the air floating video 3 is to be displayed becomes an empty space when the light source of the display apparatus 1 is turned off). Therefore, if the characters and objects are suddenly displayed in the air as the air floating video 3 when the video is being displayed using the transmissive self-luminous video display apparatus 1650 as a general two-dimensional flat display, it is possible to provide the user 230 with a more effective video experience with surprising effects.

Note that the darker the inside of the air floating video display apparatus 1000 becomes, the more the transmissive self-luminous video display apparatus 1650 appears like a two-dimensional flat display. Therefore, an absorptive polarization plate (not shown) that transmits the polarized wave of the video light reflected by the polarization separator 101B and absorbs the polarized wave whose phase is different by 90° from this polarized wave may be provided on the inner surface of the transmissive self-luminous video display apparatus 1650 inside the air floating video display apparatus 1000 (the incident surface of the video light reflected by the polarization separator 101B to the transmissive self-luminous video display apparatus 1650, that is, the surface of the transmissive self-luminous video display apparatus 1650 on the side opposite to the air floating video 3). In this way, although the influence on the video light that forms the air floating video 3 is not so great, the light that enters the interior of the air floating video display apparatus 1000 from the outside via the transmissive self-luminous video display apparatus 1650 can be significantly reduced, and the interior of the air floating video display apparatus 1000 can be suitably made darker.

FIG. 4L is a diagram showing an example of the configuration of the air floating video display apparatus. The air floating video display apparatus 1000 in FIG. 4L is a modification of the air floating video display apparatus in FIG. 4K. The arrangement direction of the configuration in the air floating video display apparatus 1000 is different from that of the air floating video display apparatus shown in FIG. 4K, and is similar to that of the air floating video display apparatus shown in FIG. 4F. Since the functions, operations, and the like of each configuration are the same as those of the air floating video display apparatus in FIG. 4K, the repetitive descriptions will be omitted.

In the air floating video display apparatus in FIG. 4L as well, after the light flux of the video light passes through the transmissive self-luminous video display apparatus 1650, the air floating video 3 is formed on the side of the user 230 with respect to the transmissive self-luminous video display apparatus 1650.

In both the example of the air floating video display apparatus in FIG. 4K and the example of the air floating video display apparatus in FIG. 4L, the air floating video 3 is displayed to be overlapped in front of the video of the transmissive self-luminous video display apparatus 1650 when viewed from the user 230. Here, the position of the air floating video 3 and the position of the video of the transmissive self-luminous video display apparatus 1650 are designed to be different in the depth direction. Therefore, when the user moves his or her head (position of the viewpoint), the depth of the two videos can be recognized based on the parallax. Therefore, by displaying two videos with different depth positions, a three-dimensional video experience can be more suitably provided to the user with naked eyes without the need for stereoscopic glasses or the like.

FIG. 4M is a diagram showing an example of the configuration of the air floating video display apparatus. In the air floating video display apparatus 1000 in FIG. 4M, a second display apparatus 1680 is provided on the rear side when viewed from the user with respect to the polarization separator 101B of the air floating video display apparatus in FIG. 4G. Since the other configuration is the same as that of the air floating video display apparatus in FIG. 4G, the repetitive descriptions will be omitted.

In the configuration example shown in FIG. 4M, the second display apparatus 1680 is provided on the rear side of the display position of the air floating video 3, and the video display surface is directed toward the air floating video 3. With this configuration, when viewed from the user 230, two videos such as the video of the second display apparatus 1680 and the air floating video 3 which are displayed at two different depth positions can be visually recognized to be overlapped with each other. Namely, it can be said that the second display apparatus 1680 is arranged so as to display the video in the direction toward the user 230 who visually recognizes the air floating video 3. Although not shown in FIG. 3, the second display apparatus 1680 can be configured as a component of the air floating video display apparatus 1000 in FIG. 3 so as to be connected to other processors such as the controller 1110.

Note that the video light from the second display apparatus 1680 of the air floating video display apparatus 1000 in FIG. 4M is visually recognized by the user 230 after passing through the polarization separator 101B. Therefore, in order for the video light of the second display apparatus 1680 to pass through the polarization separator 101B more suitably, the video light output from the second display apparatus 1680 is desirably the light of a polarized wave having a vibration direction capable of passing through the polarization separator 101B more suitably. Namely, it is desirably the light of a polarized wave having the same vibration direction as the polarized wave of the video light output from the display apparatus 1. For example, when the video light output from the display apparatus 1 is S-polarized light, it is desirable that the video light output from the second display apparatus 1680 is also S-polarized light. Also, when the video light output from the display apparatus 1 is P-polarized light, it is desirable that the video light output from the second display apparatus 1680 is also P-polarized light.

The example of the air floating video display apparatus in FIG. 4M also has the same effect as those of the example of the air floating video display apparatus in FIG. 4K and the example of the air floating video display apparatus in FIG. 4L in that the second video is displayed behind the air floating video 3. However, unlike the example of the air floating video display apparatus in FIG. 4K and the example of the air floating video display apparatus in FIG. 4L, the light flux of the video light for forming the air floating video 3 does not pass through the second display apparatus 1680 in the example of the air floating video display apparatus in FIG. 4M. Therefore, the second display apparatus 1680 does not need to be a transmissive self-luminous video display apparatus, and may be a liquid crystal display that is a two-dimensional flat display. The second display apparatus 1680 may also be an organic EL display. Therefore, in the example of the air floating video display apparatus in FIG. 4M, the air floating video display apparatus 1000 can be realized at a lower cost than those in the example of the air floating video display apparatus in FIG. 4K and the example of the air floating video display apparatus in FIG. 4L.

Here, depending on the polarization distribution of the video light output from the display apparatus 1 and the performance of the polarization separator 101B, there is a possibility that a part of the video light output from the display apparatus 1 is reflected by the polarization separator 101B and travels toward the second apparatus 1680. This light (part of video light) may be reflected again on the surface of the second display apparatus 1680 and visually recognized by the user as stray light.

Therefore, in order to prevent the stray light, an absorptive polarization plate may be provided on the surface of the second display apparatus 1680. In this case, as the absorptive polarization plate, an absorptive polarization plate that transmits the polarized wave of the video light output from the second display apparatus 1680 and absorbs the polarized wave whose phase is different by 90° from the polarized wave of the video light output from the second display apparatus 1680 can be provided. Note that, when the second display apparatus 1680 is a liquid crystal display, an absorptive polarization plate is present also on the video emission side inside the liquid crystal display. However, when a cover glass (cover glass on the video display side) is present on the emission surface of the absorptive polarization plate on the video output side inside the liquid crystal display, it is not possible to prevent the stray light generated by the reflection of the cover glass by the light from outside of the liquid crystal display. Therefore, it is necessary to separately provide the above-mentioned absorptive polarization plate on the surface of the cover glass.

Note that, when a video is being displayed on the second display apparatus 1680 which is a two-dimensional flat display, the air floating video 3 can be displayed as a video on the front side of the user with respect to the video on the second display apparatus 1680. At this time, the user 230 can visually recognize two videos at different depth positions at the same time. By displaying the character on the air floating video 3 and displaying the background on the second display apparatus 1680, it is possible to provide an effect as if the user 230 is stereoscopically viewing the space in which the character exists.

Also, if the performance that both the background and objects such as characters are displayed on the second display apparatus 1680 and then the objects such as characters only are moved to the air floating video 3 on the front side is executed, it is possible to provide the user 230 with a more effective video experience with surprising effects.

Next, FIG. 4N is a diagram showing an example of the configuration of the air floating video display apparatus. The air floating video display apparatus 1000 of FIG. 4N is an air floating video display apparatus that adopts the optical system of FIG. 2D. Similar to the example of the air floating video display apparatus that adopts the optical system of FIG. 2A to FIG. 2C, the video light passing through the transparent member 100 forms the air floating video 3 in midair. In addition, by using the sensing light of the aerial operation detection sensor 1351 arranged on the rear side of the transparent member 100 from the user's perspective, it is possible to detect the operation on the air floating video 3 by the finger 9004 of the user 230.

In the example of the air floating video display apparatus adopting the optical system of FIG. 2A to FIG. 2C and the example of the air floating video display apparatus adopting the optical system of FIG. 2D, the air floating video 3 is formed in front of the transparent member 100, and by using the sensing light of the aerial operation detection sensor 1351 arranged on the rear side of the transparent member 100 from the user's perspective, it is possible to detect the operation on the air floating video 3 by the finger of the user 230. Therefore, the air floating video display apparatus adopting the optical system of FIG. 2D differs from the air floating video display apparatus in which the optical system of FIG. 2A to FIG. 2C is arranged on the rear side of the transparent member 100 from the user's perspective.

However, from the user's perspective, usability of the air floating video display apparatus adopting the optical system of FIG. 2D is almost the same as that of the air floating video display apparatus adopting the optical system of FIG. 2A to FIG. 2C.

Next, FIG. 4O is a diagram showing an example of the configuration of the air floating video display apparatus. FIG. 4O is a diagram showing the air floating video display apparatus 1000 of FIG. 4N with a configuration of an internal optical system. The air floating video display apparatus 1000 shown in FIG. 4O is mounted with an optical system corresponding to the optical system of FIG. 2D. The air floating video display apparatus 1000 shown in FIG. 4O, is installed horizontally such that the surface on the side where the air floating video 3 is formed faces upward.

Namely, in FIG. 4O, the air floating video display apparatus 1000 has the transparent member 100 placed on the upper surface of the apparatus. The air floating video 3 is formed above the surface of the transparent member 100 of the air floating video display apparatus 1000. The light of the air floating video 3 travels obliquely upward. When the aerial operation detection sensor 1351 is provided as shown in the drawing, it is possible to detect the operation on the air floating video 3 by the finger of the user 230.

Here, the configuration of FIG. 4O is compared with the configuration of FIG. 4A to confirm differences. In FIG. 4A, the display apparatus 1 and the air floating video 3 are plane-symmetric about the surface of the polarization separator 101. In contrast, in FIG. 4O, the display apparatus 1 and the air floating video 3 are plane-symmetric about the surface of the retroreflection plate 5. In addition, the retroreflection plate 2 and the λ/4 plate 21 are present in the configuration of FIG. 4A but not in FIG. 4O. In addition, while it is preferable to include the absorptive polarization plate 12 in FIG. 4A, the absorptive polarization plate 12 is not particularly necessary in FIG. 4O.

Namely, in order to replace the optical system of FIG. 2A used in the configuration of FIG. 4A with the optical system of FIG. 2D and achieve the configuration of FIG. 4O, the following steps may be taken. Specifically, the polarization separator 101 in the configuration of FIG. 4A is replaced with the retroreflection plate 5, and the retroreflection plate 2 and the λ/4 plate 21 are removed from the configuration of FIG. 4A. The absorptive polarization plate 12 may be provided or omitted. By performing replacement based on this concept, the optical system of FIG. 2A to FIG. 2C mounted in the configuration of the air floating video display apparatus of FIG. 4A to FIG. 4G can be replaced with the optical system of FIG. 2D, thereby achieving the air floating video display apparatus mounted with the optical system of FIG. 2D. In this case, in FIG. 4A and FIG. 4B, the polarization separator 101 may be replaced with the retroreflection plate 5, and in FIG. 4C to FIG. 4G, the polarization separator 101B may be replaced with the retroreflection plate 5.

In this way, in the configuration of the air floating video display apparatus of FIG. 4A to FIG. 4G, it is possible to realize an air floating video display apparatus in which the optical system is replaced with the optical system of FIG. 2D. Even in this air floating video display apparatus with the replaced optical system of FIG. 2D, it is possible to realize an air floating video display apparatus having usability that is almost the same as the air floating video display apparatus of FIG. 4A to FIG. 4G.

### <Display Apparatus>

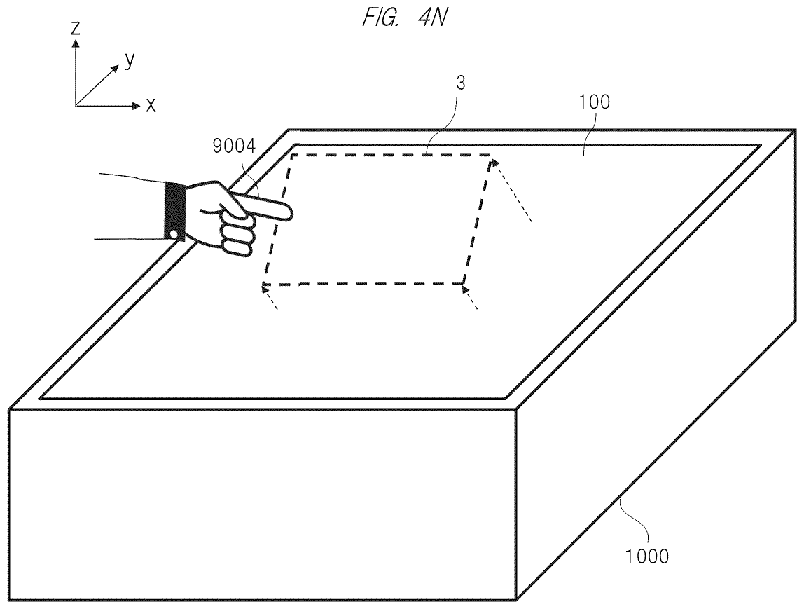

Next, the display apparatus 1 of the present embodiment will be described with reference to the drawings. The display apparatus 1 of the present embodiment includes a video display element 11 (liquid crystal display panel) and the light source apparatus 13 constituting a light source thereof, and FIG. 5 shows the light source apparatus 13 together with the liquid crystal display panel as a developed perspective view.

In the liquid crystal display panel (video display element 11), as indicated by arrows 30 in FIG. 5, an illumination light flux with narrow-angle diffusion characteristics, that is, characteristics similar to laser light with strong directivity (straightness) and a polarization plane aligned in one direction is received from the light source apparatus 13 as a backlight apparatus. The liquid crystal display panel (video display element 11) modulates the received illumination light flux in accordance with an input video signal. The modulated video light is reflected by the retroreflection plate 2 and transmitted through the transparent member 100, thereby forming an air floating image as a real image (see FIG. 1).

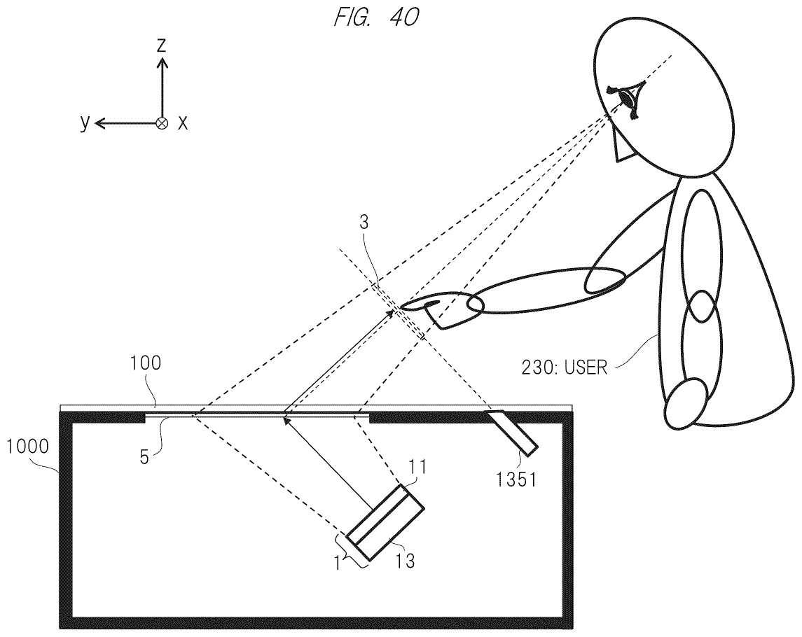

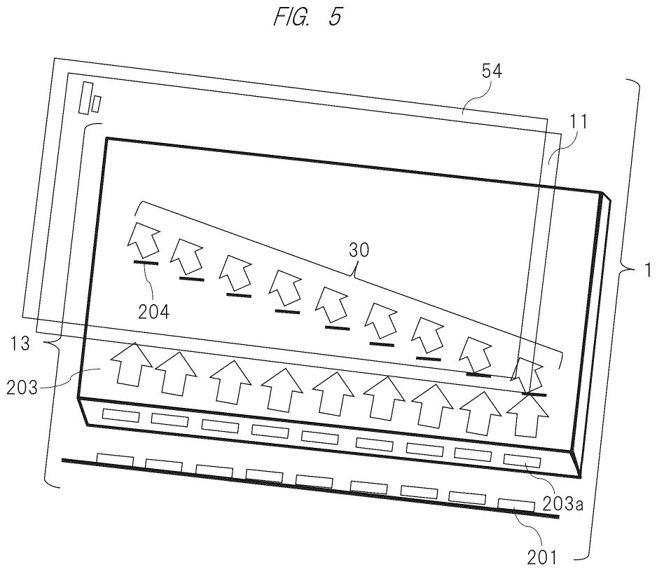

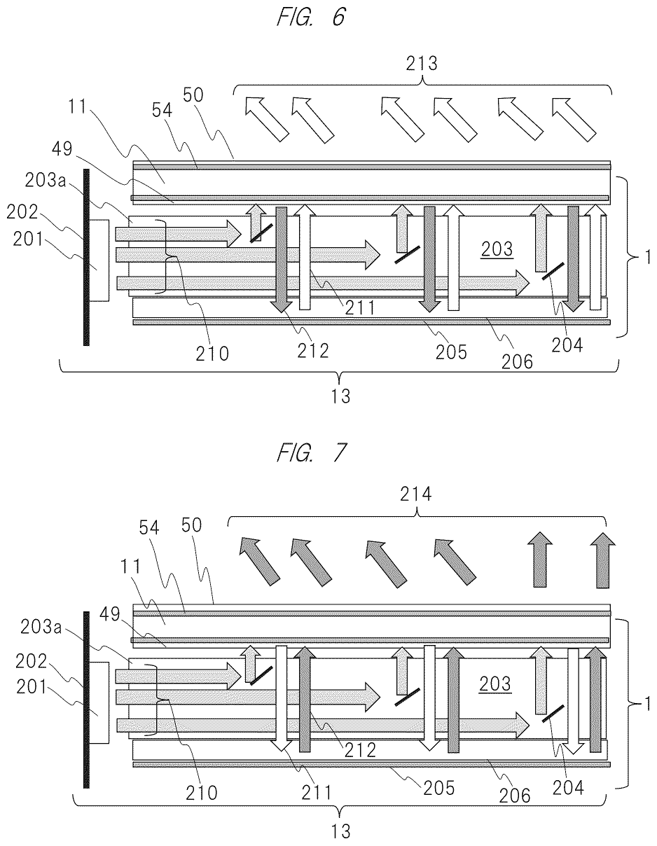

Further, in FIG. 5, the display apparatus 1 includes the liquid crystal display panel 11, a light direction conversion panel 54 configured to control the directional characteristics of the light flux emitted from the light source apparatus 13, and a narrow-angle diffusion plate as needed (not shown). Namely, polarization plates are provided on both surfaces of the liquid crystal display panel 11, and video light of a specific polarized wave is emitted at the light intensity modulated by the video signal (see the arrows 30 in FIG. 5). Thus, a desired video is projected as the light of a specific polarized wave having high directivity (straightness) toward the retroreflection plate 2 via the light direction conversion panel 54, reflected by the retroreflection plate 2, and then transmitted toward the eyes of an observer outside the store (space), thereby forming the air floating video 3. Note that a protective cover 50 (see FIG. 6 and FIG. 7) may be provided on the surface of the light direction conversion panel 54 described above.

### <Example of Display Apparatus (1)>

FIG. 6 shows an example of a specific configuration of the display apparatus 1. In FIG. 6, the liquid crystal display panel 11 and the light direction conversion panel 54 are arranged on the light source apparatus 13 in FIG. 5. The light source apparatus 13 is formed of, for example, plastic or the like on a case shown in FIG. 5, and is configured to accommodate the LED element 201 and a light guide 203 therein. Also, as shown in FIG. 5 and the like, in order to convert the divergent light from each LED element 201 into a substantially parallel light flux, the end surface of the light guide 203 is provided with a lens shape in which the cross-sectional area gradually increases toward the opposite surface with respect to the light receiving portion and which has a function of gradually reducing the divergence angle when making total reflection plural times during the propagation therein. The liquid crystal display panel 11 constituting the display apparatus 1 is attached to the upper surface of the display apparatus 1. Further, the LED (Light Emitting Diode) element 201 which is a semiconductor light source and an LED substrate 202 on which a control circuitry thereof is mounted are attached to one side surface (an end surface on the left side In the present example) of the case of the light source apparatus 13. A heat sink which is a member for cooling heat generated in the LED element and the control circuitry may be attached to an outer surface of the LED substrate 202.

Also, to a frame (not shown) of the liquid crystal display panel attached to the upper surface of the case of the light source apparatus 13, the liquid crystal display panel 11 attached to the frame, an FPC (Flexible Printed Circuits) board (not shown) electrically connected to the liquid crystal display panel 11, and the like are attached. Namely, the liquid crystal display panel 11 which is a video display element generates a display video by modulating the intensity of transmitted light based on a control signal from a control circuitry (video controller 1160 in FIG. 3) constituting an electronic device together with the LED element 201 which is a solid-state light source. At this time, since the generated video light has a narrow diffusion angle and only a specific polarization component, it is possible to obtain a novel and unconventional video display apparatus which is close to a surface-emitting laser video source driven by a video signal. Note that, at present, it is impossible to obtain a laser light flux having the same size as the image obtained by the above-described display apparatus 1 by using a laser apparatus for both technical and safety reasons. Therefore, in the present embodiment, for example, light close to the above-described surface-emitting laser video light is obtained from a light flux from a general light source including an LED element.

Next, the configuration of the optical system accommodated in the case of the light source apparatus 13 will be described in detail with reference to FIG. 6 and FIG. 7.

Since FIG. 6 and FIG. 7 are cross-sectional views, only one of a plurality of LED elements 201 constituting the light source is shown, and the light from these elements is converted into substantially collimated light by the shape of a light-receiving end surface 203a of the light guide 203. Therefore, the light-receiving portion on the end surface of the light guide and the LED element are attached while maintaining a predetermined positional relationship.

Note that each of the light guides 203 is formed of, for example, a translucent resin such as acrylic. Also, the LED light-receiving surface at one end of the light guide 203 has, for example, a conical convex outer peripheral surface obtained by rotating a parabolic cross section, the top thereof has a concave portion in which a convex portion (i.e., a convex lens surface) is formed at the central region, and the central region of the flat surface portion thereof has a convex lens surface protruding outward (or may be a concave lens surface recessed inward) (not shown). Note that the outer shape of the light receiving portion of the light guide to which the LED element 201 is attached is a paraboloid shape that forms a conical outer peripheral surface, and is set within a range of an angle at which light emitted from the LED element in the peripheral direction can be totally reflected inside the paraboloid, or has a reflection surface formed thereon.

On the other hand, each of the LED elements 201 is arranged at a predetermined position on the surface of the LED substrate 202 which is a circuit board for the LED elements. The LED substrate 202 is arranged and fixed to the LED collimator (the light-receiving end surface 203a) such that each of the LED elements 201 on the surface thereof is located at the central portion of the concave portion described above.

With such a configuration, the light emitted from the LED elements 201 can be extracted as substantially parallel light by the shape of the light-receiving end surface 203a of the light guide 203, and the utilization efficiency of the generated light can be improved.

As described above, the light source apparatus 13 is configured by attaching a light source unit, in which a plurality of LED elements 201 as light sources are arranged, to the light-receiving end surface 203a which is a light receiving portion provided on the end surface of the light guide 203, and the divergent light flux from the LED elements 201 is converted into substantially parallel light by the lens shape of the light-receiving end surface 203a on the end surface of the light guide, is guided through the inside of the light guide 203 (in the direction parallel to the drawing) as indicated by arrows, and is emitted toward the liquid crystal display panel 11 arranged substantially parallel to the light guide 203 (in the upward direction in the drawing) by a light flux direction converter 204. The uniformity of the light flux that enters the liquid crystal display panel 11 can be controlled by optimizing the distribution (density) of the light flux direction converter 204 by the shape inside the light guide or the shape of the surface of the light guide.

The above-described light flux direction converter 204 emits the light flux propagating through the inside of the light guide toward the liquid crystal display panel 11 (in the upward direction in the drawing) arranged substantially in parallel to the light guide 203 by the shape of the surface of the light guide or by providing a portion having a different refractive index inside the light guide. At this time, if the relative luminance ratio when comparing the luminance at the center of the screen with the luminance of the peripheral portion of the screen in a state in which the liquid crystal display panel 11 squarely faces the center of the screen and the viewpoint is placed at the same position as the diagonal dimension of the screen is 20% or more, there is no problem in practical use, and if the relative luminance ratio exceeds 30%, the characteristics will be even better.

Note that FIG. 6 is a cross-sectional layout drawing for describing the configuration and action of the light source of the present embodiment that performs polarization conversion in the light source apparatus 13 including the light guide 203 and the LED element 201 described above. In FIG. 6, the light source apparatus 13 is composed of, for example, the light guide 203 which is formed of plastic or the like and is provided with the light flux direction converter 204 on its surface or inside, the LED element 201 as a light source, a reflection sheet 205, a retardation plate 206, and a lenticular lens, and the liquid crystal display panel 11 including polarization plates on its light source light incident surface and video light emission surface is attached to the upper surface of the light source apparatus 13.

Also, a film-shaped or sheet-shaped reflective polarization plate 49 is provided on the light source light incident surface (lower surface in the drawing) of the liquid crystal display panel 11 corresponding to the light source apparatus 13, by which one polarized wave (e.g., a P-wave) 212 of the natural light flux 210 emitted from the LED element 201 is selectively reflected. The reflected light is reflected again by the reflection sheet 205 provided on one surface (lower side in the drawing) of the light guide 203, and is directed toward the liquid crystal display panel 11. Then, a retardation plate (λ/4 plate) is provided between the reflection sheet 205 and the light guide 203 or between the light guide 203 and the reflective polarization plate 49, and the light flux is reflected by the reflection sheet 205 to be made to pass through the retardation plate twice, so that the reflected light flux is converted from the P-polarized light into the S-polarized light and the utilization efficiency of the light source light as video light can be improved. The video light flux (arrows 213 in FIG. 6) whose light intensity is modulated by the video signal in the liquid crystal display panel 11 enters the retroreflection plate 2. An air floating image which is a real image can be obtained after the reflection on the retroreflection plate 2.

As with FIG. 6, FIG. 7 is a cross-sectional layout drawing for describing the configuration and action of the light source of the present embodiment that performs polarization conversion in the light source apparatus 13 including the light guide 203 and the LED element 201. The light source apparatus 13 is similarly composed of, for example, the light guide 203 which is formed of plastic or the like and is provided with the light flux direction converter 204 on its surface or inside, the LED element 201 as a light source, the reflection sheet 205, the retardation plate 206, and the lenticular lens. The liquid crystal display panel 11 including polarization plates on its light source light incident surface and video light emission surface is attached as the video display element to the upper surface of the light source apparatus 13.

Also, the film-shaped or sheet-shaped reflective polarization plate 49 is provided on the light source light incident surface (lower surface in the drawing) of the liquid crystal display panel 11 corresponding to the light source apparatus 13, by which one polarized wave (e.g., a S-wave) 211 of the natural light flux 210 emitted from the LED element 201 is selectively reflected. Namely, in the example in FIG. 7, the selective reflection property of the reflective polarization plate 49 is different from that in FIG. 6. The reflected light is reflected by the reflection sheet 205 provided on one surface (lower side in the drawing) of the light guide 203, and is directed toward the liquid crystal display panel 11. Then, a retardation plate (λ/4 plate) is provided between the reflection sheet 205 and the light guide 203 or between the light guide 203 and the reflective polarization plate 49, and the light flux is reflected by the reflection sheet 205 to be made to pass through the retardation plate twice, so that the reflected light flux is converted from the S-polarized light into the P-polarized light and the utilization efficiency of the light source light as video light can be improved. The video light flux (arrows 214 in FIG. 7) whose light intensity is modulated by the video signal in the liquid crystal display panel 11 enters the retroreflection plate 2. An air floating image which is a real image can be obtained after the reflection on the retroreflection plate 2.

In the light source apparatuses shown in FIG. 6 and FIG. 7, in addition to the action of the polarization plate provided on the light incident surface of the corresponding liquid crystal display panel 11, the polarization component on one side is reflected by the reflective polarization plate, and thus the contrast ratio theoretically obtained is the product of the reciprocal of the cross transmittance of the reflective polarization plate and the reciprocal of the cross transmittance obtained by the two polarization plates attached to the liquid crystal display panel. Therefore, high contrast performance can be obtained. In practice, it has been experimentally confirmed that the contrast performance of the display image is improved by 10 times or more. As a result, a high-quality video comparable to the video of a self-luminous organic EL can be obtained.

### <Example of Display Apparatus (2)>

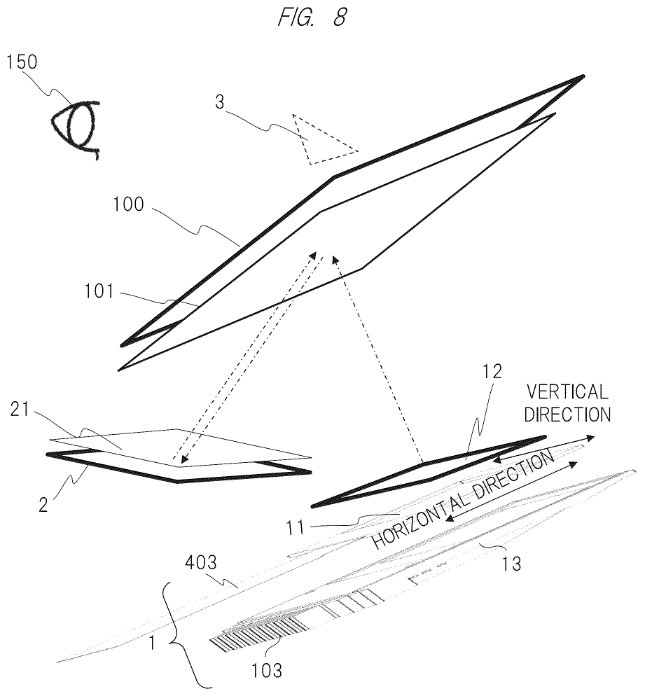

FIG. 8 shows another example of a specific configuration of the display apparatus 1. The light source apparatus 13 is configured by accommodating an LED, a collimator, a synthetic diffusion block, a light guide, and the like in a case made of, for example, plastic, and the liquid crystal display panel 11 is attached to the upper surface thereof. Further, LED (Light Emitting Diode) elements 14a and 14b which are semiconductor light sources and an LED substrate on which a control circuitry thereof is mounted are attached to one side surface of the case of the light source apparatus 13, and a heat sink 103 which is a member for cooling the heat generated in the LED elements and the control circuitry is attached to an outer surface of the LED substrate.

Also, to a frame of the liquid crystal display panel attached to the upper surface of the case, the liquid crystal display panel 11 attached to the frame, an FPC (Flexible Printed Circuits) board 403 electrically connected to the liquid crystal display panel 11, and the like are attached. Namely, the liquid crystal display panel 11 which is a liquid crystal display element generates a display video by modulating the intensity of transmitted light based on a control signal from a control circuitry (not shown here) constituting an electronic device together with the LED elements 14a and 14b which are solid-state light sources.

### <Example of Display Apparatus (3)>

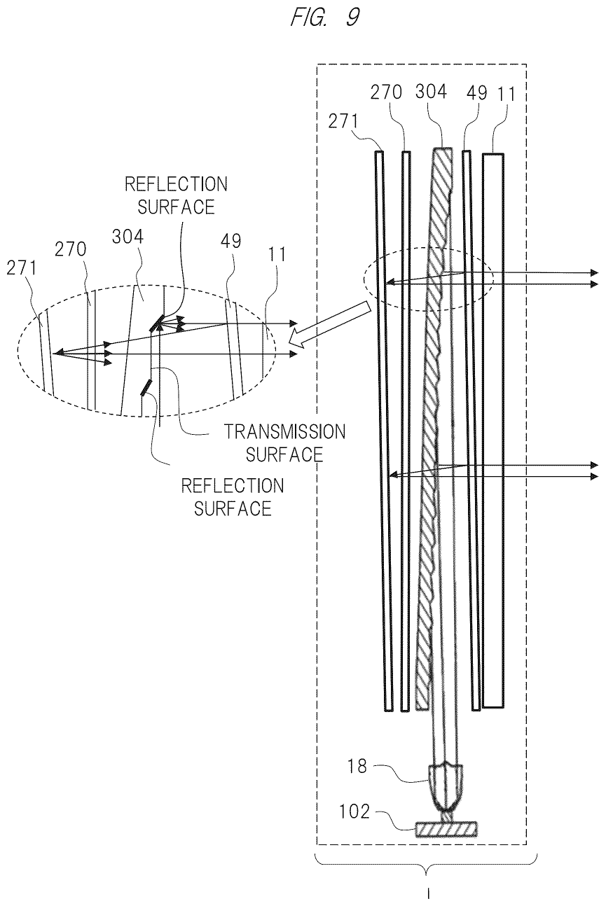

Next, another example of the specific configuration of the display apparatus 1 (example of display apparatus (3)) will be described with reference to FIG. 9. The light source apparatus of the display apparatus 1 converts a divergent light flux of the light from the LED (in which P-polarized light and S-polarized light are mixed) into a substantially parallel light flux by a collimator 18, and the converted light flux is reflected by the reflection surface of the reflective light guide 304 toward the liquid crystal display panel 11. Such reflected light enters the reflective polarization plate 49 arranged between the liquid crystal display panel 11 and the reflective light guide 304. The reflective polarization plate 49 transmits the light of a specific polarized wave (e.g., P-polarized light) and allows the transmitted polarized light to enter the liquid crystal display panel 11. Here, the polarized wave (e.g., S-polarized wave) other than the specific polarized wave is reflected by the reflective polarization plate 49 and is directed toward the reflective light guide 304 again.

The reflective polarization plate 49 is installed to be inclined with respect to the liquid crystal display panel 11 so as not to be perpendicular to the principal light ray of the light from the reflection surface of the reflective light guide 304. Then, the principal light ray of the light reflected by the reflective polarization plate 49 enters the transmission surface of the reflective light guide 304. The light that has entered the transmission surface of the reflective light guide 304 is transmitted through the back surface of the reflective light guide 304, is transmitted through a λ/4 plate 270 as a retardation plate, and is reflected by a reflection plate 271. The light reflected by the reflection plate 271 is transmitted through the λ/4 plate 270 again and is transmitted through the transmission surface of the reflective light guide 304. The light transmitted through the transmission surface of the reflective light guide 304 enters the reflective polarization plate 49 again.

At this time, since the light that enters the reflective polarization plate 49 again has passed through the λ/4 plate 270 twice, the polarization thereof is converted into a polarized wave (e.g., P-polarized light) that can pass through the reflective polarization plate 49. Therefore, the light whose polarization has been converted passes through the reflective polarization plate 49 and enters the liquid crystal display panel 11. Regarding the polarization design related to polarization conversion, the polarization may be reversed from that in the above description (the S-polarized light and the P-polarized light may be reversed).

As a result, the light from the LED is aligned into a specific polarized wave (e.g., a P-polarized light) and enters the liquid crystal panel 11. Then, after the luminance is modulated in accordance with the video signal, the video is displayed on the panel surface. As in the above-described example, a plurality of LEDs constituting the light source are provided (however, only one LED is shown in FIG. 9 due to the vertical cross section), and these LEDs are attached at predetermined positions with respect to the collimators 18.

Note that each of the collimators 18 is formed of, for example, a translucent resin such as acrylic or glass. Further, the collimator 18 may have a conical convex outer peripheral surface obtained by rotating a parabolic cross section. Also, a concave portion in which a convex portion (i.e., a convex lens surface) is formed may be provided at the central portion of the top of the collimator 18 (on the side facing the LED substrate 102). In addition, a convex lens surface protruding outward (or may be a concave lens surface recessed inward) is provided at the central portion of the flat surface portion of the collimator 18 (on the opposite side of the top mentioned above). Note that the paraboloid that forms the conical outer peripheral surface of the collimator 18 is set within a range of an angle at which light emitted from the LED in the peripheral direction can be totally reflected inside the paraboloid, or has a reflection surface formed thereon.

Note that each of the LEDs is arranged at a predetermined position on the surface of the LED substrate 102 which is a circuit board for the LEDs. The LED substrate 102 is arranged and fixed to the collimator 18 such that each of the LEDs on the surface thereof is located at the central portion at the top of the conical convex portion (concave portion when there is the concave portion at the top).

With such a configuration, of the light emitted from the LED, in particular, the light emitted from the central portion thereof is condensed into parallel light by the convex lens surface forming the outer shape of the collimator 18. Also, the light emitted from the other portion toward the peripheral direction is reflected by the paraboloid forming the conical outer peripheral surface of the collimator 18, and is similarly condensed into parallel light. In other words, with the collimator 18 having a convex lens formed at the central portion thereof and a paraboloid formed in the peripheral portion thereof, it is possible to extract substantially all of the light generated by the LED as parallel light, and to improve the utilization efficiency of the generated light.

Furthermore, the light converted into substantially parallel light by the collimator 18 shown in FIG. 9 is reflected by the reflective light guide 304. The light of a specific polarized wave of such light is transmitted through the reflective polarization plate 49 by the action of the reflective polarization plate 49, and the light of the other polarized wave reflected by the action of the reflective polarization plate 49 is transmitted through the light guide 304 again. The light is reflected by the reflection plate 271 located at a position opposite to the liquid crystal display panel 11 with respect to the reflective light guide 304. At this time, the polarization of the light is converted by passing through the λ/4 plate 270, which is a retardation plate, twice. The light reflected by the reflection plate 271 is transmitted through the light guide 304 again and enters the reflective polarization plate 49 provided on the opposite surface. Since the incident light has been subjected to polarization conversion, it is transmitted through the reflective polarization plate 49 and enters the liquid crystal display panel 11 with the aligned polarization direction. As a result, all of the light from the light source can be used, and the utilization efficiency of light in geometrical optics is doubled. Further, the degree of polarization (extinction ratio) of the reflective polarization plate is also multiplied with the extinction ratio of the entire system, so that the contrast ratio of the overall display apparatus is significantly improved by using the light source apparatus of the present embodiment. Also, by adjusting the surface roughness of the reflection surface of the reflective light guide 304 and the surface roughness of the reflection plate 271, the reflection diffusion angle of light on each reflection surface can be adjusted. It is preferable that the surface roughness of the reflection surface of the reflective light guide 304 and the surface roughness of the reflection plate 271 are adjusted for each design such that the uniformity of the light entering the liquid crystal display panel 11 becomes more suitable.

Note that the λ/4 plate 270 which is the retardation plate in FIG. 9 does not necessarily have the phase difference of λ/4 with respect to the polarized light that has vertically entered the λ/4 plate 270. In the configuration of FIG. 9, any retardation plate may be used as long as it can change the phase by 90° (λ/2) when the polarized light passes through it twice. The thickness of the retardation plate may be adjusted in accordance with the incident angle distribution of polarized light.

### <Example of Display Apparatus (4)>

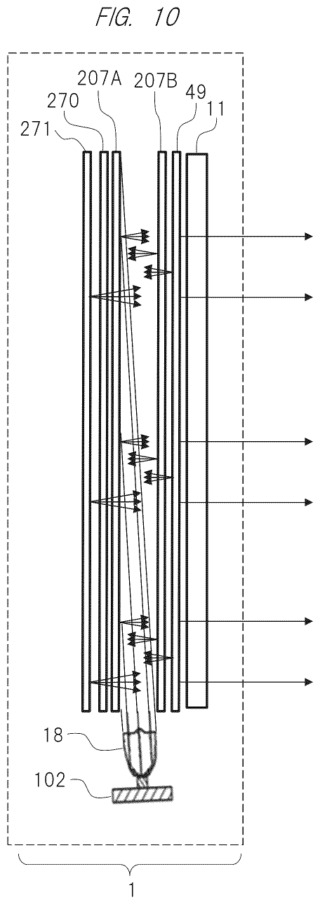

Further, another example (example of display apparatus (4)) of the configuration of the optical system of the light source apparatus or the like of the display apparatus will be described with reference to FIG. 10. This is a configuration example in which a diffusion sheet is used instead of the reflective light guide 304 in the light source apparatus in the example of display apparatus (3). Specifically, two optical sheets (optical sheet 207A and optical sheet 207B) for converting the diffusion characteristics in the vertical direction and the horizontal direction of the drawing are provided on the light emission side of the collimator 18, and the light from the collimator 18 is made to enter between the two optical sheets (diffusion sheets).

Note that this optical sheet may be composed of one sheet rather than two sheets. When composed of one sheet, the vertical and horizontal diffusion characteristics are adjusted by the fine shapes of the front surface and the back surface of the one optical sheet. Alternatively, a plurality of diffusion sheets may be used to share the function. Here, in the example in FIG. 10, it is preferable that the reflection diffusion characteristics by the front surface shapes and the back surface shapes of the optical sheet 207A and the optical sheet 207B are optimally designed with using the number of LEDs, the divergence angle from the LED substrate (optical element) 102, and optical specifications of the collimator 18 as design parameters such that the surface density of the light flux emitted from the liquid crystal display panel 11 is uniform. In other words, the diffusion characteristics are adjusted by the surface shapes of the plurality of diffusion sheets instead of the light guide.

In the example in FIG. 10, the polarization conversion is performed in the same manner as in the example of display apparatus (3) described above. Namely, in the example in FIG. 10, the reflective polarization plate 49 may be configured to have the property of reflecting the S-polarized light (and transmitting the P-polarized light). In that case, of the light emitted from the LED as a light source, the P-polarized light is transmitted, and the transmitted light enters the liquid crystal display panel 11. Of the light emitted from the LED as a light source, the S-polarized light is reflected, and the reflected light is transmitted through the retardation plate 270 shown in FIG. 10. The light that has passed through the retardation plate 270 is reflected by the reflection plate 271. The light reflected by the reflection plate 271 is converted into the P-polarized light by passing through the retardation plate 270 again. The light that has been subjected to the polarization conversion is transmitted through the reflective polarization plate 49 and enters the liquid crystal display panel 11.

Note that the λ/4 plate 270 which is the retardation plate in FIG. 10 does not necessarily have the phase difference of λ/4 with respect to the polarized light that has vertically entered the λ/4 plate 270. In the configuration of FIG. 10, any retardation plate may be used as long as it can change the phase by 90° (λ/2) when the polarized light is transmitted through it twice. The thickness of the retardation plate may be adjusted in accordance with the incident angle distribution of polarized light. Also in FIG. 10, regarding the polarization design related to polarization conversion, the polarization may be reversed from that in the above description (the S-polarized light and the P-polarized light may be reversed).

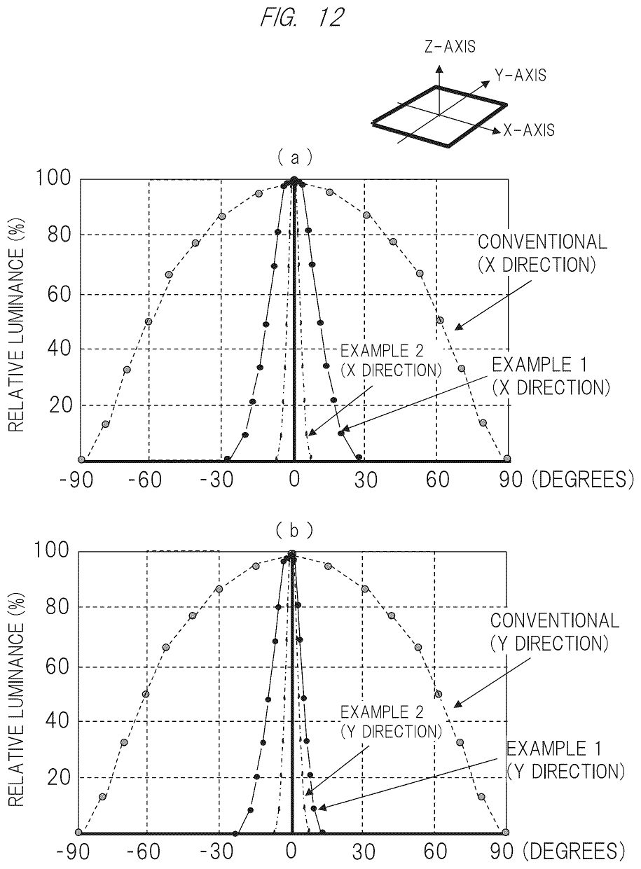

In an apparatus for use in a general TV set, the light emitted from the liquid crystal display panel 11 has similar diffusion characteristics in both the horizontal direction of the screen (indicated by the X axis in FIG. 12(a)) and the vertical direction of the screen (indicated by the Y axis in FIG. 12(b)). On the other hand, in the diffusion characteristics of the light flux emitted from the liquid crystal display panel of the present embodiment, for example, as shown in Example 1 in FIG. 12, the viewing angle at which the luminance becomes 50% of that in front view (angle of 0 degrees) is 13 degrees, and this is ⅕ of 62 degrees in the apparatus for use in a general TV set. Similarly, the reflection angle of the reflective light guide, the area of the reflection surface, and the like are optimized such that the viewing angle in the vertical direction is made uneven in the upper and lower sides and the viewing angle on the upper side is suppressed to about ⅓ of the viewing angle on the lower side. As a result, the amount of video light toward the viewing direction is significantly improved as compared with the conventional liquid crystal TV, and the luminance is 50 times or more.

Further, in the viewing angle characteristics shown in Example 2 in FIG. 12, the viewing angle at which the luminance becomes 50% of that in front view (angle of 0 degrees) is 5 degrees, and this is 1/12 of 62 degrees in the apparatus for use in a general TV set. Similarly, the reflection angle of the reflective light guide, the area of the reflection surface, and the like are optimized such that the viewing angle in the vertical direction is made even in the upper and lower sides and the viewing angle is suppressed to about 1/12 of the apparatus for use in a general TV set. As a result, the amount of video light toward the viewing direction is significantly improved as compared with the conventional liquid crystal TV, and the luminance is 100 times or more.

As described above, by setting the viewing angle to a narrow angle, the amount of light flux toward the viewing direction can be concentrated, so that the utilization efficiency of light is significantly improved. As a result, even if a liquid crystal display panel for use in a general TV set is used, it is possible to realize a significant improvement in luminance with the same power consumption by controlling the light diffusion characteristics of the light source apparatus, and to provide the video display apparatus suitable for the information display system for bright outdoor use.

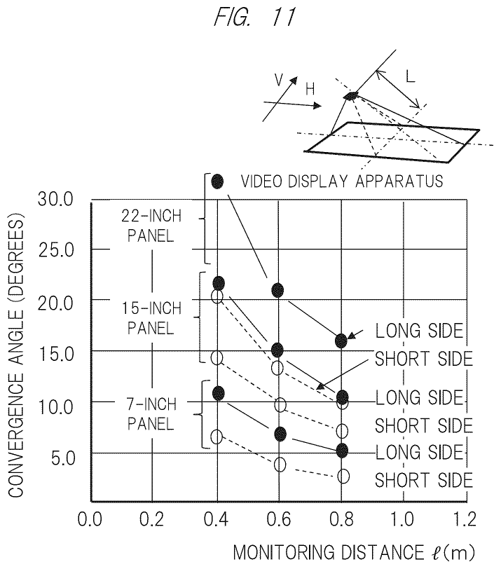

When using a large liquid crystal display panel, the overall brightness of the screen is improved by directing the light in the periphery of the screen inward, that is, toward the observer who is squarely facing the center of the screen. FIG. 11 shows the convergence angle of the long side and the short side of the panel when the distance L from the observer to the panel and the panel size (screen ratio 16:10) are used as parameters. In the case of monitoring the screen as a vertically long screen, the convergence angle may be set in accordance with the short side. For example, in the case in which a 22-inch panel is used vertically and the monitoring distance is 0.8 m, the video light from the four corners of the screen can be effectively directed toward the observer by setting the convergence angle to 10 degrees.

Similarly, in the case in which a 15-inch panel is used vertically and the monitoring distance is 0.8 m, the video light from the four corners of the screen can be effectively directed toward the observer by setting the convergence angle to 7 degrees. As described above, the overall brightness of the screen can be improved by adjusting the video light in the periphery of the screen so as to be directed to the observer located at the optimum position to monitor the center of the screen depending on the size of the liquid crystal display panel and whether the liquid crystal display panel is used vertically or horizontally.

As a basic configuration, as shown in FIG. 9, a light flux with narrow-angle directional characteristics is made to enter the liquid crystal display panel 11 by the light source apparatus, and the luminance is modulated in accordance with a video signal, whereby the air floating video obtained by reflecting the video information displayed on the screen of the liquid crystal display panel 11 by the retroreflection plate is displayed outdoors or indoors through the transparent member 100.

By using the display apparatus and the light source apparatus according to the embodiment of the present invention described above, it is possible to realize the air floating video display apparatus with high light utilization efficiency.

### <Example of Video Display Processing in Air Floating Video Display Apparatus>

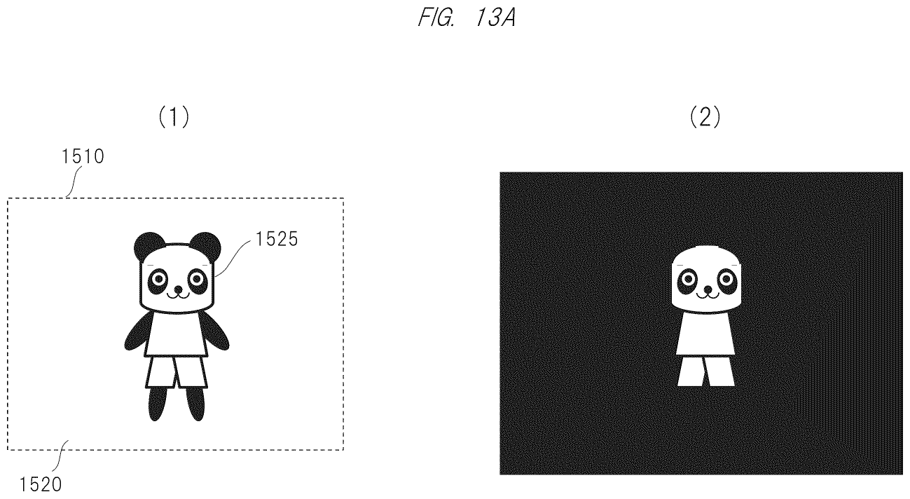

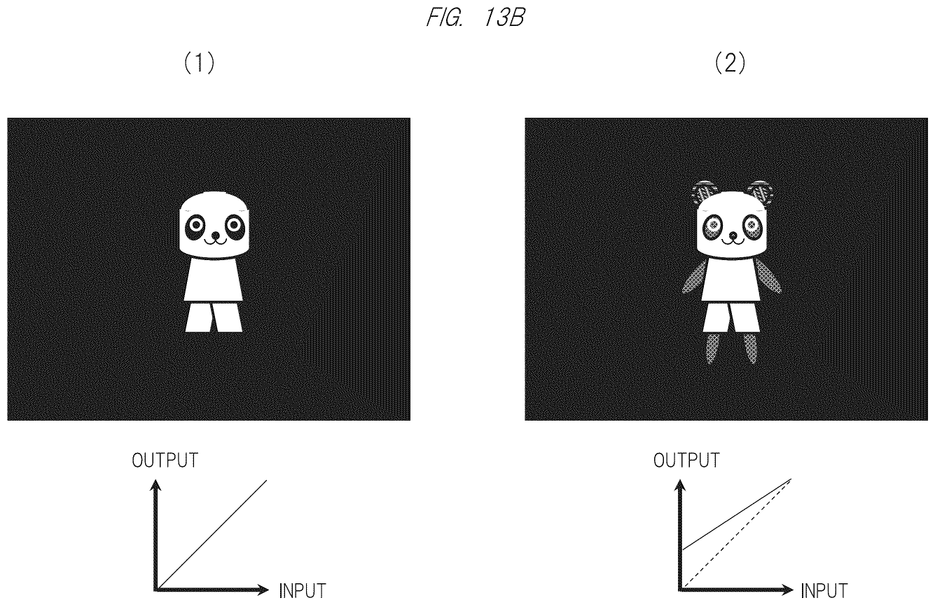

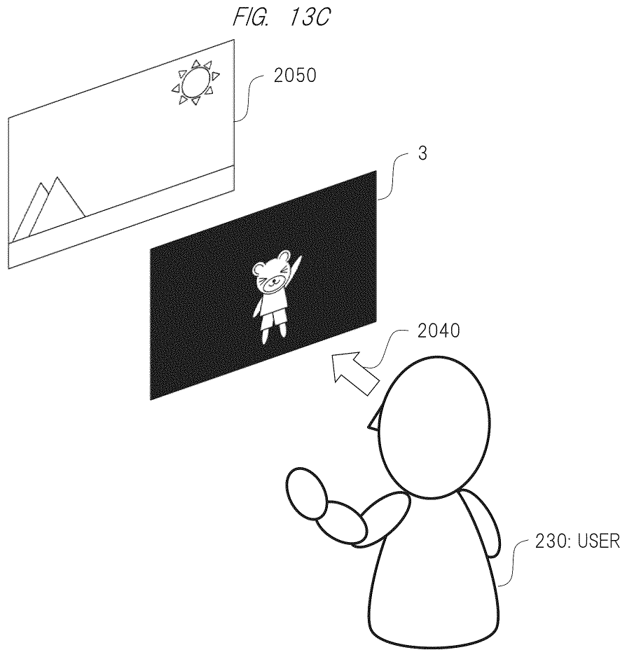

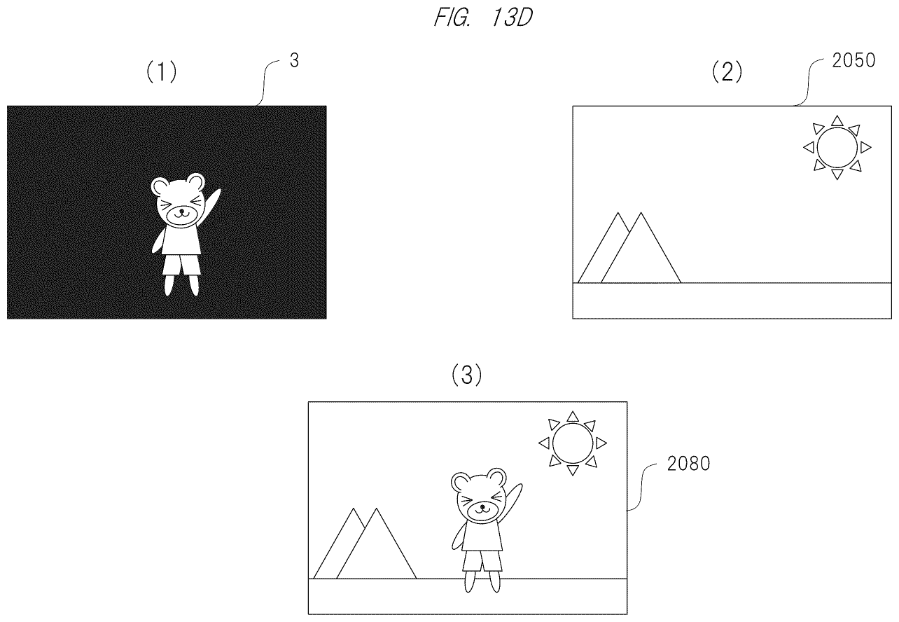

Next, an example of the problem to be solved by the image processing of the present embodiment will be described with reference to FIG. 13A. In the air floating video display apparatus 1000, the rear side of the air floating video 3 is inside of the housing of the air floating video display apparatus 1000 when viewed from the user, and the user visually recognizes that the background of the air floating video 3 is black when it is sufficiently dark.

Here, an example of displaying a character “panda” 1525 in the air floating video 3 will be described with reference to FIG. 13A. First, in an image including a pixel region in which an image of the character “panda” 1525 is drawn and a transparent information region 1520 which is a background image as shown in FIG. 13A(1), the video controller 1160 in FIG. 3 separately recognizes the pixel region in which the image of the character “panda” 1525 is drawn and the transparent information region 1520 which is a background image.

As a method of separately recognizing the character image and the background image, for example, a background image layer and a character image layer in front of the background image layer are configured such that they can be processed as different layers in image processing by the video controller 1160, and the character image and the background image can be separately recognized based on the overlapping relationship when these layers are combined.

Here, the video controller 1160 recognizes the black of the pixel drawing an object such as the character image as different information from the transparent information pixel. However, if it is assumed that the luminance of both the black of the pixel drawing the object and the transparent information pixel is 0, there is no difference in luminance between the pixel drawing the black of the image of the character “panda” 1525 and the pixel of the transparent information region 1520 which is a background image, when displaying the air floating video 3.

Therefore, in the air floating video 3, as shown in FIG. 13A(2), neither the pixel drawing the black in the image of the character “panda” 1525 nor the pixel of the transparent information region 1520 has luminance, and they are recognized by the user as the same black space. In other words, the part drawing the black of the image of the character “panda” 1525 which is an object blends into the background, and only the non-black part of the character “panda” 1525 is recognized as a video floating in the display region of the air floating video 3.

An example of image processing in the present embodiment will be described with reference to FIG. 13B. FIG. 13B is a diagram illustrating an example of image processing that more preferably solves the problem that the black image region of the object blends into the background described in FIG. 13A. In each of FIG. 13B(1) and FIG. 13(2), the display state of the air floating video 3 is shown on the upper side, and input/output characteristics of the image processing for the object image are shown on the lower side. Note that the image of the object (character “panda” 1525) and data corresponding thereto may be read from the storage 1170 or the memory 1109 in FIG. 3.

Alternatively, they may be input from the video signal input unit 1131, or may be acquired via the communication unit 1132.

Here, in the state of FIG. 13B(1), the input/output characteristics of the image processing for the object image are not particularly adjusted and are in a linear state. In this case, the display state is similar to that shown in FIG. 13A(2), and the black image region of the object has blended into the background. On the other hand, in FIG. 13B(2), the video controller 1160 of the present embodiment adjusts the input/output characteristics of image processing for the image of the object (character “panda” 1525) as shown on the lower side.

Namely, the video controller 1160 performs image processing with the input/output characteristics that convert the input image of the object (character “panda” 1525) having the pixel with low luminance into the output image having the pixel with increased luminance. The image of the object (character “panda” 1525) is subjected to the image processing with the input/output characteristics, and then the video including the image of the object (character “panda” 1525) is input and displayed on the display apparatus 1. Then, in the display state of the air floating video 3, as shown in the upper side of FIG. 13B(2), the luminance of the pixel region in which black is drawn in the image of the character “panda” 1525 increases. As a result, in the region in which the image of the character “panda” 1525 is drawn, even the region in which black is drawn can be separately recognized by the user without blending into the black background, and the object can be displayed more suitably.

In other words, by using the image processing shown in FIG. 13B(2), the region in which the image of the character “panda” 1525 which is an object is displayed can be separately recognized from the black background which is inside of the housing of the air floating video display apparatus 1000 seen through the window, and the visibility of the object is improved. Therefore, for example, even the object in which the pixel with a luminance value of 0 is included in the pixels constituting the object before the above-described image processing (that is, at the time when the image of the object and the data corresponding thereto are read from the storage 1170 or the memory 1109 in FIG. 3, when the image of the object is input from the video signal input unit 1131, when data of the object is acquired via the communication unit 1132, or the like) is converted into the object in which the luminance value of the pixel in the low luminance region is increased through the image processing with the input/output characteristics by the video controller 1160, is displayed on the display apparatus 1, and then converted into the air floating video 3 by the optical system of the air floating video display apparatus 1000.

Namely, the object is converted into the state in which the pixels constituting the object do not include the pixel with the luminance value of 0 by the image processing with the input/output characteristics, is displayed on the display apparatus 1, and then converted into the air floating video 3 by the optical system of the air floating video display apparatus 1000.

Note that, as a method of performing the image processing with the input/output characteristics in FIG. 13B(2) to only the region of the image of the object (character “panda” 1525), for example, a background image layer and a character image layer in front of the background image layer are configured such that they can be processed as different layers in the image processing by the video controller 1160, the image processing with the input/output characteristics in FIG. 13B(2) is performed to the character image layer, and the image processing is not performed to the background image layer.

Thereafter, by combining these layers, the image processing to increase the luminance of the low luminance region in the input image is performed to only the character image as shown in FIG. 13B(2). Alternatively, as another method, after combining the layer of the character image and the layer of the background image, the image processing for the input/output characteristics shown in FIG. 13B(2) may be applied to only the region of the character image.

Further, the input/output video characteristics used in the image processing to increase the luminance of the low luminance region of the input video are not limited to the example shown in FIG. 13B(2). Any image processing can be used as long as it can increase the luminance of the low luminance region, and the so-called brightness adjustment is also possible. Alternatively, video processing for improving the visibility by controlling the gain that changes the weighting of retinex processing disclosed in International Publication No. 2014/162533 may be performed.

According to the image processing of FIG. 13B(2) described above, the region drawing black in the region where images such as character and object are drawn can be recognized by the user without blending into the black background, and it is possible to realize a more suitable display.

Note that the problems and more suitable image processing for the air floating video display apparatus in which black is seen in the background (e.g., the air floating video display apparatus 1000 in FIG. 4A to FIG. 4G and the air floating video display apparatus 1000 in FIG. 41 and FIG. 4J in the state where the rear-side window is in the light-shielding state) have been described in the examples of FIG. 13A and FIG. 13B. However, the image processing is also effective in the apparatus other than these air floating video display apparatuses.

Specifically, in the air floating video display apparatus 1000 in FIG. 4H and the air floating video display apparatus 1000 in FIG. 41 and FIG. 4J in which the rear-side window is not in the light-shielding state, the background of the air floating video 3 is not black, but is the scenery on the rear side of the air floating video display apparatus 1000 beyond the window. In this case as well, the problem described in FIG. 13A and FIG. 13B similarly exists.

Namely, the part drawing the black in the image of the character “panda” 1525 that is an object blends into the scenery on the rear side of the air floating video display apparatus 1000 beyond the window. In this case as well, by using the image processing shown in FIG. 13B(2), the part drawing the black in the image of the character “panda” 1525 that is an object can be separately recognized from the scenery on the rear side of the air floating video display apparatus 1000 beyond the window, and the visibility of the object is improved.

Namely, by using the image processing shown in FIG. 13B(2), the region in which the image of the character “panda” 1525 that is an object is displayed can be separately recognized from the scenery on the rear side of the air floating video display apparatus 1000 beyond the window, so that it is possible to recognize that the character “panda” 1525 that is an object is present in front of the scenery, and the visibility of the object is improved.

In addition, when another video (video of the transmissive self-luminous video display apparatus 1650, video of the second display apparatus 1680, or the like) is displayed at the different depth position from the air floating video 3 in the air floating video display apparatus 1000 in FIG. 4K, FIG. 4L, and FIG. 4M as described above, the background of the air floating video 2 is not the black but is the different video. In this case as well, the problem described in FIG. 13A and FIG. 13B similarly exists.

Namely, the part drawing the black in the image of the character “panda” 1525 that is an object blends into the different video displayed at the different depth position from the air floating video 3. In this case as well, by using the image processing shown in FIG. 13B(2), the part drawing the black in the image of the character “panda” 1525 that is an object can be separately recognized from the different video, and the visibility of the object is improved.

Namely, by using the image processing shown in FIG. 13B(2), the region in which the image of the character “panda” 1525 that is an object is displayed can be separately recognized from the different video, so that it is possible to recognize that the character “panda” 1525 that is an object is present in front of the different video, and the visibility of the object is improved.

An example of the video display processing in the present embodiment will be described with reference to FIG. 13C. FIG. 13C is a video display example in which the air floating video 3 and a second image 2050 which is another video are simultaneously displayed in the video display examples of the present embodiment. The second image 2050 may correspond to the displayed video of the transmissive self-luminous video display apparatus 1650 in FIG. 4K or FIG. 4L. Also, the second image 2050 may correspond to the displayed video on the second display apparatus 1680 in FIG. 4M.

Namely, the video display example in FIG. 13C is a specific example of the video display of the air floating video display apparatus 1000 in FIG. 4K, FIG. 4L, and FIG. 4M. In the example of this drawing, a bear character is displayed in the air floating video 3. The region in the air floating video 3 other than the bear character is displayed in black, and is transparent as an air floating video. Further, the second image 2050 is a background image in which a plain, a mountain, and the sun are drawn.

Here, in FIG. 13C, the air floating video 3 and the second image 2050 are displayed at different depth positions. When the user 230 visually recognizes the two videos such as the air floating video 3 and the second image 2050 in the line of sight direction of the arrow 2040, the user 230 can visually recognize the two videos overlapped with each other. Specifically, the bear character in the air floating video 3 appears to be overlapped in front of the background of the plain, mountain, and sun drawn in the second image 2050.

Here, since the air floating video 3 is formed as a real image in midair, if the user 230 moves his/her viewpoint a little, the depth of the air floating video 3 and the second image 2050 can be recognized based on the parallax. Therefore, the user 230 can obtain a stronger sense of floating in the air with respect to the air floating video 3 while visually recognizing the two videos in the overlapped state.

An example of the video display processing in the present embodiment will be described with reference to FIG. 13D. FIG. 13D(1) is a diagram of the air floating video 3 viewed from the line of sight direction of the user 230 in the example of the video display in the present embodiment in FIG. 13C. Here, a bear character is displayed in the air floating video 3. The region in the air floating video 3 other than the bear character is displayed in black, and is transparent as an air floating video.

FIG. 13D(2) is a diagram of the second image 2050 viewed from the line of sight direction of the user 230 in the example of the video display in the present embodiment in FIG. 13C. In the example of this drawing, the second image 2050 is a background image in which a plain, a mountain, and the sun are drawn.

FIG. 13D(3) is a diagram showing a state in which the second image 2050 and the air floating video 3 appear to be overlapped with each other in the line of sight direction of the user 230 in the example of the video display in the present embodiment in FIG. 13C. Specifically, the bear character in the air floating video 3 appears to be overlapped in front of the background of the plain, mountain, and sun drawn in the second image 2050.

Here, in order to ensure the visibility of the air floating video 3 more suitably when displaying the air floating video 3 and the second image 2050 at the same time, it is desirable to pay attention to the balance in the brightness therebetween. If the second image 2050 is too bright compared to the brightness of the air floating video 3, the displayed video of the air floating video 3 will become transparent, and the second image 2050 which is the background seen through the air floating video 3 will be strongly visually recognized.

Therefore, the output of the light source of the air floating video 3, the luminance of the displayed video of the display apparatus 1, the output of the light source of the display apparatus that displays the second image 2050, and the luminance of the displayed video of the display apparatus are preferably set such that at least the brightness per unit area of the air floating video 3 at the display position of the air floating video 3 is greater than the brightness per unit area of the video light that reaches the display position of the air floating video 3 from the second image 2050.

Note that, since it is necessary to satisfy this condition only when displaying the air floating video 3 and the second image 2050 at the same time, the control to reduce the brightness of the second image 2050 by reducing the output of the light source of the display apparatus that displays the second image 2050 and/or the luminance of the displayed video of the display apparatus may be performed when the first display mode in which only the second image 2050 is displayed without displaying the air floating video 3 is switched to the second display mode in which the air floating video 3 and the second image 2050 are displayed at the same time. The controller 1110 in FIG. 3 can realize such control by controlling the display apparatus 1 and the display apparatus that displays the second image 2050 (transmissive self-luminous video display apparatus 1650 in FIG. 4K or FIG. 4L or second display apparatus 1680 in FIG. 4M).

Note that, in the case where the control to reduce the brightness of the second image 2050 is performed when the first display mode described above is switched to the second display mode described above, the brightness may be uniformly reduced over the entire screen of the second image 2050. Alternatively, instead of uniformly reducing the brightness over the entire screen of the second image 2050, only the part of the second image 2050 corresponding to the object displayed in the air floating video 3 is made to have the highest brightness reduction effect, and the brightness reduction effect may be gradually reduced in the surrounding region thereof. This is because, if the brightness of the second image 2050 is reduced only in the part where the air floating video 3 is visually recognized so as to be overlapped with the second image 2050, the visibility of the air floating video 3 can be sufficiently ensured.

Here, since the air floating video 3 and the second image 2050 are displayed at different depth positions, the overlapping position of the air floating video 3 with respect to the second image 2050 changes due to parallax when the user 230 slightly changes the viewpoint. Therefore, in the case where the brightness is reduced unevenly for the entire screen of the second image 2050 when the first display mode described above is switched to the second display mode described above, it is not desirable to sharply reduce the brightness based on the outline of the object displayed in the air floating video 3, and it is desirable to perform the gradation processing of brightness reduction effect, in which the brightness reduction effect is gradually varied depending on the positions as described above.

Note that, in the air floating video display apparatus 1000 in which the position of the object displayed in air floating video 3 is approximately at the center of air floating video 3, the position where the brightness reduction effect is highest in the gradation processing of brightness reduction effect may be set to the central position of the air floating video 3.

With the video display processing according to the present embodiment described above, the user 230 can visually recognize the air floating video 3 and the second image 2050 more suitably.

Note that the control not to display the second image 2050 may be performed when displaying the air floating video 3. Since the visibility of the air floating video 3 becomes higher when the second image 2050 is not displayed, this control is suitable for the air floating video display apparatus 1000 required to display the air floating video 3 such that the user can visually recognize the air floating video 3 without fail.

### Second Embodiment

Another configuration example of the air floating video display apparatus will be described as the second embodiment. Note that, in the air floating video display apparatus according to the present embodiment, the optical system stored in the air floating video display apparatus described in the first embodiment is changed to the optical system shown in FIG. 14(1) or FIG. 14(2). In the present embodiment, differences from the first embodiment will be described, and repetitive descriptions of the same configuration as that of the first embodiment will be omitted. Note that, in the following description of the present embodiment, the specific polarized light and the other polarized light are polarized lights of polarized waves whose phases differ from each other by 90°.

FIG. 14(1) is an example of the optical system and optical path according to the present embodiment. In the optical system shown in FIG. 14(1), the display apparatus 1 is brought closer to the polarization separator 101B in the optical system of FIG. 2C, thereby making the entire optical system more compact. In FIG. 14(1), detailed descriptions of components denoted by the same reference characters as those in FIG. 2C are omitted.

In FIG. 14(1), as in FIG. 2C, the video light of a specific polarized light (P-polarized light in the drawing) emitted from the display apparatus 1 travels in a perpendicular direction from the video display surface of the display apparatus 1. Here, as in FIG. 2C, the polarization separator 101B selectively transmits the specific polarized light (P-polarized light in the drawing) emitted from the display apparatus 1 and reflects the other polarized light (S-polarized light in the drawing).

Therefore, the video light of the specific polarized light (P-polarized light in the drawing) traveling in the perpendicular direction from the video display surface of the display apparatus 1 passes through the polarization separator 101B and reaches the retroreflection plate 2 to which the λ/4 plate 21 is attached.

The video light that has been retroreflected by the retroreflection plate 2 and travels again toward the polarization separator 101B is converted from the specific polarized light (P-polarized light in the drawing) at the time of emission from the display apparatus 1 into the other polarized light (S-polarized light in the drawing) by passing through the λ/4 plate 21 twice. Since the video light that travels again toward the polarization separator 101B is the other polarized light (S-polarized light in the drawing), it is reflected by the polarization separator 101B toward the position where the user should be. The traveling direction of the video reflected by the polarization separator 101B is determined based on the angle at which the polarization separator 101B is arranged.

In the example of FIG. 14(1), the video light traveling toward the polarization separator 101B is reflected at a right angle by the polarization separator 101B and travels as shown in the drawing. The video light reflected by the polarization separator 101B forms an air floating video 3A. The air floating video 3A can be visually recognized suitably by the user in the direction indicated by the arrow A.

Because of the characteristics of retroreflection by the retroreflection plate 2, the optical path length of the video light emitted from the display apparatus 1 to reach the retroreflection plate 2 is equal to the optical path length of the video light emitted from the retroreflection plate 2 to reach the position where the air floating video 3A is formed. This relationship determines the position where the air floating video 3A is formed in the traveling direction of the video light reflected by the polarization separator 101B.

In the example of FIG. 14(1), the display apparatus 1, the polarization separator 101B, and the retroreflection plate 2 are arranged closer together than those in the example of FIG. 2C.

This allows the entire optical system to be configured more compactly. However, the amount by which the air floating video 3A projects from the optical system of FIG. 14(1) is not very large. For example, as an index of the amount by which the air floating video 3A projects from the optical system, the distance from the position where light ray at the central part of the video light is reflected by the polarization separator 101B to the position where the video light forms the air floating video 3A (L1 in the example of FIG. 14(1)) is shown in the drawing.

In addition, in the polarization design of the optical system of FIG. 14(1), the characteristics of P-polarized light and S-polarized light may be interchanged. Specifically, the specific polarized light of the video light emitted from the display apparatus 1 may be made S-polarized light, and the reflection characteristics of the polarization separator 101B may be interchanged between P-polarized light and S-polarized light. In this case, the P-polarized light and S-polarized light shown in the drawing are both reversed, but optical designs such as the optical path can be realized in exactly the same way.

Next, FIG. 14(2) shows another example of an optical system and optical path according to the present embodiment. In the optical system of FIG. 14(2), the configuration of the optical system of FIG. 14(1) is modified in order to increase the amount by which the air floating video projects from the optical system while still achieving the same compactness as the optical system of FIG. 14(1). In FIG. 14(2), detailed descriptions of components denoted by the same reference characters as those in FIG. 14(1) will not be repeated.

In FIG. 14(2), as in FIG. 14(1), video light of a specific polarized light (P-polarized light in the drawing) emitted from the display apparatus 1 travels in a perpendicular direction from the video display surface of the display apparatus 1. Here, the polarization characteristics of the polarization separator 101B differ by 90 degrees from that in FIG. 14(1). The video light of the specific polarized light (P-polarized light in the drawing) traveling in the perpendicular direction from the video display surface of the display apparatus 1 passes through the polarization separator 101B.

Here, unlike FIG. 14(1), ahead of the video light that has passed through the polarization separator 101B, a specular reflection plate 4 to which a λ/4 plate 21B is attached is arranged instead of the retroreflection plate 2 to which the λ/4 plate 21 is attached. Here, the reflection at the specular reflection plate 4 is specular reflection (referred to also as regular reflection), and is not retroreflection.

Therefore, the video light that has passed through the polarization separator 101B is specularly reflected by the specular reflection plate 4 to which the λ/4 plate 21B is attached.

The video light that has been specularly reflected by the specular reflection plate 4 and travels again toward the polarization separator 101B is converted from the specific polarized light (P-polarized light in the drawing) at the time of emission from the display apparatus 1 into the other polarized light (S-polarized light in the drawing) by passing through the λ/4 plate 21B twice. The video light that travels again toward the polarization separator 101B is the other polarized light (S-polarized in the drawing), and is thus reflected by the polarization separator 101B.

Here, since the orientation of the polarization separator 101B in FIG. 14(2) is different from that in FIG. 14(1), the video light reflected by the polarization separator 101B travels in the opposite direction relative to the position where the user should be. Ahead of the video light traveling after being reflected by the polarization separator 101B, the retroreflection plate 2 to which a λ/4 plate 21C is attached is arranged. The video light is retroreflected by the retroreflection plate 2. The video light that has been retroreflected by the retroreflection plate 2 and travels again toward the polarization separator 101B is converted from the other polarized light (S-polarized light in the drawing) into the specific polarized light (P-polarized light in the drawing) again by passing through the λ/4 plate 21C twice.

The video light that travels again toward the polarization separator 101B is the specific polarized light (P-polarized light in the drawing), and thus passes through the polarization separator 101B and continues to travel toward the position where the user should be. The video light that has passed through the polarization separator 101B forms an air floating video 3B. The air floating video 3B can be visually recognized suitably by the user in the direction indicated by the arrow A.

Also in FIG. 14(2), as in FIG. 14(1), because of the characteristics of the retroreflection by the retroreflection plate 2, the optical path length of the video light emitted from the display apparatus 1 to reach the retroreflection plate 2 is equal to the optical path length of the video light emitted from the retroreflection plate 2 to reach the position where the air floating video 3B is formed. This relationship determines the position where the air floating video 3B is formed in the traveling direction of the video light that has passed through the polarization separator 101B.

The optical path length of the video light emitted from the display apparatus 1 to reach the retroreflection plate 2 in FIG. 14(2) is longer than the optical path length of the video light emitted from the display apparatus 1 to reach the retroreflection plate 2 in FIG. 14(1). This is because an optical path going back and forth between the polarization separator 101B and the specular reflection plate 4, which does not exist in the optical system of FIG. 14(1), is added to the optical path length of the video light emitted from the display apparatus 1 to reach the retroreflection plate 2 in the optical system of FIG. 14(2).

As a result, the distance from the position where light ray at the central part of the video light passes through the polarization separator 101B to the position where the video light forms the air floating video 3B (L2 in the example of FIG. 14(2)) in the optical system of FIG. 14(2) becomes much longer than the distance from the position where light ray at the central part of the video light is reflected by the polarization separator 101B to the position where the video light forms the air floating video 3A (L1 in the example of FIG. 14(1)) in the optical system of FIG. 14(1).

In addition, in the polarization design of the optical system of FIG. 14(2) as well, the characteristics of P-polarized light and S-polarized light may be interchanged. Specifically, the specific polarized light of the video light emitted from the display apparatus 1 may be made S-polarized light, and the reflection characteristics of the polarization separator 101B may be interchanged between P-polarized light and S-polarized light. In this case, the P-polarized light and S-polarized light shown in the drawing are both reversed, but optical designs such as the optical path can be realized in exactly the same way.

With the optical systems of FIG. 14(1) and FIG. 14(2) according to the second embodiment of the present invention described above, a more compact optical system can be realized. In particular, the optical system of FIG. 14(2) makes it possible to increase the amount by which the air floating video projects from the optical system, while still achieving a more compact optical system.

When incorporating the optical system of FIG. 14(1) or FIG. 14(2) into an air floating video display apparatus, this can be realized by replacing the optical system in the air floating video display apparatus described in the first embodiment with the optical system of FIG. 14(1) or FIG. 14(2). Specifically, the optical system of FIG. 14(1) may be replaced with the optical system of the air floating video display apparatus of FIG. 4E, FIG. 4F, FIG. 4G, FIG. 4H, FIG. 41, FIG. 4J, FIG. 4K, FIG. 4L, or FIG. 4M. In this case, since the optical system becomes compact, it is possible to make the housing of the air floating video display apparatus in each drawing smaller.

More specifically, the optical system of FIG. 14(2) may be replaced with the optical system of the air floating video display apparatus of FIG. 4E, FIG. 4F, FIG. 4G, FIG. 4K, or FIG. 4L. In this case, it is possible to further increase the amount by which the air floating video projects from the optical system. Also, since the optical system becomes more compact, it is possible to make the housing of the air floating video display apparatus of each drawing smaller.

### Third Embodiment

As a third embodiment of the present invention, a configuration example of the air floating video display apparatus will be described. Any of the configurations of the first embodiment or the second embodiment can be applied to the air floating video display apparatus of the third embodiment as a basic configuration. The configuration of optical system of the air floating video display apparatus of the third embodiment can be based on, for example, FIG. 2A or the like, and the housing, or the configuration of the main body, can be based on FIG. 4A. In addition, the third embodiment is a system (sometimes referred to as an air floating video display system or the like) having an air floating video display apparatus and an external device connected to the apparatus. The external device includes, for example, a mobile terminal such as a smartphone, a tablet device, or a wearable terminal (e.g., smartwatch) of the user. The mobile terminal may also be referred to as a mobile information processing terminal apparatus.

The air floating video display apparatus/system of the third embodiment realizes the following basic functions. The air floating video display system connects and coordinates the air floating video display apparatus with the user's mobile terminal via communication. The system has a function that allows an image/video possessed by the user such as an image stored in the mobile terminal and displayed on its screen by the user (sometimes referred to as target image or the like) to be displayed by the air floating video display apparatus as the air floating video 3. For this purpose, the user performs an operation/action to bring the mobile terminal into contact with the air floating video 3 (a corresponding predetermined imaging position or display range) of the air floating video display apparatus. This operation/action is a predetermined operation/action and is sometimes referred to as an insertion operation/contact operation or the like. The air floating video display apparatus determines/recognizes this contact operation using a sensor or the like. In the present embodiment, for example, the user performs the contact operation by inserting the mobile terminal into a planar position of the air floating video 3 or by bringing the mobile terminal into contact with the planar position of the air floating video 3 while the mobile terminal transmits a display request based on the user's input operation.

Based on this contact operation, the air floating video display apparatus or the mobile terminal generates a display request/display instruction to display the target image on the mobile terminal side as the air floating video 3. In other words, when it is determined that a predetermined contact operation has been performed, satisfying predetermined conditions regarding the contact between mobile terminal and the air floating video 3, the air floating video display apparatus/the mobile terminal generates such a display request/display instruction. The video controller 1160 of the air floating video display apparatus particularly shown in FIG. 3 receives this display request and receives/acquires data of the target image from the mobile terminal via communication. The air floating video display apparatus then executes video processing of the display apparatus 1 such that the target image is displayed as the air floating video 3.

This function may be implemented as follows. The user's mobile terminal transmits the display request in conjunction with the above-described contact operation, that is, immediately before, during, or immediately after the contact. Based on the contact operation, the air floating video display apparatus receives and authorizes/enables the display request from the mobile terminal, and executes processing for displaying the target image as the air floating video 3 in the same manner as described above. The display request may be combined with the transmission of the data of the target image. Although this function differs in whether the display request is generated by the air floating video display apparatus or the mobile terminal, in either case, the target image is automatically displayed as the air floating video 3 upon the predetermined contact operation.

This function may be implemented as follows. Initially, the mobile terminal does not transmit the display request. The user brings the mobile terminal into contact with the air floating video 3. When the air floating video display apparatus determines/recognizes the predetermined contact operation, information regarding confirmation and the like of accepting the display request, or in other words, indication that the image display by this function is possible is sent to the mobile terminal via communication. When the mobile terminal receives the information regarding this confirmation and the like, it sends the data of the target image to the air floating video display apparatus. The data of the target image may be accompanied by a display request. When the air floating video display apparatus receives the target image data, it displays the target image as the air floating video 3.

### [Air Floating Video Display System]

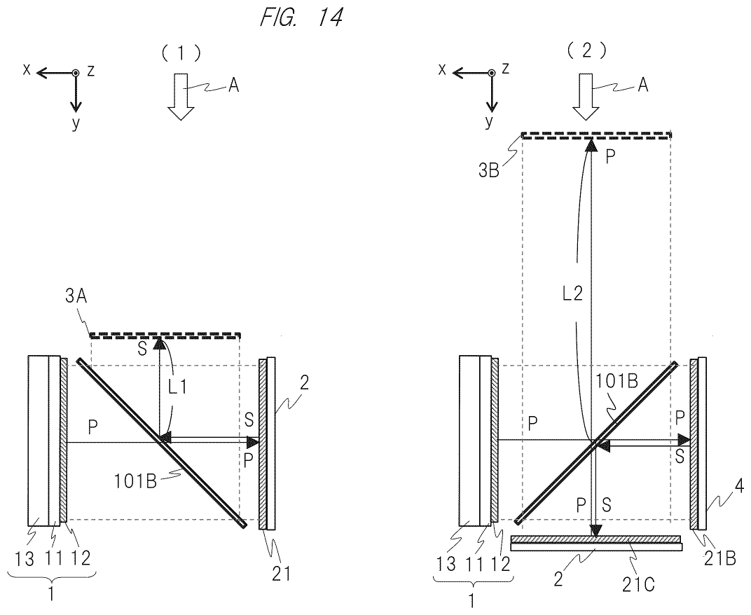

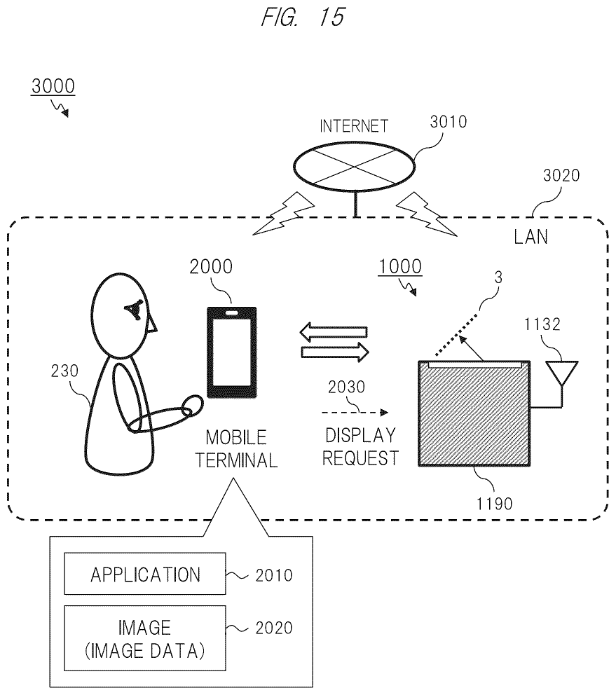

FIG. 15 shows a configuration of a system 3000 which is an air floating video display system of a third embodiment. This system 3000 is a system in which the air floating video display apparatus 1000 and a mobile terminal 2000 of the user 230 are connected via a communication network such as a LAN 3020 and/or the Internet 3010. FIG. 15 schematically shows the housing 1190, or the main body, of the air floating video display apparatus 1000, the air floating video 3, and part of the communication unit 1132 (FIG. 3). The housing 1190 accommodates the various components described with reference to FIG. 3. Note that the controller 1110, the communication unit 1132, and the like shown in FIG. 3 may be implemented inside the housing 1190 or outside the housing 1190. Components such as the camera of the imager 1180, the aerial operation detection sensor 1351, a microphone, and a speaker may also be installed outside the housing 1190.

This system 3000 performs communication between the mobile terminal 2000 and the air floating video display apparatus 1000 using any communication interface. The mobile terminal 2000 and the air floating video display apparatus 1000 may be communicatively connected directly, for example, via short-range wireless communication, or may be communicatively connected via the Internet 3010 or the like. Note that, in this system 3000, since image data and the like are exchanged between the mobile terminal 2000 and the air floating video display apparatus 1000, a certain level of communication speed is required. Therefore, in the example of FIG. 15, the mobile terminal 2000 and the air floating video display apparatus 1000 are connected via the LAN 3020. That is, the mobile terminal 2000 and the air floating video display apparatus 1000 are connected to the same network via a router or the like, and are configured to be mutually identifiable using IP addresses or the like. This is not limited to this configuration. Communication via mirroring or the like is also possible.

The mobile terminal 2000 includes an application 2010 and an image 2020. The application 2010 is any application program configured to display the image 2020 or the like on a display screen of the mobile terminal 2000. The application 2010 may be a general OS or application, or may be a dedicated application for coordinating and communicating with the air floating video display apparatus 1000 of the system 3000 of the third embodiment.

Data of the application 2010 may be distributed from the air floating video display apparatus 1000 or from a server or the like on the Internet 3010. The image 2020 is image data serving as a target image. The image 2020 may be held by the server or the like on the Internet 3010, or may be distributed from the air floating video display apparatus 1000. The image 2020 may be either a still image or a video. The image 2020 may also be data in a format such as a program.

The application 2010 of the mobile terminal 2000 may create a display request 2030 to display the target image (image 2020) as the air floating video 3 and transmit it to the air floating video display apparatus 1000.

FIG. 16 shows an overview of functions and the like of the air floating video display system of the third embodiment. (1) First, the user 230 has a target image 1601 and the like on his/her mobile terminal 2000. The target image 1601 is the image to be displayed as the air floating video 3.
(2) The user 230 performs a contact operation 1600 in which the mobile terminal 2000 is inserted to be in contact with a display range 3R of the air floating video 3 of the air floating video display apparatus 1000. At this time, the mobile terminal 2000 may transmit the display request 2030. The display request 2030 is a request or instruction to display the target image 1601 as the air floating video 3.
(3) Upon recognizing the contact operation 1600, the air floating video display apparatus 1000 displays the target image 1601 from the mobile terminal 2000 as an image 1602 which is the air floating video 3. At this time, the air floating video display apparatus 1000 may receive the display request 2030 and acquire the target image 1601 from the mobile terminal 2000 based on the display request 2030. The air floating video display apparatus 1000 may send some response for the display request 2030 to the mobile terminal 2000.

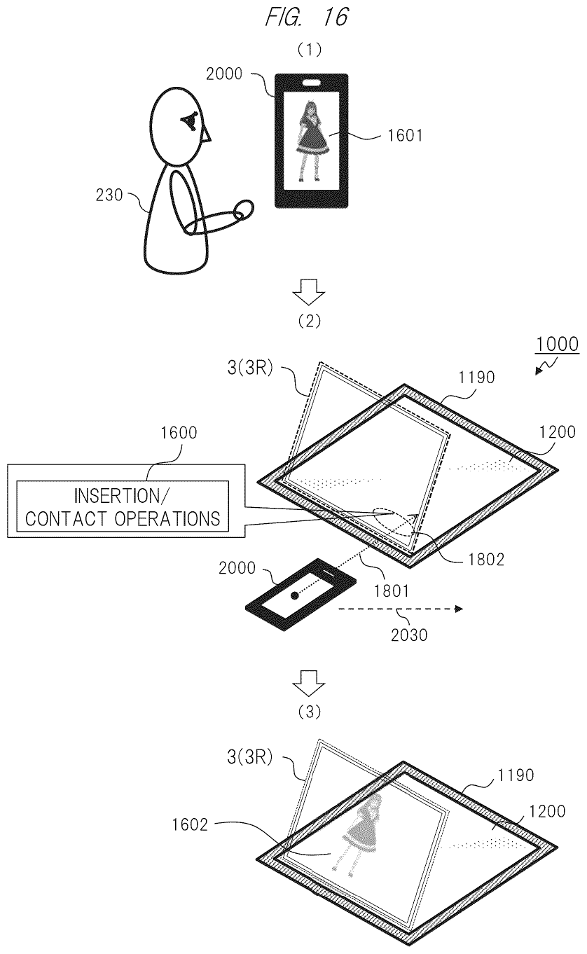

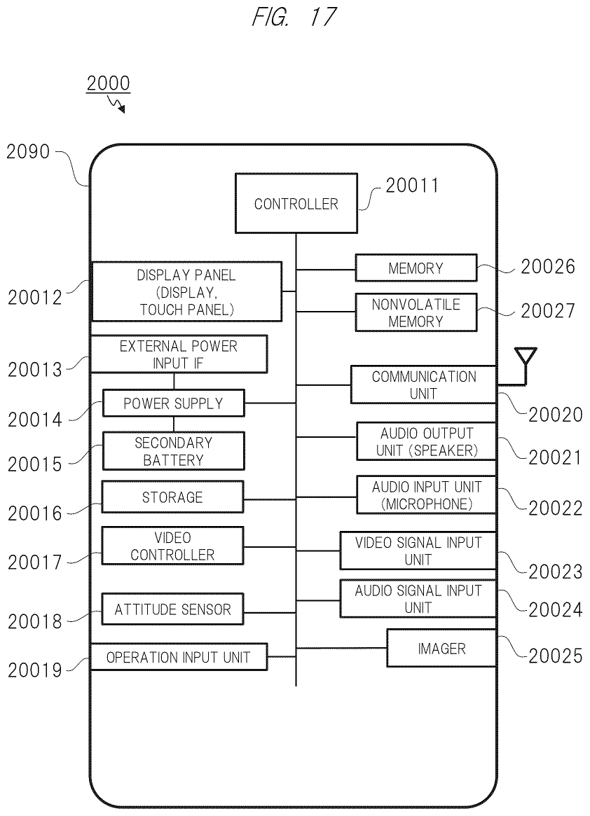

FIG. 17 shows a configuration example of the mobile terminal 2000. The mobile terminal 2000 comprises, in a housing 2090, a controller 20011, a display panel 20012, an external power input IF (interface) 20013, a power supply 20014, a secondary battery 20015, a storage 20016, a video controller 20017, an attitude sensor 20018, an operation input unit 20019, a communication unit (including antenna) 20020, an audio output unit (including speaker) 20021, an audio input unit (including microphone) 20022, a video signal input unit 20023, an audio signal input unit 20024, an imager 20025, a memory 20026, a nonvolatile memory 20027, and the like. These components are connected via a bus architecture or the like.

The controller 20011 has a processor or the like that controls the entire mobile terminal 2000 and individual units. The controller 20011 loads data such as a program stored in the nonvolatile memory 20027 or the storage 20016 into the memory 20026 and executes processing according to the program. As a result, various kinds of functions can be realized. The controller 20011 may perform an arithmetic operation based on information acquired from individual units in the mobile terminal 2000 in cooperation with the program stored in the memory 20026. The application 2010 shown in FIG. 15 is executed by, for example, the controller 20011 or the video controller 20017.

The memory 20026 stores video data to be displayed on the display panel 20012, control data for the mobile terminal 2000, and the like. The controller 20011 may read various kinds of software programs from the storage 20016 or the like, and load them into the memory 20026 to be stored. The nonvolatile memory 20027 and the storage 20016 hold various kinds of data and information used by the mobile terminal 2000. The data and information stored in the nonvolatile memory 20027 and the storage 20016 include, for example, various kinds of operation data to be displayed on the display panel 20012, display icons, data for objects to be operated by the user 230, and layout information.

The display panel 20012 is a display, and is, for example a touch panel serving as both a display means and an input means that accepts touch operation inputs. The image and the like are displayed on the screen of the display panel 20012. The display panel 20012 includes a touch sensor and accepts touch operation inputs such as those by a finger of the user 230. The display panel 20012 can adopt a liquid crystal panel, an organic EL panel, or the like.

The communication unit 20020 is a device implementing various kinds of communication interfaces. The communication unit 20020 implements communication interfaces/communication methods such as mobile communication interfaces such as 4G or 5G, wireless LAN communication interfaces such as Wi-Fi (registered trademark), and short-range communication interfaces such as Bluetooth (registered trademark) or NFC. The communication unit 20020 of the mobile terminal 2000 can communicate with the communication unit 1132 (FIG. 3) of the air floating video display apparatus 1000 using these communication methods.

Similarly, from the perspective of the air floating video display apparatus 1000, the communication unit 1132 has these communication interfaces/communication methods implemented. The communication unit 20020 can communicate with a communication apparatus connected to the Internet 3010, such as wireless base stations, using any of these communication methods. As a result, the mobile terminal 2000 can communicate with a server or the like connected to the Internet 3010.

The power supply 20014 converts AC current input from an external source via the external power input IF 20013 into DC current, and supplies the necessary DC current to each unit of the mobile terminal 2000. The secondary battery 20015 stores power supplied from the power supply 20014. The secondary battery 20015 supplies power to each unit requiring power when power is not supplied externally via the external power input IF 20013.

The video signal input unit 20023 inputs video data by connecting an external video output apparatus. Various digital video input interfaces can be applied to the video signal input unit 20023. For example, it can adopt an HDMI (High-Definition Multimedia Interface, registered trademark) standard video input interface, a DVI (Digital Visual Interface) standard video input interface, a DisplayPort standard video input interface, or the like. Alternatively, there may be provided an analog video input interface such as an analog RGB or composite video. The video signal input unit 20023 may also be various kinds of USB interfaces.

The audio signal input unit 20024 inputs audio data by connecting an external audio output apparatus. The audio signal input unit 20024 may adopt an HDMI standard audio input interface, an optical digital terminal interface, a coaxial digital terminal interface, or the like. The audio signal input unit 20024 may also be various kinds of USB interfaces. When using the HDMI standard interface, the video signal input unit 20023 and the audio signal input unit 20024 may be configured as an integrated interface with combined terminals and cables.

The audio output unit 20021 can output audio based on audio data input to the audio signal input unit 20024 or audio data stored in the storage 20016. The audio output unit 20021 may be configured as a speaker, or may include an earphone jack.

In addition, the audio output unit 20021 may output built-in operation sounds or error warning sounds. The audio output unit 20021 may also adopt a configuration in which the audio is output to an external device as a digital signal, such as the Audio Return Channel function specified in the HDMI standard.

The audio input unit 20022 including a microphone captures sound in the vicinity of the mobile terminal 2000, converts the sound into a signal, and generates an audio signal. The audio input unit 20022 may capture a human voice such as the voice of the user 230 via the microphone to generate the audio signal such that the controller 20011 and the like can perform audio recognition processing on the audio signal to acquire text information.

The imager 20025 is, for example, a camera that has an image sensor. The mobile terminal 2000 may be provided with, for example, a camera (front camera) on the front side on the display panel 20012 side of the housing 2090, or may be provided with a camera (rear camera) on the opposite rear side. In the present embodiment, the imager 20025 has both a front camera and a rear camera.

The storage 20016 is a storage apparatus that records various kinds of data such as video data, image data, audio data and the like, and various kinds of information such as programs. The storage 20016 may be configured, for example, with a magnetic recording medium storage apparatus such as a hard disk drive (HDD) or a semiconductor element memory such as a solid-state drive (SSD). The storage 20016 may have, for example, various kinds of data such as video data, image data, audio data and the like, and various information such as programs pre-recorded at the time of product shipment. In addition, the storage 20016 may record various kinds of data and information acquired from an external server or the like via the communication unit 20020. Image data and the like recorded in the storage 20016 is output and displayed on the display panel 20012 via processing by the video controller 20017. The mobile terminal 2000 may output and transmit various kinds of data and information recorded in the storage 20016 to an external server or the like via the communication unit 20020.

The video controller 20017 performs various kinds of controls related to the video signal input to the display panel 20012. The video controller 20017 may also be referred to as a video processing circuitry, a video processing unit, or an image processor. The video controller 20017 may be configured by, for example, hardware such as an ASIC, FPGA, a video processor, or the like. The video controller 20017 performs a video switching control such as determining which video signal to input to the display panel 20011 for display from among video signals stored in memory 20026 and the like, video signals (video data) input to the video signal input unit 20023, and the like. In addition, the video controller 20017 may control image processing performed on the video signal input from the video signal input unit 20023 or the video signal stored in the memory 20026. Examples of image processing include scaling processing for enlarging, reducing, or deforming the image, brightness adjustment processing for changing luminance, contrast adjustment processing for changing the contrast curve of the image, and Retinex processing for decomposing the image into light components and changing the weighting for each component. The video controller 20017 may also include video memory or the like for holding video data to be input to the display panel 20012.

The attitude sensor 20018 is constituted by a combination of gyro sensors, gravity sensors, acceleration sensors, geomagnetic sensors, and the like capable of detecting an attitude of the mobile terminal 2000. The attitude can be expressed, for example, in terms of direction and angle of three orthogonal axes (X, Y, Z) in space. Based on the attitude detection result from the attitude sensor 20018, the controller 20011 may control the operation of individual units. Additionally, the mobile terminal 2000 may include a GPS receiver, proximity sensor, illuminance sensor, distance sensor, or the like.

The operation input unit 20019 is a device to allow the user 230 to perform operation inputs, and includes a power button, volume buttons, or the like.

### [Video Display Method]

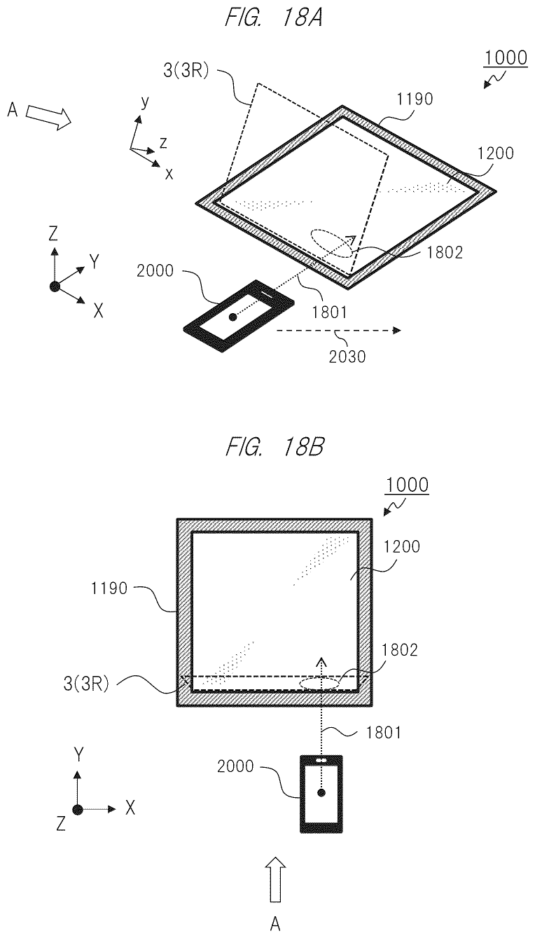

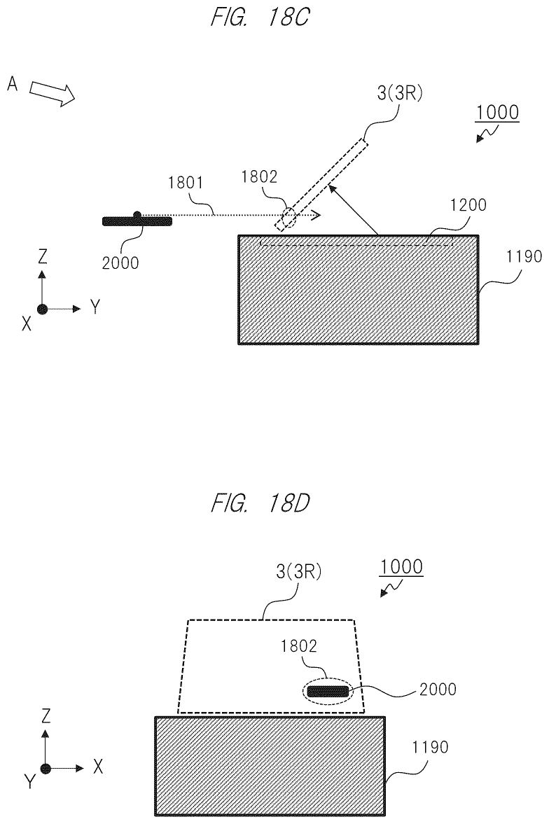

FIG. 18 (e.g., FIG. 18A) is an explanatory diagram showing a video display method based on the collaboration between the air floating video display apparatus 1000 and the mobile terminal 2000 in the system 3000 of the third embodiment. FIG. 18A and the like each shows the user 230 making the display request 2030 from the mobile terminal 2000 to the air floating video display apparatus 1000 by bringing the mobile terminal 2000 into contact with the display range 3R of the air floating video 3 of the air floating video display apparatus 1000. FIG. 18A is a perspective view, FIG. 18B is a top view (XY plane view) from above, FIG. 18C is a side view (plan view in the YZ plane) from the side, and FIG. 18D is a front view (plan view in the XZ plane) from the front of the apparatus.

In FIG. 18A, a top surface of the housing 1190 has an opening 1200. The opening 1200 is provided with, for example, the transparent member 100 (e.g., a glass plate) and the polarization separator 101, similar to FIG. 2A. The display range 3R represents a predetermined position or plane in the space where the air floating video 3 which is the real image is formed. In FIG. 18A, X, Y, and Z are used as a spatial coordinate system. The X axis/X direction is the left-right direction (first horizontal direction) as viewed from the user 230 (a viewpoint not shown but located in the direction of arrow A). The Y axis/Y direction is the front-back direction (depth direction, second horizontal direction) as viewed from the user 230. The Z axis/Z direction is the up-down direction (vertical direction) as seen from the user 230. In addition, the coordinate system in the air floating video 3 is shown by x, y, and z. The x direction is the screen horizontal direction, the y direction is the screen vertical direction, and the z direction is the depth direction.

A direction 1801 denotes an example of an insertion direction in which the user 230 inserts the mobile terminal 2000 into the display range 3R of the air floating video 3 during the contact operation. In the present example, this direction is the Y direction. FIG. 18A shows an example of a contact point 1802 where the mobile terminal 2000 contacts the display range 3R. In the present example, the contact point 1802 is located near the lower right corner of the display range 3R.

In the embodiment of FIG. 18, the display request 2030 is made from the mobile terminal 2000 to the air floating video display apparatus 1000 upon contact between the mobile terminal 2000 and the display range 3R. In other words, the display request 2030 is transmitted from the mobile terminal 2000 to the air floating video display apparatus 1000 immediately before, during, or immediately after contact. For example, the air floating video display apparatus 1000 determines and recognizes the contact, and upon recognizing this contact, receives the display request 2030 transmitted from the mobile terminal 2000. That is, the air floating video display apparatus 1000 allows the displaying of the target image as the air floating video 3 based on the display request 2030. The air floating video display apparatus 1000 receives the image data of the target image associated with the display request 2030 from the mobile terminal 2000 via transfer.

The air floating video display apparatus 1000 controls the display apparatus 1 based on the acquired image data to display the target image as the air floating video 3. In other words, the air floating video display apparatus 1000 converts the target image designated by the user 230 into an air floating video to display it as the air floating video 3.

The display request 2030 transmitted from the mobile terminal 2000 can be performed through various kinds of communication methods described above, and details thereof are not limited. In the present example, the display request 2030 is transmitted via wireless communication with the LAN 3020, but this is not limited thereto. A wired connection may also be used, or the mobile terminal 2000 and the air floating video display apparatus 1000 may be connected via infrared communication or the like.

As described in detail below, determining and recognizing contact between the mobile terminal 2000 and the display range 3R can be achieved by using the aerial operation detection sensor 1351 (FIG. 3), the imager 1180 (camera), or the like. Additionally, determining and recognizing the contact may be performed by using various kinds of sensors mounted inside or outside the housing 1190, various kinds of sensors of the mobile terminal 2000 such as a gyro sensor, or by combining these methods.

As described above, upon determining and recognizing the contact operation of the mobile terminal 2000 with respect to the display range 3R, the present system 3000 causes the air floating video display apparatus 1000 to recognize the display request 2030 from the mobile terminal 2000. The air floating video display apparatus 1000 then starts displaying the target image as the air floating video. As described above, a feature of the third embodiment is that the target image which is an air floating video can be displayed simply by contacting and placing the mobile terminal 2000 in the display range 3R of the air floating video 3.

### [Contact Operation]

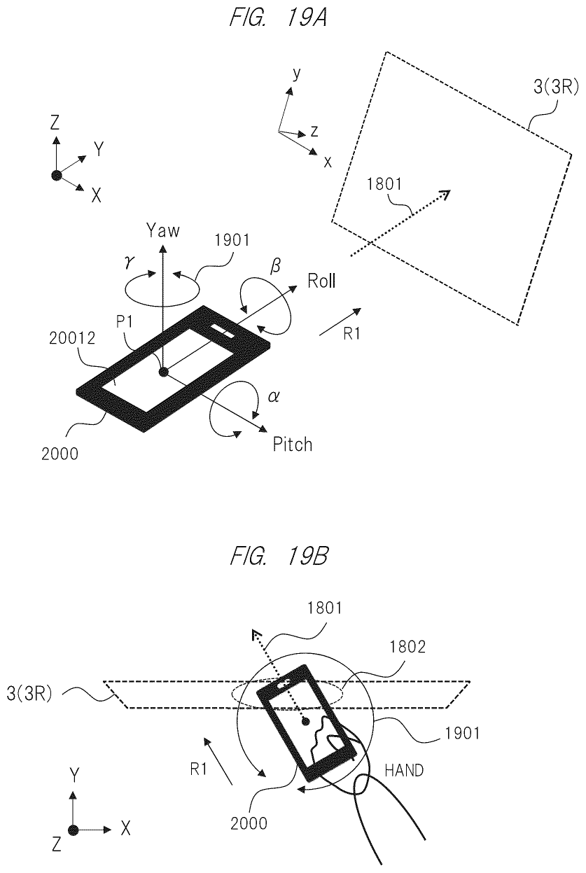

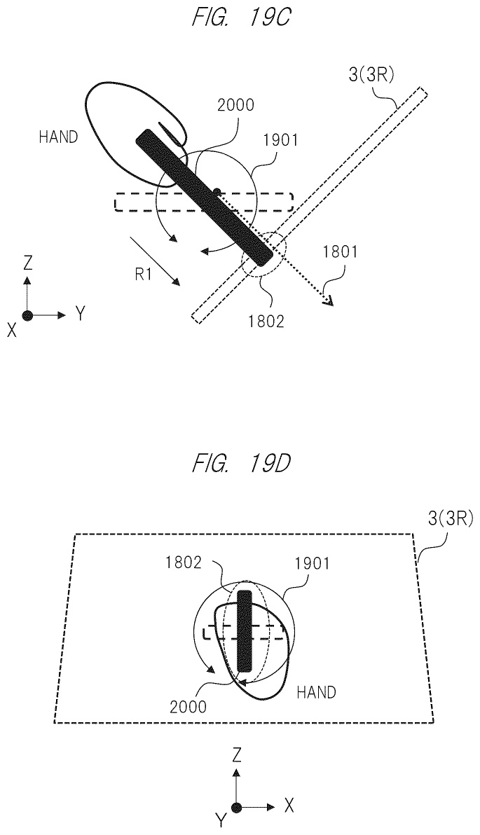

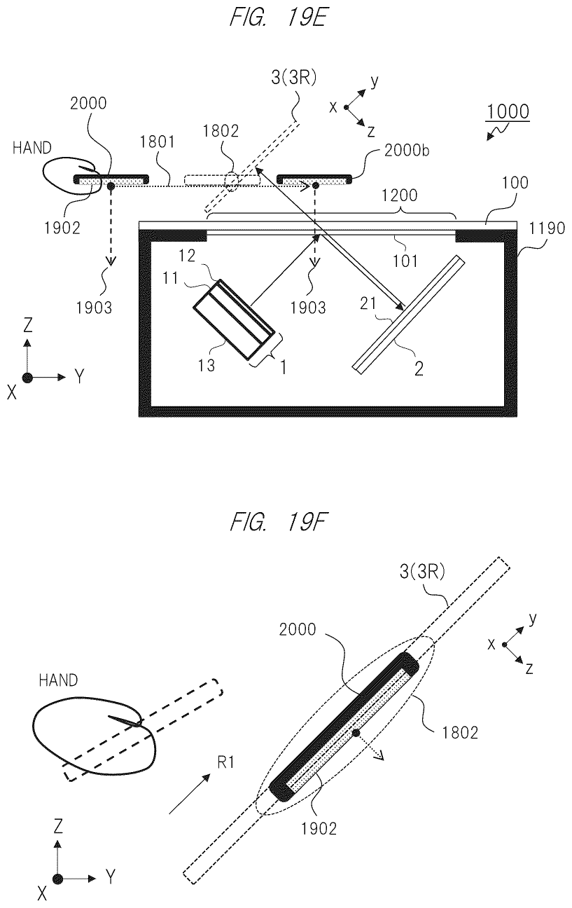

FIG. 19 (including FIG. 19A, etc.) shows attitude change directions when the mobile terminal 2000 is brought into contact with the display range 3R of the air floating video 3. An attitude change direction 1901 for the mobile terminal 2000 can be in various directions as shown in the drawings. FIG. 19A shows a perspective view representing rotational angles of three axes: pitch angle α, roll angle β, and yaw angle γ. In the present embodiment, the attitude of the mobile terminal 2000 during the contact operation can essentially take any attitude. That is, these angles (α, β, γ) can be in any state. This makes contact operation by the user 230 simple and highly convenient.

FIG. 19B is a plan view in the XY plane showing an example where the attitude of the mobile terminal 2000 during the contact operation is rotated in the horizontal plane (XY plane). As in FIG. 19A, a representative position and orientation of the mobile terminal 2000 are set to the front surface of the housing, specifically a central position P1 on the display panel 20012, and an orientation R1 (same as axis of roll angle β) along a long side of the front surface for explanatory purposes. In the present example, the orientation R1 of the mobile terminal 2000 at contact and the corresponding the insertion direction 1801 are rotated around the Z axis (yaw angle γ), resulting in an orientation tilted diagonally left relative to the Y axis. The attitude change direction 1901 is the rotation direction around the Z axis (yaw angle γ). Regarding the display range 3R, the vicinity of an upper side of the housing of the mobile terminal 2000 is in contact (contact point 1802). The user 230 inserts the mobile terminal 2000 held, for example, in his/her right hand into the vicinity of the center of the display range 3R.

FIG. 19C is a plan view in the YZ plane showing an example where the attitude of the mobile terminal 2000 during the contact operation is rotated in the YZ plane. In the present example, the orientation R1 of the mobile terminal 2000 at contact and the corresponding insertion direction 1801 are rotated around the X axis (pitch angle α), resulting in an orientation tilted diagonally downward relative to the Y axis. The attitude change direction 1901 is the rotation direction around the X axis (pitch angle α). This is a case where the insertion direction 1801 is vertical with respect to the display range 3R. Regarding the display range 3R, the vicinity of the upper side of the housing of the mobile terminal 2000 is in contact (contact point 1802).

FIG. 19D is a plan view in the XZ plane showing an example where the attitude of the mobile terminal 2000 during the contact operation is rotated in the XZ plane. In the present example, the orientation R1 of the mobile terminal 2000 at contact and the corresponding insertion direction 1801 are rotated around the Y axis (roll angle β), resulting in a flat plate of the housing being oriented vertically. The attitude change direction 1901 is the rotation direction around the Y axis (roll angle R).

FIG. 19E is a cross-sectional view in the YZ plane showing another example of the attitude of the mobile terminal 2000 during the contact operation. The present example shows a case where the screen of the display panel 20012 on the front surface of the mobile terminal 2000 is in a downward orientation during the contact operation. FIG. 19E shows an example adopting the configuration of FIG. 4A to the air floating video display apparatus 1000. Video light is emitted diagonally upward from the opening 1200 in the transparent member 100 on the top surface (XY plane) of the housing 1190, forming the air floating video 3. The plane (xy plane) of the display range 3R of the air floating video 3 is positioned at an angle of approximately 45 degrees relative to the XY plane. FIG. 19E omits the depiction of the aerial operation detection sensor 1351 and the like (described below).

During the contact operation, the user 230 inserts the mobile terminal 2000 into the display range 3R with a screen 1902 in the downward orientation (direction 1903) and along the Y direction toward the rear (positive direction) as the insertion direction 1801. FIG. 19E shows the state where the mobile terminal 2000 has contacted the display range 3R and passed through to the rear side (mobile terminal 2000b). In this state, the screen 1902 of the mobile terminal 2000b is in the downward orientation (direction 1903). Such a contact operation is also acceptable.

FIG. 19F is a cross-sectional view in the YZ plane showing another example of the attitude of the mobile terminal 2000 during the contact operation. The present example shows a case where the screen 1902 of the display panel 20012 on the front surface of the mobile terminal 2000 is oriented along the plane (xy plane) of the display range 3R of the air floating video 3 during the contact operation. The user 230 operates the screen 1902 of the mobile terminal 2000 so that it overlaps and faces the display range 3R. In FIG. 19F, the screen 1902 of the mobile terminal 2000 is maintained in a state where it contacts the display range 3R.

In addition, the predetermined contact operation may be an operation in which the time (referred to as the contact time) during which the mobile terminal 2000 is in contact with the display range 3R is determined. That is, the air floating video display apparatus 1000 counts the contact time and determines that a predetermined contact operation has been performed when the contact time reaches or exceeds a predetermined duration as a determination condition.

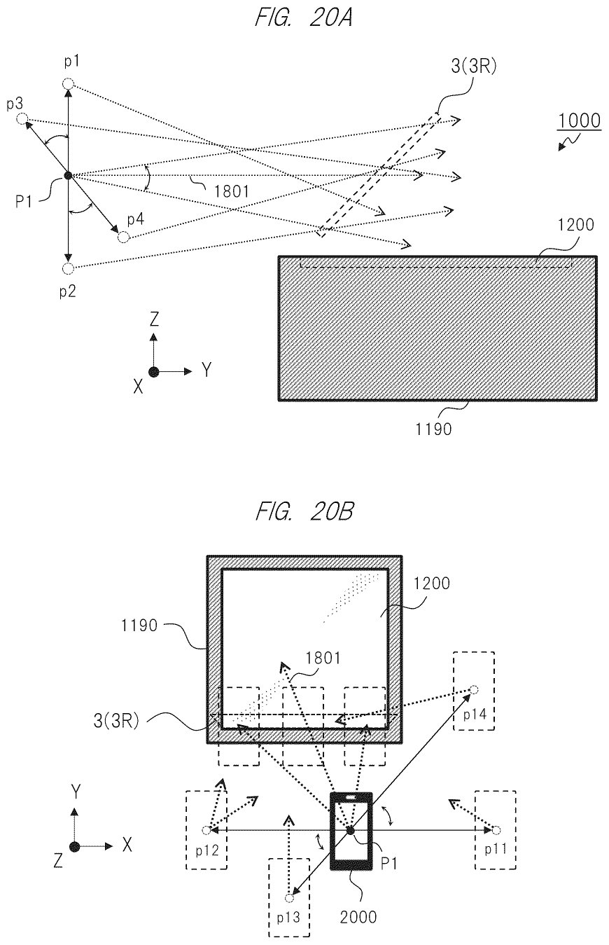

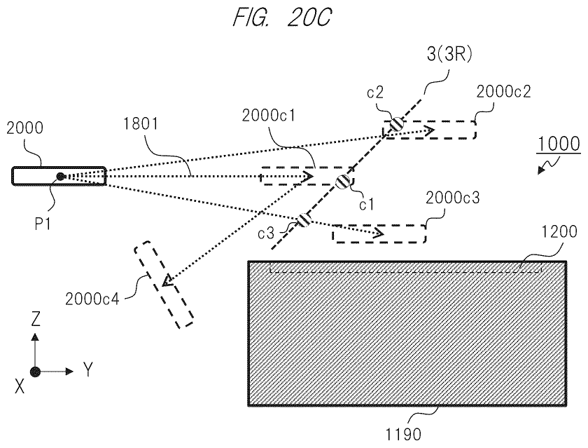

FIG. 20 (including FIG. 20A, etc.) includes explanatory diagrams showing that the position and the like of the mobile terminal 2000 that may be essentially at any position or the like at each point in time including before insertion, during insertion, and after insertion when performing the contact operation to insert the mobile terminal 2000 into the display range 3R. Insertion of the mobile terminal 2000 into the display range 3R requires only that the mobile terminal 2000 and the display range 3R come into contact. In other words, it is sufficient as long as contact determination is possible. The insertion can occur at any position, in any insertion direction, and at any attitude angle. In addition, contact between the display range 3R and the mobile terminal 2000 can essentially occur at any point in the display range 3R.

In this manner, allowing a wide range of permissible contact operations and actions (corresponding determination conditions) offers the advantage of making user operation easier. Conversely, it is also possible to narrow the permissible touch operations and actions (determination conditions). That is, it may be defined such that the position, attitude, insertion direction, contact duration, and contact region in the display range 3R of the mobile terminal 2000 during the contact operation (before insertion, during insertion, after insertion, etc.) are limited.

FIG. 20A shows examples of the position and insertion direction of the mobile terminal 2000 before insertion in the YZ plane. In FIG. 20A, the mobile terminal 2000 is not shown, and its position is indicated by dots. Black dots and white dots (p1, etc.) show examples of the position of the mobile terminal 2000 before insertion. As shown, various positions and insertion directions are possible as long as the mobile terminal 2000 contacts the display range 3R.

FIG. 20B shows examples of positions and insertion directions of the mobile terminal 2000 before insertion in the XY plane. Operation is possible from any position before insertion (p11, etc.) in any insertion direction such that the mobile terminal 2000 contacts the display range 3R. In addition, in the case of position p14, before insertion, the mobile terminal 2000 is located to the right of the display range 3R and further back in the Y direction than the display range 3R. The insertion direction can be either from the back (+Y) to the front (−Y) relative to the display range 3R, or in the left-right direction. Even in such a case, if the mobile terminal 2000 contacts the display range 3R, it is accepted as the contact operation.

FIG. 20C is a plan view in the YZ plane showing an example of a state when the mobile terminal 2000 contacts the display range 3R. Contact of the mobile terminal 2000 with the display range 3R may be contact with any portion of the mobile terminal 2000 as long as the contact is recognizable and determinable. In addition, once the mobile terminal 2000 has made contact with the display range 3R (after the contact operation is recognized), it may subsequently move away from the display range 3R.

State 2000c1 shows an example of the state of the mobile terminal 2000 at the time of contact. A contact point (contact position) c1 at this time is in the vicinity of the center on the display range 3R side and is a portion on the mobile terminal 2000 side, for example, near the upper side of the housing. State 2000c2 shows another example of the state of the mobile terminal 2000 at the time of contact. A contact point c2 at this time is at the top of the display range 3R, for example, a portion near the lower side of the housing. State 2000c3 shows another example of the state of the mobile terminal 2000 at the time of contact. A contact point c3 at this time is at the bottom on the display range 3R side. After initially making contact, the mobile terminal 2000 has moved further back and is no longer touching the display range 3R. In addition, state 2000c4 is a state where the mobile terminal 2000 has been pulled back toward the user in the Y direction from the contacted state 2000c1.

### [Modification: Determination Condition]

In the third embodiment, the attitude and position of the mobile terminal 2000 during insertion and contact operations into the display range 3R were optional, but this is not limited thereto. In a modification, the attitude, position, and the like of the mobile terminal 2000 at the time of insertion and contact operations may be limited to specific states. That is, the air floating video display apparatus 1000 may determine and recognize a specific attitude or other state during the contact operation of the mobile terminal 2000, and only permit the display request 2030 when such a state is recognized. As a modification, when narrowly limiting the permitted predetermined contact operation, the following determination conditions can be provided.
(1) Only insertion in the Y direction toward the front, that is, toward the user 230 visually recognizing the air floating video 3, relative to the plane of the display range 3R of the air floating video 3 is permitted. In other words, contact from the rear or side relative to the display range 3R is not permitted. In addition, insertion is permitted only when the insertion direction lies within a predetermined angular range relative to the plane of the display range 3R of the air floating video 3.
(2) When the mobile terminal 2000 contacts the plane of the display range 3R, the contact point, that is, the position of the mobile terminal 2000 and the region in the display range 3R, is limited to specific portions. For example, a central portion, a lower-right portion, or an upper-left portion in the display range 3R.
(3) The attitude of the mobile terminal 2000 when it contacts the plane of the display range 3R is limited to certain attitudes. For example, the angle relative to the plane of the display range 3R is within a predetermined angular range. For example, as shown in FIG. 19C, it may be permissible only when the flat body of the mobile terminal 2000 is inserted approximately vertically relative to the plane of the display range 3R. In addition, as shown in FIG. 19F, it may be permissible only when the flat plate-like housing of the mobile terminal 2000 contacts the plane of the display range 3R in an approximately parallel direction.
(4) After the mobile terminal 2000 contacts the plane of the display range 3R and passes through to the rear side, the attitude and holding time of the mobile terminal 2000 are limited. For example, as shown in the example of FIG. 19E, the attitude angle relative to the plane of the display range 3R or the opening 1200 is within a predetermined angular range.

### [Guide Display]

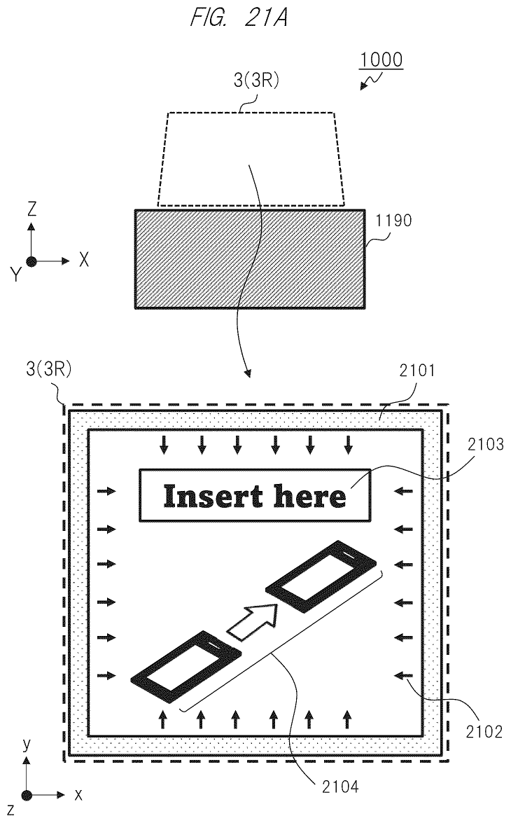

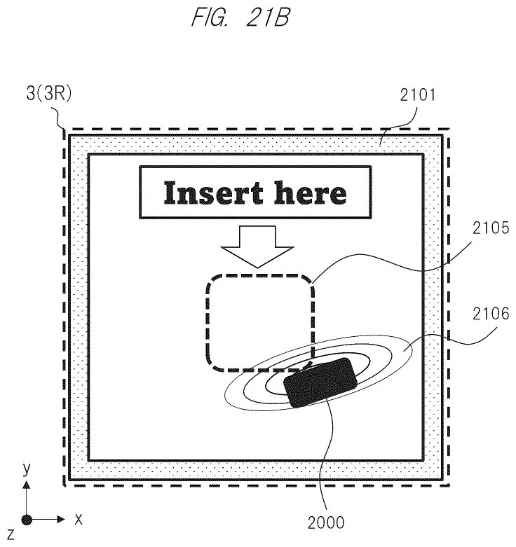

FIG. 21A shows an example where the air floating video display system displays guide information for the user 230 regarding the insertion and contact operations when inserting the mobile terminal 2000 into the display range 3R of the air floating video 3. In the third embodiment, the air floating video display apparatus 1000 displays the guide information, that is, information guiding and indicating the location and direction for inserting the mobile terminal 2000, as well as user interface information, on the air floating video 3. As a result, the user 230 can easily perform the contact operation of inserting the mobile terminal 2000 into the display range 3R by following the guide information.

Examples of guidance displays for this guide information include the following:
(a) Displaying the entire display range 3R (the region accepting the contact operation which may be a partial region) in a predetermined color or the like. Alternatively, displaying a frame representing the entire display range 3R in color or the like.
(b) Explaining the insertion location or insertion direction using displays such as arrows.
(c) Explaining the insertion location and direction using natural language, video, images, animations, etc.

In the example of FIG. 21A, the lower portion shows an example of guide information displayed in a plan view in the XY plane when the air floating video 3 is viewed from the front. The guide information in FIG. 21A shows several guidance display examples collectively, and adopting at least one of these is sufficient. A guidance display example 2101 is an example where a rectangular frame representing the entire display range 3R is displayed in color. A guidance display example 2102 is an example where an arrow image (or other predetermined symbols or shapes) is displayed to indicate to the user the region accepting insertion or contact. In the present example, the arrow image consists of multiple arrows pointing inward from the four sides of the display range 3R. A guidance display example 2103 is an example where the display of a natural language text image such as “Insert here” indicates to the user the region of the display range 3R accepting insertion or contact. A guidance display example 2104 is an example where the display of video or images such as animations indicates to the user the region of the display range 3R accepting insertion or contact.

As a modification, the guide information may similarly be displayed on the screen of the mobile terminal 2000 as described below.

As another modification, at the time of insertion and contact operations of the mobile terminal 2000, a guide image indicating a contact status may be displayed on the air floating video 3. In the example of FIG. 21B, only a portion of a region 2105 in the display range 3R of the air floating video 3 is defined as a predetermined region (insertion region/contact region) accepting insertion and contact operations.

The air floating video display apparatus 1000 uses sensors to detect the contact status of the mobile terminal 2000 relative to the display range 3R, and based on the detected contact points, displays a guide image 2106 representing the contact status. This guide image 2106 is an image indicating that the mobile terminal 2000 is contacting the display range 3R at the spatial position corresponding to the guide image 2106. In the present example, the guide image 2106 is an effect image resembling ripples spreading out from the contact point. By viewing the guide image 2106, the user 230 can more easily recognize the contact status of the mobile terminal 2000 with the display range 3R. The user 230 can then move the mobile terminal 2000 to the insertion region which is a portion of the region 2105 based on the guide image 2106. The guide information/feedback information provided to the user 230 is not limited to the image display described above, and audio output or other methods may also be implemented.

### [Display Restriction Function]

In addition, the present system 3000 may also include the following function (referred to as the display restriction function). When the mobile terminal 2000 is inserted into the display range 3R during the contact operation, the present system 3000 may hide the air floating video 3 in a portion of the display range 3R near the column where the mobile terminal 2000 is inserted, while displaying different content in the remaining regions of the display range 3R. When the user 230 views the display range 3R during the insertion operation of the mobile terminal 2000, areas where the air floating video 3 which is the displayed video may be obscured or blocked by the mobile terminal 2000. This function controls the display of the air floating video 3 in such obscured areas (partial regions) to be temporarily hidden. The video controller 1160 of the air floating video display apparatus 1000, particularly as shown in FIG. 3, may realize this hiding by controlling the light source apparatus 13 and the video display element (liquid crystal display panel 11) of the display apparatus 1.

In addition, when the air floating video display apparatus 1000 hides a portion of the display range 3R in response to the contact operation, the air floating video display apparatus 1000 may reduce the display size of the displayed video or change its aspect ratio so that the remaining display region matches the air floating video 3 which is the displayed video.

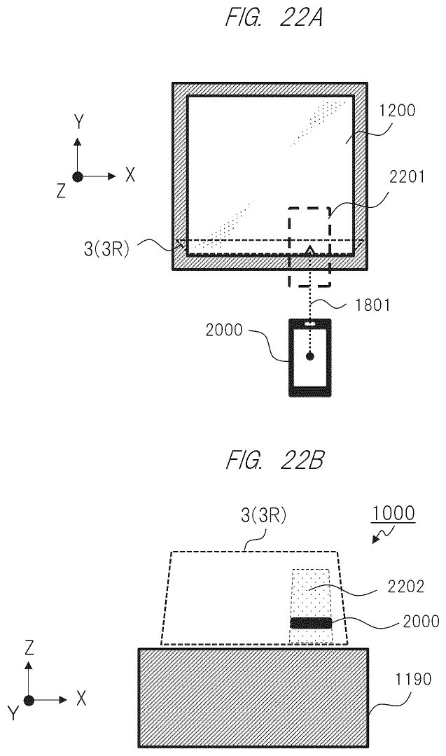

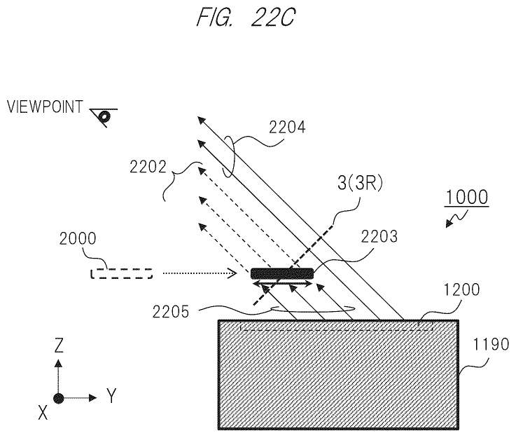

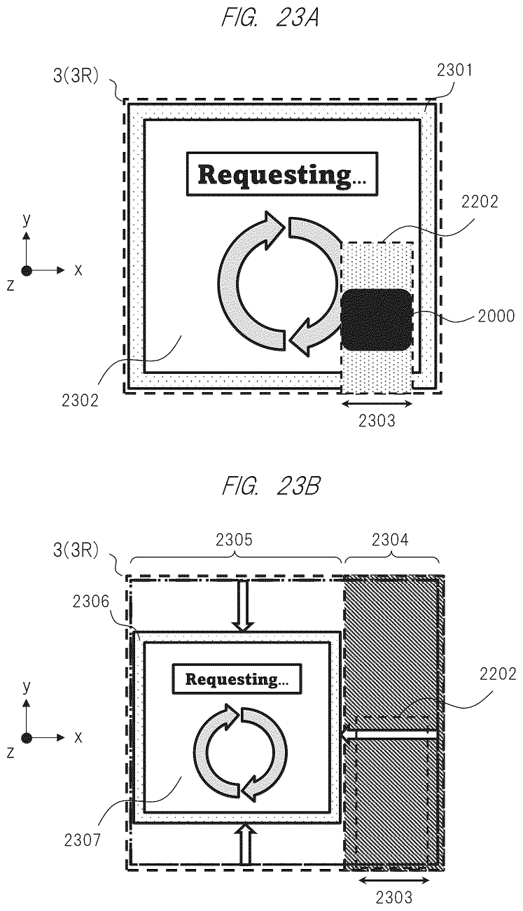

FIG. 22 (including FIG. 22A, etc.) shows examples of this display restriction function. FIG. 22A is a plan view in the XY plane showing, for example, a case where the user 230 inserts and contacts the mobile terminal 2000 in the Y direction relative to a portion of the display range 3R, similar to FIGS. 18A to 18D. A region 2201 indicates the position and region of the mobile terminal 2000 when it is in contact after insertion into the display range 3R. FIG. 22B is a plan view in the XZ plane corresponding to the state of FIG. 22A. A region 2202 is an example of a non-visible region caused by blocking the video light. Correspondingly, FIG. 22C is a plan view in the YZ plane showing a state of video light blocking. A position 2203 indicates the position and region of the mobile terminal 2000 in a contacting state after being inserted into the display range 3R.

A video light component 2204 indicates a component that forms the air floating video 3 in the display range 3R. This is achieved by the light flux of the video light emitted outward from the opening 1200 entering the viewpoint (eye) of the user 230 without being blocked by the mobile terminal 2000 (position 2203). A video light component 2205 indicates a component that forms the non-visible region 2202 in the display range 3R. This is achieved by the light flux of the video light emitted outward from the opening 1200 being blocked by the mobile terminal 2000 (position 2203) and not entering the viewpoint (eye) of the user 230.

FIG. 23 (FIG. 23A, etc.) shows display examples of a guide image in the air floating video 3, along with examples of operations of the display restriction function.

First, FIG. 23A shows an example where, in the front view (xy plane) of the display range 3R of the air floating video 3, a guide image 2302 indicating that the display request 2030 is occurring is displayed when the contact operation is recognized. In the present example, a frame display 2301 indicating the entire display range 3R is provided. The guide image 2302 indicating that the display request 2030 is occurring is displayed in this frame display 2301. The guide image 2302 is, for example, a text image representing the occurrence of the display request 2030 such as “Requesting . . . ”, an arrow icon, or the like. In addition, in this state, the non-visible region 2202 occurs due to the blocking by the mobile terminal 2000.

FIG. 23B shows an example where the air floating video display apparatus 1000, hides a portion of the display range 3R and controls the display of the remaining region based on recognition of the occurrence of the non-visible region 2202 as shown in FIG. 23A. Recognition of the occurrence of the non-visible region 2202 can be performed by the aerial operation detection sensor 1351 or the imager 1180.

The video controller 1160 of the air floating video display apparatus 1000 as shown, for example, in FIG. 3 determines and recognizes the non-visible region 2202 along with the contact operation, and determines a hidden region in the display range 3R that includes the non-visible region 2202. In the present example, based on detection by the aerial operation detection sensor 1351 (described below), a contact point 2303 within the display range 3R, specifically its width and column in the X direction and the x direction, can be determined. Therefore, the air floating video display apparatus 1000 determines that a hidden region 2304, shown with a diagonal hatch pattern, is to be the display column corresponding to the contact point 2303 in the display range 3R. The hidden region 2304 encompasses the non-visible region 2202. The region within the display range 3R other than the hidden region 2304 becomes a display region 2305. In other words, the air floating video display apparatus 1000 constitutes the display range 2305 by reducing the size of the display range 3R by the width of the hidden region 2304 in both the X direction and the x direction.

The air floating video display apparatus 1000 controls the display of display apparatus 1 such that the air floating video 3 is not displayed in the hidden region 2304 and is displayed only within the display range 2305. In the present example, in the display range 2305 of the display range 3R, the original frame image 2301 and the guide image 2302 as shown in FIG. 23A are adjusted, such as by scaling, to fit within the width of the display range 2305 while maintaining their aspect ratio, thereby changing into a frame image 2306 and a guide image 2307.

This function makes it easier for the user 230 to visually recognize the guide image 2307 and the like in the air floating video 3. The above example shows a case where a wider region than the non-visible region 2202 is designated as the hidden region 2304. However, this is not limited thereto. The hidden region may be the same region as the non-visible region, or may be a different region that overlaps at least partially with the non-visible region. In addition, modifying and adjusting the guide image can be performed in various ways, such as changing the aspect ratio, altering color or brightness, or shifting the display position.

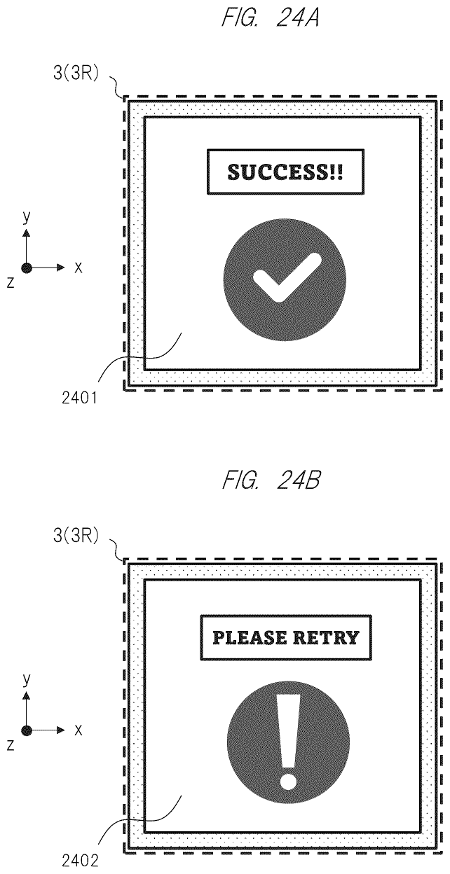

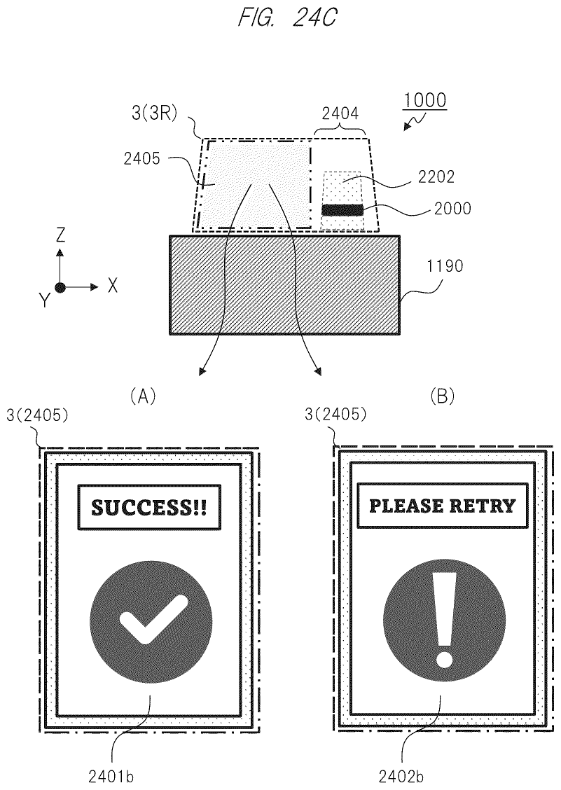

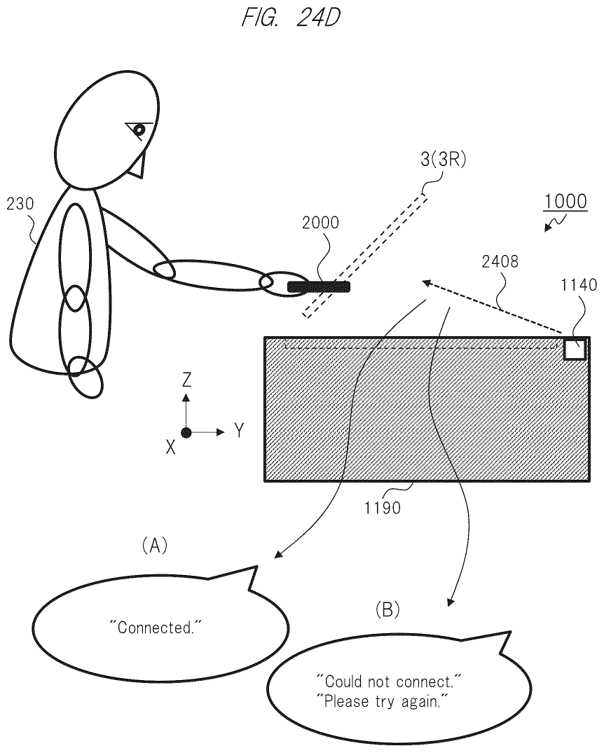

FIG. 24A shows a display example of a guide image for the air floating video 3 as feedback such as notification to the user 230 when a predetermined contact operation is recognized, in other words, when the contact operation is determined as successful and the display request 2030 is received. In the present example, a guide image 2401 indicating success is displayed across the entire the display range 3R. The guide image 2401 is configured by text, icons, or the like representing success. Upon such a successful operation, the system transitions to the phase of displaying the target image as the air floating video 3.

FIG. 24B shows a display example of a guide image for the air floating video 3 as feedback such as notification to the user 230 when a predetermined contact operation cannot be recognized, in other words, when the contact operation is determined as a failure and the display request 2030 is not received. In the present example, a guide image 2402 indicating failure is displayed across the entire display range 3R. The guide image 2402 is configured by text, icons, or the like representing failure or retry.

If the insertion and contact operations of the mobile terminal 2000 into the display range 3R by the user 230 is not performed correctly, or if it is performed correctly but the system 3000 fails to recognize it properly due to sensor malfunction or the like, the air floating video display apparatus 1000 determines it as a failure or error as described above and outputs the guide image 2402 to the user 230 as feedback. In this case, the air floating video display apparatus 1000 may instruct the user 230 to retry the contact operation. The user 230 repeats the contact operation.

Furthermore, FIG. 24C shows an example where, when displaying a guide image as air floating video 3 indicating that the display request 2030 from the mobile terminal 2000 to the air floating video display apparatus 1000 was performed correctly (success) along with the contact operation of the mobile terminal 2000 on the display range 3R, the display region is adjusted according to the non-visible region 2202. A hidden region 2404 is a region of the display range 3R that includes the non-visible region 2202, while a display region 2405 is a region excluding the hidden region 2404.

The lower-left drawing (A) in FIG. 24C shows an example of a successful case. The display region 2405 displays a guide video 2401b whose size or the like has been adjusted based on the guide video 2401 as shown in FIG. 24A. Similarly, the lower-right drawing (B) of FIG. 24C shows an example of a failure case. The display region 2405 displays a guide video 2402b whose size or the like has been adjusted based on the guide video 2402 as shown in FIG. 24B.

The above-described feedback to the user 230 is not limited to visual means such as displaying a guide image in the air floating video 3 or lamp illumination, and may also employ auditory means such as audio output, or tactile means such as apparatuses that generate stimuli like vibration, air, or ultrasound. Such apparatuses such as an air blower or an ultrasonic generator may be installed inside or outside the housing 1190. In addition, each means may be combined and used simultaneously.

FIG. 24D shows the air floating video display apparatus 1000 generating audio 2408 indicating success or failure from the audio output unit 1140 (e.g., a speaker) as shown in FIG. 3 to the user 230 when the contact operation and the display request 2030 results in success or failure in the YZ plane. (A) is the audio 2408 (audio notification example) for a successful case, such as “Connected.” (B) is the audio 2408 (audio notification example) for a failure case, such as “Could not connect.” or “Please try again.” The speaker may be installed inside or outside the housing 1190. The speaker may be a super directional speaker or the like. The above-described example is an example of natural language audio output, but is not limited thereto, and predetermined short sounds such as beeps, alert tones, or music output may also be used.

### [Aerial Operation Detection Sensor]

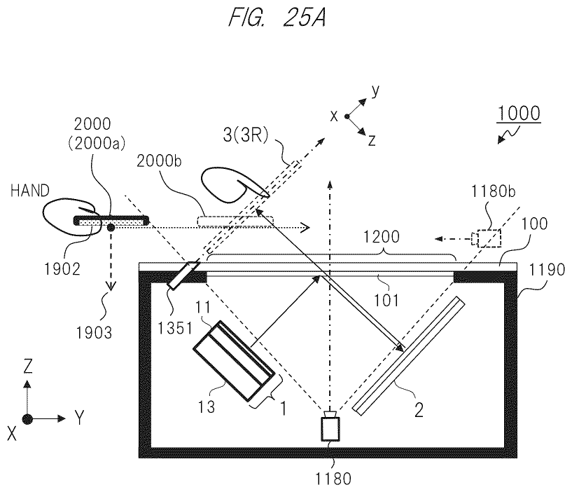

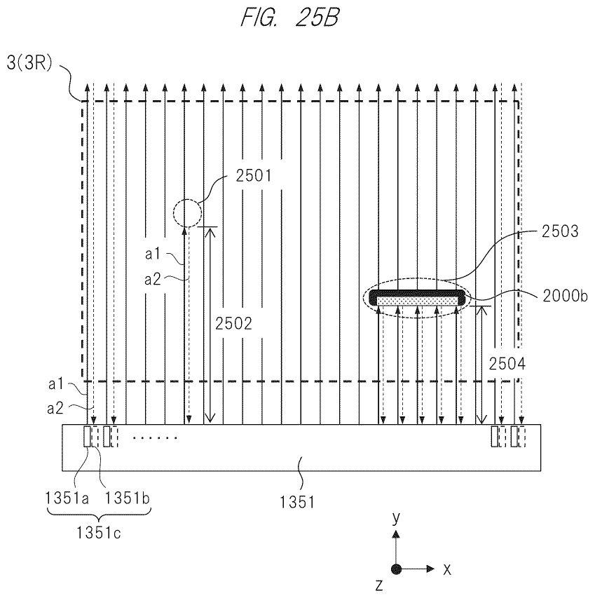

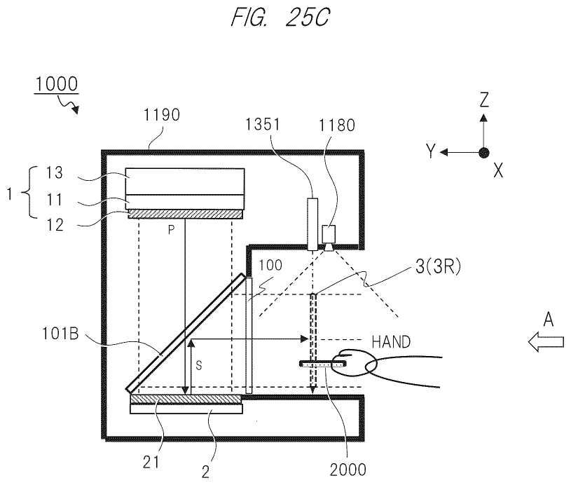

FIG. 25 (FIG. 25A, etc.) includes implementation examples of the aerial operation detection sensor 1351 and the imager 1180 (camera) as sensors in the air floating video display apparatus 1000 of the third embodiment. The aerial operation detector 1350, the controller 1110, the video controller 1160 or the like of the air floating video display apparatus 1000 of the third embodiment, particularly as shown in FIG. 3, use these sensors to determine and recognize insertion and contact operations of the mobile terminal 2000 relative to the display range 3R of the air floating video 3.

FIG. 25A is a plan view in the YZ plane showing an arrangement example of the aerial operation detection sensor 1351 and the imager 1180 (camera) in the housing 1190. The optical system configuration example in FIG. 25A is similar to that in FIGS. 4A and 18E. In the example of FIG. 25A, the aerial operation detection sensor 1351 is installed on the near side closer to the user 230 in the Y direction, near the transparent member 100 on the top surface of the housing 1190. This aerial operation detection sensor 1351 has an optical axis, indicated by a single-dotted line arrow, directed diagonally upward, or in the y direction, as shown in the drawing. This optical axis is set to overlap with the display range 3R of the air floating video 3. In addition, in the example of FIG. 25A, the imager 1180 (camera) is installed in the housing 1190 with its optical axis, indicated by the single-dotted line arrow, directed upward, or in the Z direction. An imaging range of the imager 1180 (camera) is set to include the display range 3R and the opening 1200, as indicated by dashed lines.

FIG. 25B shows a configuration example of the aerial operation detection sensor 1351. FIG. 25B shows a plan view in the XY plane aligned with the display range 3R of the air floating video 3. The aerial operation detection sensor 1351 has a plurality of optical elements 1351c arranged in the x direction (X direction in FIG. 25A). Each optical element 1351c comprises a pair of an emitting element 1351a and a receiving element 1351b. The emitting element 1351a is, for example, configured by an infrared element or the like. An emitting surface of the emitting element 1351a of the aerial operation detection sensor 1351 is assumed to coincide with the top surface of the transparent member 100 of the housing 1190 in FIG. 25A. The emitting element 1351a emits light a1 such as infrared light in the y direction. When not obstructed by an object, this light a1 passes through the display range 3R. When obstructed by an object, this light a1 is reflected by the object and returns as reflected light a2. The reflected light a2 is received by the receiving element 1351b.

For example, if there is a contact point 2501 made by a finger of the user 230 in the xy plane of the display range 3R, light a1 is reflected at the contact point 2501 and returns as reflected light a2. The receiving element 1351b at a certain x direction position detects this reflected light a2. As a result, the aerial operation detector 1350 determines that the contact point 2501 exists at that x direction position. In addition, the aerial operation detector 1350 can calculate a distance using a TOF method based on the time taken for the emitted light a1 to return as the reflected light a2. For example, the aerial operation detector 1350 can calculate a distance 2502 to the contact point 2501. As a result, position coordinates of the contact point 2501 in the xy plane of the display range 3R can be determined.

In addition, FIG. 25B shows a case where the mobile terminal 2000b is positioned in the display range 3R by the insertion and contact operations at a contact point 2503.

Similarly, the aerial operation detection sensor 1351 and the aerial operation detector 1350 can detect the position coordinates of the contact point 2503. Note that, in the example of FIG. 25A, there is nothing above the air floating video 3. However, a portion of the housing 1190 may also be provided above the air floating video 3. In such a case, light a1 from the aerial operation detection sensor 1351 is reflected by that portion of the housing 1190 and returns as reflected light a2.

The air floating video display apparatus 1000 can recognize contact with the display range 3R by the mobile terminal 2000b as the contact operation as shown in FIG. 25A using the aerial operation detection sensor 1351 and the aerial operation detector 1350. Not limited to the above-described arrangement example, the aerial operation detection sensor 1351 may be positioned above the xy plane of the display range 3R, may be positioned offset in the front-back direction, that is, the z direction or the y direction, or a plurality of aerial operation detection sensors may be positioned at a plurality of locations in the front-back direction.

In addition, in the example of FIG. 25A, when the mobile terminal 2000b is positioned in the display range 3R, the imager 1180 (camera) captures an image that includes the mobile terminal 2000b. Therefore, the video controller 1160 and the like linked to the imager 1180 can detect the mobile terminal 2000b in the captured image and determine whether the mobile terminal 2000b has contacted the display range 3R. As a result, the air floating video display apparatus 1000 can recognize contact with the display range 3R by the mobile terminal 2000b as the contact operation as shown in FIG. 25A also by using the above-described imager 1180. The air floating video display apparatus 1000 may determine and recognize the contact operation using at least one of the aerial operation detection sensor 1351 and the imager 1180 described above. Using both allows for higher accuracy in the determination and recognition.

Not limited to the example in FIG. 25A, the imager 1180 (camera) may be positioned elsewhere. For example, as shown by the dashed line as an imager 1180b, it may be positioned outside the housing 1190, at a position deeper in the Y direction, with the optical axis facing the display range 3R. The imager 1180b may capture the face of the user 230 or the like, or may detect the user 230 approaching. In addition, not limited to the aerial operation detection sensor 1351 sensing parallel to the plane of the air floating video 3 as shown in FIG. 25B, a distance sensor or a stereo camera sensing the plane from a direction perpendicular to the plane of the air floating video 3 or the like may also be used.

FIG. 25C shows another arrangement example of the aerial operation detection sensor 1351 and the imager 1180 (camera) in the housing 1190. The example in FIG. 25C shows a case where the optical system is based on FIG. 2B, with the housing 1190 vertically oriented, forming the air floating video 3 to stand in the vertical direction (Z direction). Components of the above-described optical system are mounted at the rear of the housing 1190 in the Y direction. The air floating video 3 is formed between upper and lower housing sections at the front of the housing 1190. In the present example, the aerial operation detection sensor 1351 and the imager 1180 (camera) are installed in the upper housing section. The aerial operation detection sensor 1351 faces downward such that its optical axis overlaps with the display range 3R. The imager 1180 (camera) has its imaging range set to include the display range 3R. Even with this configuration, when the mobile terminal 2000 is inserted into the display range 3R, the contact operation can be recognized using at least one of the aerial operation detection sensor 1351 and the imager 1180 (camera).

### [Distinguishing Between Hand/Fingers and Mobile Terminal]

The air floating video display apparatus 1000 may or may not distinguish between the hand or finger of the user 230 and the mobile terminal 2000 as an object contacting the air floating video 3 (display range 3R). When distinguishing between them, technical means include, for example, the following.
(1) The air floating video display apparatus 1000 may recognize the mobile terminal 2000 from communication information such as a connection request during any communication between the mobile terminal 2000 and the air floating video display apparatus 1000. When the air floating video display apparatus 1000 recognizes, via the aerial operation detection sensor 1351, that some kind of object is contacting the display range 3R, it may infer that the object is the mobile terminal 2000 if the above-described communication information is present.
(2) The air floating video display apparatus 1000 may recognize and determine that an object contacting the air floating video 3 is the mobile terminal 2000 based on an image recognition process or the like using an image or the like captured by the imager 1180 (camera), etc.
(3) The air floating video display apparatus 1000 may perform a determination to distinguish whether an object contacting the air floating video 3 is the hand/finger of the user 230 or the mobile terminal 2000 using the aerial operation detection sensor 1351 and the aerial operation detector 1350. For example, for normal aerial operation/touch operation, it may be configured to accept operation by a single finger (e.g., detection like contact point 2501 in FIG. 25B). When the mobile terminal 2000 is inserted into the display range 3R, it utilizes the fact that the area of the contact point of the mobile terminal 2000 is larger than that of a single finger and that the shape of the contact point becomes linear. The air floating video display apparatus 1000 detects and determines the area and shape of the contact point such as the contact point 2503 in FIG. 25B using the aerial operation detection sensor 1351 and the like. Based on this, it determines whether the contacting object is a hand/finger or the mobile terminal 2000.
(4) In the information exchanged between the air floating video display apparatus 1000 and the mobile terminal 2000, information representing the mobile terminal 2000 such as the QR code described below is included. By recognizing and acquiring this information, the air floating video display apparatus 1000 distinguishes whether the object contacting the air floating video 3 is the hand/finger of the user 230 or the mobile terminal 2000.

### [Application and Screen of Mobile Terminal]

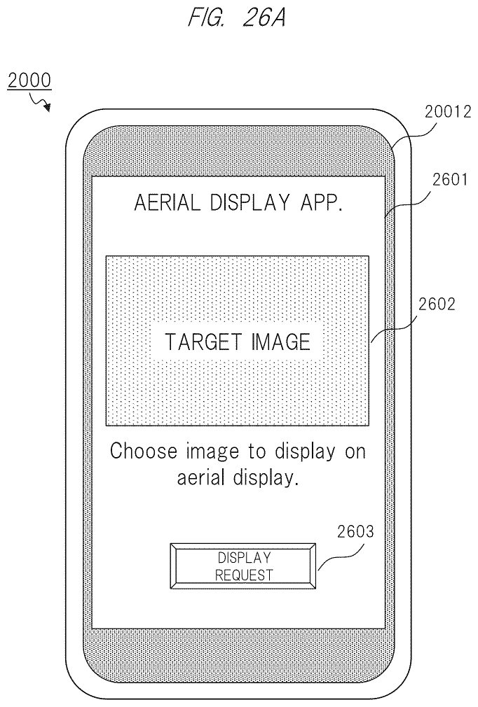

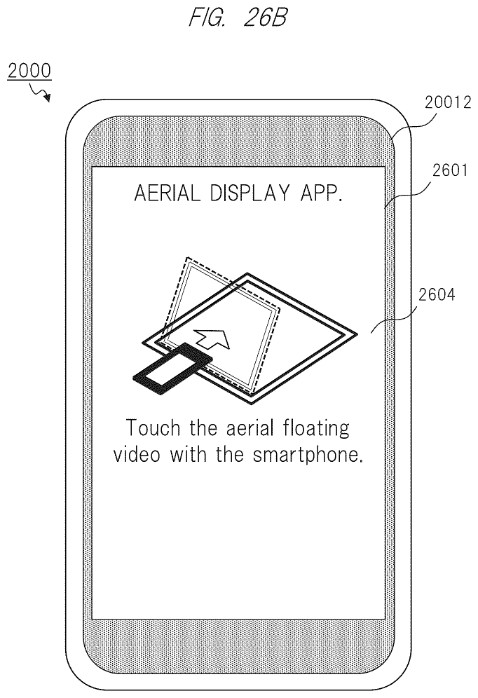

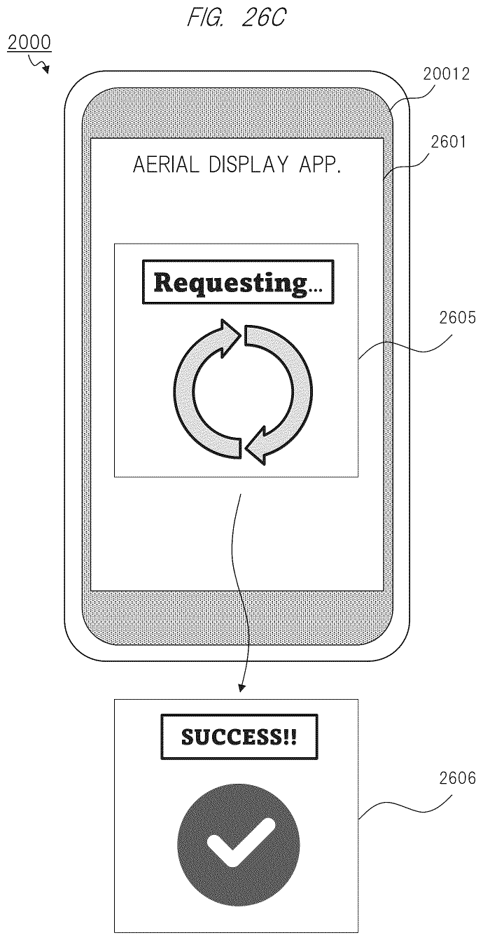

FIG. 26A shows a display example of a screen on the display 20012 by the application 2010 or the like on the mobile terminal 2000 in the third embodiment. Based on the input operation by the user 230, the mobile terminal 2000 displays an application screen 2601 on the screen of the display 20012 through processing by an OS, the application 2010, or the like. In the present example, the application 2010 is a dedicated application that coordinates with the air floating video display apparatus 1000 to enable the user 230 to conveniently utilize the various functions of the air floating video display apparatus 1000.

The application screen 2601 in FIG. 26A has a GUI prompting the user 230 to specify the image 2020 (target image) to be displayed as the air floating video 3 on the air floating video display apparatus 1000. For example, a message such as “Please specify the image to display on the aerial display” is displayed. The user 230 selects the image 2020 (FIG. 15) to be displayed on the aerial display from images stored in the mobile terminal 2000. The selected image is previewed as display target image 2602. After confirming the display target image 2602, the user 230 presses a display request button 2603. As a result, the mobile terminal 2000 transmits the display request 2030 to the air floating video display apparatus 1000 via short-range wireless communication or the like, using the display target image 2602 as the target image.

FIG. 26B is a modification related to the display of the guide image described in the preceding FIG. 21A, showing an example where the guide image is displayed on the screen of the mobile terminal 2000. The application screen 2601 in FIG. 26B displays a guide image 2604 to prompt the user 230 to perform the contact operation. The guide image 2604 displays, for example, a message such as “Touch aerial floating video with the smartphone.” along with an image representing the action of inserting and contacting the mobile terminal 2000 with the display range 3R.

FIG. 26C is a modification related to the display of the guide image in the above-described FIG. 23A and the display of the guide image in FIG. 24A, showing an example of displaying a guide image on the screen of the mobile terminal 2000. In FIG. 26C, depending on the situation, a guide image such as a guide image 2605 informing the user 230 that the display request 2030 is in progress, or a guide image 2606 informing the user that the display request 2030 has been received successfully is displayed on the application screen 2601.

In the third embodiment, one method involves the following. That is, as described above, during the contact operation, the user 230 specifies the target image 2020 on the screen of the application 2010 of the mobile terminal 2000 and presses the display request button 2603, causing the mobile terminal 2000 to transmit the display request 2030. Subsequently, the user 230 inserts the mobile terminal 2000 into the display range 3R.

Not limited to this, in other embodiments, the operation of the user 230 may be minimized. For example, the user 230 may display a desired target image on the screen of the mobile terminal 2000 and insert the mobile terminal 2000 into the display range 3R in that state. The air floating video display apparatus 1000 determines and recognizes the contact operation and, if successful, generates the display request 2030. The air floating video display apparatus 1000 communicates with the mobile terminal 2000 to acquire the target image corresponding to the display request 2030 and displays it as the air floating video 3. This target image is the image displayed on the screen of the mobile terminal 2000 at that time.

### [Displaying Target Image in Air Floating Video]

The video controller 1160 (FIG. 3) of the air floating video display apparatus 1000 generates image data for display on the screen of the display apparatus 1 (liquid crystal display panel 11) based on the image data of the target image. This image data is, for example, two-dimensional image data generated by processing the two-dimensional image data when the target image is two-dimensional image data. In addition, when the target image is three-dimensional image data (such as a three-dimensional model), two-dimensional image data is generated from that three-dimensional image data through rendering in a virtual three-dimensional space, etc.

Through the above-described function as shown in, for example, FIG. 16, the target image 1601 (e.g., character image) displayed and specified by the user 230 on the mobile terminal 2000 can be displayed as the image 1602, as the air floating video 3, in response to the contact operation and the display request 2030. As a result, the user 230 can enjoy viewing the desired target image 1601 as the image 1602 of the air floating video 3.

Thereafter, the method for canceling the display of the target image in the air floating video 3 is not particularly limited. For example, it may be automatically canceled after a predetermined period of time has elapsed since the display of the target image began. In addition, a display cancel button or the like may be provided on the air floating video 3 or on the screen of the mobile terminal 2000. The display cancel button or the like may also be provided on the housing 1190.

As described above, the air floating video display system of the third embodiment can provide services to the user 230, such as viewing the desired image displayed as the air floating video 3 by linking with the mobile terminal 2000.

Note that the data and information exchanged between the mobile terminal 2000 and the air floating video display apparatus 1000 is not limited to only the display target image. It is also possible to exchange, along with the display target image, some management or control data and information such as user information.

As a modification, it is similarly possible to pre-display a background image or the character image as the air floating video 3. From this state, the target image can be superimposed and displayed on top of the background image or the like by the contact operation of the mobile terminal 2000 by the user 230 and the display request 2030.

In the third embodiment, when the mobile terminal 2000 contacts the air floating video 3, it is set to receive the display request 2030 as a success and display the target image. However, this is not limited thereto. In a modification, it may be considered a success when the user 230 inserts the mobile terminal 2000 into the air floating video 3 to make contact, and then the mobile terminal 2000 passes through the air floating video 3 and enters the space behind it, resulting in a state where it is not in contact with the display range 3R (e.g., FIG. 19E).

Additionally, the following modification is also possible. The function in this modification is to acquire the image displayed as the air floating video 3 on the mobile terminal 2000 side. The air floating video display apparatus 1000 pre-displays the character image or the like on the air floating video 3 (e.g., similar to (3) in FIG. 16). When the user 230 wishes to acquire the image displayed as the air floating video 3 to the mobile terminal 2000, he/she performs the contact operation on the air floating video 3 with the mobile terminal 2000 as described above. Upon successful contact operation, the air floating video display apparatus 1000 transmits the image displayed as the air floating video 3 (or its corresponding image data) to the mobile terminal 2000. As a result, the user 230 can acquire and display the image on the mobile terminal 2000 for viewing enjoyment (e.g., as shown in (1) of FIG. 16).

In the third embodiment, the function was implemented such that after displaying the target image by contacting the air floating video 3 with the mobile terminal 2000, the display of the target image continues even when the mobile terminal 2000 is no longer in contact with the air floating video 3. However, this is not limited thereto. In a modification, the function may be configured to display the target image only while the mobile terminal 2000 remains in contact with the air floating video 3.

The air floating video display apparatus 1000 recognizes when the mobile terminal 2000 moves away from the display range 3R and then cancels the display of the target image on the air floating video 3.

### Fourth Embodiment

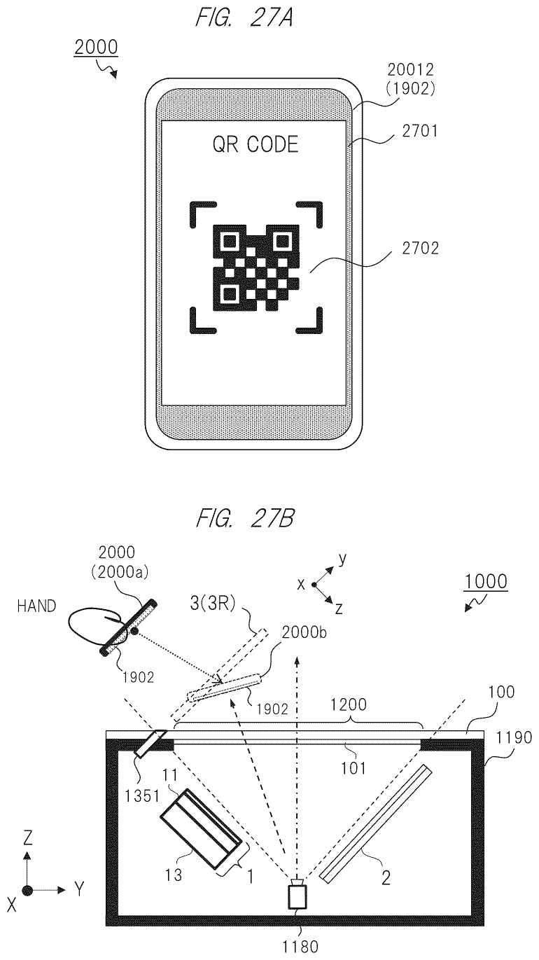

Next, another embodiment (fourth embodiment) using a QR code (two-dimensional code) will be described with reference to using FIG. 27A and subsequent figures. The fourth embodiment is a modification of the third embodiment. The mobile terminal 2000 has a function to display a QR code on the screen of the display 20012 as appropriate. This QR code may, for example, represent the above-described display request 2030.

In the fourth embodiment, when the display request 2030 is sent from the mobile terminal 2000 to the air floating video display apparatus 1000, the following operations/actions may be performed to allow the mobile terminal 2000 to recognize the air floating video display apparatus 1000, or to allow the air floating video display apparatus 1000 to recognize the mobile terminal 2000. The user 230 performs an operation from the application 2010 or the like on the mobile terminal 2000 side to indicate intent to coordinate or connect with the air floating video display apparatus 1000 and to issue the display request 2030 (e.g., similar to FIG. 26A, etc.). Subsequently, the user 230 performs the contact operation to insert the mobile terminal 2000 into the display range 3R. Alternatively, for example, the user 230 may display a QR code or the like on the screen of the mobile terminal 2000 before insertion, and then may perform the contact operation to insert into the display range 3R in an attitude that allows the imager 1180 (camera) of the air floating video display apparatus 1000 to read the QR code or the like from the mobile terminal 2000.

FIG. 27A shows an example where the mobile terminal 2000 displays a QR code screen 2701 on the screen 1902 of the display 20012 based on the input operation by the user 230, and displays image information such as the QR code 2702 on the QR code screen 2701.

FIG. 27B is a plan view in the YZ plane showing an example where the user 230 displays the QR code on the screen 1902 using a mobile terminal 2000a at a position before insertion into the display range 3R (FIG. 27A), then inserts the mobile terminal 2000a into the display range 3R from that position, resulting in the state of the mobile terminal 2000b at the point of contact. In this state, the mobile terminal 2000b has its screen 1902 facing downward, and is in the imaging range of the imager 1180 (camera). Therefore, the air floating video display apparatus 1000 can detect the mobile terminal 2000b from the captured image and can also detect the QR code 2702 displayed on the screen 1902. The air floating video display apparatus 1000 recognizes that QR code and extracts the data/information described in it. For example, the air floating video display apparatus 1000 acquires the display request 2030 from that QR code.

The air floating video display apparatus 1000 recognizes the contact of the mobile terminal 2000b with the display range 3R via the aerial operation detection sensor 1351 or the imager 1180, and acquires the display request 2030 from the QR code of the mobile terminal 2000b. Based on the success of these operations, the air floating video display apparatus 1000 displays the target image corresponding to the display request 2030 as the air floating video 3.

Note that, in FIG. 27B, the mobile terminal 2000b is in contact with the display range 3R. However, this is not limited thereto. As described above, the mobile terminal 2000 may enter beyond the display range 3R after contacting it and switch to a non-contact state. The attitude of the mobile terminal 2000 need only be such that the QR code on the screen 1902 can be detected by the imager 1180 (camera). For example, in the case of the imager 1180b shown in FIG. 25A, the attitude of the mobile terminal 2000 may be such that screen 1902 faces the rear side in the Y direction (e.g., similar to FIG. 19E).

In the fourth embodiment, the condition for recognizing the QR code is added to the predetermined contact operation determination condition of the third embodiment as described above. In other words, in the fourth embodiment, the air floating video display apparatus 1000 receives and authorizes the display request 2030 and displays the target image on the air floating video 3 only when an AND condition is satisfied. The AND condition is a condition in which a predetermined contact operation is detected and a QR code is recognized.

In the fourth embodiment (FIG. 27B), the user 230 may insert the mobile terminal 2000 into the display range 3R in a horizontal direction parallel to the top surface of the housing 1190, with the screen 1902 facing downward (similar to FIG. 19E). In a modification, after inserting the mobile terminal 2000 into the display range 3R with the screen 1902 facing downward, the user 230 may place the screen 1902 in contact with the top surface of the transparent member 100 of the housing 1190. QR codes remain recognizable in these cases as well.

### [QR Code]

The data/information described in the above-described QR code/barcode or the like is not limited to the example of the above-described display request 2030, and may include, for example, the following. These data/information may be used in combination.
(1) Connection Information: Information for establishing a communicative connection between the mobile terminal 2000 and the air floating video display apparatus 1000 within the communication network of FIG. 15. Examples include IP address, ID, and password information. The communication network here refers to the Internet 3010, LAN 3020, or the like, or may be direct communication between the mobile terminal 2000 and the air floating video display apparatus 1000.
(2) Terminal ID/User ID: Information such as the ID of the mobile terminal 2000. Alternatively, information such as the ID of the user 230.
(3) Image ID: Information such as the ID or URL of the target image that the user 230 wishes to display.

When the above-described connection information is represented as a QR code, the mobile terminal 2000 indicates the connection information to the air floating video display apparatus 1000 by presenting the QR code. A wireless connection is then established between the communication unit 20020 of the mobile terminal 2000 and the communication unit 1132 of the air floating video display apparatus 1000 using that connection information.

When the terminal ID/user ID or the like is used as the QR code, the air floating video display apparatus 1000 can recognize a specific mobile terminal 2000/user 230. The air floating video display apparatus 1000 may be configured to authorize only the specific mobile terminal 2000/user 230 corresponding to the specific terminal ID/user ID as the target for providing the services of this function.

When the above-described image ID is a QR code, the target image can be any image, not limited to those stored on the mobile terminal 2000.

As described above, the air floating video display system of the fourth embodiment enables the use of the QR code to define a predetermined contact operation between the mobile terminal 2000 and the air floating video display apparatus 1000, while also allowing various controls using the QR code.

Note that, even in a form such as the third embodiment that does not use a OR code, the above-described data and information may be exchanged and used between the mobile terminal 2000 and the air floating video display apparatus 1000 together with the display request 2030.

As a modification of the fourth embodiment, the air floating video display apparatus 1000 may transmit the information of the above-described QR code to a nearby mobile terminal 2000, and the mobile terminal 2000 that receives this information may then display the QR code.

In the third and fourth embodiments, data of the target image to be displayed on the air floating video 3 is pre-stored in the mobile terminal 2000, but this is not limited thereto. In the modification, the data of the target image may be stored on the air floating video display apparatus 1000 side, and the user 230 or the mobile terminal 2000 side may select/specify the target image and issue the display request 2030. In another modification, the data for the target image may be stored on a server or similar device on a communication network, with the user 230 or the mobile terminal 2000 selecting and specifying the target image and issuing the display request 2030.

As another modification of the fourth embodiment, the air floating video display apparatus 1000 may display the information of the QR code on the air floating video 3, and the user 230 may recognize the information of the QR code displayed as the air floating video 3 using the camera of the mobile terminal 2000.

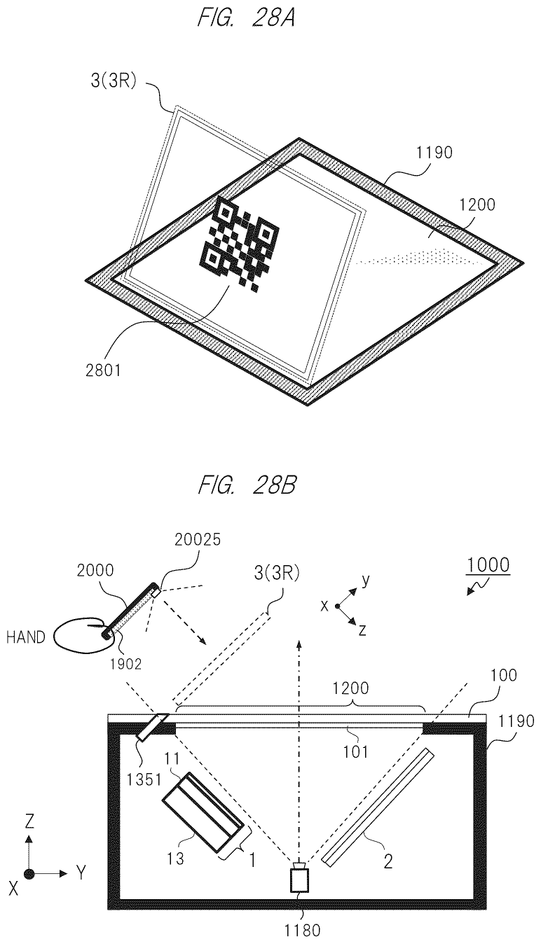

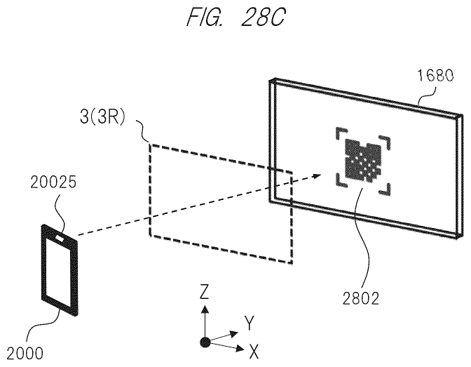

FIG. 28 (FIG. 28A) shows such a modification. FIG. 28A shows an example where the air floating video display apparatus 1000 displays a QR code 2801 as the air floating video 3. FIG. 28B is a plan view in the YZ plane showing an example where the mobile terminal 2000 captures and reads the QR code 2801 of the air floating video 3 in FIG. 28A using the camera of the imager 20025, for example, the rear camera. The mobile terminal 2000 obtains predetermined information from the recognized QR code 2801. After recognizing the QR code 2801, the user 230 brings the mobile terminal 2000 into contact with the display range 3R.

FIG. 28C shows a further modification, showing an example of displaying the QR code 2802 on the screen of the second display apparatus 1680 of the air floating video display apparatus 1000. The air floating video display apparatus 1000 displays the QR code 2802 on the screen of the second display apparatus 1680 using the second display apparatus 1680 positioned to overlap with the air floating video 3 from the rear, for example, as shown in FIG. 4M. In addition, the air floating video display apparatus 1000 may display the QR code on the screen of the transmissive self-luminous video display apparatus 1650 as shown in FIG. 4L.

The user 230 captures the QR code 2802 displayed on the screen of the second display apparatus 1680 using the camera of the imager 20025 of the mobile terminal 2000. The mobile terminal 2000 recognizes the QR code and obtains information. After recognizing the QR code 2802, the user 230 brings the mobile terminal 2000 into contact with the display range 3R.

### Fifth Embodiment

As a fifth embodiment of the present invention, a configuration example of an air floating video display apparatus is described. The air floating video display apparatus of the fifth embodiment can similarly adopt the configurations of the first to fourth embodiments as its basic configuration. In addition, the fifth embodiment can be a system (air floating video display system) having an air floating video display apparatus and an external device connected to the apparatus, similar to the third and fourth embodiments. The external device includes, for example, a mobile terminal (mobile information processing terminal device) such as a smartphone, a tablet device, or a wearable device (e.g., smartwatch) of the user.

### Issues and Solutions Regarding the Fifth Embodiment

One issue is that while the air floating video display apparatus 1000 includes various sensors such as the aerial operation detection sensor 1351 and the attitude sensor 1113 (FIG. 3), the mobile terminal 2000 may also possess similar sensors (touch sensors, attitude sensors). As in the third and fourth embodiments, when the mobile terminal 2000 is communicatively connected to the air floating video display apparatus 1000, various possibilities exist regarding which apparatus' operation and detection (sensors) should be enabled or used. If it is unclear which apparatus' operation and detection should be enabled, this could potentially lead to undesirable operation or effect depending on the application, function, or situation. Therefore, it is necessary to clearly define which apparatus' operation and detection should be enabled based on the application, function, or situation.

Therefore, the air floating video display system and display method of the fifth embodiment have the following features. The system of the fifth embodiment utilizes both sensors: one for detecting the user operation on the mobile terminal 2000 side and one for detecting the user operation on the air floating video display apparatus 1000 side. This system handles the sensor for detecting the touch operation and the rotation operation on the image displayed on the screen of the mobile terminal 2000, and the sensor for detecting the touch operation and the rotation operation on the image displayed on the air floating video 3 of the air floating video display apparatus 1000. This system selects, sets, and controls which apparatus' sensors are enabled or disabled when the image or video is displayed on both the mobile terminal 2000 screen and the air floating video 3 side (dual display described below).

### Example 1 of Problem and Solution

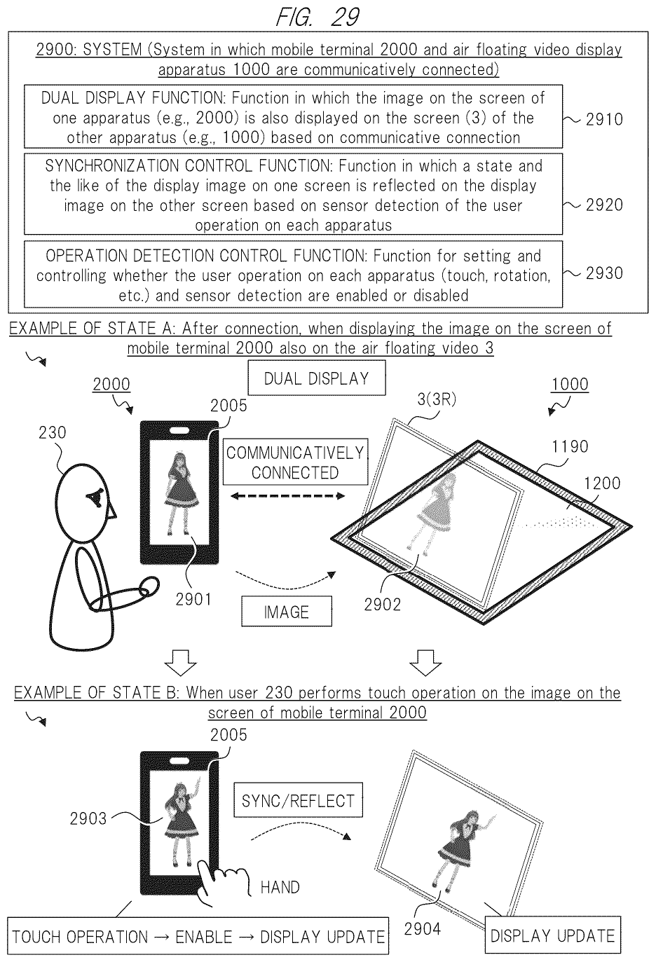

FIG. 37 shows Example 1 of a problem and its solution. First, assume an image 3701 (e.g., image B) is displayed on a screen 2005 of the mobile terminal 2000. Based on this image B, the same image 3702 (e.g., image B) is also displayed on the air floating video 3 which is the screen of the air floating video display apparatus 1000 (dual display function 2910 in FIG. 29). One challenge is that, in this state, it is ambiguous in conventional systems what happens to these two images 3701 and 3702 when the user 230 performs a touch operation on, for example, the image B on the screen 2005 of the mobile terminal 2000.

In the present embodiment, one solution is implemented as follows. This system performs synchronization so that, in response to detecting an operation such as a touch operation on the image 3701 (image B) displayed on the screen 2005 of the mobile terminal 2000, a predetermined processing corresponding to that image 3701 such as the display update is performed, and this display update is also reflected in the image 3702 (image B) on the air floating video 3 side (synchronization control function 2920 in FIG. 29). The image B on the mobile terminal 2000 side changes from the image B to an image Bb as the display update, and the image B on the air floating video 3 side changes from the image B to the image Bb as the display update.

Conversely, as shown at the bottom of FIG. 37, when a touch operation is performed on the image 3702 (image B) on the air floating video 3 side, the system does not perform the display update or the like on the image 3702 and does not reflect it on the image 3701 (image B) on the mobile terminal 2000 side. In other words, synchronization is not performed on the mobile terminal 2000 side.

This type of synchronization control is performed based on a setting that enables detection of the touch operation on the mobile terminal 2000 side and disables detection of the touch operation on the air floating video 3 side (operation detection control function 2930 in FIG. 29). The system configures such settings regarding a post-connection state when the two apparatuses establish a communicative connection. Each apparatus controls operation, detection, and display according to its post-connection settings. As a result, the operational effect shown in FIG. 37 is realized.

### Example 2 of Problem and Solution

FIG. 38 shows Example 2 of a problem and its solution. In the example of FIG. 38, assume an image 3802 (image A) is displayed on the air floating video 3 which is the screen of the air floating video display apparatus 1000. Based on this image A, the same image 3801 (image A) is also displayed on the screen of the mobile terminal 2000 (dual display function 2910 in FIG. 29). One challenge is that, in this state, it is ambiguous in conventional systems what happens to these two images 3801 and 3802 when the user 230 performs the touch operation on, for example, the image A of the air floating video 3.

In the present embodiment, one solution is implemented as follows. This system performs synchronization so that, in response to detecting an operation such as the touch operation on the image 3802 (image A) displayed on the air floating video 3, a predetermined processing corresponding to that image 3802 such as the display update is performed, and this display update is also reflected in the image 3801 (image A) on the mobile terminal 2000 side (synchronization control function 2920 in FIG. 29). The image A on the air floating video 3 side changes to an image Ab as the display update, and the image A on the mobile terminal 2000 side changes to the image Ab as the display update.

Conversely, as shown at the bottom of FIG. 38, when the touch operation is performed on the image 3801 (image A) on the mobile terminal 2000 side, the system does not perform the display update or the like on the image 3801 and does not reflect it on the image 3802 (image A) on the air floating video 3 side.

This type of synchronization control is performed based on a setting that disables detection of the touch operation on the mobile terminal 2000 side and enables detection of the touch operation on the air floating video 3 side (operation detection control function 2930 in FIG. 29). The system configures such settings regarding a post-connection state when the two apparatuses establish a communicative connection. Each apparatus controls operation, detection, and display according to its post-connection settings. As a result, the operational effect shown in FIG. 38 is realized.

### Example 3 of Problem and Solution

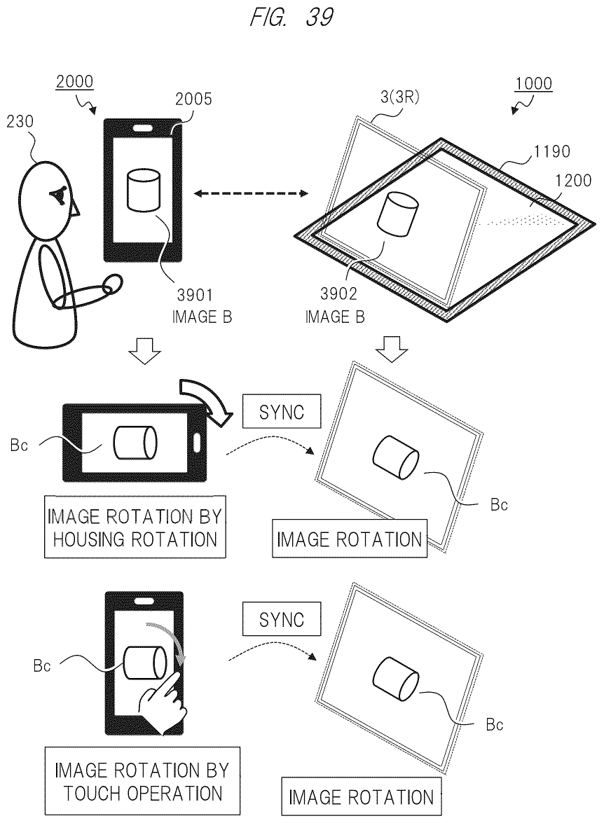

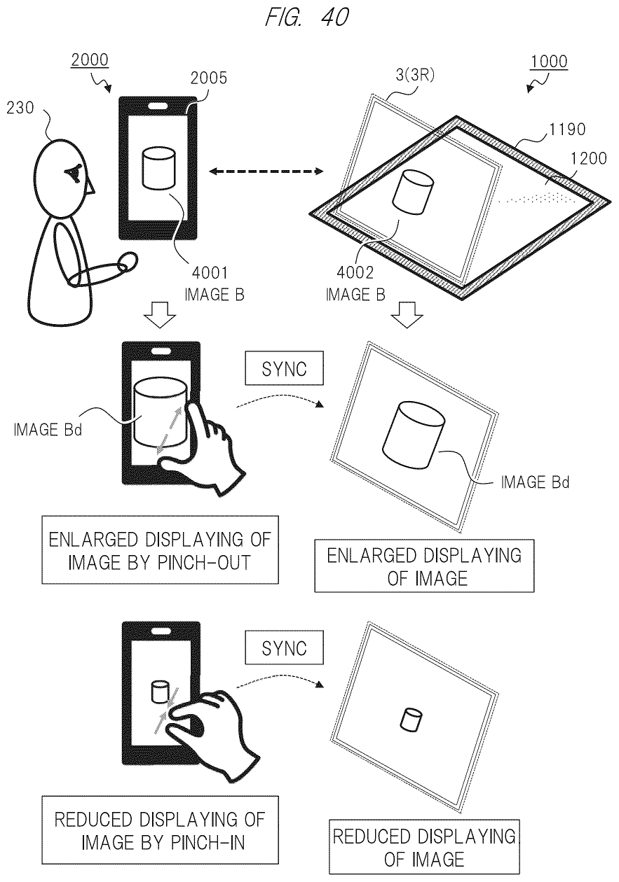

FIG. 39 shows an Example 3 of a problem and its solution. In the example of FIG. 39, assume an image 3901 (image B) is displayed on the screen 2005 of the mobile terminal 2000, as in FIG. 37. Based on this image B, the same image 3902 (e.g., image B) is also displayed on the air floating video 3 which is the screen of the air floating video display apparatus 1000 (dual display function 2910 in FIG. 29). One challenge is that, in this state, it is ambiguous in conventional systems what happens to these two images 3901 and 3902 when the user 230 performs a rotation operation on the image B on the screen 2005 of the mobile terminal 2000.

In the present embodiment, one solution is implemented as follows. This system detects the rotation operation on the image 3901 (image B) displayed on the screen 2005 of the mobile terminal 2000 such as rotation of the image 3901 caused by rotating the housing. The image B visible to the user 230 on the screen 2005 is now, for example, an image Bc rotated by 90 degrees. In response to this detection, the system performs synchronization (synchronization control function 2920 in FIG. 29) so that this image rotation is reflected in the image 3902 (image B) on the air floating video 3 side to reflect. The image B of the air floating video 3 from the perspective of the user 230 is now image Bc rotated by 90 degrees.

Alternatively, as shown at the bottom of FIG. 39, the system detects the image rotation by, for example, the touch operation performed on image 3901 (image B) displayed on the screen 2005 of the mobile terminal 2000. The image B on the screen 2005 from the perspective of the user 230 is, for example, the image Bc rotated by 90 degrees. In response to this detection, the system performs synchronization (synchronization control function 2920 in FIG. 29) so that the image rotation is also reflected in the image 3902 (image B) on the air floating video 3 side.

This type of synchronization control is performed based on a setting that enables detection of the rotation operation and image rotation on the mobile terminal 2000 side and disables detection of the rotation operation and image rotation on the air floating video 3 side (operation detection control function 2930 in FIG. 29). The system configures such settings regarding the post-connection state when the two apparatuses establish a communicative connection. Each apparatus controls operation, detection, and display according to its post-connection settings. As a result, the operational effect shown in FIG. 39 is realized.

### Example 4 of Problem and Solution

FIG. 40 shows Example 4 of a problem and its solution. In the example of FIG. 40, assume an image 4001 (image B) is displayed on the screen 2005 of the mobile terminal 2000, as in FIG. 39. Based on this image B, the same image 4002 (e.g., image B) is also displayed on the air floating video 3 which is the screen of the air floating video display apparatus 1000 (dual display function 2910 in FIG. 29). One challenge is that, in this state, it is ambiguous in conventional systems what happens to these two images 4001 and 4002 when the user 230 performs a scaling operation (particularly a pinch operation) via the touch operation on the image B on the screen 2005 of the mobile terminal 2000.

In the present embodiment, one solution is implemented as follows. This system detects the touch operation such as a pinch-out operation on the image 4001 (image B) on the screen 2005 of the mobile terminal 2000, and performs an enlarged displaying of the image 4001 corresponding to the pinch-out operation. The image B becomes an enlarged image Bd. In response to this detection, the system performs synchronization (synchronization control function 2920 in FIG. 29) so that this enlarged displaying is also reflected in the image 4002 (image B) on the air floating video side 3. As shown at the bottom of FIG. 40, the same applies when a pinch-in operation is performed for reduced displaying.

This type of synchronization control is performed based on a setting that enables detection of the touch operation and scaling display on the mobile terminal 2000 side and disables detection of the touch operation and scaling display on the air floating video 3 side (operation detection control function 2930 in FIG. 29). The system configures such settings regarding the post-connection state when the two apparatuses establish a communicative connection. Each apparatus controls operation, detection, and display according to its post-connection settings. As a result, the operational effect shown in FIG. 40 is realized.

As described in the above examples, when the mobile terminal 2000 and the air floating video display apparatus 1000 are connected, the target image/video may be displayed on both the screen of the mobile terminal 2000 and the screen of the air floating video display apparatus 1000 (air floating video 3) (dual display). In this case, the user 230 may perform the touch operation or the like on the display image on the mobile terminal 2000 side or on the display image on the air floating video 3 side. When a user operation is performed on one device, it was previously unclear whether that operation should be reflected in the display image of the device where the operation was not performed, and various possibilities existed for handling such a situation. After establishing a communicative connection, particularly in the dual display state, it is necessary to appropriately set and control the operation and detection of hardware and software on one or both apparatuses, that is, operation and detection on the mobile terminal 2000 side and on the air floating video 3 side. By appropriately setting and controlling these aspects according to the request by the user 230, a clear user operation and a corresponding response (display control processing) can be realized for both the display image on the mobile terminal 2000 side and the display image on the air floating video 3 side. For example, by setting the mobile terminal 2000 side as enabled and the air floating video 3 side as disabled, when the user 230 rotates the display image on the mobile terminal 2000 side as shown in FIG. 39, the display image on the air floating video 3 side can be rotated synchronously in response to that operation. This clarifies the user operation and enhances convenience for the user 230.

As described above, in the state after communicative connection, during certain time periods or modes, only operation detection on the mobile terminal 2000 side is enabled, and during other time periods or modes, only operation detection on the air floating video display apparatus 1000 side is enabled. Each mode implements predetermined functions. When operation detection is enabled on one device, it prevents unnecessary operation detection on the other device. Depending on the predetermined mode, operation detection may be enabled on both devices.

In addition, when the communicative connection between the mobile terminal 2000 and the air floating video display apparatus 1000 is disconnected, the system restores the settings related to operation detection for each apparatus to their pre-connection state, that is, the normal settings.

### [Air Floating Video Display System and Display Method]

FIG. 29 is an explanatory diagram of the air floating video display system and display method in the fifth embodiment. A system 2900 in FIG. 29 is an air floating video display system where the air floating video display apparatus 1000 and the mobile terminal 2000 are communicatively connected. An overview of the fifth embodiment will be described with reference to FIG. 29.

State A indicates a case where, after the communicative connection between the air floating video display apparatus 1000 and the mobile terminal 2000, the image 2901 on the screen 2005 of the mobile terminal 2000 is also displayed as an image 2902 on the air floating video 3 (display range 3R) of the air floating video display apparatus 1000. State A is a dual display state where the image 2901 on the mobile terminal 2000 side and the image 2902 on the air floating video 3 side are displayed simultaneously. This dual display is a state where the images 2901 and 2902 on the screens of each apparatus are displayed based on the same image data.

State B shows a transition from state A, for example, when the user 230 performs the touch operation on the image 2901 displayed on the screen 2005 of the mobile terminal 2000. In the example of FIG. 29, the system is configured with post-connection settings (modes described below) that enables operation detection on the mobile terminal 2000 side and disables operation detection on the air floating video 3 side. The image 2901 is an object that accepts the touch operation, and a predetermined processing corresponding to this image 2901 such as display update is executed. In the present example, the touch operation and detection on the image 2901 are determined as enabled, and thus, the display update causes the image 2901 to change to an image 2903.

Next, based on the detection of the touch operation on image 2901 on the mobile terminal 2000 side and the display update, the system communicates with the air floating video display apparatus 1000 side, and as the synchronization control, it reflects the processing corresponding to the touch operation on the image 2903 on the air floating video 3. That is, as a result of the touch operation, the display update is also performed on the image 2902 on the air floating video 3 side. Through this display update, the image 2902 changes to an image 2904. In this manner, when the mobile terminal 2000 side is set as enabled, if the user 230 performs a user operation on the mobile terminal 2000 side, that user operation can also be reflected in the air floating video 3 side.

On the other hand, if the user 230 performs the touch operation on the image 2902 displayed on the air floating video 3 side, since operation detection on the air floating video 3 side is set as disabled, the system does not reflect this touch operation on either image 2902 on the air floating video 3 side or image 2901 on the mobile terminal 2000 side. As a result, no display update occurs, so the image 2902 on the air floating video 3 side and the image 2901 on the mobile terminal 2000 side remain unchanged.

The system 2900 in FIG. 29 includes the dual display function 2910, the synchronization control function 2920, and the operation detection control function 2930 as functions for performing the above-described settings and controls.

The dual display function 2910 is a function that, depending on the communicative connection, displays the image/video displayed on the screen formed by the air floating video 3 of the air floating video display apparatus 1000 onto the screen of the mobile terminal 2000, and/or displays the image/video displayed on the screen of the mobile terminal 2000 onto the screen formed by the air floating video 3 of the air floating video display apparatus 1000. The synchronization control function 2920 synchronizes the display images on the screen of each apparatus via dual display such that when the user 230 performs an operation such as the touch operation on the screen of one device, a predetermined processing (in other words, display control processing, system processing) executed in response to that operation is also reflected in the display image of the screen of the other device via communication. Note that the synchronization control function 2920 may be integrated and considered as part of the dual display function 2910.

Furthermore, the operation detection control function 2930 is a function that sets and controls whether to enable or disable, on either or both sides, the operation/detection/display control on the air floating video display apparatus 1000 side and the operation/detection/display control on the mobile terminal 2000 side, with respect to the touch operation or other operations on the display image on the screen of each apparatus and the predetermined processing executed in response to those operations.

### [Dual Display Function]

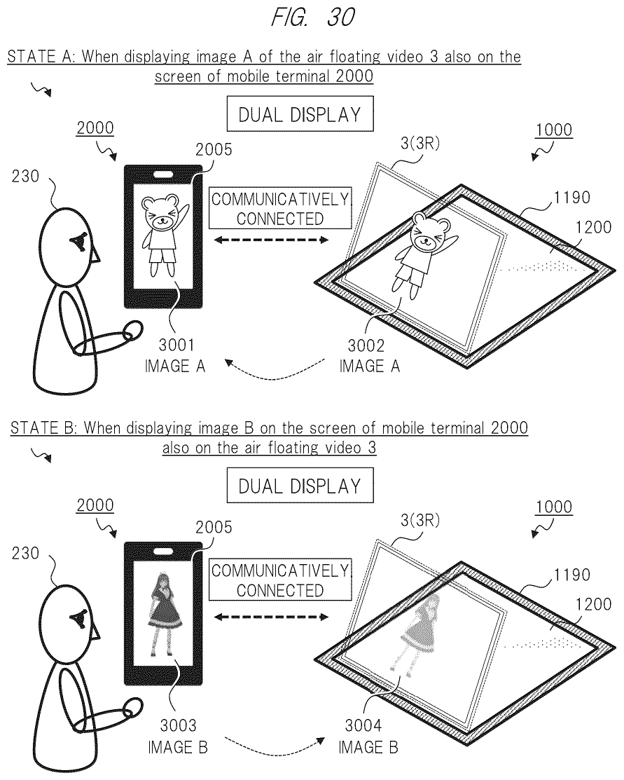

FIG. 30 is an explanatory diagram regarding the dual display function 2910 of FIG. 29. State A shows Example 1 of dual display, where the image A displayed on the air floating video 3 of the air floating video display apparatus 1000 is also displayed as the image A on the screen 2005 of the mobile terminal 2000. Initially, the image A is displayed as an image 3002 on the air floating video 3 of the air floating video display apparatus 1000. The user 230 communicatively connects the mobile terminal 2000 to the air floating video display apparatus 1000. The air floating video display apparatus 1000 transmits image data corresponding to the image A to the mobile terminal 2000 via communication. The mobile terminal 2000 acquires the image data corresponding to the image A from the air floating video display apparatus 1000 via communication and displays the image A as an image 3001 on the screen 2005. The user 230 can view the image A of the air floating video 3 and can also view the corresponding image A on the screen 2005 of the mobile terminal 2000.

State B shows Example 2 of dual display, where the image B displayed on the screen 2005 of the mobile terminal 2000 is also displayed as the image B on the air floating video 3 of air floating video display apparatus 1000. Initially, the image B is displayed as an image 3003 on the screen 2005 of the mobile terminal 2000. The user 230 communicatively connects the mobile terminal 2000 to the air floating video display apparatus 1000. The mobile terminal 2000 transmits image data corresponding to the image B to the air floating video display apparatus 1000 via communication. The air floating video display apparatus 1000 acquires the image data corresponding to the image B from the mobile terminal 2000 and displays the image B as an image 3004 on the air floating video 3. The user 230 can view the image B on the screen 2005 of the mobile terminal 2000 and can also view the corresponding image B of the air floating video 3.

### [Modification Concerning Acquisition of Image Data]

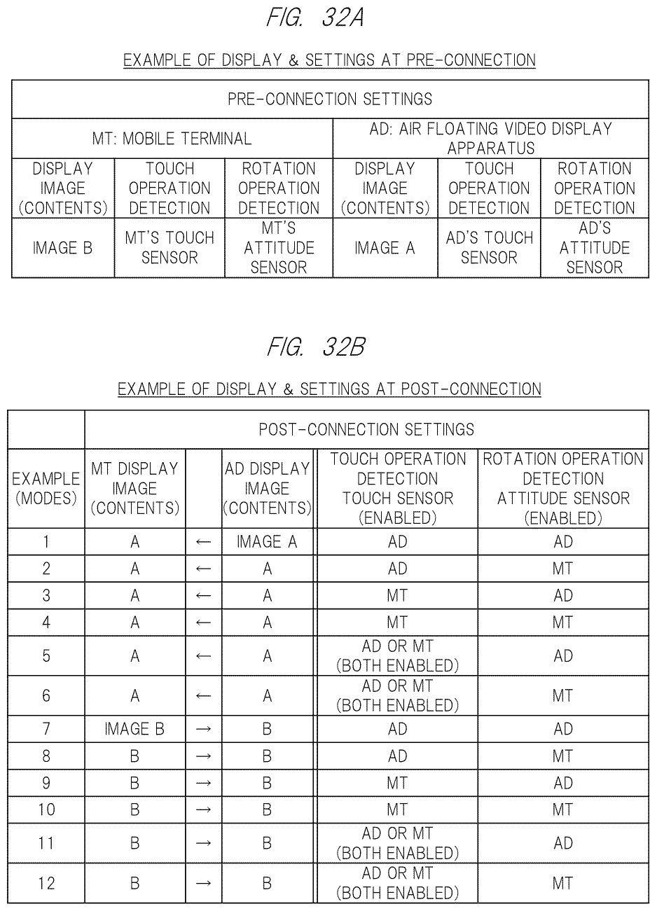

As shown in FIG. 30 or the FIG. 32B described below, the transmission of target image data is not limited to being in the direction from the air floating video display apparatus 1000 to the mobile terminal 2000, or vice versa. In a modification, for example, the air floating video display apparatus 1000 transmits ID information for the target image to the mobile terminal 2000. The mobile terminal 2000 identifies the target image data held in its memory based on the received ID information and displays the target image on the screen 2005 based on the identified image data. Alternatively, the mobile terminal 2000 may reference an external server or the like based on the received ID information (which may also be a URL or the like), identify the target image data held on that external server or the like, acquire the identified image data from that external server or the like, and display the target image on the screen 2005 based on that image data.

### [Basic Control Flow]

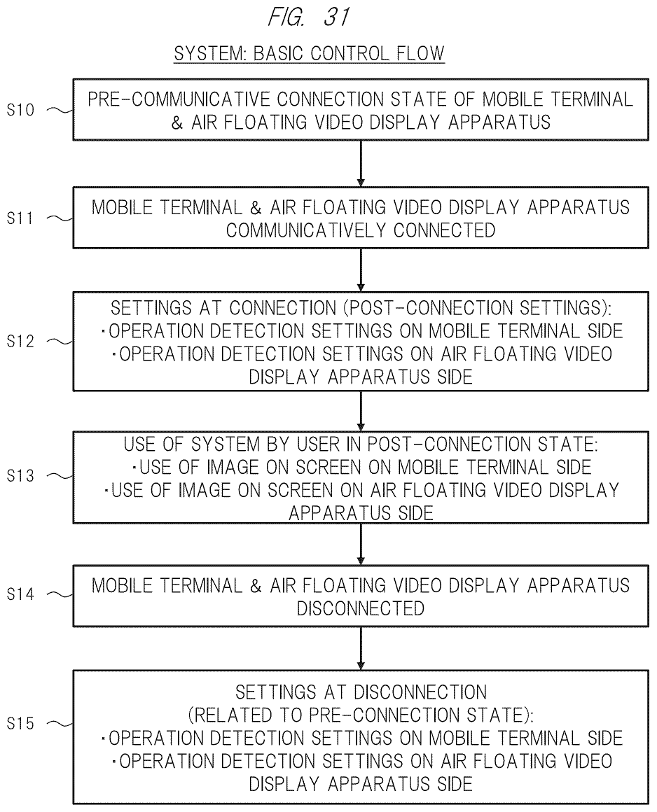

FIG. 31 shows a basic control flow for the air floating video display system (system 2900 in FIG. 29) and display method in the fifth embodiment. The main components of each apparatus, specifically the controller of the mobile terminal 2000 and the video processor of the air floating video display apparatus 1000, perform processing related to control in the present embodiment. Unless otherwise specified, the main components are the same.

In step S10, the air floating video display apparatus 1000 and the mobile terminal 2000 are in a pre-communicative connection state (in other words, a non-connected state). Each apparatus is in any state of use. Note that, in step S10, the selection and setting of the mode described below may be performed beforehand as system settings or user settings.

From the pre-connection state of step S10, in step S11, the mobile terminal 2000 and the air floating video display apparatus 1000 establish a communicative connection. For example, the mobile terminal 2000 communicatively connects with the air floating video display apparatus 1000 based on the operation or action of the user 230 holding the mobile terminal 2000. This communicative connection is via any method, including the communication interface. Details of the method are omitted here.

This communicative connection may be established in a conventional, general manner where the mobile terminal 2000 transmits a connection request to the air floating video display apparatus 1000 to establish the connection with the air floating video display apparatus 1000. Alternatively, as a specific method unique to the above-described the third and fourth embodiments, this communicative connection may be established by bringing the mobile terminal 2000 into contact with the air floating video 3.

Step S12 represents the processing and state immediately following the communicative connection. In Step S12, each apparatus in this system such as the mobile terminal 2000 and the air floating video display apparatus 1000 configures settings at the time of connection, or in other words, settings immediately after connection, settings related to the post-connection state of this system, and post-connection settings. Each apparatus performs its own “post-connection settings” based on coordination with the other apparatus during communication. These settings include configurations related to hardware, software, functions, and the like. Primarily, these settings concern enabling/disabling the user operation and sensor detection at each apparatus in the operation detection function 2930 shown in FIG. 29. These settings may also include settings related to the image displayed on the screen of each apparatus concerning the dual display function 2910 and the synchronization control function 2920 shown in FIG. 29. Details of the “post-connection settings” are described below (FIG. 32B).

For the operation detection settings on the mobile terminal 2000 side, these settings include enabling/disabling sensors for detecting the touch operation and the rotation operation on the screen of the mobile terminal 2000. In addition, for the operation detection settings on the air floating video display apparatus 1000 side, these settings include enabling/disabling sensors for detecting the touch operation and the rotation operation on the screen (display range 3R) created by the air floating video 3. The “post-connection settings” remain in effect until the communicative connection is disconnected as described below.

In step S12, the system may select and set a mode as described below. For example, a GUI for mode selection and setting may be displayed on the screen of either apparatus, allowing the user 230 to select and set the mode.

Step S13 is the state of usage of each apparatus of the system by the user 230 after connection, in other words, the state of usage while in the communicative connection state. For example, as a dual display, the display image from the air floating video 3 side is also displayed on the screen of the mobile terminal 2000 side. Alternatively, the image from the mobile terminal 2000 side is also displayed on the air floating video 3 side. The user 230 utilizes the display image on the screen of the mobile terminal 2000 and also utilizes the display image on the air floating video 3 of air floating video display apparatus 1000. At this time, the user operation such as the touch operation or the rotation operation on the display image on the screen of each apparatus is controlled for enabling/disabling, synchronization, or the like based on the post-connection settings in step S12. For example, in one mode setting, the touch operation on the display image on the mobile terminal 2000 side is enabled. In response to this operation, a reaction such as display update occurs on the display image of each apparatus. However, the touch operation on the display image on the air floating video 3 side becomes disabled. This clarifies the operation and detection during dual display, making it easier for the user 230 to perform the operation. Details of each mode are described below.

In step S14, the communicative connection between the mobile terminal 2000 and the air floating video display apparatus 1000 is disconnected. For example, the mobile terminal 2000 disconnects from the communicative connection with the air floating video display apparatus 1000 based on the operation or action of the user 230 holding the mobile terminal 2000. Disconnection includes not only intentional disconnection or termination by the user 230, but also unintentional disconnection or termination due to errors or the like. Through step S14, the system enters a disconnected state, or in other words, a non-connected state, returning to the state before connection.

In step S15 after step S14, each apparatus of the system including the mobile terminal 2000 and the air floating video display apparatus 1000 performs settings at disconnection, or in other words, settings immediately after disconnection, settings related to the pre-connection state of the system, and pre-connection settings. These settings include configurations related to hardware, software, and functions of each apparatus. Each apparatus performs its own “pre-connection settings”. The settings correspond to returning to the pre-connection state in step S10. For example, it is returned to the settings shown in FIG. 32A described below. Note that the system may store the “pre-connection settings” in a memory at communicative connection in steps S11 and S12, and then return to the “pre-connection settings” based on information in the memory when at disconnection in steps S14 and S15.

### [Example of Display and Settings Before and After Connection]

FIGS. 32A and 32B are explanatory diagrams summarizing in tables examples (i.e., modes or patterns) of display and settings before and after communicative connection between the mobile terminal 2000 and the air floating video display apparatus 1000 in this system.

FIG. 32A shows an example of the display and settings before connection. This configuration corresponds to the state in step S10 of FIG. 31. The table shows the settings for the mobile terminal 2000 (abbreviated as MT in the table) and the air floating video display apparatus 1000 (abbreviated as AD in the table) as the pre-connection settings for this system. The air floating video display apparatus 1000 displays a predetermined image such as the image A (in other words, content A) selected by the user 230 on the screen of the air floating video 3. The mobile terminal 2000 displays a predetermined image such as the image B (in other words, content B) selected by the user 230 on the screen of its display panel. The image A and image B are different images/content. On the air floating video display apparatus 1000 side, the touch sensor (described below) of the AD is used for the touch operation and detection of the image A on the screen, and the attitude sensor (described below) of the AD is used for the rotation operation and detection of the image A on the screen. On the mobile terminal 2000 side, the touch sensor (described below) of the MT is used for the touch operation and detection of the image B on the screen, and the attitude sensor (described below) of the MT is used for the rotation operation and detection of the image B on the screen.

Before connection, the two apparatuses (MT, AD) are independent. Therefore, FIG. 32A merely shows a technique of a general sensor and the like adopted and arranged on each apparatus.

FIG. 32B shows an example of display and settings after connection. This setting corresponds to the setting in step S12 of FIG. 31. In the table, the post-connection settings for this system indicate the display image on the screen of each apparatus for the mobile terminal (MT) 2000 and the air floating video display apparatus (AD) 1000, the touch sensor used for the touch operation and detection (in other words, which operation and detection of the apparatus is enabled), and the attitude sensor used for the rotation operation and detection (in other words, which operation and detection of the apparatus is enabled).

The settings at the time of connection in step S12 of FIG. 31 correspond to the “POST-CONNECTION SETTINGS” shown in FIG. 32B. These settings include the selection of the image data storage source described below.

Note that the settings of the apparatus/sensor enabled in the columns “TOUCH OPERATION DETECTION: TOUCH SENSOR” and “ROTATION OPERATION DETECTION: ATTITUDE SENSOR” specify which user operation of the apparatus and corresponding response is enabled. This does not interfere with the normal use of the various sensor devices (touch sensor and attitude sensor). The sensor device of the apparatus set to disabled will still perform its normal detection operation (e.g., generating and outputting touch detection signals) and will be used for existing functions. When set to disabled, a predetermined processing corresponding to the detection and determination of the touch operation will not be executed.

Note that “TOUCH SENSOR” and “ATTITUDE SENSOR” in the table refer to any sensors for detecting the touch operation or the rotation operation on the display image on the screen of each apparatus. They include different predetermined hardware and software depending on implementation and details are not limited.

Note that, depending on the implementation of this system, the housing 1190 of the air floating video display apparatus 1000 may not necessarily include the attitude sensor 1113 (FIG. 3). This is because detecting the attitude of the housing 1190 and the air floating video 3 (display range 3R) is not essential when the housing 1190 and the air floating video 3 are fixedly installed in a specific orientation. In this configuration, the control of rotation operation related to the column “ATTITUDE SENSOR” in the table of FIG. 32B should be considered excluded. In other words, in this configuration, no control is performed on the air floating video display apparatus (AD) 1000 side regarding the rotation operation on the displayed image.

In FIG. 32B, the major categories of a plurality of examples (or modes) are as follows. Examples 1 to 6 are examples where the image A displayed on the air floating video 3 side as in state A of FIG. 30 is also displayed as the image A on the screen on the mobile terminal 2000 side. The user 230 can view both images A. Examples 7 to 12 are examples where the image B displayed on the screen of the mobile terminal 2000 is also displayed as the image B on the air floating video 3 side as shown in state B of FIG. 30. The user 230 can view both images B.

In addition, the right-hand column showing each example and mode shows which of the apparatuses is the operation and detection is enabled. In the present embodiment, the user operation to be controlled is broadly divided into the touch operation and the rotation operation (see FIG. 42 described below). Each device has a touch sensor used for detecting the touch operation and an attitude sensor (in other words, a rotation sensor) used for detecting the rotation operation. For each operation and detection, the column “TOUCH OPERATION DETECTION: TOUCH SENSOR” in the table indicates whether the touch sensor of the AD side or the MT side device is set as active. The column “ROTATION OPERATION DETECTION: ATTITUDE SENSOR” indicates whether the attitude sensor of the AD side or the MT side apparatus is set as enabled. For example, in the row for Example 1, the touch sensor on the AD side is set as enabled, and the attitude sensor on the AD side is set as enabled. This setting means the touch sensor on the MT side is disabled, and the attitude sensor on the MT side is disabled. In addition, for example, in the row for the fourth embodiment, the touch sensor on the MT side is set as active, and the attitude sensor on the MT side is set as active. This setting means, in other words, that the touch sensor on the AD side is disabled and the attitude sensor on the AD side is disabled. In addition, in the fifth embodiment and Example 6, the “TOUCH OPERATION DETECTION: TOUCH SENSOR” column in the table is labeled “AD OR MT”. This notation indicates that both the touch sensor on the AD side and the touch sensor on the MT side are enabled. The specific operation for each example is described below.

### [Regarding Use of Each Mode]

The various examples and modes shown in FIG. 32B are implemented and made available in the design or configuration of this system, with at least one being implemented. The system may be implemented with only one mode fixedly implemented and set, or may be implemented with a plurality of modes available for selection and use. In the latter case, the system predefines and prepares examples of various settings and modes shown in the table of FIG. 32B and controls switching between these modes as appropriate. The system may also allow the user 230 to select and set the mode to use, for example, through user settings.

### [Example of Mode Selection/Setting Screen]

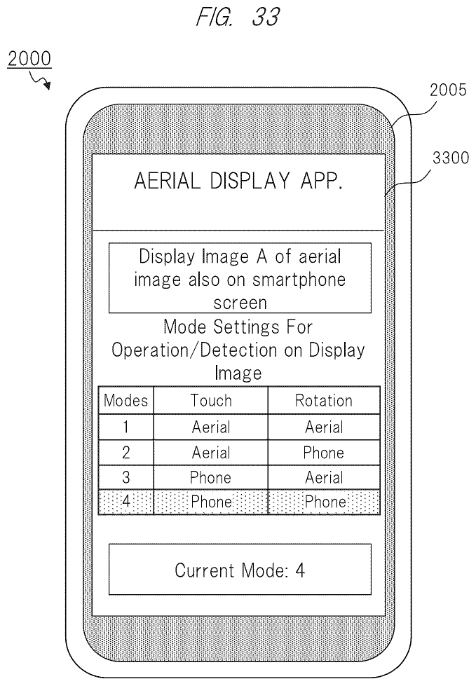

FIG. 33 shows an example of a screen display when providing a GUI for user settings to allow the user 230 to select and set the above-described modes. The example in FIG. 33 shows an example of displaying a GUI 3300 on the screen 2005 of the mobile terminal 2000 to enable mode selection. This is not limited to the present example. Similarly, a GUI can be provided on the air floating video 3. In addition, while the present example shows selection from Modes 1 to 4 as in FIG. 32B, the GUI screen may also display tables like FIG. 32B or detailed information to enable selection of each mode.

In the example of FIG. 33, when acquiring and displaying the image A on the air floating video 3 side and on the mobile terminal 2000 side as in state A of FIG. 30, Modes 1 to 4 related to the enabling/disabling the touch operation (touch sensor) and rotation operation (attitude sensor) are displayed as options as the “Mode Settings For Operation/Detection on Display Image” corresponding to Examples 1 to 4 in FIG. 32B, allowing mode selection by the operation of the user 230. For example, if Mode 4 is selected, Mode 4 is set as the current mode. For example, Mode 4 is selected and set as the current mode.

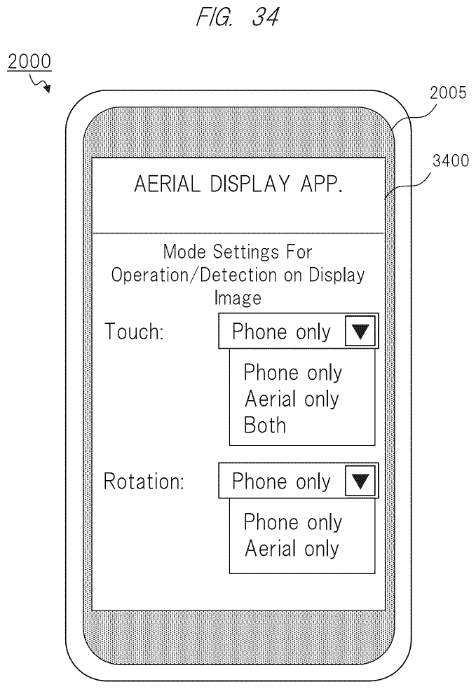

FIG. 34 shows an example of the GUI for selecting and setting the above mode, using a different representation from FIG. 33. In the example of FIG. 34, a GUI 3400 on the screen 2005 of the mobile terminal 2000 displays options for touch operation and rotation operation as the “Mode Settings For Operation/Detection on Display Image”. For each of these, the user can perform a selection setting, using a list box or other GUI, whether to enable operation and detection on the mobile terminal (MT) 2000 or the air floating video (AD) side, or on both apparatuses. These selection settings correspond to the mode selection setting. For example, if “MT only” is selected for the touch operation and “MT only” for rotation operation, this corresponds to Mode 4.

The present example describes a case where the user operation can be divided into the touch operation and the rotation operation and set individually. However, it may also be configured to allow setting only the touch operation or only the rotation operation. In addition, in the present example, only the rotation operation of one apparatus can be selected as enabled for rotation operation. This is not limited to this configuration. It is also possible to allow selection of the rotation operation of both apparatuses.

### [Functional Block Configuration Example]

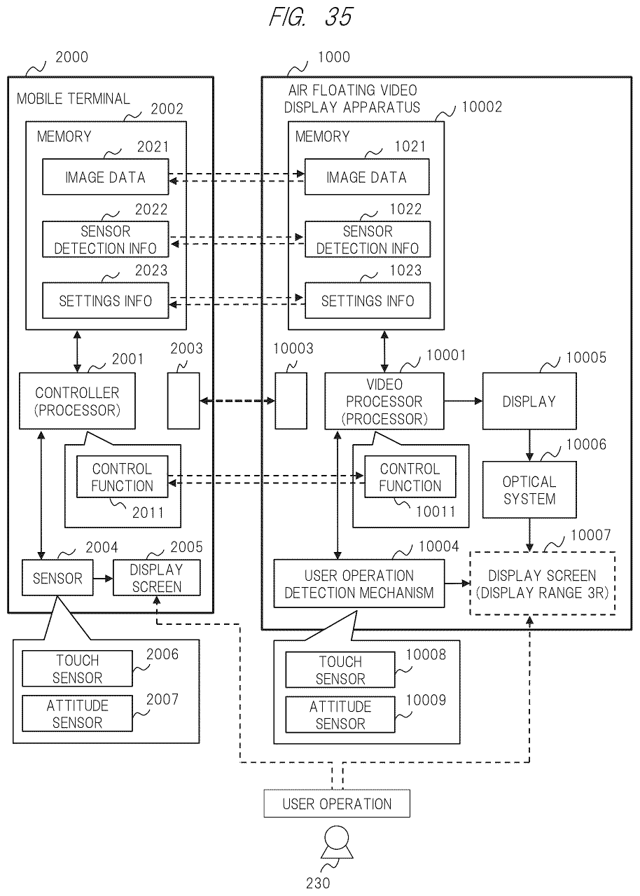

FIG. 35 shows a functional block configuration example of this system that realizes the functions shown in FIG. 29. The mobile terminal 2000 includes a controller (processor) 2001, memory 2002, a communication interface 2003, a sensor 2004, a display screen (screen) 2005, and the like. These components are interconnected via a bus or other predetermined architecture.

The controller (processor) 2001 implements a predetermined control function 2011 based on execution of programs and other processing by the processor. The control function 2011 includes the dual display function 2910, the synchronization control function 2920, and the operation detection control function 2930 shown in FIG. 29. The control function 2011 implements the necessary functional components on the mobile terminal 2000 side.

The memory 2002 stores image data 2021, sensor detection information 2022, setting information 2023, and the like. The sensor 2004 includes a touch sensor 2006 and an attitude sensor 2007.

The air floating video display apparatus 1000 comprises a video processor (processor) 10001, a memory 10002, a communication interface 10003, a user operation detection mechanism 10004, a display 10005, an optical system 10006, a display screen 10007 (display range 3R) and the like. These components are interconnected via a bus or other predetermined architecture. The controller (processor) 10001 implements a predetermined control function 10011 based on execution of programs and other processing by the processor. The control function 10011 includes the dual display function 2910, the synchronization control function 2920, and the operation detection control function 2930 shown in FIG. 29. The control function 10011 implements the necessary functional components on the air floating video display apparatus 1000 side. The memory 10002 stores image data 1021, sensor detection information 1022, setting information 1023, and the like. The user operation detection mechanism 10004 includes a touch sensor 10008 and an attitude sensor 10009.

The video processor 10001 displays an image/video on the screen of the display 10005 based on image data created through image processing. Based on the image/video displayed on the display 10005, the emitted video light is adjusted via the optical system 10006 and then forms an image in the display range 3R which is the display screen 10007 to form the air floating video 3.

The control function 2011 on the mobile terminal 2000 side and the control function 10011 on the air floating video display apparatus 1000 side cooperate with each other as appropriate via communication. Image data, sensor detection information, and setting information stored in the memory of each apparatus may be transmitted from the local apparatus to the other apparatus as appropriate.

The user 230 performs the user operation such as the touch operation on the display screen 2005 of the mobile terminal 2000. The sensor 2004 detects such an operation. The controller 2001 executes display control processing according to the detected operation. In addition, the user 230 performs the user operation such as the touch operation on the display screen 10007 (air floating video 3) of the air floating video display apparatus 1000. The user operation detection mechanism 10004 detects such an operation. The video processor 10001 executes display control processing according to the detected operation.

The image data 2021 on the mobile terminal 2000 side is image data for displaying an image/video on the display screen 2005. The sensor detection information 2022 is information detected by the sensor 2004. The setting information 2023 is setting information related to mode settings such as those in FIG. 32B, performed by the operation detection control function 2930 of FIG. 29. Similarly, the image data 1021 on the air floating video display apparatus 1000 side is image data for displaying an image/video on the screen of the display 10005. The sensor detection information 1022 is information detected by the sensor of the user operation detection mechanism 10004. The setting information 1023 is setting information related to mode settings such as those in FIG. 32B, performed by the operation detection control function 2930 of FIG. 29.

For example, the control function 2011 on the mobile terminal 2000 side performs settings for the mobile terminal 2000 after communicative connection is established according to the selected mode, and stores the setting information 2023 in the memory 2002. The settings include settings regarding enabling/disabling the user operation on the display image of the display screen 2005, detection of the user operation using the sensor 2004, and display control processing corresponding to the user operation. Similarly, the control function 10011 on the air floating video display apparatus 1000 performs settings for the air floating video display apparatus 1000 after communicative connection according to the selected mode, and stores the setting information 1023 in the memory 10002. The settings include settings regarding enabling/disabling the user operation on the display image of the display screen 10007, detection of the user operation using the user operation detection mechanism 10004, and display control processing corresponding to the user operation.

The following describes the correspondence between the configuration examples of the mobile terminal 2000 in FIGS. 35 and 17. The controller 2001 in FIG. 35 corresponds to the controller 20011 and the video controller 20017 in FIG. 17. The memory 2002 corresponds to the memory 20026, the nonvolatile memory 20027, and the storage 20016. The communication interface 2003 corresponds to the communication unit 20020. The touch sensor 2006 in the sensor 2004 corresponds to the touch sensor built in the display panel 20012 (touch panel). The attitude sensor 2007 corresponds to the attitude sensor 20018. The display screen 2005 corresponds to the display panel 20012.

The following describes the correspondence between the configuration examples of the air floating video display apparatus 1000 in FIGS. 35 and 3. The video processor 10001 in FIG. 35 corresponds to the controller 1110 and the video controller 1160 in FIG. 3. The memory 10002 corresponds to the memory 1109, the nonvolatile memory 1108, and the storage 1170. The communication interface 10003 corresponds to the communication unit 1132. The touch sensor 10008 in the user operation detection mechanism 10004 corresponds to the aerial operation detection sensor 1351, the aerial operation detector 1350, the imager 1180, and the like. The attitude sensor 10009 corresponds to the attitude sensor 1113. The display 10005 corresponds to the display apparatus 1, specifically the video display 1102. The optical system 10006 corresponds to the retroreflective unit 1101 and the like. The display screen 10007 corresponds to the display range 3R of the air floating video 3.

### [Aspect Ratio of Screen and Image]

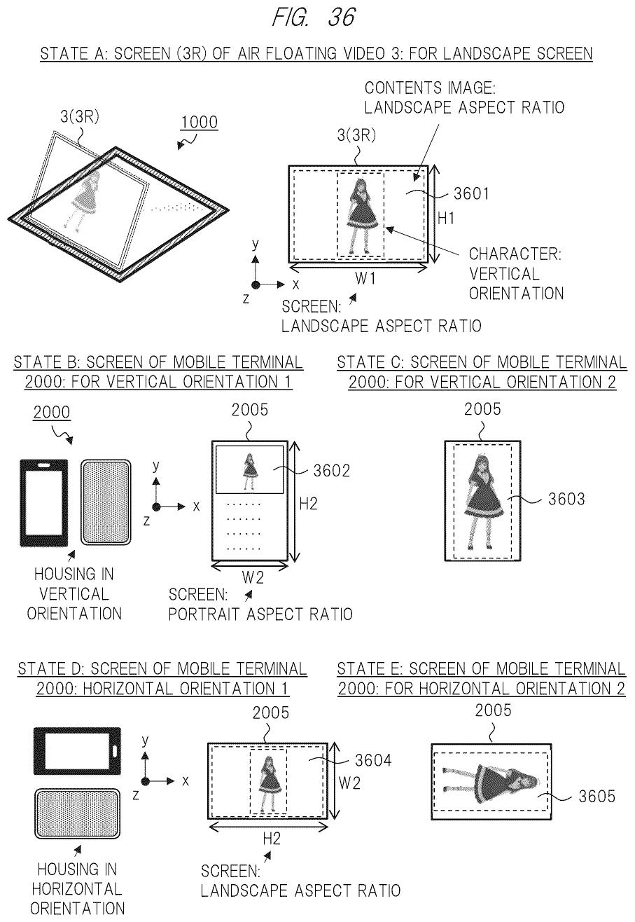

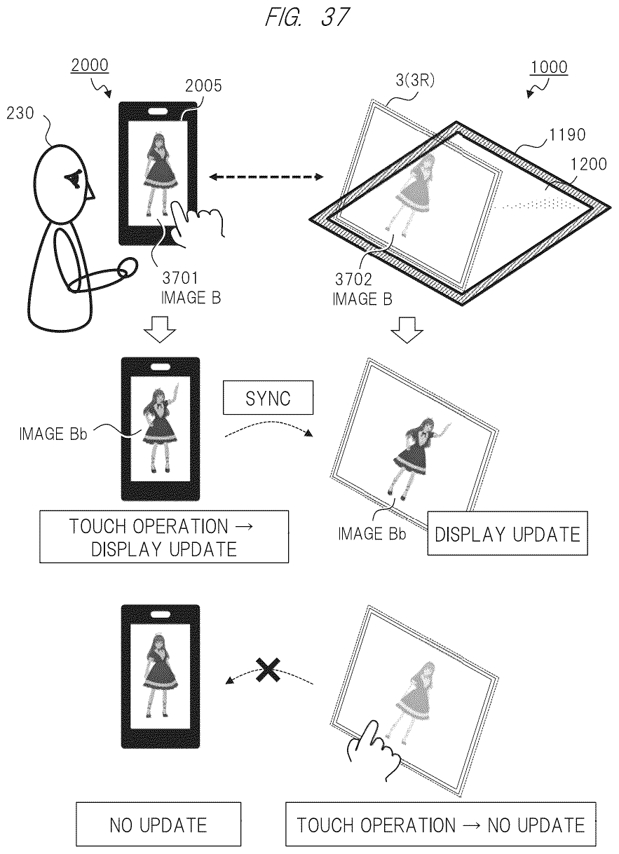

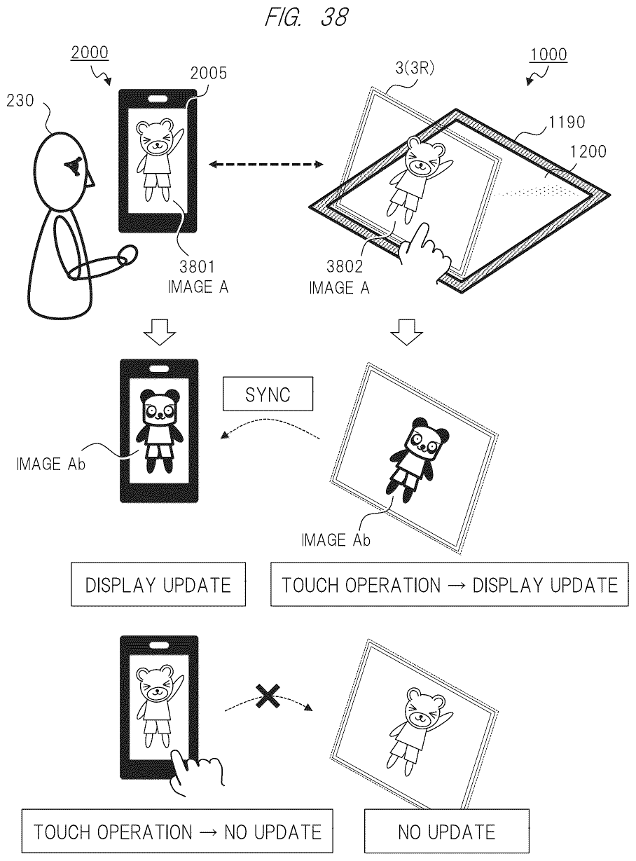

FIG. 36 shows examples of the aspect ratios of the screens and images for each apparatus including the air floating video display apparatus 1000 and the mobile terminal 2000 for illustrating specific examples of each mode in FIG. 32B.

State A shows a configuration example of the aspect ratio of the screen (display range 3R) of the air floating video 3 of the air floating video display apparatus 1000, specifically illustrating cases for a landscape screen and landscape content images. In the present example, the aspect ratio of the air floating video display apparatus 1000, that is, the aspect ratio of the screen (display range 3R) of the air floating video 3, is assumed to be a landscape aspect ratio such as 16:9 or 16:10, similar to a general display in a standard installation state. The width of the screen (display range 3R) is denoted as W1, and the height is denoted as H1. In other implementations or installation states, the aspect ratio of the screen (display range 3R) of the air floating video 3 can also be for a portrait screen (described below). In the front view in the x-y plane of the air floating video 3, the screen (display range 3R) has a landscape aspect ratio as shown. An image (content image) 3601 displayed on the screen is an image with a landscape aspect ratio as shown. In the present example, the image 3601 is displayed with its width size matched to the width size of the screen. Note that, in the present example, only the character image portion contained in the image 3601 is vertically oriented. While the present example includes only the character image in the image 3601, it may also include the background image or the like.

State B shows a configuration example of the aspect ratio of the screen 2005 of the mobile terminal 2000, specifically Case 1 where the housing of the mobile terminal 2000 is in the vertical orientation, and in the front view in the x-y plane in the screen the screen 2005 of the mobile terminal 2000, the screen 2005 has a portrait aspect ratio in which its length in the vertical direction (y direction) is longer than its length in the horizontal direction (x direction). The width of the screen 2005 is denoted as W2, and the height is denoted as H2. In state B, the longer side of the housing is oriented along the y direction (e.g., corresponding to the vertical direction from the perspective of the user 230) which is described as a vertical orientation. An image 3602 displayed on the screen 2005 has a landscape aspect ratio, similar to the image 3601. In the present example, as a common case for displaying applications or websites, the image 3602 is displayed with its width size adjusted to match the width size (W2) of the screen 2005.

State C is a configuration example of the aspect ratio for the screen 2005 of the mobile terminal 2000, specifically Case 2 where the mobile terminal 2000 housing is in a vertical orientation. Case 2 is an example where the image 3602 is enlarged in the screen 2005, and a portion of the image 3602 (e.g., character image portion) is displayed as an image 3603. In the present example, the character image portion is displayed by adjusting its width size to match the width size of the screen 2005.

State D is a configuration example of the aspect ratio for the screen 2005 of the mobile terminal 2000, specifically Case 1 where the mobile terminal 2000 is in a horizontal orientation. In state D, the longer side of the housing from state B is oriented along the x direction (e.g., corresponding to the horizontal direction from the perspective of the user 230) which is described as a horizontal orientation. An image 3604 displayed on the screen 2005 has a landscape aspect ratio, similar to the image 3601. In the present example, the image 3604 is displayed by adjusting its width size to match the width size (H2) of the screen 2005.

The user 230 uses the mobile terminal 2000 in a desired state. For example, compared to the display image in state B, the display image in state D can be visually recognized in a larger displayed state. In addition, in the case of dual display, the user 230 can visually recognize the display image of the desired apparatus. For example, compared to the display image in state D, the display image in the air floating video 3 in state A can be visually recognized in a larger displayed state. The example in FIG. 36 shows a case where the size of the screen (display range 3R) of the air floating video 3 is larger than the size of the screen 2005 of the mobile terminal 2000, but this is not limited thereto.

Note that, as shown in FIG. 36, assume that the user 230 is initially viewing the image 3602 while the mobile terminal 2000 is in a vertical orientation, such as state B. Since the image 3602 is displayed in the screen 2005 at a relatively small size, if the user 230 wishes to view the image at a larger size, he/she can rotate the device, for example, 90 degrees to a horizontal orientation and view the image 3604. The mobile terminal 2000 then displays the image 3604 in the screen 2005 at a larger size, as shown in state D. At this time, as a general action or function, the mobile terminal 2000 changes the display layout of the image data for the image displayed in the screen 2005 from state B to state D based on the changed output information (detection information) from the attitude sensor. In this case, a vertical orientation relationship of the image (e.g., relationship between a character's head and feet) is maintained before and after rotation.

Note that, depending on the function, settings, operation or the like of the mobile terminal 2000, it is also possible to set the display state to a state such as state E. State E is, for example, a case where the housing is rotated 90 degrees from state C. This is a display that fixes the arrangement of the image in the screen 2005 independently from the attitude of the housing (attitude detection information), and is also a common function (e.g., the “screen orientation lock” function on the smartphone). An image 3605 is an example of a character, and thus appears unnatural to the user 230 (head and feet are horizontally aligned). However, for other object images, the user 230 may wish to view them in this rotated state.

### [System Processing, Display Control Processing]

Note that the predetermined processing (in other words, system processing, display control processing) executed in response to detecting and determining the touch operation or the like on the display image of the screen of each apparatus is not limited to the display change (display update) as shown in FIG. 29, and any processing predefined corresponding to the content image and operation is possible. For example, when the display image is a numeric button object or a YES button object, a predetermined processing such as determination processing, numeric input, or YES input is executed in response to the touch operation, tap operation, press operation or the like on that object image. In addition, when the display image is a character image, a predetermined processing such as an undo processing is executed in response to a slide operation on that object image.

### [Image Display and Image Data Storage Sources on Two Apparatuses]

FIG. 41 is an explanatory diagram summarizing in a table examples (or patterns) of image display on each screen of the air floating video display apparatus (AD) 1000 and the mobile terminal (MT) 2000, and the corresponding selection of image data storage source. In the pattern shown in row #1, the image displayed on the air floating video 3 which is the screen of the air floating video display apparatus (AD) 1000 is the image A (or content A), while no image is displayed on the screen of the mobile terminal (MT) 2000 (indicated as “NONE”). In this pattern, the system does not perform the above-described dual display and synchronization control (FIG. 29) (indicated as OFF). After connection, the data storage source for the image displayed on the screen of the air floating video display apparatus (AD) 1000 (in other words, the selection of the data storage source) is the air floating video display apparatus (AD) 1000 as the data storage source for the image A. Specifically, this refers to the memory, address, file, and the like of the AD.

In the pattern shown in row #2, the image displayed on the screen of the mobile terminal (MT) 2000 is the image B (or content B), while no image is displayed on the air floating video 3 which is the screen of the air floating video display apparatus (AD) 1000. In this case, the system does not perform the dual display and synchronization control (FIG. 29). After connection, the data storage source for the image displayed on the screen of the mobile terminal (MT) 2000 is the mobile terminal (MT) 2000 as the data storage source for the image B. Specifically, this refers to the memory, address, file, and the like of the MT.

In the pattern shown in row #3, the image displayed on the screen of the mobile terminal (MT) 2000 is the image B, while the image displayed on the screen of the air floating video display apparatus (AD) 1000 is the image A. The image A and the image B are different images independent of each other. In this case, the system does not perform the dual display and synchronization control (FIG. 29). After connection, the data storage source for the image displayed on the screen of the mobile terminal (MT) 2000 is the mobile terminal (MT) 2000 as the data storage source for the image B, while the data storage source for the image displayed on the screen of the air floating video display apparatus (AD) 1000 is the air floating video display apparatus (AD) 1000 as the data storage source for the image A.

In the pattern shown in row #4, the image displayed on the screen of the air floating video display apparatus (AD) 1000 is the image A, while the image displayed on the screen of the mobile terminal (MT) 2000 is the same image A acquired from the AD side. In this case, the system performs the dual display and synchronization control (FIG. 29) (indicated as ON). After connection, the data storage source for the image displayed on the screen of the air floating video display apparatus (AD) 1000 is the air floating video display apparatus (AD) 1000 as the data storage source for the image A, while the data storage source for the image displayed on the screen of the mobile terminal (MT) 2000 is the air floating video display apparatus (AD) 1000 as the data storage source for the same image A.

In the pattern shown in row #5, the image displayed on the screen of the mobile terminal (MT) 2000 is the image B, while the image displayed on the screen of the air floating video display apparatus (AD) 1000 is the same image B acquired from the MT side. In this case, the system performs the dual display and synchronization control (FIG. 29). After connection, the data storage source for the image displayed on the screen of the mobile terminal (MT) 2000 is the mobile terminal (MT) 2000 as the data storage source for the image B, while the data storage source for the image displayed on the screen of the air floating video display apparatus (AD) 1000 is the mobile terminal (MT) 2000 as the data storage source for the same image B.

Note that the above-described examples show the selection of the storage source for the image data related to the display target image. However, regarding image display control, there is a predetermined processing executed not only based on the image data from the storage source but also in response to the user operation such as the touch operation on the object of the image. Examples of such predetermined processing include the above-described display update, image rotation, scaling, and the like. Therefore, regarding image display control, in addition to the image data, there may also be data such as data of programs or tables necessary for the predetermined processing, or image data after display changes. In such a case, the data stored in the data storage source corresponding to the display target image includes such program data, image data after display changes, and the like.

Note that, in the above-described examples, the image data storage source corresponds to the apparatus that initially holds the image data, but this is not limited thereto. The image data storage source can also be an external server or the like. For example, in the pattern of #4, the initial data storage source for the image A may be an external server. In addition, for example, in the pattern of #1, the image A displayed by the air floating video display apparatus (AD) 1000 is an image initially held by the AD. However, this is not limited thereto. It is also possible to have the image A initially held by an external server or the mobile terminal (MT) 2000, have the image A transferred to or acquired from the AD via communication, and then have the AD display the image A.

### [Operations and Actions Subject to Control]

FIG. 42 is a table summarizing the operations (user operation) that are control targets for the display images on each screen of each apparatus in this system, and the sensors and the like used to detect and control such operations. In row #1, the operation which is the control target is the touch operation. The touch operation is a collective term encompassing operations such as touch, tap, slide, pinch, and the like. Although the details differ, this touch operation is possible on either the air floating video display apparatus (AD) 1000 side or the mobile terminal (MT) 2000 side. The sensor for detecting and controlling this touch operation on the AD side is the touch sensor (touch sensor 10008 in FIG. 35) of the AD. The touch sensor on the AD side is a collective term encompassing the aerial operation detection sensor 1351, the camera of the imager 1180, and the like. In addition, this sensor is the touch sensor (touch sensor 2006 in FIG. 35) of the mobile terminal (MT) 2000 on the MT side.

In row #2, the operation which is the control target is the touch operation. The touch operation is specifically a pressing operation. This pressing operation involves the finger penetrating into the space behind the screen. Therefore, while this pressing operation can be detected by the touch sensor corresponding to the screen via the air floating video 3 on the air floating video display apparatus (AD) 1000 side, it cannot be detected on the mobile terminal (MT) 2000 side because it is a physical screen. Alternatively, if this pressing operation is an operation in which the screen is pressed, and a pressure sensor is provided on the mobile terminal (MT) 2000 side, the pressing operation can be detected by the MT side. Conversely, the operation in which the physical screen on the MT side is pressed cannot be detected by the AD side.

As in the example of #2, there are types of operations detectable on the air floating video display apparatus (AD) 1000 side but not detectable on the mobile terminal (MT) 2000 side, and types of operations detectable on the MT side but not detectable on the AD side. For such operations, the side equipped with sensors or mechanisms capable of detecting the operation may be set as the control target.

In row #3, the operation which is the control target is the rotation operation. The rotation operation is specifically an operation realized by the touch operation. This rotation operation involves performing a predetermined touch operation on the screen such as drawing an arc with the finger to rotate the display image. Since this rotation operation is a type of touch operation, it can be detected by the touch sensors on both the air floating video display apparatus (AD) 1000 side and the mobile terminal (MT) 2000 side.

In row #4, the operation which is the control target is the rotation operation. The rotation operation is specifically an operation realized not by a touch operation, but by rotating the housing of the apparatus. For the mobile terminal (MT) 2000 side, this rotation operation is the operation or action where the user 230 holds the housing and rotates it within a space (as shown in the example of FIG. 39). The sensors detecting this rotation operation include the attitude sensor (attitude sensor 10009 in FIG. 35) of the AD on the air floating video display apparatus (AD) 1000 side and the attitude sensor (attitude sensor 2007 in FIG. 35) of the MT on the mobile terminal (MT) 2000 side. The attitude sensor of the MT includes a compass sensor, a gyro sensor, an acceleration sensor, and the like. On the AD side, if the housing is fixedly installed in the environment, this rotation operation is not possible. However, when a person changes the orientation of the housing during installation, the attitude sensor of the housing can detect the state of the attitude and rotation of the AD including the air floating video 3 (described below). In addition, the housing may include a mechanical mechanism for changing the position and attitude of the plane (display range 3R) forming the air floating video 3. In such a case, the state of the attitude and rotation of the plane of the air floating video 3 can also be detected by the attitude sensor associated with that mechanism (described below). Note that, as described above, control using this attitude sensor is not applicable in configurations where the AD does not include the attitude sensor.

As in the above-described example, there are sensors available depending on the operation to be controlled. The operation detection control function 2930 (FIG. 29) in this system controls to enable/disable the sensors to be used and the processing performed using the sensors based on the operation that are control targets and the set mode.

### [Attitude of Air Floating Video Display Apparatus]

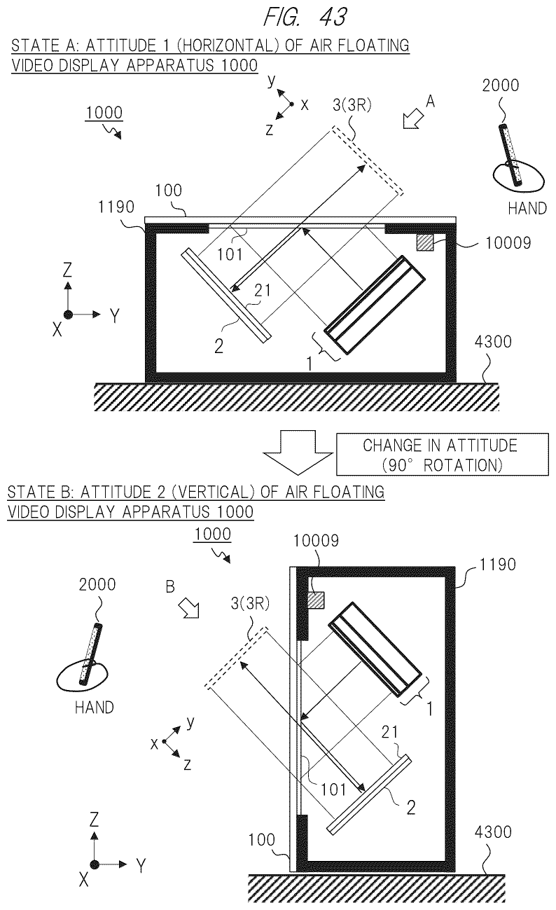

FIG. 43 shows examples of the attitude states of the air floating video display apparatus 1000 and the air floating video 3. State A, as attitude 1, shows a case where the housing 1190 implemented as shown in FIG. 2A or FIG. 19E is placed horizontally. The housing 1190 of the air floating video display apparatus 1000 is placed horizontally on a floor 4300. As the attitude, the display range 3R (x-y plane) of the air floating video 3 is positioned with its optical axis directed diagonally upward as shown. The user 230 can comfortably visually recognize the air floating video 3 in the direction of the arrow A (diagonally downward).

State B, as attitude 2, shows a case where the housing 1190 is placed vertically. The housing 1190 of the air floating video display apparatus 1000 is placed vertically on the floor 4300.

As the attitude, the display range 3R (x-y plane) of the air floating video 3 is positioned with its optical axis directed diagonally upward as shown. The user 230 can visually recognize the air floating video 3 in the direction of the arrow B (diagonally downward).

The user 230 utilizes the air floating video display apparatus 1000 in either installation state A or state B depending on the environment and other factors. In addition, the user 230 may change the installation state from, for example, state A to state B as necessary, or in other words, change the attitude and orientation. For example, changing the attitude from state A to state B involves rotating the housing 1190 by 90 degrees.

The attitude sensor 10009 in the housing 1190 detects the attitude of the housing 1190, or in other words, its rotational state. Since the attitude of the housing 1190 and the attitude of the air floating video 3 have a corresponding relationship, the attitude of the air floating video 3 can be detected and calculated from the detection information of the attitude sensor 10009. Note that the attitude can be expressed by, for example, the orientation of each axis of a coordinate system.

Note that, when the housing 1190 is large, the attitude of installation of the air floating video display apparatus 1000 is often fixed at the initial installation state upon introduction. However, changing the installation state is possible. When the housing 1190 is small, the user 230 can conveniently change the attitude of the housing 1190 as needed.

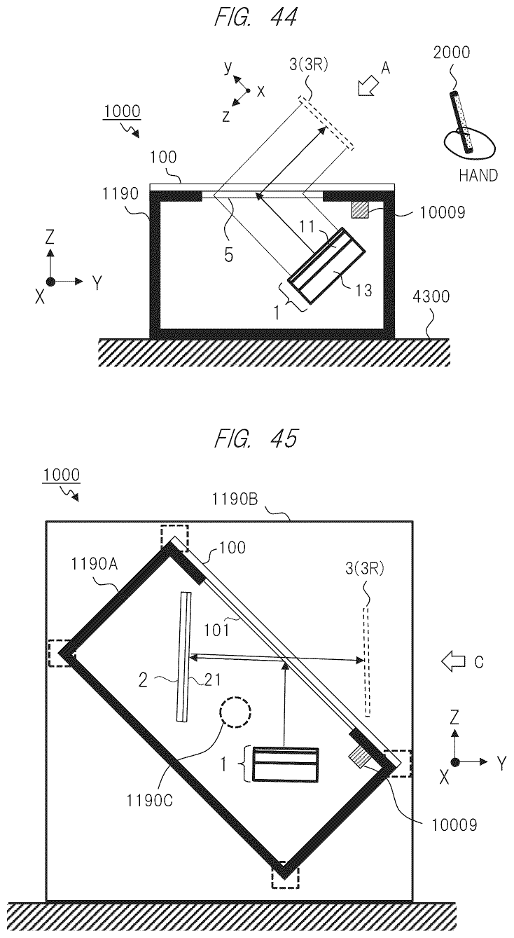

FIG. 44 shows a similar example of the attitude for the housing 1190 implemented using a method with a retroreflector 5 as in FIG. 2D. Here, the housing 1190 is placed horizontally on the floor 4300. As the attitude, the display range 3R (x-y plane) of the air floating video 3 is positioned with its optical axis directed diagonally upward as shown. The user 230 can comfortably view the air floating video 3 in the direction of the arrow A (diagonally downward).

FIG. 45 shows a modification where the air floating video display apparatus 1000 comprises a mechanism enabling its own attitude change. In the illustrated example, a housing 1190B (or external housing) is provided outside a housing 1190A (or internal housing) and rotatably supports the housing 1190A via a rotation axis 1190C. In the illustrated example, only the left and right side panels of the housing 1190B are schematically shown. This mechanism allows the housing 1190A to be rotated to change its attitude, that is, to change the attitude of the air floating video 3. In the installed state of the illustrated example, the user 230 can comfortably view the air floating video 3 in the direction of the arrow C (horizontal direction, Y direction). The attitude sensor 10009 in the housing 1190A can detect the attitude of the housing 1190A and the air floating video 3.

### SPECIFIC EXAMPLES

Next, specific examples of each mode shown in FIG. 32B will be explained in order.

### Mode 1: Explanation (1)

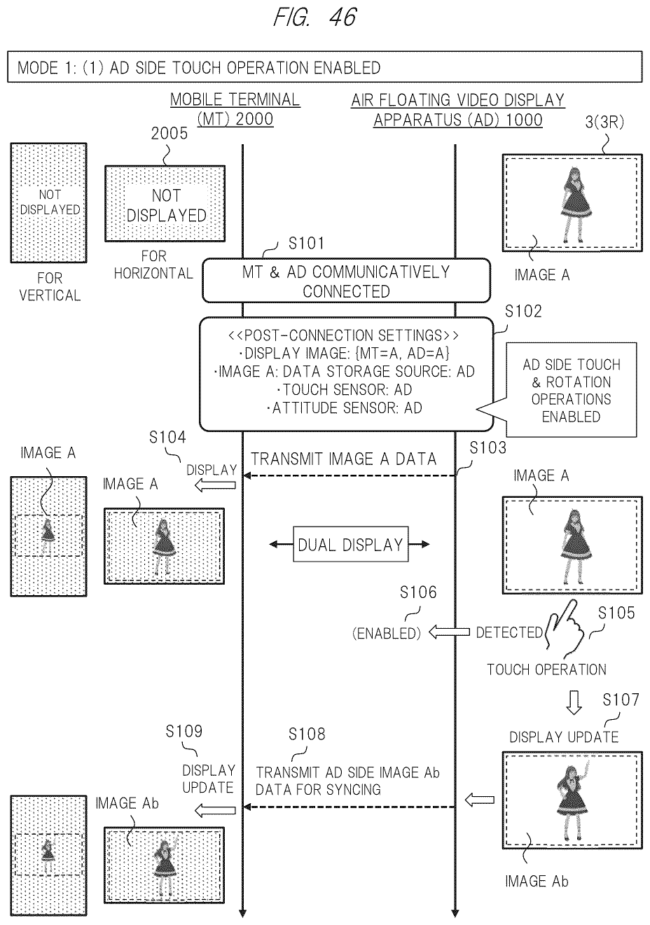

FIG. 46 shows a specific example of the sequence of processing and operation between the mobile terminal (MT) 2000 of this system and the air floating video display apparatus (AD) 1000 for the case of Example 1, Mode 1 in FIG. 32B. FIG. 46 specifically shows that the touch operation on the AD side is enabled. Initially, before step S101, the system is in a pre-connection state. Assume no image is displayed on the screen 2005 of the mobile terminal (MT) 2000 shown on the left. Note that “NOT DISPLAYED” means the target image is not displayed, and displays for any applications, GUIs or the like may still be present. Note that this figure collectively shows both vertical (as in FIG. 36) and horizontal orientations. Assume that the image A (or content A) is displayed on the air floating video 3 (display range 3R which is the screen on the air floating video display apparatus (AD) 1000 side shown on the right. In the present example, the screen of the air floating video 3 (display range 3R) has a landscape aspect ratio as shown in FIG. 36, and displays a content image with a landscape aspect ratio as the image A.

In step S101, assume the mobile terminal (MT) 2000 has established a communicative connection with the air floating video display apparatus (AD) 1000. Note that, during the communicative connection, the mobile terminal 2000 may, for example, request the image A from the air floating video display apparatus 1000. In step S102, the system performs the post-connection settings as shown in the row of Example 1 in FIG. 32B. In the “post-connection settings”, for the display image for each apparatus, the display image of the air floating video 3 on the air floating video display apparatus (AD) 1000 side is the image A. The display image on the screen 2005 on the mobile terminal (MT) 2000 side is the same image A as that on the air floating video 3 side. The data storage source for image A is the AD. In addition, in the “post-connection settings”, the enabled touch sensor used for detecting the touch operation is set as the touch sensor (touch sensor 10008 in FIG. 35) on the AD side, and the enabled attitude sensor used for detecting the rotation operation is set as the attitude sensor (attitude sensor 10009 in FIG. 35) on the AD side. In other words, the post-connection settings in step S102 correspond to enabling the touch operation and the rotation operation on the AD side.

In step S103, for example, the image data for the image A stored in the air floating video display apparatus (AD) 1000 is transmitted/transferred to the mobile terminal 2000. In step S104, the mobile terminal 2000 displays the image A on the screen 2005 based on the acquired image data. As a result, the dual display state of the image A on both apparatuses can be achieved as illustrated.

Next, in step S105, assume the touch operation by the user 230 is performed on the image A of the air floating video 3 on the air floating video display apparatus (AD) 1000 side. In step S106, the touch sensor and video processor on the AD side detect this touch operation, and based on the post-connection settings in step S102, determine this touch operation as enabled.

In step S107, based on the touch operation being enabled, the video processor on the air floating video display apparatus (AD) 1000 side executes a predetermined processing such as display update processing predefined to correspond to the touch operation on the image A. As a result, the image A changes, for example, to the image Ab. Note that, since the AD side holds the original data for both images A and Ab, it is possible to generate the image Ab.

In step S108, the video processor on the air floating video display apparatus (AD) 1000 side transmits/transfers the image data for the image Ab on the AD side to the mobile terminal (MT) 2000 for synchronization regarding the display update. Note that the MT side does not hold the original data for the images A and Ab, making it impossible to generate the image Ab. Therefore, in step S108, the image data for the image Ab from the AD side is transmitted to the mobile terminal (MT) 2000.

In step S109, upon acquiring the image data for the image Ab, the mobile terminal (MT) 2000 displays the image Ab on the screen 2005 to realize the display update on the MT side. In this manner, based on the settings of Mode 1, dual display and synchronization control of the image A across the two apparatuses are realized. Specifically, when the touch operation is performed on the air floating video 3 on the AD side, the display control corresponding to the touch operation can be reflected in both the image A on the AD side and the image A on the MT side.

### Mode 1: Explanation (2)

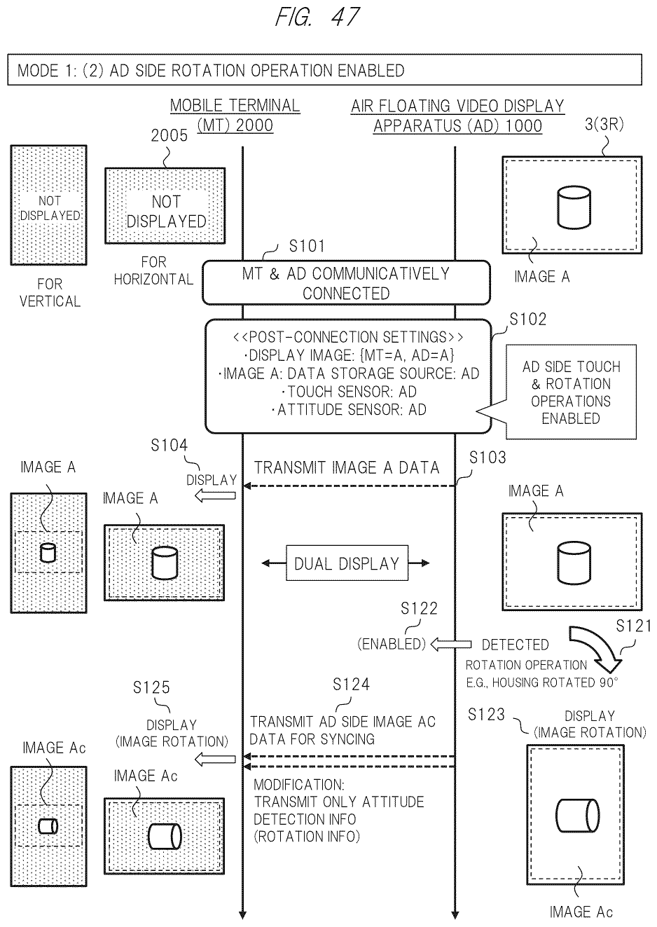

FIG. 47 shows Mode 1, specifically showing that the rotation operation is enabled on the AD side. Steps S101 to S104 are the same as in FIG. 46. The image A shows a cylindrical object to clearly illustrate the action related to the rotation.

In step S121, assume the rotation operation has been performed on the image A of the air floating video 3 on the air floating video display apparatus (AD) 1000 side. For example, assume the air floating video 3 has been rotated 90 degrees as an attitude change. This rotation operation corresponds, for example, to the housing 1190 being rotated as shown in FIG. 43.

In step S122, the attitude sensor and video processor on the AD side detect this attitude change, that is, the rotation operation, and based on the post-connection settings in step S102, determine this rotation operation as enabled.

In step S123, based on the above-described rotation operation being enabled, the video processor on the air floating video display apparatus (AD) 1000 side executes a predetermined processing corresponding to the rotation operation. In the present example, the image rotation which is the predetermined processing changes the image A in the landscape screen to a rotated image Ac in the portrait screen. Since the AD side holds the original data for the image A and the image Ac, it can generate the image Ac. Note that, in the present example, the processing for this image rotation maintains the arrangement relationship of the display image in the screen of the air floating video 3. Therefore, the image A and the image Ac are substantially the same, and the display on the display 10005 (FIG. 35) remains unchanged.

In step S124, the video processor on the air floating video display apparatus (AD) 1000 side transmits the image data of the rotated image Ac to the mobile terminal (MT) 2000 for synchronization. In step S125, the mobile terminal (MT) 2000 displays the image Ac on the screen 2005 based on image data of the acquired image Ac. As a result, the image A changes to the rotated image Ac as the image rotation on the mobile terminal (MT) 2000 side.

As a modification, in step S124, the air floating video display apparatus (AD) 1000 may transmit only the attitude detection information (in other words, rotation information) obtained from the attitude sensor to the mobile terminal (MT) 2000 for synchronization, instead of transmitting the image data of the rotated image Ac. In this case, in step S125, the mobile terminal (MT) 2000 performs rotation processing on the image A based on the acquired attitude detection information and the data of the acquired image A, generates the rotated image Ab, and displays it on the screen 2005.

In this manner, specifically when the rotation operation is performed on the air floating video 3 on the AD side, the display control corresponding to that rotation operation can be reflected in both the image A on the AD side and the image A on the MT side. After the rotation operation, the image Ac on the AD side and the image Ac on the MT side are displayed in a rotated state from the perspective of the user 230 and are aligned.

There may be a case where the user 230 wishes to view the rotated state of an object image. For example, the user 230 may wish to inspect a three-dimensional object image such as a product from various directions based on the rotation operation. In such a case, as in the above-described example, if the user 230 performs the rotation operation on the screen of one device, the target image can be conveniently viewed in its rotated state on the screens of both apparatuses.

### Mode 1: Explanation (3)

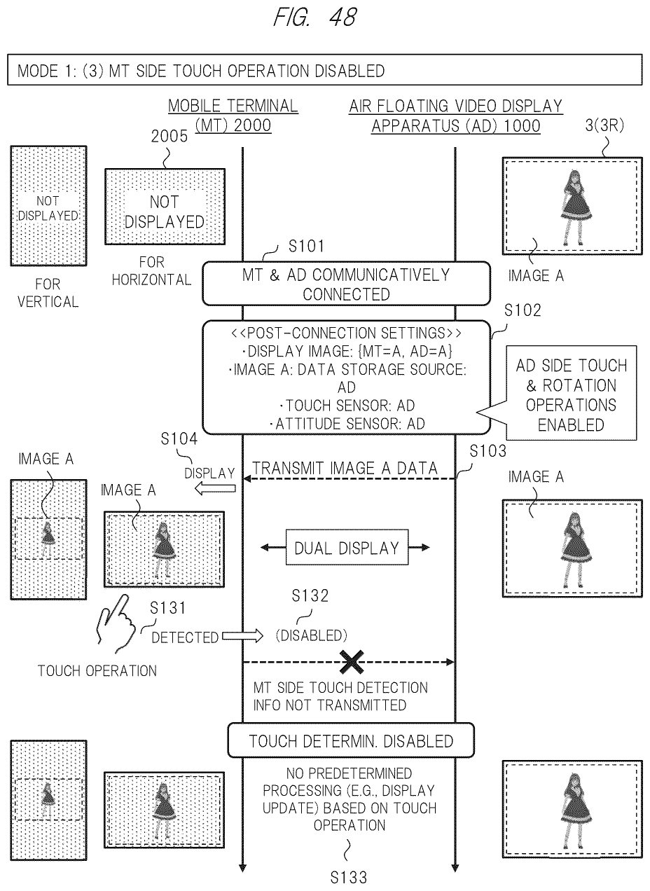

FIG. 48 shows Mode 1, specifically showing that the touch operation on the MT side is disabled. Steps S101 to S104 are the same as in FIG. 46. In step S131, assume the touch operation by the user 230 has been performed on the image A on the mobile terminal (MT) 2000 side. In step S132, the touch sensor and controller on the MT side detect this touch operation, and based on the post-connection settings in step S102, determine this touch operation as disabled.

In step S133, based on the above-described touch operation being disabled, the mobile terminal (MT) 2000 does not execute a predetermined processing such as display update processing that is predefined to correspond to the touch operation on the image A. As a result, the image A on the MT side remains unchanged. In addition, the mobile terminal (MT) 2000 does not perform synchronization with the air floating video display apparatus (AD) 1000 side. That is, the mobile terminal (MT) 2000 does not transmit the touch detection information on the MT side to the AD side. As a result, the image A on the AD side also remains unchanged.

In this manner, in Mode 1, the touch operation on the mobile terminal (MT) 2000 side is disabled, and the dual display state of the image A on the mobile terminal (MT) 2000 side and the image A on the air floating video display apparatus (AD) 1000 side is maintained.

### Mode 1: Explanation (4)

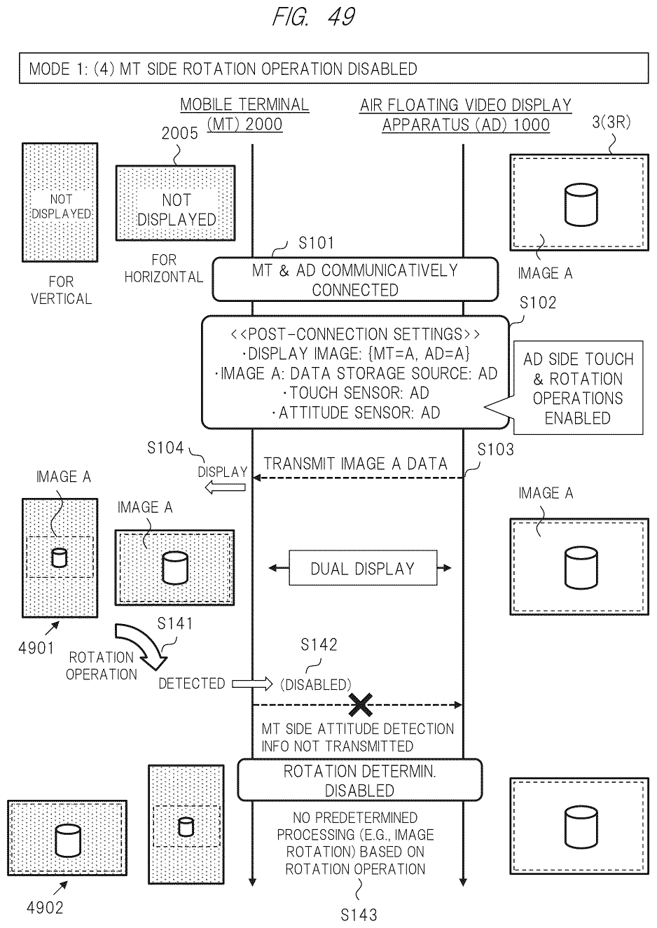

FIG. 49 shows Mode 1, specifically showing that the rotation operation on the MT side is disabled. Steps S101 to S104 are the same as in FIG. 46. In step S141, assume the rotation operation is performed by the user 230 on the image A on the mobile terminal (MT) 2000 side. This rotation operation is, for example, a 90-degree rotation of the housing. In step S142, the attitude sensor and controller on the MT side detect this rotation operation, and based on the post-connection settings in step S102, determine this rotation operation as disabled.

In step S143, based on the above-described rotation operation being disabled, the mobile terminal (MT) 2000 does not execute a predetermined processing operation such as image rotation processing (here, processing to maintain the arrangement relationship of the image A in the screen 2005) which is predefined to correspond to the rotation operation of the image A. As a result, the image A on the MT side remains unchanged. That is, from the perspective of the user 230, while the screen 2005 changes from a vertical orientation to a horizontal orientation or vice versa, the image A in the screen 2005 does not rotate. To achieve this effect where the image A does not appear as if it were rotated to the user 230, the mobile terminal (MT) 2000 performs processing to rotate the image A in the screen 2005 by 90 degrees and change its arrangement relationship. In addition, the mobile terminal (MT) 2000 does not perform synchronization with the air floating video display apparatus (AD) 1000. That is, the mobile terminal (MT) 2000 does not transmit the attitude detection information on the MT side to the AD side. As a result, the image A on the AD side also remains unchanged.

In this manner, in Mode 1, the rotation operation on the mobile terminal (MT) 2000 side is disabled, and the dual display state of the image A on the mobile terminal (MT) 2000 side and the image A on the air floating video display apparatus (AD) 1000 side is maintained.

### Mode 2: Explanation (1)

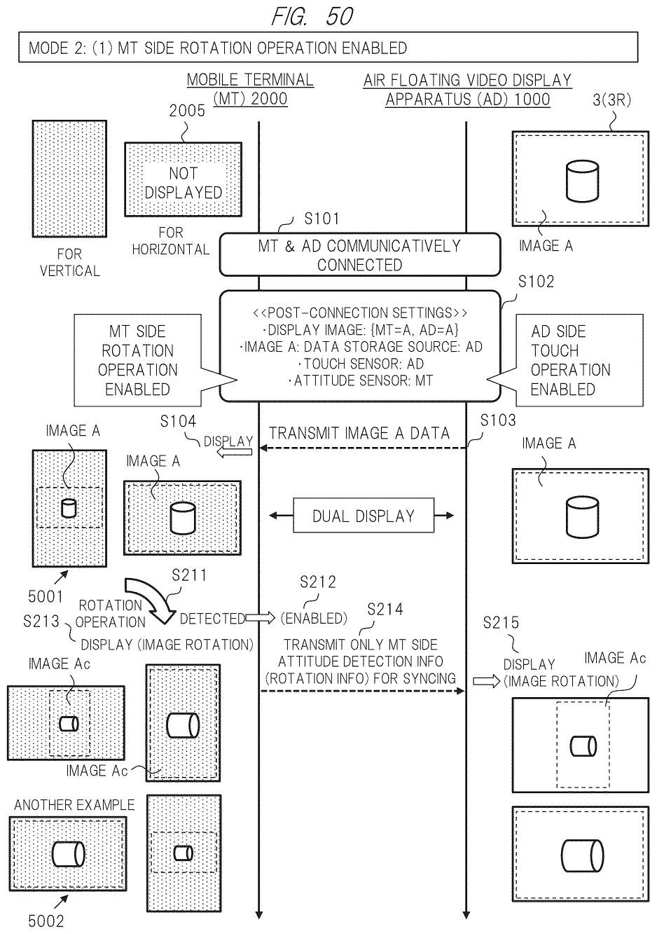

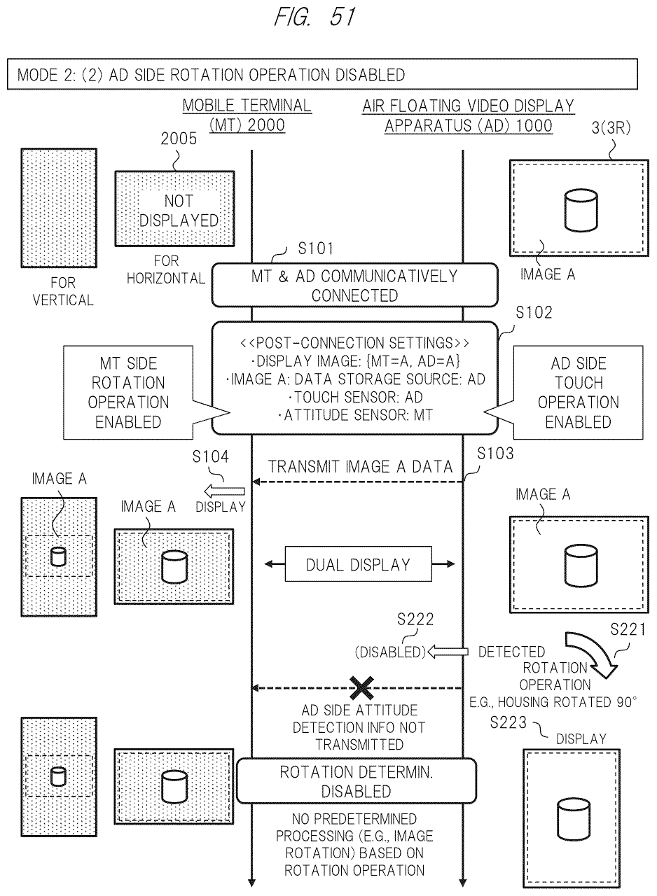

FIG. 50 shows a specific example of the sequence of Example 2, Mode 2 in FIG. 32B. Mode 2 differs from Mode 1 in that the rotation operation on the MT side is enabled. FIG. 50 shows Mode 2, specifically showing that the rotation operation on the MT side is enabled. Steps S101 to S104 are the same as in FIG. 46. In step S102, for the post-connection settings, the mobile terminal (MT) 2000 is set as the enabled attitude sensor used for the rotation operation.

In step S211, assume the rotation operation is performed on the image A displayed on the screen 2005 of the mobile terminal (MT) 2000. This rotation operation is, for example, a 90-degree rotation of the housing. In step S212, the attitude sensor and controller on the MT side detect this attitude change, that is, the rotation operation, and based on the post-connection settings in step S102, determine this rotation operation as enabled.

In step S213, based on the above-described rotation operation being enabled, the mobile terminal (MT) 2000 executes a predetermined processing (image rotation) corresponding to that rotation operation. In the present example, this processing (image rotation) maintains the arrangement relationship of the image A in the screen 2005. The image A in the screen 2005 in the vertical orientation changes to the rotated image Ac in the screen 2005 in the horizontal orientation. The image A in the screen 2005 in the horizontal orientation changes to the rotated image Ac in the screen 2005 in the vertical orientation. That is, from the perspective of the user 230, the image A appears as if it were the rotated image Ac. In the present example, the arrangement relationship of display image in the screen 2005 is maintained. Therefore, the image A and the image Ac are substantially the same, and the display on the display panel 20012 (FIG. 17) of the screen 2005 remains unchanged.

In step S214, the mobile terminal (MT) 2000 transmits only the attitude detection information (in other words, rotation information) obtained from the attitude sensor to the air floating video display apparatus (AD) 1000 for synchronization. In step S215, the air floating video display apparatus (AD) 1000 generates the rotated image Ac from the image A based on the acquired attitude detection information and the image data for the image A, and displays the image Ac on the air floating video 3.

In this manner, in Mode 2, the rotation operation on the mobile terminal (MT) 2000 side becomes enabled, realizing dual display and synchronization control between the image A on the mobile terminal (MT) 2000 side and the image A on the air floating video display apparatus (AD) 1000 side.

### Mode 2: Explanation (2)

FIG. 51 shows Mode 2, specifically showing that the rotation operation on the AD side is disabled. In step S221, assume the rotation operation is performed on the image A on the screen of the air floating video 3 on the air floating video display apparatus (AD) 1000 side. This rotation operation is, for example, a 90-degree rotation of the housing 1190. In step S222, the attitude sensor and video processor on the AD side detect this attitude change, that is, the rotation operation, and based on the post-connection settings in step S102, determine this rotation operation as disabled.

In step S223, based on the rotation operation being disabled, the air floating video display apparatus (AD) 1000 does not execute the predetermined processing (image rotation) corresponding to the above-described rotation operation. In the present example, this processing (image rotation) maintains the arrangement relationship of the image A in the screen. Specifically, it ensures that the image A remains within the portrait screen after rotation from the perspective of the user 230, as it was within the landscape screen before rotation. For this purpose, in step S223, the air floating video display apparatus (AD) 1000 rotates the image A in the screen of the air floating video 3 by 90 degrees. In addition, since the air floating video display apparatus (AD) 1000 does not perform synchronization with the mobile terminal (MT) 2000, it does not transmit the attitude detection information on the AD side to the MT.

In this manner, in Mode 2, the rotation operation on the air floating video display apparatus (AD) 1000 side becomes enabled, and the dual display state of the image A on the mobile terminal (MT) 2000 side and the image A on the air floating video display apparatus (AD) 1000 side is maintained.

### Mode 3: Explanation (1)

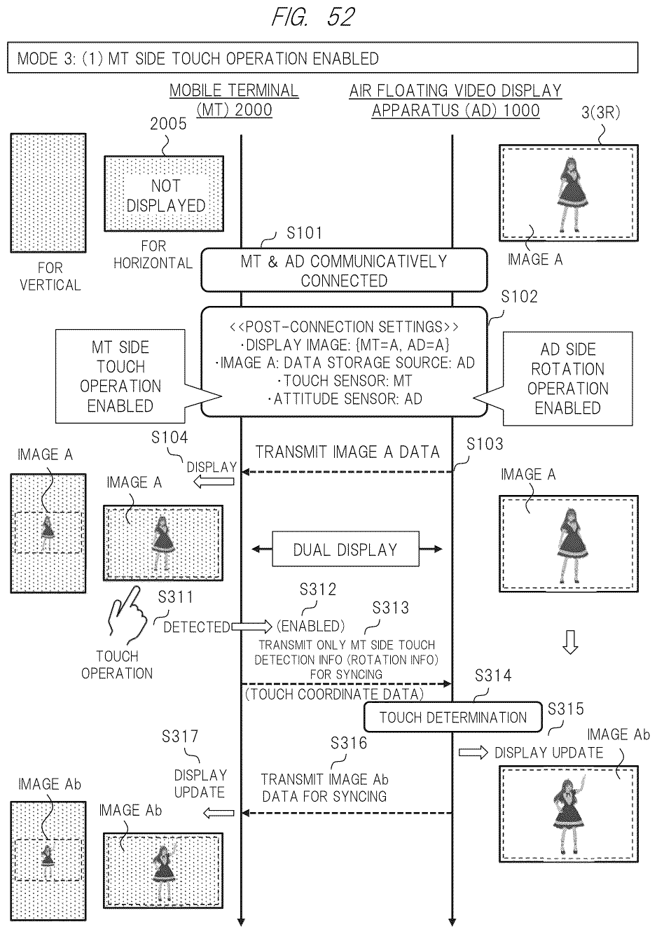

FIG. 52 shows a specific example of the sequence of Example 3, Mode 3 in FIG. 32B. Mode 3 differs from Mode 1 in that the touch operation on the MT side is enabled. FIG. 52 shows Mode 3, specifically showing that the touch operation on the MT side is enabled. Steps S101 to S104 are the same as in FIG. 46. In step S102, for post-connection configuration, the mobile terminal (MT) 2000 is set as the enabled touch sensor used for detecting the touch operation.

In step S311, assume the touch operation by the user 230 is performed on the image A on the mobile terminal (MT) 2000 side. In step S312, the touch sensor and controller on the MT side detect this touch operation, and based on the post-connection settings in step S102, determine this touch operation as enabled.

In step S313, based on the touch operation being enabled, the mobile terminal (MT) 2000 executes a predetermined processing operation such as display update processing that is predefined to correspond to the touch operation on the image A. However, since the mobile terminal (MT) 2000 does not hold the data for updating the display of the image A (the original data related to the image A, e.g., data for the image Ab), it cannot yet execute the display update processing. In step S313, the mobile terminal (MT) 2000 first transmits the touch detection information (e.g., touch coordinate data) from the touch sensor on the MT side to the air floating video display apparatus (AD) 1000 side for synchronization.

In step S314, the air floating video display apparatus (AD) 1000 performs the touch determination for the image A based on the acquired touch detection information. In step S315, based on the determination result, it executes a predetermined processing corresponding to the touch operation such as the display update processing. As a result, the image A changes to the image Ab. Since the AD side holds the original data for the image A, it can generate the image Ab. In step S316, the air floating video display apparatus (AD) 1000 transmits the data for the updated image Ab to the mobile terminal (MT) 2000 for synchronization. In step S317, based on the acquired data for the image Ab, the mobile terminal (MT) 2000 displays the image Ab on the screen 2005 as part of the display update processing.

In this manner, in Mode 3, the touch operation on the mobile terminal (MT) 2000 side becomes enabled, and dual display and synchronization control between the image A on the mobile terminal (MT) 2000 side and the image A on the air floating video display apparatus (AD) 1000 side are realized.

Note that, in the example of FIG. 52, since the mobile terminal (MT) 2000 does not hold the original data for the image A (data capable of generating image Ab, display update processing definitions, etc.), the display update is achieved by acquiring the data for the image Ab from the air floating video display apparatus (AD) 1000 holding the original data. The following modification is also possible. In step S103, when transmitting the data for the image A from AD to MT, it is possible to transmit not only the data for the image A but also a dataset enabling display updates for image A. In this case, when the touch operation is performed on the image A on the MT side, the MT performs synchronization with the AD side as in step S313 and generates and displays the image Ab based on that dataset. This modification is similarly adopted to each mode.

### Mode 3: Explanation (2)

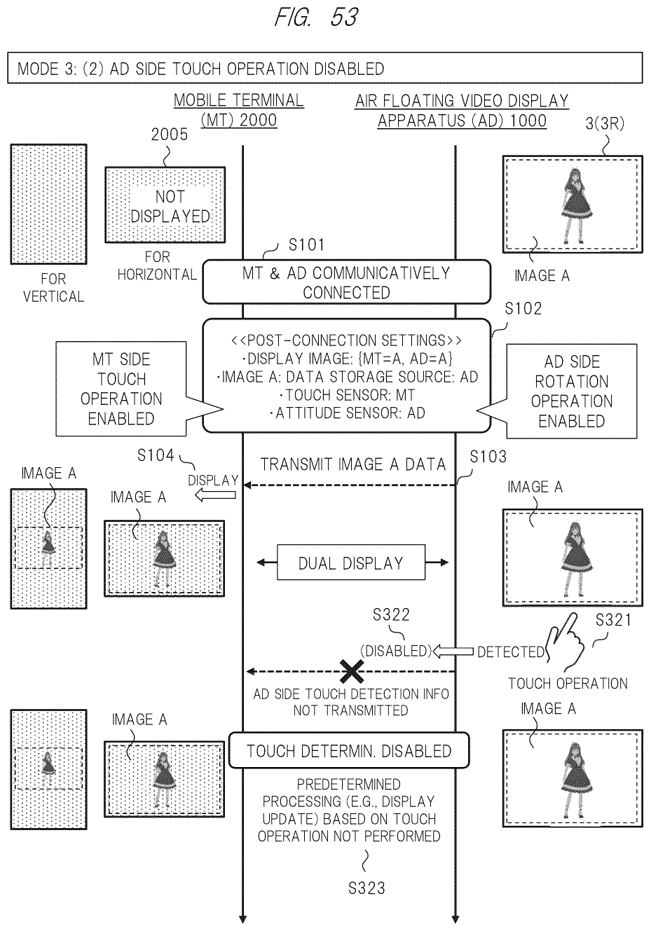

FIG. 53 shows Mode 3, specifically showing that the touch operation on the AD side is disabled. Steps S101 to S104 are the same as in FIG. 46. In step S321, assume the touch operation by the user 230 is performed on the image A of the air floating video 3 on the air floating video display apparatus (AD) 1000 side. In step S322, the touch sensor and video processor on the AD side detect this touch operation, and based on the post-connection settings in step S102, determine this touch operation as disabled.

In step S323, based on the above-described touch operation being disabled, the air floating video display apparatus (AD) 1000 does not execute a predetermined processing such as display update processing which is predefined to correspond to the touch operation on the image A. The air floating video display apparatus (AD) 1000 does not perform synchronization with the mobile terminal (MT) 2000. That is, the air floating video display apparatus (AD) 1000 does not transmit the touch detection information on the AD side to the MT side. As a result, the image A on the AD side and the image A on the MT side remain unchanged.

In this manner, in Mode 3, the touch operation on the air floating video display apparatus (AD) 1000 side is disabled, and the dual display state of the image A on the mobile terminal (MT) 2000 side and the image A on the air floating video display apparatus (AD) 1000 side is maintained.

Note that, if the rotation operation is performed on the AD side in Mode 3, the behavior is the same as in Mode 1 in FIG. 47. If the rotation operation is performed on the MT side in Mode 3, the behavior is the same as in Mode 1 in FIG. 49.

### Mode 4: Explanation (1)

Regarding Example 4, Mode 4 in FIG. 32B, the sequence details are omitted as they overlap with the explanations for Modes 1 to 3. In Mode 4, at step S102, for the post-connection settings, both touch operation detection and rotation operation detection on the mobile terminal (MT) 2000 side are set as enabled. That is, in Mode 4, the touch operation and the rotation operation on the mobile terminal (MT) 2000 side are enabled. If the touch operation is performed on the MT side (enabled), the behavior is the same as in Mode 3 in FIG. 52. If the rotation operation is performed on the MT side (enabled), the behavior is the same as in Mode 2 of FIG. 50. If the touch operation is performed on the AD side (disabled), the behavior is the same as in Mode 3 in FIG. 53. If the rotation operation is performed on the AD side (disabled), the behavior is the same as in Mode 2 in FIG. 51.

### Mode 5: Explanation (1)

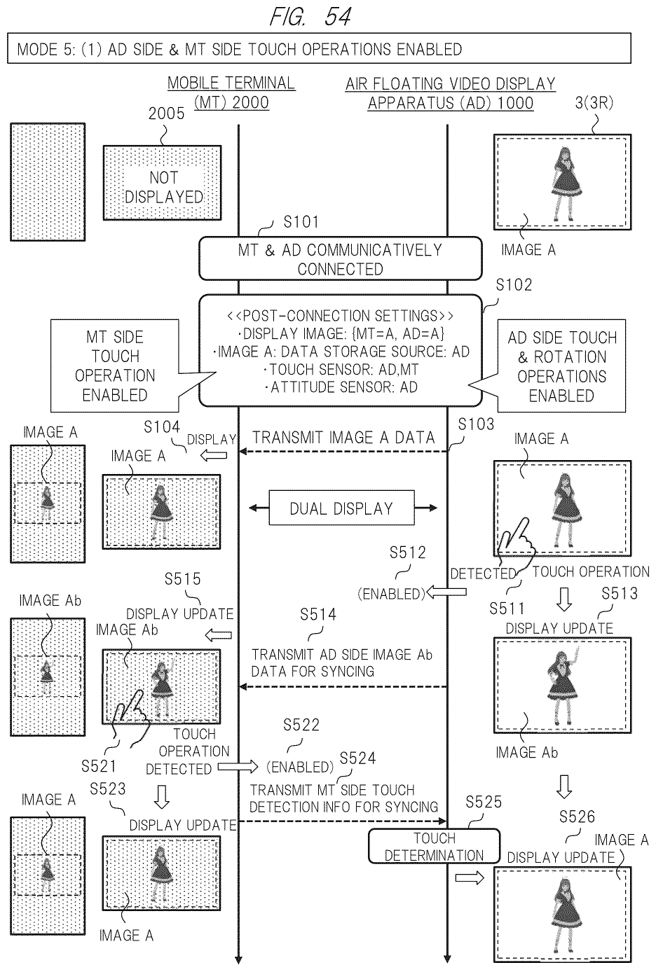

FIG. 54 shows a specific example of the sequence of Example 5, Mode 5 in FIG. 32B. FIG. 54 specifically shows that both the touch operation on the mobile terminal (MT) 2000 side and the touch operation on the air floating video display apparatus (AD) 1000 side are enabled. In Mode 5, during the post-connection configuration in step S102, both the mobile terminal (MT) 2000 side and the air floating video display apparatus (AD) 1000 side are set as enabled for touch operation detection. That is, in Mode 5, the touch operations are enabled on both the mobile terminal (MT) 2000 side and the air floating video display apparatus (AD) 1000 side. For the rotation operation detection, similar to Modes 1 and 3, the air floating video display apparatus (AD) 1000 side is set as enabled.

If the touch operation is performed on the MT side (enabled), the behavior is the same as in Mode 3 in FIG. 52. If the touch operation is performed on the AD side (enabled), the behavior is the same as in Mode 1 in FIG. 46. If the rotation operation is performed on the AD side (enabled), the behavior is the same as in Mode 1 in FIG. 47. If the rotation operation is performed on the MT side (disabled), the behavior is the same as in Mode 1 in FIG. 49.

In FIG. 54, first, in step S511, assume the touch operation is performed on the image A of the screen of the air floating video 3 on the air floating video display apparatus (AD) 1000 side. In step S512, the air floating video display apparatus (AD) 1000 detects this touch operation, and based on the settings in step S102, determines this touch operation as enabled. In step S513, the air floating video display apparatus (AD) 1000 executes a predetermined processing corresponding to this touch operation such as display update. As a result, the image A of the air floating video 3 changes to the image Ab. In step S514, the air floating video display apparatus (AD) 1000 transmits the data for the image Ab on the AD side to the mobile terminal (MT) 2000 side for synchronization. In step S515, based on the acquired data for the image Ab, the mobile terminal (MT) 2000 displays the image Ab on the screen 2005. This changes the image A on the screen 2005 to the image Ab as the display update.

Next, in step S521, assume the touch operation is performed on the image Ab on the screen 2005 of the mobile terminal (MT) 2000. In step S522, the mobile terminal (MT) 2000 detects this touch operation, and based on the setting in step S102, determines this touch operation as enabled. In step S523, the mobile terminal (MT) 2000 executes a predetermined processing corresponding to this touch operation such as the display update. Here, this display update is to revert the image Ab back to the image A. Since the mobile terminal (MT) 2000 has already acquired the data for the original image A, this display update is possible. As a result, the image Ab on the screen 2005 changes to the image A. In addition, in step S524, the mobile terminal (MT) 2000 transmits the touch detection information from the MT side to the air floating video display apparatus (AD) 1000 for synchronization. In step S525, the air floating video display apparatus (AD) 1000 performs the touch determination based on the acquired touch detection information. In step S526, based on the determination result, the air floating video display apparatus (AD) 1000 changes the image Ab of the air floating video 3 to the image A as the display update.

In this manner, in Mode 5, dual display and synchronization control can be realized regardless of whether the touch operation is performed on the mobile terminal 2000 side or the air floating video display apparatus 1000 side. Note that, if the MT side lacks the data required for the predetermined processing in step S523, it can request and acquire that data from the AD side holding the original data.

### Mode 6: Explanation (1)

Regarding Example 6, Mode 6 in FIG. 32B, the sequence details are omitted as they overlap with the explanations for Modes 1 to 5. In Mode 6, during the post-connection settings in step S102, both the mobile terminal (MT) 2000 side and the air floating video display apparatus (AD) 1000 side are set as enabled for the touch operation detection, similar to Mode 5. Additionally, unlike Mode 5, the rotation operation detection is enabled on the mobile terminal (MT) 2000 side in Mode 6. That is, in Mode 6, the rotation operation on the mobile terminal (MT) 2000 side is enabled. The touch operation behavior is the same as in Mode 5 in FIG. 54. If the rotation operation is performed on the MT side (enabled), the behavior is the same as in Mode 2 in FIG. 50. If the rotation operation is performed on the AD side (disabled), the behavior is the same as in Mode 2 in FIG. 51.

### Mode 7: Explanation (1)

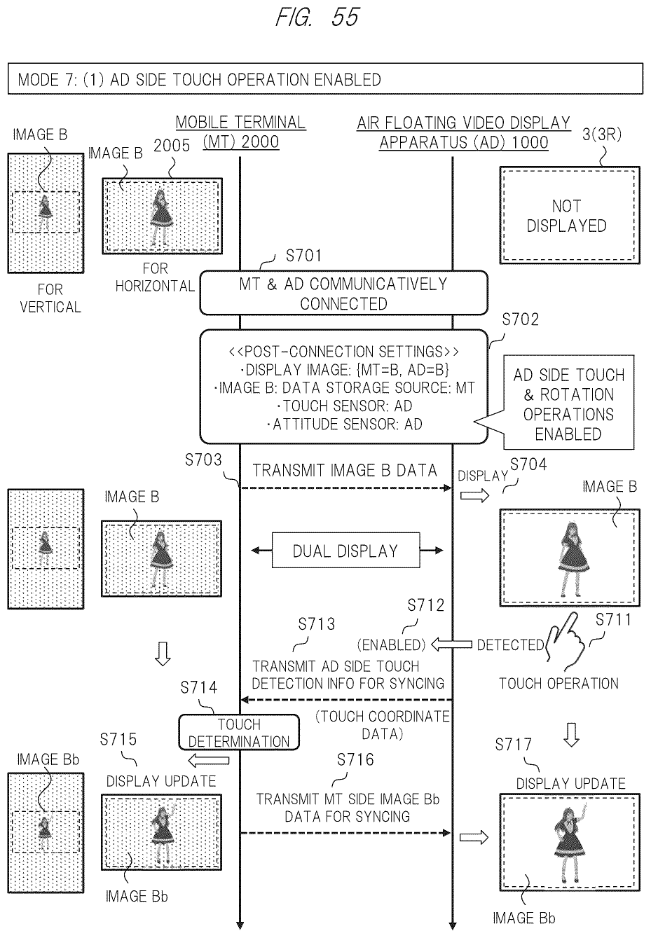

FIG. 55 shows a specific example of the sequence of processing and operation between the mobile terminal (MT) 2000 of this system and the air floating video display apparatus (AD) 1000 for the case of Example 7, Mode 7 in FIG. 32B. FIG. 55 specifically shows that the touch operation on the AD side is enabled. Initially, before step S701, the system is in the pre-connection state. Assume no image is displayed on the screen of the air floating video 3 on the air floating video display apparatus (AD) 1000 shown on the right. Displays of any applications, GUIs or the like may still be present. Assume that the image B (or content B) is displayed on the screen 2005 on the mobile terminal (MT) 2000 side shown on the left.

In step S701, assume the mobile terminal (MT) 2000 has established a communicative connection with the air floating video display apparatus (AD) 1000. In step S702, the system performs the post-connection settings as shown in the row for Example 7 in FIG. 32B. In the “post-connection settings”, for the display image of each apparatus, the display image on the mobile terminal (MT) 2000 side is the image B. The display image of the air floating video 3 on the air floating video display apparatus (AD) 1000 side is the same image B as that on the mobile terminal (MT) 2000 side. The data storage source for the image B is the MT. In addition, in the “post-connection settings”, the enabled touch sensor used for detecting touch operations is set as the AD-side touch sensor (touch sensor 10008 in FIG. 35), and the enabled attitude sensor used for detecting the rotation operation is set as the attitude sensor (attitude sensor 10009 in FIG. 35) on the AD side. In other words, the post-connection settings in step S702 correspond to enabling the touch operation and the rotation operation on the AD side.

In step S703, for example, the image data for the image B stored in the mobile terminal 2000 is transmitted/transferred to the air floating video display apparatus 1000. In step S704, the air floating video display apparatus 1000 displays the image B on the screen of the air floating video 3 based on that image data. As a result, the dual display state of the image B on both apparatuses can be achieved as illustrated.

Next, in step S711, assume the touch operation by the user 230 is performed on the image B of the air floating video 3 on the air floating video display apparatus (AD) 1000 side. In step S712, the touch sensor and video processor on the AD side detect this touch operation, and based on the post-connection settings in step S102, determine this touch operation as enabled.

Based on the above-described touch operation being enabled, the air floating video display apparatus (AD) 1000 executes a predetermined processing such as display update processing predefined to correspond to the touch operation on the image B. However, since the air floating video display apparatus (AD) 1000 does not hold the original data for the image B, it cannot yet execute the display update processing. In step S713, the air floating video display apparatus (AD) 1000 transmits the touch detection information (e.g., touch coordinate data) on the AD side to the mobile terminal (MT) 2000 side for synchronization. In step S714, the mobile terminal (MT) 2000 performs the touch determination based on the acquired touch detection information. In step S315, based on the determination result, it executes the display update processing. For the processing, the mobile terminal (MT) 2000 generates the image Bb based on the data for the image B, and displays the image Bb on the screen 2005. In step S716, the mobile terminal (MT) 2000 transmits the data for the image Bb to the air floating video display apparatus (AD) 1000 for synchronization. In step S717, based on the acquired data for the image Bb, the air floating video display apparatus (AD) 1000 displays the image Bb on the screen of the air floating video 3 as the display update.

In this manner, based on the setting of Mode 7, dual display and synchronization control of the image B across the two apparatuses are realized. Specifically, the display control corresponding to the touch operation for the air floating video 3 on the AD side can be reflected in the images on both the AD side and the MT side.

### Mode 7: Explanation (2)

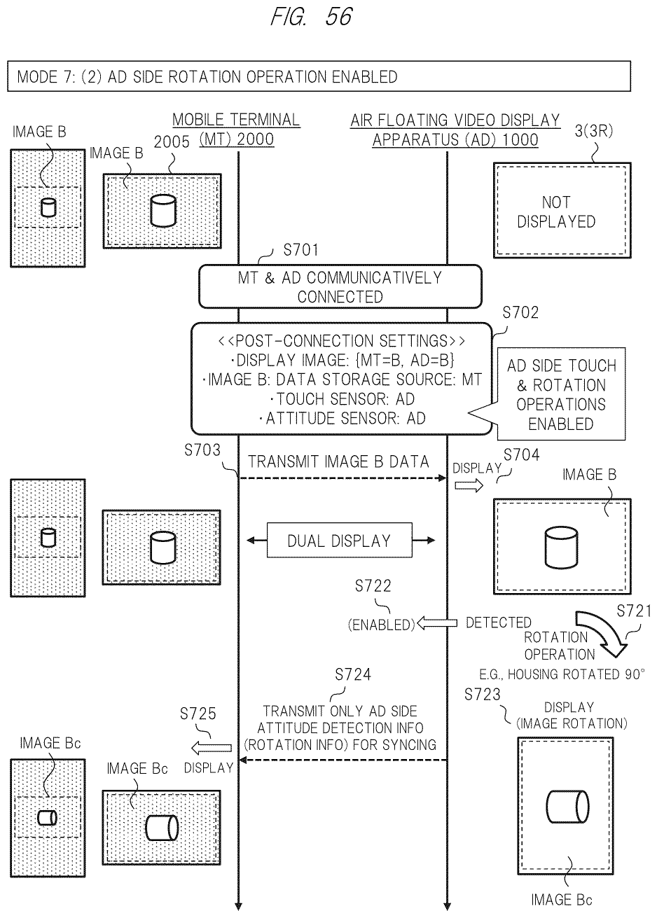

FIG. 56 shows Mode 7, specifically showing that the rotation operation is enabled on the air floating video display apparatus (AD) 1000 side. Steps S701 to S704 are the same as in FIG. 55. In step S721, assume the rotation operation has been performed on the image B of the air floating video 3 on the air floating video display apparatus (AD) 1000 side. This rotation operation is, for example, a rotation of the housing 1190. In step S722, the attitude sensor and video processor on the AD side detect this attitude change, that is, the rotation operation, and based on the post-connection settings in step S702, determine this rotation operation as enabled.

In step S723, based on the above-described rotation operation being enabled, the air floating video display apparatus (AD) 1000 executes a predetermined processing corresponding to the rotation operation. In the present example, the image rotation which is the predetermined processing maintains the arrangement relationship of the image B in the landscape screen such that, from the perspective of the user 230, the image B appears as if it were the rotated image Bc. The AD side is capable of generating the rotated image Bc based on the data for the image B.

In step S724, the air floating video display apparatus (AD) 1000 transmits the attitude detection information at the time of rotation to the mobile terminal (MT) 2000 for synchronization. In step S725, the mobile terminal (MT) 2000 generates the rotated image Bc based on the acquired attitude detection information and the data for the image B, and displays the image Bc on the screen 2005.

In this manner, in Mode 7, when the rotation operation is performed on the air floating video 3 on the AD side, the display control corresponding to that rotation operation can be reflected in both the image B on the AD side and the image B on the MT side. After the rotation operation, the image Bc on the AD side and the image Bc on the MT side are displayed in their rotated states and are aligned.

### Mode 7: Explanation (3)

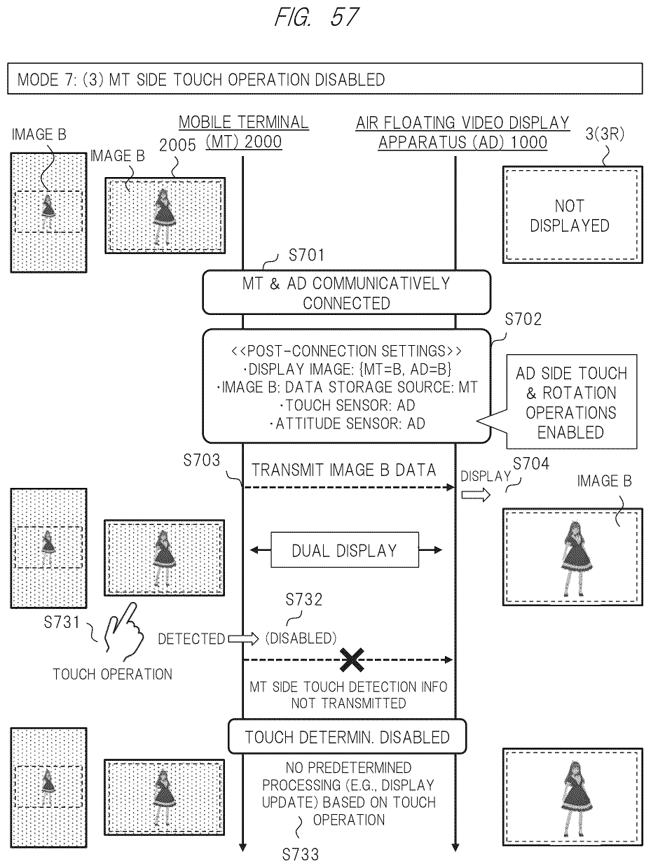

FIG. 57 shows Mode 7, specifically showing that the touch operation on the mobile terminal (MT) 2000 side is disabled. Steps S701 to S704 are the same as in FIG. 55. In step S731, assume the touch operation has been performed on the image B on the screen 2005 on the mobile terminal (MT) 2000 side. In step S732, the touch sensor and controller on the MT side detect this touch operation, and based on the post-connection settings in step S702, determine this touch operation as disabled.

In step S733, based on the above-described touch operation being disabled, the mobile terminal (MT) 2000 does not execute a predetermined processing (e.g., display update) corresponding to the touch operation, and also does not perform synchronization (e.g., transmitting of touch detection information) on the air floating video display apparatus (AD) 1000 side.

In this manner, in Mode 7, the touch operation on the mobile terminal (MT) 2000 side is disabled, and the dual display state of the image B on the mobile terminal (MT) 2000 side and the image B on the air floating video display apparatus (AD) 1000 side is maintained.

### Mode 7: Explanation (4)

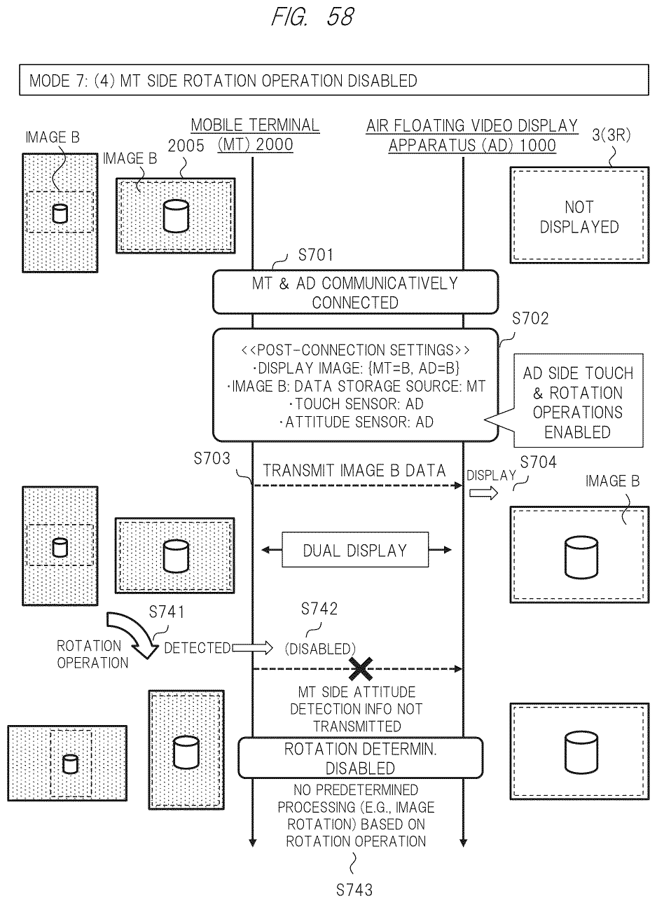

FIG. 58 shows Mode 7, specifically showing that the rotation operation on the mobile terminal (MT) 2000 side is disabled. Steps S701 to S704 are the same as in FIG. 55. In step S741, assume the rotation operation (e.g., housing rotation) is performed on the image B on the screen 2005 on the mobile terminal (MT) 2000 side. In step S742, the attitude sensor and controller on the MT side detect this rotation operation, and based on post-connection settings in step S702, determine this rotation operation as disabled.

In step S743, based on the above-described rotation operation being disabled, the mobile terminal (MT) 2000 does not execute a predetermined processing (e.g., image rotation) corresponding to the rotation operation, and also does not perform synchronization (e.g., transmitting of attitude detection information) on the air floating video display apparatus (AD) 1000 side.

In this manner, in Mode 7, the rotation operation on the mobile terminal (MT) 2000 side is disabled, and the dual display state of the image B on the mobile terminal (MT) 2000 side and the image B on the air floating video display apparatus (AD) 1000 side is maintained.

### Mode 8: Explanation (1)

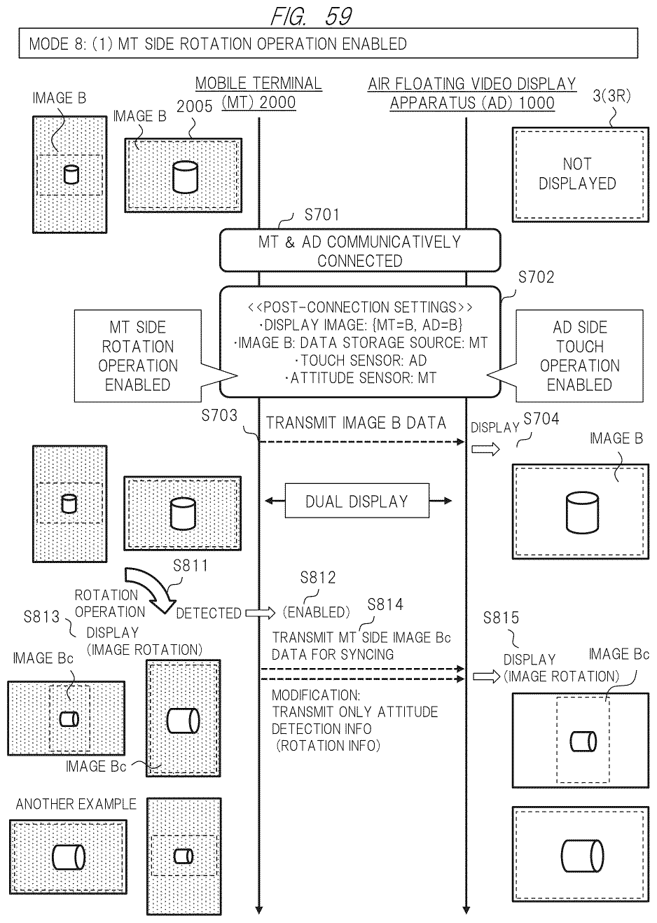

FIG. 59 shows a specific example of the sequence of Example 8, Mode 8 in FIG. 32B. Mode 8 differs from Mode 7 in that the rotation operation on the MT side is enabled. FIG. 59 shows Mode 8, specifically showing that the rotation operation on the MT side is enabled. Steps S701 to S704 are the same as in FIG. 55.

In step S702, for the post-connection settings, the mobile terminal (MT) 2000 is set as the enabled attitude sensor used for the rotation operation detection.

In step S811, assume the rotation operation is performed on the image B displayed on the screen 2005 on the mobile terminal (MT) 2000 side. This rotation operation is, for example, a 90-degree rotation of the housing. In step S812, the attitude sensor and controller on the MT side detect this attitude change, that is, the rotation operation, and based on the post-connection settings in step S702, determine this rotation operation as enabled.

In step S813, based on the above-described rotation operation being enabled, the mobile terminal (MT) 2000 executes a predetermined processing (image rotation) corresponding to that rotation operation. In the present example, this processing (image rotation) maintains the arrangement relationship of the image B in the screen 2005. The image B in the screen 2005 in the vertical orientation changes to the rotated image Bc in the screen 2005 in the horizontal orientation. The image B in the screen 2005 in the horizontal orientation changes to the rotated image Bc in the screen 2005 in the vertical orientation. That is, from the perspective of the user 230, the image B appears as if it were the rotated image Bc. In the present example, the arrangement relationship of display image in the screen 2005 is maintained. Therefore, the image B and the image Bc are substantially the same, and the display on the display panel 20012 remains unchanged.

In step S814, the mobile terminal (MT) 2000 transmits the image data for the rotated image Bc (in other words, only rotation information) to the air floating video display apparatus (AD) 1000 for synchronization. Alternatively, in a modification, the mobile terminal (MT) 2000 may transmit only the attitude detection information (in other words, rotation information) to the air floating video display apparatus (AD) 1000 for synchronization. In step S815, the air floating video display apparatus (AD) 1000 displays the image Bc on the air floating video 3 based on the acquired image data for the image Bc or the attitude detection information. As a result, from the perspective of the user 230, the image B on the AD side changes to the rotated image Bc.

In this manner, in Mode 8, the rotation operation on the mobile terminal (MT) 2000 side becomes enabled, realizing dual display and synchronization control between the image B on the mobile terminal (MT) 2000 side and the image B on the air floating video display apparatus (AD) 1000 side.

### Mode 8: Explanation (2)

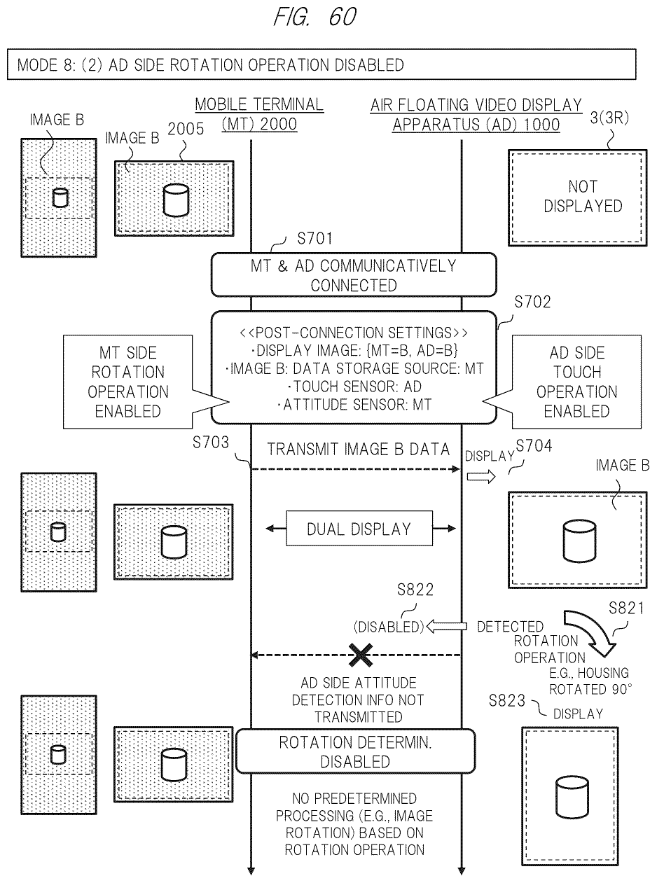

FIG. 60 shows Mode 8, specifically showing that the rotation operation on the AD side is disabled. In step S821, assume the rotation operation is performed on the image B on the screen of the air floating video 3 on the air floating video display apparatus (AD) 1000 side. This rotation operation is, for example, a 90-degree rotation of the housing 1190. In step S822, the attitude sensor and video processor on the AD side detect this attitude change, that is, the rotation operation, and based on the post-connection settings in step S702, determine this rotation operation as disabled.

In step S823, based on the above-described rotation operation being disabled, the air floating video display apparatus (AD) 1000 does not execute the predetermined processing (image rotation) corresponding to that rotation operation. In the present example, this processing (image rotation) maintains the arrangement relationship of the image B in the screen. Specifically, it ensures that the image B remains within the portrait screen after rotation from the perspective of the user 230, as it was within the landscape screen before rotation. For this purpose, in step 3823, the air floating video display apparatus (AD) 1000 rotates the image B in the screen of the air floating video 3 by 90 degrees. In addition, since the air floating video display apparatus (AD) 1000 does not perform synchronization with the mobile terminal (MT) 2000, it does not transmit the attitude detection information on the AD side to the MT.

In this manner, in Mode 8, the rotation operation on the air floating video display apparatus (AD) 1000 side becomes disabled, and the dual display state of the image B on the mobile terminal (MT) 2000 side and the image B on the air floating video display apparatus (AD) 1000 side is maintained.

### Mode 9: Explanation (1)

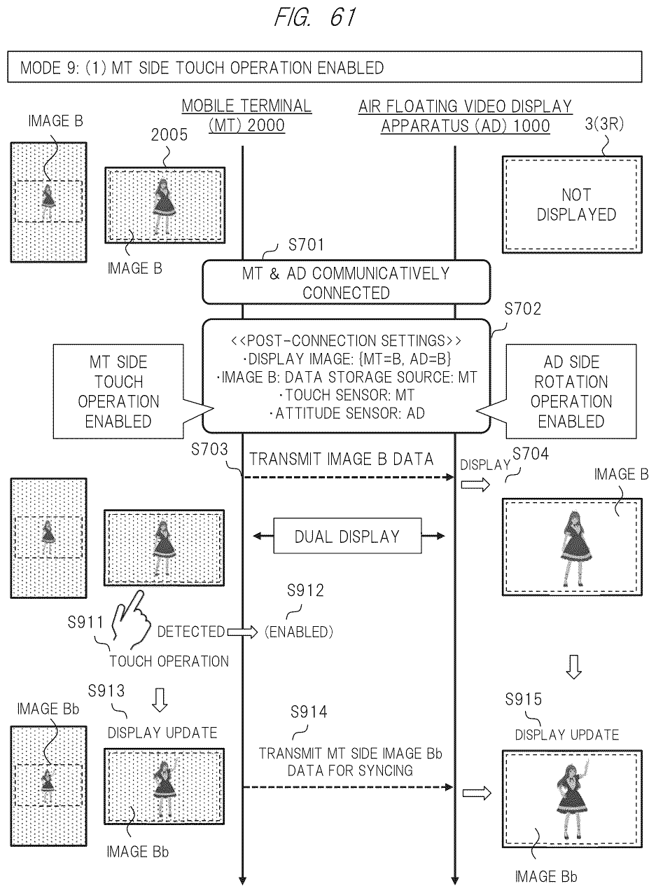

FIG. 61 shows a specific example of the sequence of Example 9, Mode 9 in FIG. 32B. Mode 9 differs from Mode 7 in that the touch operation on the MT side is enabled. FIG. 61 shows Mode 9, specifically showing that the touch operation on the MT side is enabled. Steps S701 to S704 are the same as in FIG. 55. In step S702, for post-connection configuration, the mobile terminal (MT) 2000 is set as the enabled touch sensor used for detecting the touch operation.

In step S911, assume the touch operation by the user 230 is performed on the image B on the mobile terminal (MT) 2000 side. In step S912, the touch sensor and controller on the MT side detect this touch operation, and based on the post-connection settings in step S702, determine this touch operation as enabled.

In step S913, based on the above-described touch operation being enabled, the mobile terminal (MT) 2000 executes a predetermined processing such as display update processing that is predefined to correspond to the touch operation on the image B. As a result, the image B on the screen 2005 changes to the image Bb. In step S914, the mobile terminal (MT) 2000 transmits the data for the image Bb on the MT side to the air floating video display apparatus (AD) 1000 for synchronization. In step S915, based on the acquired data for the image Bb, the air floating video display apparatus (AD) 1000 displays the image Bb on the screen of the air floating video 3 as the display update.

In this manner, in Mode 9, the touch operation on the mobile terminal (MT) 2000 side becomes enabled, and dual display and synchronization control between the image B on the mobile terminal (MT) 2000 side and the image B on the air floating video display apparatus (AD) 1000 side are realized.

### Mode 9: Explanation (2)

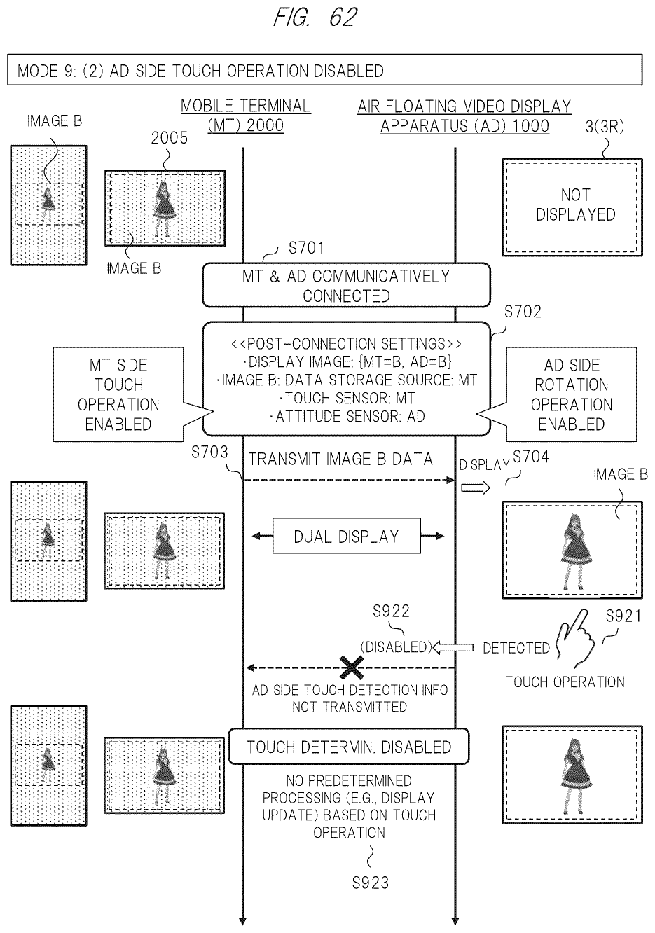

FIG. 62 shows Mode 9, specifically showing that the touch operation on the AD side is disabled. Steps S701 to S705 are the same as in FIG. 55. In step S921, assume the touch operation by the user 230 is performed on the image B of the air floating video 3 on the air floating video display apparatus (AD) 1000 side. In step S922, the touch sensor and video processor on the AD side detect this touch operation, and based on the post-connection settings in step S702, determine this touch operation as disabled.

In step S923, based on the above-described touch operation being disabled, the air floating video display apparatus (AD) 1000 does not execute a predetermined processing such as display update processing which is predefined to correspond to the touch operation on the image B. The air floating video display apparatus (AD) 1000 does not perform synchronization with the mobile terminal (MT) 2000 side. That is, the air floating video display apparatus (AD) 1000 does not transmit the touch detection information on the AD side to the MT side. As a result, the image B on the AD side and the image B on the MT side remain unchanged.

In this manner, in Mode 9, the touch operation on the air floating video display apparatus (AD) 1000 side is disabled, and the dual display state of the image B on the mobile terminal (MT) 2000 side and the image B on the air floating video display apparatus (AD) 1000 side is maintained. Note that, if the rotation operation is performed on the AD side in Mode 9, the behavior is the same as in Mode 7 in FIG. 56. If the rotation operation is performed on the MT side in Mode 9, the behavior is the same as in Mode 7 in FIG. 58. 58.

### Mode 10: Explanation (1)

Regarding Example 10, Mode 10 in FIG. 32B, the sequence details are omitted as they overlap with the explanations for Modes 7 to 9. In Mode 10, at step S702, for the post-connection settings, both touch operation detection and rotation operation detection on the mobile terminal (MT) 2000 side are set as enabled. That is, in Mode 10, the touch operation and the rotation operation on the mobile terminal (MT) 2000 side are enabled. If the touch operation is performed on the MT side (enabled), the behavior is the same as in Mode 9 in FIG. 61. If the rotation operation is performed on the MT side (enabled), the behavior is the same as in Mode 8 in FIG. 59. If the touch operation is performed on the AD side (disabled), the behavior is the same as in Mode 9 in FIG. 62. If the rotation operation is performed on the AD side (disabled), the behavior is the same as in Mode 8 in FIG. 60.

### Mode 11: Explanation (1)

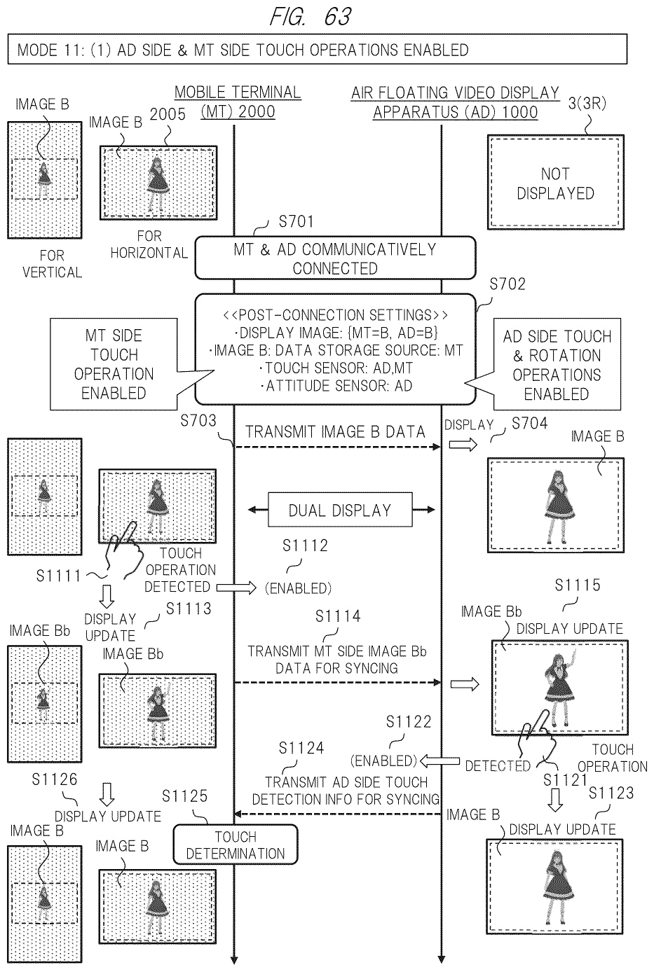

FIG. 63 shows a specific example of the sequence of Example 11, Mode 11 in FIG. 32B. FIG. 63 specifically shows that both the touch operation on the mobile terminal (MT) 2000 side and the touch operation on the air floating video display apparatus (AD) 1000 side are enabled. In Mode 11, during the post-connection configuration in step S702, both the mobile terminal (MT) 2000 side and the air floating video display apparatus (AD) 1000 side are set as enabled for touch operation detection. That is, in Mode 11, the touch operations are enabled on both the mobile terminal (MT) 2000 side and the air floating video display apparatus (AD) 1000 side. For the rotation operation detection, similar to Modes 7 and 9, the air floating video display apparatus (AD) 1000 side is set as enabled.

If the touch operation is performed on the MT side (enabled), the behavior is the same as in Mode 9 in FIG. 61. If the touch operation is performed on the AD side (enabled), the behavior is the same as in Mode 7 in FIG. 55. If the rotation operation is performed on the AD side (enabled), the behavior is the same as in Mode 7 in FIG. 56. If the rotation operation is performed on the MT side (disabled), the behavior is the same as in Mode 7 in FIG. 58.

In FIG. 63, first, in step S1111, assume the touch operation is performed on the image B on the screen 2005 on the mobile terminal (MT) 2000 side. In step S1112, the mobile terminal (MT) 2000 detects this touch operation, and based on the settings in step S702, determines this touch operation as enabled. In step S1113, the mobile terminal (MT) 2000 executes a predetermined processing corresponding to this touch operation such as display update. As a result, the image B on the screen 2005 changes to the image Bb. In step S1114, the air floating video display apparatus (AD) 1000 transmits the data for the image Bb on the MT side to the air floating video display apparatus (AD) 1000 side for synchronization. In step S1115, based on the acquired data for the image Bb, the air floating video display apparatus (AD) 1000 displays the image Bb on the screen of the air floating video 3. This changes the image B on the screen of the air floating video 3 to the image Bb as the display update.

Next, in step S1121, assume the touch operation is performed on the image Bb on the screen of the air floating video 3 on the air floating video display apparatus (AD) 1000 side. In step S1122, the air floating video display apparatus (AD) 1000 detects this touch operation, and based on the setting in step S702, determines this touch operation as enabled. In step S1123, the air floating video display apparatus (AD) 1000 executes a predetermined processing corresponding to this touch operation such as the display update. Here, this display update is to revert the image Bb back to the image B. Since the air floating video display apparatus (AD) 1000 has already acquired the data for the original image B, this display update is possible. As a result, the image Bb on the screen of the air floating video 3 changes to the image B. In addition, in step S1124, the air floating video display apparatus (AD) 1000 transmits the touch detection information on the AD side to the mobile terminal (MT) 2000 side for synchronization. In step S1125, the mobile terminal (MT) 2000 performs the touch determination based on the acquired touch detection information, and in step S1126, based on the determination result, changes the image Bb on the screen 2005 to the image B as the display update.

In this manner, in Mode 11, dual display and synchronization control can be realized regardless of whether the touch operation is performed on the mobile terminal 2000 side or the air floating video display apparatus 1000 side. Note that, if the AD side lacks the data required for the predetermined processing in step S1123, it can request and acquire that data from the MT side holding the original data.

### Mode 12: Explanation (1)

Regarding Example 12, Mode 12 in FIG. 32B, the sequence details are omitted as they overlap with the explanations for Modes 7 to 11. In Mode 12, during the post-connection settings in step S702, both the mobile terminal (MT) 2000 side and the air floating video display apparatus (AD) 1000 side are set as enabled for the touch operation detection, similar to Mode 11. Additionally, unlike Mode 11, the rotation operation detection is set as enabled on the mobile terminal (MT) 2000 side in Mode 12. That is, in Mode 12, the rotation operation on the mobile terminal (MT) 2000 side is enabled. The touch operation behavior is the same as in Mode 11 in FIG. 63. If the rotation operation is performed on the MT side (enabled), the behavior is the same as in Mode 8 in FIG. 59. If the rotation operation is performed on the AD side (disabled), the behavior is the same as in Mode 8 in FIG. 60.

### Usage Example of Modes

When the above-described Modes 1 to 12 and the like are selectable, the user 230 can differentiate mode usage as follows. For example, as in state A of FIG. 30, after connecting to this system, the image A on the air floating video display apparatus 1000 side is acquired and displayed as the image A on the mobile terminal 2000 side. Initially, if the user 230 is using the mobile terminal 2000 in a vertical orientation, the image A is displayed in the screen 2005 at a relatively small size, as shown in example state B of FIG. 36. If the user 230 wishes to view the image A at a larger size, he/she rotates the housing of the mobile terminal 2000 to a horizontal orientation. As a result, a configuration such as the state D of FIG. 36 can be achieved. If the user 230 does not wish to rotate the image A, he/she can specify, for example, Mode 1 or Mode 3. The system then switches to the specified mode. In these modes, the rotation operation detection is enabled on the air floating video display apparatus (AD) 1000 side and disabled on the mobile terminal (MT) 2000 side. Therefore, in these modes, when the user 230 rotates the housing of the mobile terminal 2000 to a horizontal orientation, the image A in the screen 2005 remains in a non-rotated state from the perspective of the user 230. For example, in FIG. 49, the state changes from state 4901 to state 4902. Since the mobile terminal 2000 has rotation operation disabled, it does not perform synchronization with the air floating video display apparatus (AD) 1000. Therefore, the image A on the air floating video 3 side also maintains its non-rotated state.

In addition, similar to the above-described example, when the image A is in the dual display state on two apparatuses, if the user 230 wishes to rotate the housing of the mobile terminal 2000 to a horizontal orientation to rotate the image A, he/she can specify, for example, Mode 2 or Mode 4. The system then switches to the specified mode. In these modes, the rotation operation detection is enabled on the mobile terminal (MT) 2000 side and disabled on the air floating video display apparatus (AD) 1000 side. Therefore, in these modes, when the user 230 rotates the housing of the mobile terminal 2000 to a horizontal orientation, the image A in the screen 2005 changes to a rotated state from the perspective of the user 230. For example, in FIG. 50, the state changes from state 5001 to state 5002. Since the mobile terminal 2000 has rotation operation enabled, it performs synchronization with the air floating video display apparatus (AD) 1000 side. Therefore, the image A on the air floating video 3 side also changes to the rotated state.

In the technique according to the present embodiment, by displaying the high-resolution and high-luminance video information in the air floating state, for example, the user can operate without feeling anxious about contact infection of infectious diseases. If the technique according to the present embodiment is applied to a system used by an unspecified number of users, it will be possible to provide a non-contact user interface that can reduce the risk of contact infection of infectious diseases and can eliminate the feeling of anxiety. In this way, it is possible to contribute to “Goal 3: Ensure healthy lives and promote well-being for all at all ages” in the Sustainable Development Goals (SDGs) advocated by the United Nations.

In addition, in the technique according to the present embodiment, only the normal reflected light is efficiently reflected with respect to the retroreflection plate by making the divergence angle of the emitted video light small and aligning the light with a specific polarized wave, and thus a bright and clear air floating video can be obtained with high light utilization efficiency. With the technique according to the present embodiment, it is possible to provide a highly usable non-contact user interface capable of significantly reducing power consumption. In this way, it is possible to contribute to “Goal 9: Build resilient infrastructure, promote inclusive and sustainable industrialization and foster innovation” and “Goal 11: Make cities and human settlements inclusive, safe, resilient and sustainable” in the Sustainable Development Goals (SDGs) advocated by the United Nations.

In the foregoing, various embodiments have been described in detail, but the present invention is not limited only to the above-described embodiments, and includes various modifications. For example, in the above-described embodiments, the entire system has been described in detail so as to make the present invention easily understood, and the present invention is not necessarily limited to that including all the configurations described above. Also, part of the configuration of one embodiment may be replaced with the configuration of another embodiment, and the configuration of one embodiment may be added to the configuration of another embodiment. Furthermore, another configuration may be added to part of the configuration of each embodiment, and part of the configuration of each embodiment may be eliminated or replaced with another configuration.

### EXPLANATION OF REFERENCE SIGNS

1, 10 . . . display apparatus, 2 . . . retroreflection plate, 3 . . . air floating video (aerial floating video), 3R . . . display range, 5 . . . retroreflector, 100 . . . transparent member, 101, 101B . . . polarization separator, 11 . . . liquid crystal display panel, 12 . . . absorptive polarization plate, 13 . . . light source apparatus, 230 . . . user, 1000 . . . air floating video display apparatus (aerial floating video display apparatus), 1190 . . . housing, 1351 . . . aerial operation detection sensor, 2005 . . . screen, 2000 . . . mobile terminal, 2900 . . . system, 2901, 2902, 2903, 2904 . . . image, 2910 . . . dual display function, 2920 . . . synchronization control function, 2930 . . . operation detection control function.

1. An aerial floating video display apparatus comprising:
a video processor;
a display configured to display a video that has been subjected to video processing by the video processor;
an optical system configured to generate an aerial floating video based on the video displayed on the display;
a recognition unit configured to recognize contact of an object with a display range of the aerial floating video; and
a communication unit configured to communicate with a user's mobile terminal,
wherein, when contact of the mobile terminal with the display range is recognized, a target image designated at the mobile terminal side is displayed as the aerial floating video.

2. The aerial floating video display apparatus according to claim 1,
wherein a display request from the mobile terminal to the aerial floating video display apparatus is generated before, during, or after contact of the mobile terminal with the display range, and
wherein, when contact of the mobile terminal with the display range is recognized, the display request is received, and a target image designated at the mobile terminal side is acquired from the mobile terminal or an external device via communication and displayed as the aerial floating video.

3. The aerial floating video display apparatus according to claim 1,
wherein, when contact of the mobile terminal with a specific region in the display range is recognized, a target image designated at the mobile terminal side is displayed as the aerial floating video.

4. The aerial floating video display apparatus according to claim 1,
wherein, during contact of the mobile terminal with the display range, when a specific attitude of the mobile terminal is recognized, a target image designated at the mobile terminal side is displayed as the aerial floating video.

5. The aerial floating video display apparatus according to claim 1,
wherein, after contact of the mobile terminal with the display range, when the mobile terminal entering a space behind the display range is recognized, a target image designated at the mobile terminal side is displayed as the aerial floating video.

6. The aerial floating video display apparatus according to claim 1,
wherein, during contact of the mobile terminal with the display range, when a contact duration exceeds a predetermined duration, a target image designated at the mobile terminal side is displayed as the aerial floating video.

7. The aerial floating video display apparatus according to claim 1,
wherein a guide image prompting an operation for contacting the mobile terminal with the display range is displayed as the air floating video.

8. The aerial floating video display apparatus according to claim 1,
wherein a guide image prompting an operation for contacting the mobile terminal with the display range is displayed on a screen of the mobile terminal.

9. The aerial floating video display apparatus according to claim 1,
wherein, when a non-visible region caused by contact of the mobile terminal with the display range is recognized, a hidden region in the display range that includes the non-visible region is determined, and an image is displayed as the air floating video in a display region excluding the hidden region.

10. The aerial floating video display apparatus according to claim 1,
wherein the recognition unit is one of: an aerial operation detection sensor configured to detect an aerial operation performed in a range including the display range; and an imager configured to capture the range including the display range.

11. The aerial floating video display apparatus according to claim 1, configured to:
recognize code displayed on a screen of the mobile terminal and acquire its information; and
when the code is recognized and when contact of the mobile terminal with the display range is recognized, a target image designated at the mobile terminal side is displayed as the aerial floating video.

12. The aerial floating video display apparatus according to claim 1,
wherein the mobile terminal is configured to recognize code displayed in the air floating video and acquire its information, and
wherein when the code is recognized and when contact of the mobile terminal with the display range is recognized, a target image designated at the mobile terminal side is displayed as the aerial floating video.

13. The aerial floating video display apparatus according to claim 11,
wherein the information of the code includes at least one type of information among:
a display request from the mobile terminal to the aerial floating video display apparatus;
a connection information regarding communication between the mobile terminal and the aerial floating video display apparatus;
an ID of the mobile terminal or an ID of the user; and
an ID of the target image or URL.

14. The aerial floating video display apparatus according to claim 1,
wherein, when contact of the mobile terminal with the display range is recognized, the image displayed in the air floating video is acquired by the mobile terminal side.

15.-16. (canceled)

17. An aerial floating video display apparatus comprising:
a video processor configured to perform video processing;
a display configured to display a video that has been subjected to video processing by the video processor;
an optical system configured to generate an aerial floating video based on the video displayed on the display;
a user operation detection mechanism configured to detect a user operation by a user on a display range in the aerial floating video; and
a communication unit configured to communicate with a user's mobile terminal,
wherein, based on the communicative connection with the user's mobile terminal, a first image displayed in the aerial floating video is also displayed on a screen of the mobile terminal as the first image, and/or a second image displayed on the screen of the mobile terminal is also displayed in the aerial floating video, and
wherein, based on detection and determination of the user operation on the first image displayed in the aerial floating video, a predetermined first processing for the first image in the aerial floating video is executed, and a control is performed to reflect the first processing also in the first image on the screen of the mobile terminal, and/or based on detection and determination of the user operation on the second image displayed on the screen of the mobile terminal on the mobile terminal side, a predetermined second processing for the second image on the screen of the mobile terminal is executed, and a control is performed to reflect the second processing also in the second image in the aerial floating video.

18. The aerial floating video display apparatus according to claim 17, configured to perform a control such that, as settings after communicative connected is established, the user operation and its detection on a display image in the aerial floating video on the aerial floating video display apparatus side and the user operation and its detection on a display image on the screen on the mobile terminal side are set as enabled or disabled, and based on the settings, the operation, detection, displaying, and processing are controlled.

19. The aerial floating video display apparatus according to claim 18, configured to:
perform, when communicatively connected, enabling or disabling settings for post-communicative connection, and
revert, when communicative connection is disconnected, the enabling or disabling settings to the settings before communicative connection.

20. The aerial floating video display apparatus according to claim 18,
wherein the user operation on a display image in the aerial floating video or on the screen of the mobile terminal includes a touch operation and a rotation operation,
wherein a touch sensor in the user operation detection mechanism of the aerial floating video display apparatus or a touch sensor in the mobile terminal is used to detect the touch operation, and
wherein an attitude sensor in the aerial floating video display apparatus or an attitude sensor in the mobile terminal is used to detect the rotation operation.

21. The aerial floating video display apparatus according to claim 18,
wherein, in a certain mode, the user operation and its detection for a display image in the aerial floating video on the aerial floating video display apparatus side are set as enabled, the user operation and its detection for a display image on the screen on the mobile terminal side are set as disabled

22. The aerial floating video display apparatus according to claim 18,
wherein, in a certain mode, the user operation and its detection for a display image in the aerial floating video on the aerial floating video display apparatus side are set as disabled, and the user operation and its detection for a display image on the screen on the mobile terminal side are set as enabled.

23. The aerial floating video display apparatus according to claim 18,
wherein, in a certain mode, the user operation and its detection for a display image in the aerial floating video on the aerial floating video display apparatus side are set as enabled, and the user operation and its detection for a display image on the screen on the mobile terminal side are also set as enabled.

24. The aerial floating video display apparatus according to claim 18,
wherein mode options are displayed in the aerial floating video of the aerial floating video display apparatus and/or on the screen of the mobile terminal, the modes corresponding to enabled or disabled settings regarding the user operation and its detection for a display image in the aerial floating video on the aerial floating video display apparatus side and regarding the user operation and its detection for a display image on the screen on the mobile terminal side, and enabled or disabled settings are performed based on the mode selected by the user.

25. The aerial floating video display apparatus according to claim 20,
wherein the touch sensor of the aerial floating video display apparatus includes an aerial operation detection sensor or camera configured to detect the hand or finger of the user or a position of an object relative to a display range of the aerial floating video.

26. The aerial floating video display apparatus according to claim 20,
wherein the rotation operation includes a rotation operation of a housing of the aerial floating video display apparatus or a housing of the mobile terminal,
wherein predetermined processing according to determination of the rotation operation includes displaying a display image in the aerial floating video or a display image on the screen of the mobile terminal such that the display image appears to be rotated from a perspective of the user.

27. The aerial floating video display apparatus according to claim 17, configured to display, when communicatively connected, a first image displayed in the aerial floating video also on the screen of the mobile terminal as the first image, and/or a second image displayed on the screen of the mobile terminal also in the aerial floating video as the second image, based on recognition of contact of the mobile terminal with the display range of the aerial floating video.

28.-29. (canceled)
